(19) United States
(12) Patent Application Publication
(10) Pub. No.: US 2019/0359888 A1
(43) Pub. Date: Nov. 28, 2019

(54) LIQUID CRYSTAL COMPOUND, LIQUID CRYSTAL COMPOSITION AND LIQUID CRYSTAL DISPLAY DEVICE

(71) Applicants: JNC CORPORATION, Tokyo (JP); JNC PETROCHEMICAL CORPORATION, Tokyo (JP)

(72) Inventors: Yasuyuki GOTOH, TOKYO (JP); Kazuo OKUMURA, CHIBA (JP); Akihiro TAKATA, CHIBA (JP); Takahiro KOBAYASHI, CHIBA (JP); Michiko SAWADA, CHIBA (JP)

(73) Assignees: JNC CORPORATION, Tokyo (JP); JNC PETROCHEMICAL CORPORATION, Tokyo (JP)

(21) Appl. No.: 16/418,996

(22) Filed: May 22, 2019

(30) Foreign Application Priority Data
May 22, 2018 (JP) 2018-098194

(51) Int. Cl. C09K 19/30; C09K 19/06; C09K 19/32; C09K 19/34

(52) U.S. Cl. CPC C09K 19/3066; C09K 19/062; C09K 19/32; C09K 2019/3422; C09K 19/3003; C09K 2019/3027; C09K 19/3402

(57) ABSTRACT

Liquid crystal compound satisfying at least one of physical properties such as high stability to heat or light, high maximum temperature, high clearing point, low minimum temperature of liquid crystal phase, small viscosity, suitable optical-anisotropy, large negative dielectric-anisotropy, suitable elastic constant and good compatibility with other liquid crystal compounds; liquid crystal composition containing the compound; and liquid crystal display device including the composition. Compound represented by formula (1), wherein R¹ is alkyl having 1 to 15 carbons; R² is alkyl having branched-chain and 3 to 15 carbons; A¹, A² are independently 1,2-cyclopropylene; Z¹, Z² are independently single bond or alkylene having 1 to 15 carbons; L¹, L² are fluorine, chlorine, —OCF₃ or —OCH₂F; X¹, X² are oxygen or sulfur; and a is 0 or 1, b is 0 or 1, and sum of a and b is 0, 1 or 2.

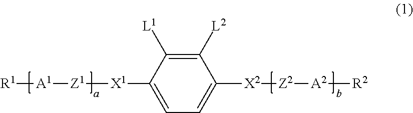

### CROSS-REFERENCE TO RELATED APPLICATION

This application claims the priority benefit of Japan application serial no. 2018-098194, filed on May 22, 2018. The entirety of the above-mentioned patent application is hereby incorporated by reference herein and made a part of this specification.

### TECHNICAL FIELD

The invention relates to a liquid crystal compound, a liquid crystal composition and a liquid crystal display device. More specifically, the invention relates to a liquid crystal compound having 2,3-disubstituted-1,4-phenylene and negative dielectric anisotropy, a liquid crystal composition containing the liquid crystal compound, and a liquid crystal display device including the composition.

### BACKGROUND ART

In a liquid crystal display device, a classification based on an operating mode for liquid crystal molecules includes a phase change (PC) mode, a twisted nematic (TN) mode, a super twisted nematic (STN) mode, an electrically controlled birefringence (ECB) mode, an optically compensated bend (OCB) mode, an in-plane switching (IPS) mode, a vertical alignment (VA) mode, a fringe field switching (FFS) mode and a field-induced photo-reactive alignment (FPA) mode. A classification based on a driving mode in the device includes a passive matrix (PM) and an active matrix (AM). The PM is classified into static, multiplex and so forth, and the AM is classified into a thin film transistor (TFT), a metal insulator metal (MIM) and so forth.

The device is sealed with a liquid crystal composition. Physical properties of the composition relate to physical properties in the device. Specific examples of the physical properties in the composition include stability to heat or light, a temperature range of a nematic phase, viscosity, optical anisotropy, dielectric anisotropy, specific resistance and an elastic constant. The composition is prepared by mixing many liquid crystal compounds. Physical properties required for a compound include high stability to environment such as water, air, heat and light, a wide temperature range of a liquid crystal phase, small viscosity, suitable optical anisotropy, large dielectric anisotropy, a suitable elastic constant and good compatibility with other liquid crystal compounds. A compound having high maximum temperature of the nematic phase is preferred. A compound having low minimum temperature in the liquid crystal phase such as the nematic phase and a smectic phase is preferred. A compound having small viscosity contributes to a short response time in the device. A suitable value of optical anisotropy depends on a kind of an operating mode in the device. A compound having large positive or negative dielectric anisotropy is preferred for driving the device at low voltage. A compound having good compatibility with other liquid crystal compounds is preferred for preparing the composition. The device may be occasionally used at a temperature below freezing point, and therefore a compound having good compatibility at low temperature is preferred.

Many liquid crystal compounds have been so far prepared. Development of a new liquid crystal compound has been still continued. The reason is that good physical properties that are not found in conventional compounds are expected from a new compound. The reason is that the new compound may be occasionally provided with a suitable balance regarding at least two physical properties in the composition.

WO 2011/098224 A discloses compound (I-6A-9) on page 10.

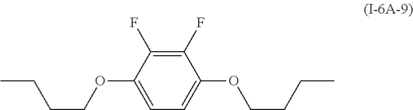 [SMILES: CCCCOc1ccc(OCCCC)c(F)c1F]

JP 2017-19767 A discloses compound (1-1-3) on page 43.

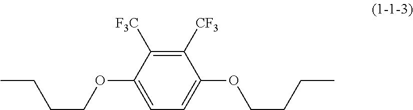 [SMILES: CCCCOc1ccc(OCCCC)c(C(F)(F)F)c1C(F)(F)F]

CN 105218328 A discloses compound (A) on page 1.

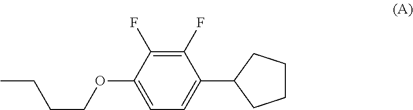 [SMILES: CCCCOc1ccc(C2CCCC2)c(F)c1F]

### CITATION LIST

### Patent Literature

Patent literature No. 1: WO 2011/098224 A

Patent literature No. 2: JP 2017-19767 A

Patent literature No. 3: CN 105218328 A

### SUMMARY OF INVENTION

### Technical Problem

The invention provides a liquid crystal compound satisfying at least one of physical properties such as high stability to heat or light, a high maximum temperature of a nematic phase, a high clearing point, a low minimum temperature of a liquid crystal phase, small viscosity, suitable optical anisotropy, large negative dielectric anisotropy, a suitable elastic constant and good compatibility with other liquid crystal compounds. The invention also provides a compound having a maximum temperature in comparison with a similar compound. The invention further provides a liquid crystal composition containing the compound and satisfying at least one of physical properties such as high stability to heat and light, a high maximum temperature of a nematic phase, a low minimum temperature of the nematic phase, small viscosity, suitable optical anisotropy, large negative dielectric anisotropy, large specific resistance and a suitable elastic constant. The invention provides a liquid crystal composition having a suitable balance regarding at least two of the physical properties. The invention still provides a liquid crystal display device including the composition, and having a wide temperature range in which the device can be used, a short response time, a large voltage holding ratio, a low threshold voltage, a large contrast ratio, a small flicker rate and a long service life.

### Solution to Problem

The invention relates to a compound represented by formula (1), a liquid crystal composition containing the compound, and a liquid crystal display device including the composition. With regard to definition of symbols in formula (1), see item 1 described below.

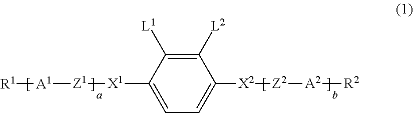

### Advantageous Effects of Invention

A first advantage is to provide a liquid crystal compound satisfying at least one of physical properties such as high stability to heat or light, a high maximum temperature of a nematic phase, a high clearing point, a low minimum temperature of a liquid crystal phase, small viscosity, suitable optical anisotropy, large negative dielectric anisotropy, a suitable elastic constant and good compatibility with other liquid crystal compounds. The advantage is also to provide a compound having a maximum temperature in comparison with a similar compound (see Comparative Example 1). A second advantage is to provide a liquid crystal composition containing the compound and satisfying at least one of physical properties such as high stability to heat and light, a high maximum temperature of a nematic phase, a low minimum temperature of the nematic phase, small viscosity, suitable optical anisotropy, large negative dielectric anisotropy, large specific resistance and a suitable elastic constant. The advantage is to provide a liquid crystal composition having a suitable balance regarding at least two of the physical properties. A third advantage is to provide a liquid crystal display device including the composition, and having a wide temperature range in which the device can be used, a short response time, a large voltage holding ratio, a low threshold voltage, a large contrast ratio, a small flicker rate and a long service life.

### DESCRIPTION OF EMBODIMENTS

Usage of terms herein is as described below. Terms “liquid crystal compound,” “liquid crystal composition” and “liquid crystal display device” may be occasionally abbreviated as “compound,” “composition” and “device,” respectively. “Liquid crystal compound” is a generic term for a compound having a liquid crystal phase such as a nematic phase and a smectic phase, and a compound having no liquid crystal phase but to be added for the purpose of adjusting physical properties of a composition such as a maximum temperature, a minimum temperature, viscosity and dielectric anisotropy. The compound has a six-membered ring such as 1,4-cyclohexylene and 1,4-phenylene, and has rod-like molecular structure. “Liquid crystal display device” is a generic term for a liquid crystal display panel and a liquid crystal display module. “Polymerizable compound” is a compound to be added for the purpose of forming a polymer in the composition. A liquid crystal compound having alkenyl is not polymerizable in the above meaning.

The liquid crystal composition is prepared by mixing a plurality of liquid crystal compounds. An additive is added to the composition for the purpose of further adjusting the physical properties. The additive such as the polymerizable compound, a polymerization initiator, a polymerization inhibitor, an optically active compound, an antioxidant, an ultraviolet light absorber, a light stabilizer, a heat stabilizer, a dye and an antifoaming agent is added thereto when necessary. A proportion (content) of the liquid crystal compound is expressed in terms of weight percent (% by weight) based on the weight of the liquid crystal composition containing no additive, even after the additive has been added. A proportion of the additive is expressed in terms of weight percent (% by weight) based on the weight of the liquid crystal composition containing no additive. More specifically, a proportion of the liquid crystal compound or the additive is calculated based on the total weight of the liquid crystal compound. Weight parts per million (ppm) may be occasionally used. A proportion of the polymerization initiator and the polymerization inhibitor is exceptionally expressed based on the weight of the polymerizable compound.

“Clearing point” is a transition temperature between the liquid crystal phase and an isotropic phase in the liquid crystal compound. “Minimum temperature of the liquid crystal phase” is a transition temperature between a solid and the liquid crystal phase (the smectic phase, the nematic phase or the like) in the liquid crystal compound. “Maximum temperature of the nematic phase” is a transition temperature between the nematic phase and the isotropic phase in a mixture of the liquid crystal compound and a base liquid crystal or in the liquid crystal composition, and may be occasionally abbreviated as “maximum temperature.” “Minimum temperature of the nematic phase” may be occasionally abbreviated as “minimum temperature.” An expression “increase the dielectric anisotropy” means that a value of dielectric anisotropy positively increases in a composition having positive dielectric anisotropy, and the value of dielectric anisotropy negatively increases in a composition having negative dielectric anisotropy. An expression “having a large voltage holding ratio” means that the device has a large voltage holding ratio at room temperature and also at a temperature close to the maximum temperature in an initial stage, and the device has the large voltage holding ratio at room temperature and also at a temperature close to the maximum temperature even after the device has been used for a long period of time. The physical properties of the composition or the device may be occasionally examined by an aging test.

A compound represented by formula (1) may be occasionally abbreviated as compound (1). At least one compound selected from compounds represented by formula (1) may be occasionally abbreviated as compound (1). “Compound (1)” means one compound, a mixture of two compounds or a mixture of three or more compounds represented by formula (1). A same rule applies also to any other compound represented by any other formula. For example, in formulas (2) to (13), a symbol of B¹, C¹ or the like surrounded by a hexagonal shape corresponds to a ring such as ring B¹ and ring C¹, respectively. The hexagonal shape represents a six-membered ring such as cyclohexane or benzene. The hexagonal shape may occasionally represents a fused ring such as naphthalene or a bridged ring such as adamantane.

A symbol of terminal group R¹¹ is used in a plurality of compounds in chemical formulas of component compounds. In the compounds, two groups represented by two arbitrary R¹¹ may be identical or different. For example, in one case, R¹¹ of compound (2) is ethyl and R¹¹ of compound (3) is ethyl. In another case, R¹¹ of compound (2) is ethyl and R¹¹ of compound (3) is propyl. A same rule applies also to a symbol of R¹², R¹³, Z¹¹ or the like. In compound (24), when i is 2, two of rings E¹ exist. In the compound, two groups represented by two of ring E¹ may be identical or different. A same rule applies also to two of arbitrary rings E¹ when i is larger than 2. A same rule applies also to other symbols.

An expression “at least one ‘A’” means that the number of ‘A’ is arbitrary. An expression “at least one ‘A’ may be replaced by ‘B’” means that, when the number of ‘A’ is 1, a position of ‘A’ is arbitrary, and also when the number of ‘A’ is 2 or more, positions thereof can be selected without restriction. A same rule applies also to an expression “at least one ‘A’ is replaced by ‘B’.” An expression “at least one ‘A’ may be replaced by ‘B’, ‘C’ or ‘D’” includes a case where arbitrary ‘A’ is replaced by ‘B’, a case where arbitrary ‘A’ is replaced by ‘C’, and a case where arbitrary ‘A’ is replaced by ‘D’, and also a case where a plurality of ‘A’ are replaced by at least two ‘B’, ‘C’ and/or ‘D’. For example, “alkyl in which at least one —CH₂— may be replaced by —O— or —CH═CH—” includes alkyl, alkoxy, alkoxyalkyl, alkenyl, alkoxyalkenyl and alkenyloxyalkyl. In addition, a case where two consecutive —CH₂— are replaced by —O— to form —O—O— is not preferred. In alkyl or the like, a case where —CH₂— of a methyl part (—CH₂—H) is replaced by —O— to form —O—H is not preferred, either.

An expression “R¹¹ and R¹² are independently alkyl having 1 to 10 carbons or alkenyl having 2 to 10 carbons, and in the alkyl and the alkenyl, at least one —CH₂— may be replaced by —O—, and in the groups, at least one hydrogen may be replaced by fluorine” may be occasionally used. In the expression, “in the groups” may be interpreted according to wording. In the expression, “the groups” means alkyl, alkenyl, alkoxy, alkenyloxy or the like. More specifically, “the groups” represents all of the groups described before the term “in the groups.” The common interpretation is applied also to terms of “in the monovalent groups” or “in the divalent groups.” For example, “the monovalent groups” represents all of the groups described before the term “in the monovalent groups.”

Halogen means fluorine, chlorine, bromine and iodine. Preferred halogen is fluorine and chlorine. Further preferred halogen is fluorine. Alkyl of the liquid crystal compound is straight-chain alkyl or branched-chain alkyl, but includes no cyclic alkyl. In general, straight-chain alkyl is preferred to branched-chain alkyl. A same rule applies also to a terminal group such as alkoxy and alkenyl. With regard to a configuration of 1,4-cyclohexylene, trans is preferred to cis for increasing the maximum temperature. Then, 2-fluoro-1,4-phenylene means two divalent groups described below. In a chemical formula, fluorine may be leftward (L) or rightward (R). A same rule applies also to an asymmetrical divalent group formed by removing two hydrogens from a ring, such as tetrahydropyran-2,5-diyl.

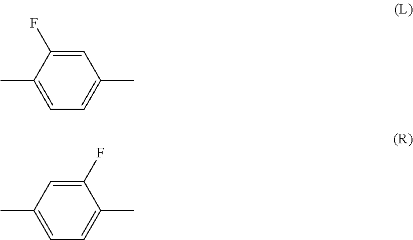

The invention includes items described below.

Item 1. A compound, represented by formula (1):

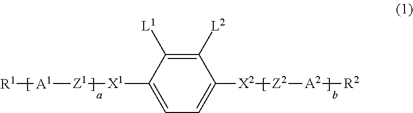

wherein, in formula (1),

R¹ is alkyl having 1 to 15 carbons, and in the alkyl, at least one —CH₂— may be replaced by —O— or —S—, and at least one —CH₂CH₂— may be replaced by —CH═CH—, —C≡C—, —COO— or —OCO—, and in the groups, at least one hydrogen may be replaced by fluorine or chlorine;

R² is alkyl having a branched-chain and 3 to 15 carbons, alkyl having a branched-chain and 3 to 15 carbons in which at least one hydrogen is replaced by fluorine, or straight-chain alkyl having 2 to 15 carbons in which 1 to 4 hydrogens are replaced by fluorine, and in the alkyl, at least one —CH₂— may be replaced by —O— or —S—, and at least one —CH₂CH₂— may be replaced by —CH═CH—, —C≡C—, —COO— or —OCO—;

A¹ and A² are independently 1,2-cyclopropylene, 1,2-cyclopropenylene, 1,3-cyclopropenylene, 1,3-cyclobutylene, 1,3-cyclobutenylene, 1,3-cyclopentylene, 1,3-cyclopentenylene, 1,4-cyclopentenylene or 3,5-cyclopentenylene;

Z¹ and Z² are independently a single bond or alkylene having 1 to 15 carbons, and in the alkylene, at least one —CH₂— may be replaced by —O— or —S—, and at least one —CH₂CH₂— may be replaced by —CH═CH—, —CC—, —COO— or —OCO—, and in the divalent groups, at least one hydrogen may be replaced by fluorine or chlorine;

L¹ and L² are independently fluorine, chlorine, —OCF₃ or —OCH₂F;

X¹ and X² are independently oxygen or sulfur;

a is 0 or 1, and b is 0 or 1, and a sum of a and b is 0, 1 or 2; and

R¹ is hydrogen when a is 1, and R² is hydrogen when b is 1, and X¹ may be a single bond when b is 1.

Item 2. The compound according to item 1, wherein

in formula (1),

R¹ is alkyl having 1 to 15 carbons, and in the alkyl, one or two —CH₂— may be replaced by —O—, and one or two —CH₂CH₂— may be replaced by —CH═CH—, —C≡C—, —COO— or —OCO—, and in the groups, at least one hydrogen may be replaced by fluorine or chlorine;

R² is alkyl having a branched-chain and 3 to 15 carbons, alkyl having a branched-chain and 3 to 15 carbons in which at least one hydrogen is replaced by fluorine, or straight-chain alkyl having 2 to 15 carbons in which 1 to 4 hydrogens are replaced by fluorine, and in the alkyl, one or two —CH₂— may be replaced by —O—, and one or two —CH₂CH₂— may be replaced by —CH═CH—, —C≡C—, —COO— or —OCO—;

A¹ and A² are independently 1,2-cyclopropylene, 1,3-cyclobutylene or 1,3-cyclopentylene;

Z¹ and Z² are independently a single bond or alkylene having 1 to 15 carbons, and in the alkylene, one or two —CH₂— may be replaced by —O— or —S—, and one or two —CH₂CH₂— may be replaced by —CH═CH—, —CC—, —COO— or —OCO—, and in the divalent groups, at least one hydrogen may be replaced by fluorine or chlorine;

L¹ and L² are independently fluorine, chlorine, —OCF₃ or —OCH₂F;

X¹ and X² are independently oxygen or sulfur;

a is 0 or 1, and b is 0 or 1, and a sum of a and b is 0, 1 or 2; and

R¹ is hydrogen when a is 1, and R² is hydrogen when b is 1, and X¹ may be a single bond when b is 1.

Item 3. The compound according to item 1 or 2, represented by any one of formula (1-1) to formula (1-5):

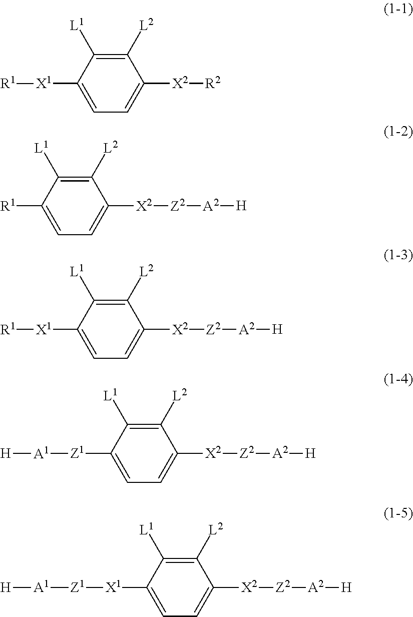

wherein, in formula (1-1) to formula (1-5),

R¹ is alkyl having 1 to 15 carbons, and in the alkyl, at least one —CH₂— may be replaced by —O—, and one or two —CH₂CH₂— may be replaced by —CH═CH—, and in the groups, at least one hydrogen may be replaced by fluorine;

R² is alkyl having a branched-chain and 3 to 15 carbons, alkyl having a branched-chain and 3 to 15 carbons in which at least one hydrogen is replaced by fluorine, or straight-chain alkyl having 2 to 15 carbons in which 1 to 4 hydrogens are replaced by fluorine, and in the alkyl, at least one —CH₂— may be replaced by —O—, and one or two —CH₂CH₂— may be replaced by —CH═CH—;

A¹ and A² are independently 1,2-cyclopropylene, 1,3-cyclobutylene or 1,3-cyclopentylene;

Z¹ and Z² are independently a single bond or alkylene having 1 to 15 carbons, and in the alkylene, one or two —CH₂— may be replaced by —O—, and one or two —CH₂CH₂— may be replaced by —CH═CH—, and in the divalent groups, at least one hydrogen may be replaced by fluorine;

L¹ and L² are independently fluorine, chlorine, —OCF₃ or —OCH₂F; and

X¹ and X² are independently oxygen or sulfur.

Item 4. The compound according to item 3, wherein

in formula (1-1) to formula (1-5),

R¹ is alkyl having 1 to 10 carbons, alkoxy having 1 to 9 carbons, alkoxyalkyl having 2 to 9 carbons, alkenyl having 2 to 10 carbons or alkenyloxy having 2 to 9 carbons, and in the groups, at least one hydrogen may be replaced by fluorine;

R² is alkyl having a branched-chain and 3 to 10 carbons, alkoxyalkyl having a branched-chain and 3 to 9 carbons, alkenyl having a branched-chain and 3 to 10 carbons, alkyl having a branched-chain and 3 to 10 carbons in which at least one hydrogen is replaced by fluorine, alkoxyalkyl having a branched-chain and 3 to 9 carbons in which at least one hydrogen is replaced by fluorine, alkenyl having a branched-chain and 3 to 10 carbons in which at least one hydrogen is replaced by fluorine, straight-chain alkyl having 2 to 10 carbons in which 1 to 4 hydrogens are replaced by fluorine, or straight-chain alkoxyalkyl having 2 to 9 carbons in which 1 to 4 hydrogens are replaced by fluorine, or straight-chain alkenyl having 2 to 10 carbons in which 1 to 4 hydrogens are replaced by fluorine;

A¹ and A² are 1,2-cyclopropylene, 1,3-cyclobutylene or 1,3-cyclopentylene;

Z¹ and Z² are independently a single bond or alkylene having 1 to 10 carbons, alkylene having 1 to 10 carbons in which one or two —CH₂— are replaced by —O—, or alkylene having 2 to 10 carbons in which one or two —CH₂CH₂— are replaced by —CH═CH—, and in the divalent groups, at least one hydrogen may be replaced by fluorine;

L¹ and L² are independently fluorine or —OCF₃; and

X¹ and X² are independently oxygen or sulfur.

Item 5. The compound according to any one of items 1 to 4, represented by formula (1-6):

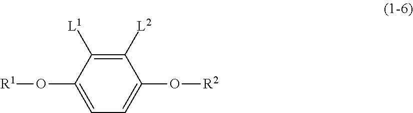

wherein, in formula (1-6),

R¹ is alkyl having 1 to 10 carbons, alkoxyalkyl having 2 to 9 carbons and alkenyl having 2 to 10 carbons;

R² is alkyl having a branched-chain and 3 to 10 carbons, alkoxyalkyl having a branched-chain and 3 to 9 carbons, alkenyl having a branched-chain and 3 to 10 carbons, straight-chain alkyl having 2 to 10 carbons in which 1 to 4 hydrogens are replaced by fluorine, straight-chain alkoxyalkyl having 2 to 9 carbons in which 1 to 4 hydrogens are replaced by fluorine, or alkenyl having 2 to 10 carbons in which 1 to 4 hydrogens are replaced by fluorine; and

L¹ and L² are independently fluorine or —OCF₃.

Item 6. The compound according to item 5, wherein

in formula (1-6),

R¹ is alkyl having 1 to 6 carbons, alkoxyalkyl having 2 to 6 carbons and alkenyl having 2 to 6 carbons;

R² is straight-chain alkyl having 2 to 6 carbons in which 1 to 4 hydrogens are replaced by fluorine, straight-chain alkoxyalkyl having 2 to 6 carbons in which 1 to 4 hydrogens are replaced by fluorine, or straight-chain alkenyl having 2 to 6 carbons in which 1 to 4 hydrogens are replaced by fluorine; and

L¹ and L² are fluorine.

Item 7. The compound according to any one of items 1 to 4, represented by any one of formula (1-7) to formula (1-12):

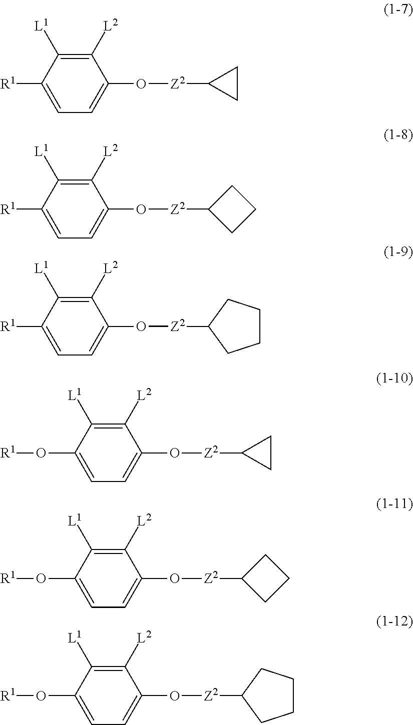

wherein, in formula (1-7) to formula (1-12),

R¹ is alkyl having 1 to 10 carbons, alkoxyalkyl having 2 to 9 carbons and alkenyl having 2 to 10 carbons;

Z² is a single bond or alkylene having 1 to 6 carbons, alkylene having 1 to 6 carbons in which one —CH₂— is replaced by —O—, or alkylene having 2 to 6 carbons in which one or two —CH₂CH₂— are replaced by —CH═CH—; and

L¹ and L² are independently fluorine or —OCF₃.

Item 8. The compound according to item 7, wherein

in formula (1-7) to formula (1-12),

R¹ is alkyl having 1 to 6 carbons, alkoxyalkyl having 2 to 6 carbons and alkenyl having 2 to 6 carbons;

Z² is a single bond or alkylene having 1 to 6 carbons, or alkylene having 2 to 6 carbons in which one —CH₂CH₂— is replaced by —CH═CH—; and

L¹ and L² are fluorine.

Item 9. The compound according to any one of items 1 to 4, represented by any one of formula (1-12) to formula (1-29):

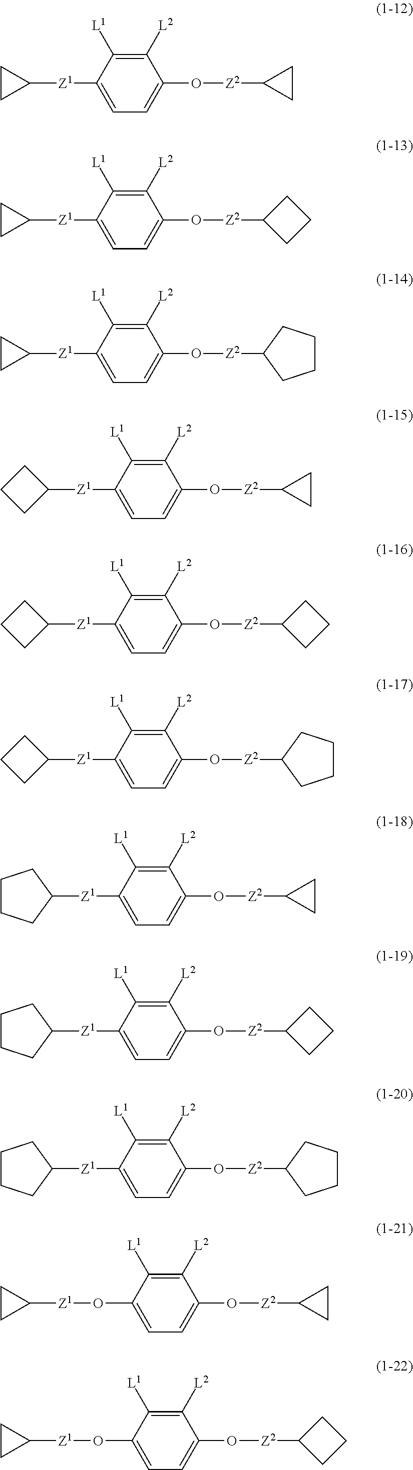

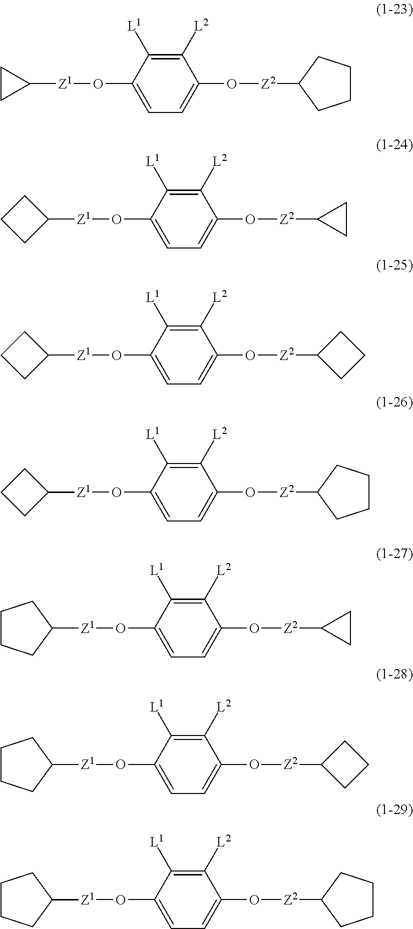

wherein, in formula (1-12) to formula (1-29),

Z¹ and Z² are independently a single bond or alkylene having 1 to 6 carbons, alkylene having 1 to 10 carbons in which one —CH₂— is replaced by —O—, or alkylene having 2 to 10 carbons in which one or two —CH₂CH₂— are replaced by —CH═CH—; and L¹ and L² are independently fluorine or —OCF₃.

Item 10. The compound according to item 9, wherein

in formula (1-12) to formula (1-29),

Z¹ and Z² are a single bond or alkylene having 1 to 6 carbons, or alkylene having 2 to 6 carbons in which one —CH₂CH₂— is replaced by —CH═CH—; and L¹ and L² are fluorine.

Item 11. A liquid crystal composition, containing at least one compound selected from compounds represented by formula (1), and at least one compound selected from the group of compounds represented by formula (2) to formula (4):

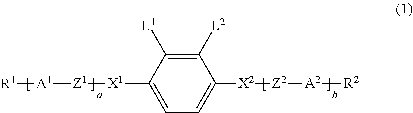

wherein, in formula (1),

R¹ is alkyl having 1 to 15 carbons, in the alkyl, at least one —CH₂— may be replaced by —O— or —S—, and at least one —CH₂CH₂— may be replaced by —CH═CH—, —C≡C—, —COO— or —OCO—, and in the groups, at least one hydrogen may be replaced by fluorine or chlorine;

R² is alkyl having a branched-chain and 3 to 15 carbons, alkyl having a branched-chain and 3 to 15 carbons in which at least one hydrogen is replaced by fluorine, or straight-chain alkyl having 2 to 15 carbons in which 1 to 4 hydrogens are replaced by fluorine, and in the alkyl, at least one —CH₂— may be replaced by —O— or —S—, and at least one —CH₂CH₂— may be replaced by —CH═CH—, —C≡C—, —COO— or —OCO—;

A¹ and A² are independently 1,2-cyclopropylene, 1,2-cyclopropenylene, 1,3-cyclopropenylene, 1,3-cyclobutylene, 1,3-cyclobutenylene, 1,3-cyclopentylene, 1,3-cyclopentenylene, 1,4-cyclopentenylene or 3,5-cyclopentenylene;

Z¹ and Z² are independently a single bond or alkylene having 1 to 15 carbons, and in the alkylene, at least one —CH₂— may be replaced by —O— or —S—, and at least one —CH₂CH₂— may be replaced by —CH═CH—, —CC—, —COO— or —OCO—, and in the divalent groups, at least one hydrogen may be replaced by fluorine or chlorine;

L¹ and L² are independently fluorine, chlorine, —OCF₃ or —OCH₂F;

X¹ and X² are independently oxygen or sulfur;

a is 0 or 1, b is 0 or 1, and a sum of a and b is 0, 1 or 2;

R¹ is hydrogen when a is 1, and R² is hydrogen when b is 1, and X¹ may be a single bond when b is 1;

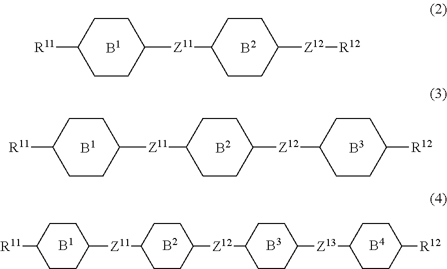

wherein, in formula (2) to formula (4),

R¹¹ and R¹² are independently alkyl having 1 to 10 carbons or alkenyl having 2 to 10 carbons, and in the alkyl and the alkenyl, at least one —CH₂— may be replaced by —O—, and in the groups, at least one hydrogen may be replaced by fluorine;

ring B¹, ring B², ring B³ and ring B⁴ are independently 1,4-cyclohexylene, 1,4-phenylene, 2-fluoro-1,4-phenylene, 2,5-difluoro-1,4-phenylene or pyrimidine-2,5-diyl; and

Z¹¹, Z¹² and Z¹³ are independently a single bond, —COO—, —CH₂CH₂—, —CH═CH— or —C≡C—.

Item 12. The liquid crystal composition according to item 11, further containing at least one compound selected from the group of compounds represented by formula (5) to formula (13):

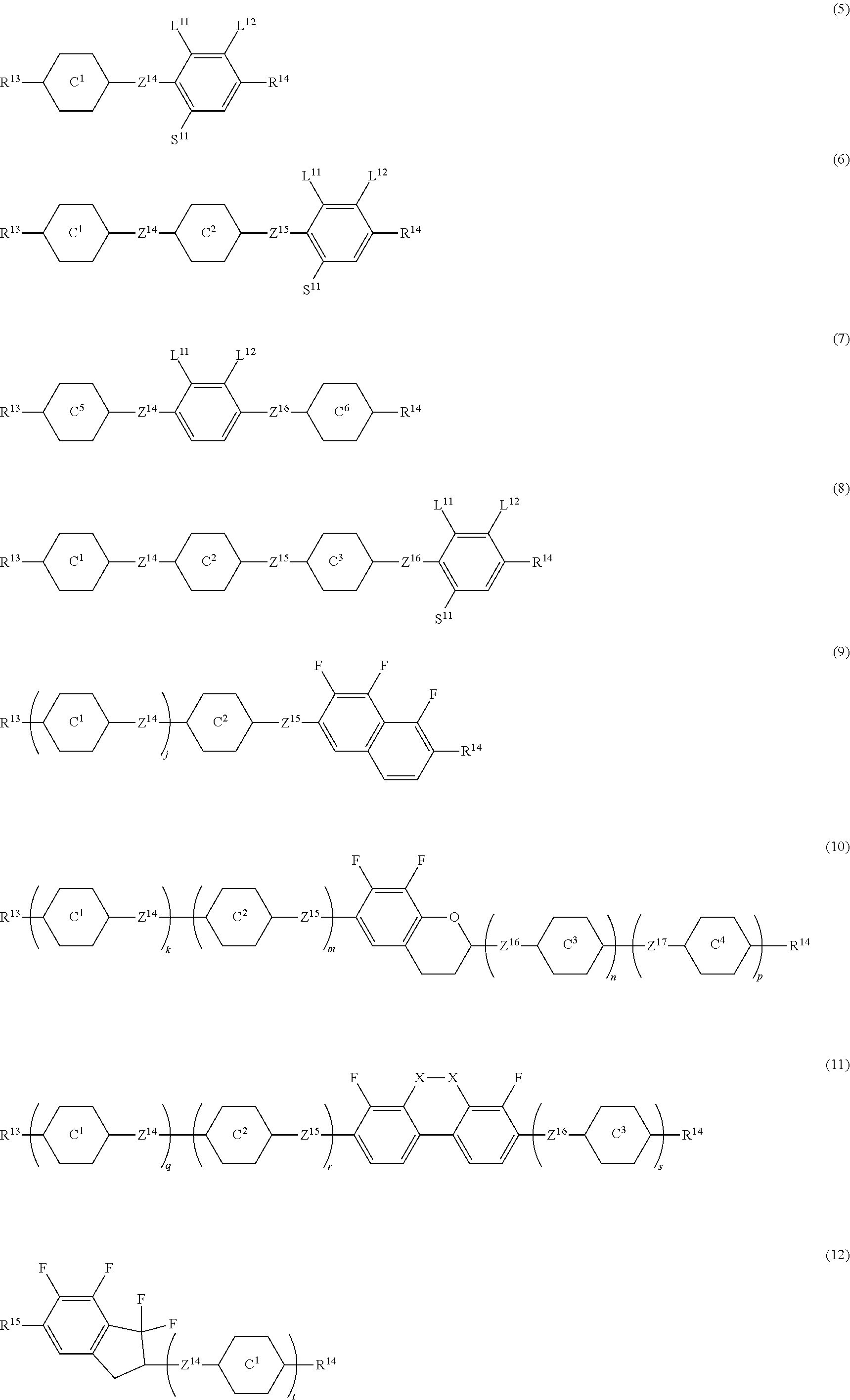

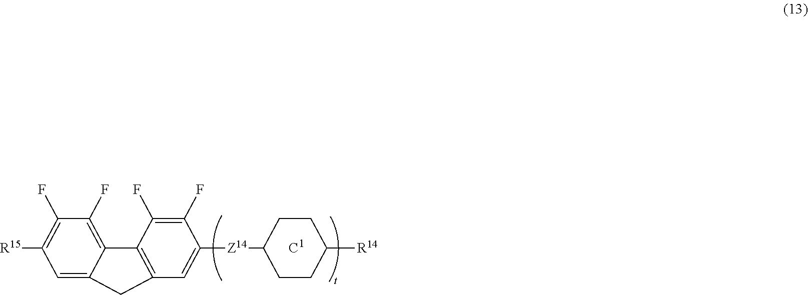

wherein, in formula (5) to formula (13),

R¹³, R¹⁴ and R¹⁵ are independently alkyl having 1 to 10 carbons or alkenyl having 2 to 10 carbons, and in the alkyl and the alkenyl, at least one —CH₂— may be replaced by —O—, and in the groups, at least one hydrogen may be replaced by fluorine, and R¹⁵ may be hydrogen or fluorine;

ring C¹, ring C², ring C³ and ring C⁴ are independently 1,4-cyclohexylene, 1,4-cyclohexenylene, 1,4-phenylene in which at least one hydrogen may be replaced by fluorine, tetrahydropyran-2,5-diyl or decahydronaphthalene-2,6-diyl;

ring C⁵ and ring C⁶ are independently 1,4-cyclohexylene, 1,4-cyclohexenylene, 1,4-phenylene, tetrahydropyran-2,5-diyl, or decahydronaphthalene-2,6-diyl;

Z¹⁴, Z¹⁵, Z¹⁶ and Z¹⁷ are independently a single bond, —COO—, —CH₂O—, —OCF₂—, —CH₂CH₂— or —OCF₂CH₂CH₂—;

L¹¹ and L¹² are independently fluorine or chlorine;

S¹¹ is hydrogen or methyl;

X is —CHF— or —CF₂—; and

j, k, m, n, p, q, r and s are independently 0 or 1, a sum of k, m, n and p is 1 or 2, a sum of q, r and s is 0, 1, 2 or 3, and t is 1, 2 or 3.

Item 13. The liquid crystal composition according to item 11 or 12, further containing at least one compound selected from the group of compounds represented by formula (21) to formula (23):

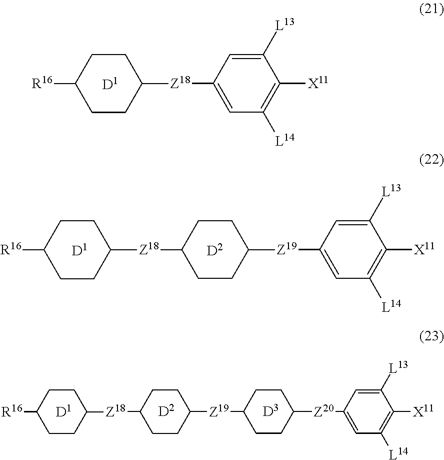

wherein, in formula (21) to formula (23),

R¹⁶ is alkyl having 1 to 10 carbons or alkenyl having 2 to 10 carbons, and in the alkyl and the alkenyl, at least one —CH₂— may be replaced by —O—, and in the groups, at least one hydrogen may be replaced by fluorine;

X¹¹ is fluorine, chlorine, —CF₃, —CHF₂, —CH₂F, —OCF₃, —OCHF₂, —OCF₂CHF₂ or —OCF₂CHFCF₃;

ring D¹, ring D² and ring D³ are independently 1,4-cyclohexylene, 1,4-phenylene in which at least one hydrogen may be replaced by fluorine, tetrahydropyran-2,5-diyl, 1,3-dioxane-2,5-diyl or pyrimidine-2,5-diyl;

Z¹⁸, Z¹⁹ and Z²⁰ are independently a single bond, —COO—, —CH₂O—, —CF₂O—, —OCF₂—, —CH₂CH₂—, —CH═CH—, —CC— or —(CH₂)₄—; and

L¹³ and L¹⁴ are independently hydrogen or fluorine.

Item 14. The liquid crystal composition according to any one of items 11 to 13, further containing at least one compound selected from compounds represented by formula (24):

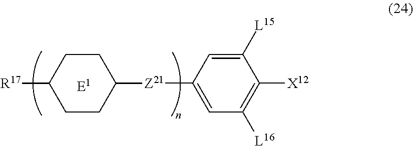

wherein, in formula (24),

R¹⁷ is alkyl having 1 to 10 carbons or alkenyl having 2 to 10 carbons, and in the alkyl and the alkenyl, at least one —CH₂— may be replaced by —O—, and in the groups, at least one hydrogen may be replaced by fluorine;

X¹² is —C≡N or —C≡C—C≡N;

ring E¹ is 1,4-cyclohexylene, 1,4-phenylene in which at least one hydrogen may be replaced by fluorine, tetrahydropyran-2,5-diyl, 1,3-dioxane-2,5-diyl or pyrimidine-2,5-diyl;

Z²¹ is a single bond, —COO—, —CH₂O—, —CF₂O—, —OCF₂—, —CH₂CH₂— or —CC—;

L¹⁵ and L¹⁶ are independently hydrogen or fluorine; and

i is 1, 2, 3 or 4.

Item 15. A liquid crystal display device, including the liquid crystal composition according to any one of items 11 to 14.

The invention still further includes the following items: (a) the composition, further containing at least one optically active compound and/or at least one polymerizable compound; and (b) the composition, further containing at least one antioxidant and/or at least one ultraviolet light absorber.

The invention still further includes the following items: (c) the composition, further containing one, two or at least three additives selected from the group of a polymerizable compound, a polymerization initiator, a polymerization inhibitor, an optically active compound, an antioxidant, an ultraviolet light absorber, a light stabilizer, a heat stabilizer, a dye and an antifoaming agent; and (d) the composition, wherein a maximum temperature of a nematic phase is 70° C. or higher, an optical anisotropy (measured at 25° C.) at a wavelength of 589 nanometers is 0.08 or more and a dielectric anisotropy (measured at 25° C.) at a frequency of 1 kHz is −2 or less.

The invention still further includes the following items: (e) a device including the composition and having a PC mode, a TN mode, an STN mode, an ECB mode, an OCB mode, an IPS mode, a VA mode, an FFS mode, an FPA mode or a PSA mode; (f) an AM device including the composition; (g) a transmissive device including the composition; (h) use of the composition as the composition having the nematic phase; and (i) use as an optically active composition by adding the optically active compound to the composition.

An aspect of compound (1), synthesis of compound (1), the liquid crystal composition and the liquid crystal display device will be described in the order.

### 1. Aspect of Compound (1)

In compound (1), preferred examples of terminal groups (R¹ and R²), aliphatic rings (A¹ and A²), bonding groups (Z¹ and Z²), divalent groups (X¹ and X²), lateral groups (L¹ and L²), subscripts (a and b) are as described below. In compound (1), physical properties can be arbitrarily adjusted by suitably combining the groups. Compound (1) may contain a larger amount of isotope such as ²H (deuterium) and ¹³C than the amount of natural abundance because no significant difference exists in the physical properties of the compound.

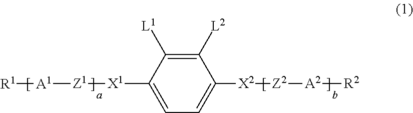

In formula (1), R¹ is alkyl having 1 to 15 carbons, and in the alkyl, at least one —CH₂— may be replaced by —O—, —S—, —CO— or —S—, and at least one —CH₂CH₂— may be replaced by —CH═CH—, —C≡C—, —COO— or —OCO—, and in the groups, at least one hydrogen may be replaced by fluorine or chlorine. In addition, R¹ is hydrogen when a is 1.

Preferred R¹ is alkyl, alkoxy, alkoxyalkyl, alkoxyalkoxy, alkylthio, alkylthioalkoxy, alkenyl, alkenyloxy, alkenyloxyalkyl, alkoxyalkenyl, alkynyl, and alkynyloxy. In the groups, at least one hydrogen may be replaced by fluorine or chlorine. The example includes a group in which at least two hydrogens are replaced by both fluorine and chlorine. A group in which at least one hydrogen is replaced by fluorine only is further preferred. In R¹, a straight-chain is preferred to a branched-chain. Even if R¹ has the branched-chain, the group is preferred when the group has optical activity. Further preferred R¹ is alkyl, alkoxy, alkoxyalkyl, alkenyl, monofluoroalkyl, polyfluoroalkyl, monofluoroalkoxy and polyfluoroalkoxy.

In formula (1), R² is alkyl having a branched-chain and 3 to 15 carbons, alkyl having a branched-chain and 3 to 15 carbons in which at least one hydrogen is replaced by fluorine, or straight-chain alkyl having 2 to 15 carbons in which 1 to 4 hydrogens are replaced by fluorine, and in the alkyl, at least one —CH₂— may be replaced by —O— or —S—, and at least one —CH₂CH₂— may be replaced by —CH═CH—, —C≡C—, —COO— or —OCO—. In addition, when b is 1, R² is hydrogen, and when b is 1, X¹ may be a single bond.

Examples of preferred R² include branched-chain alkyl, branched-chain alkoxy, branched-chain alkoxyalkyl, branched-chain alkoxyalkoxy, branched-chain alkylthio, branched-chain alkylthioalkoxy, branched-chain alkenyl, branched-chain alkenyloxy, branched-chain alkenyloxyalkyl, branched-chain alkoxyalkenyl, branched-chain alkynyl and branched-chain alkynyloxy. In the groups, at least one hydrogen may be replaced by fluorine or chlorine.

Examples of preferred R² include straight-chain alkyl in which 1 to 4 hydrogens are replaced by fluorine, straight-chain alkoxy in which 1 to 4 hydrogens are replaced by fluorine, straight-chain alkoxyalkyl in which 1 to 4 hydrogens are replaced by fluorine, straight-chain alkoxyalkoxy in which 1 to 4 hydrogens are replaced by fluorine, straight-chain alkylthio in which 1 to 4 hydrogens are replaced by fluorine, straight-chain alkylthioalkoxy in which 1 to 4 hydrogens are replaced by fluorine, straight-chain alkenyl in which 1 to 4 hydrogens are replaced by fluorine, straight-chain alkenyloxy in which 1 to 4 hydrogens are replaced by fluorine, straight-chain alkenyloxyalkyl in which 1 to 4 hydrogens are replaced by fluorine, straight-chain alkoxyalkenyl in which 1 to 4 hydrogens are replaced by fluorine, straight-chain alkynyl in which 1 to 4 hydrogens are replaced by fluorine, and straight-chain alkynyloxy in which 1 to 4 hydrogens are replaced by fluorine.

Examples of further preferred R² include branched-chain alkyl, branched-chain alkoxy, branched-chain alkoxyalkyl, branched-chain alkenyl, branched-chain alkyl in which 1 to 4 hydrogens are replaced by fluorine, branched-chain polyfluoroalkyl, branched-chain alkoxy in which 1 to 4 hydrogens are replaced by fluorine, branched-chain polyfluoroalkoxy, straight-chain alkyl in which 1 to 4 hydrogens are replaced by fluorine, straight-chain alkoxy in which 1 to 4 hydrogens are replaced by fluorine, straight-chain alkoxyalkyl in which 1 to 4 hydrogens are replaced by fluorine, and straight-chain alkenyl in which 1 to 4 hydrogens are replaced by fluorine.

Next, specific examples of R¹ will be described. ChemBioDraw V14 (registered trademark) is used for nomenclature of the group.

Specific examples of R¹ include methyl, ethyl, propyl, butyl, pentyl, hexyl, heptyl, octyl, isopropyl, s-butyl, pentane-2-yl, hexane-2-yl, heptane-2-yl, octane-2-yl, isobutyl, 2-methylbutyl, 2-methylpentyl, 2-methylhexyl, 2-methylheptyl, 2-methyloctyl, isopentyl, 3-methylpentyl, 3-methylhexyl, 3-methylheptyl, 3-methyloctyl, 4-methylpentyl, 4-methylhexyl, 4-methylheptyl, 4-methyloctyl, 5-methylhexyl, 5-methylheptyl, 5-methyloctyl, 6-methylheptyl, 6-methyloctyl, pentane-3-yl, hexane-3-yl, heptane-3-yl, octane-3-yl, 2-ethylbutyl, 2-ethylpentyl, 2-ethylhexyl, 2-ethylheptyl, 3-ethylpentyl, 3-ethylhexyl, 3-ethylheptyl, 4-eilhexyl, 4-ethylheptyl, heptane-4-yl, octane-4-yl, 2-propylpentyl, 2-propylhexyl, nonane-5-yl, t-butyl, t-pentyl, 2-methylpentane-2-yl, 2-methylhexane-2-yl, 2-methylheptane-2-yl, 2-methyloctane-2-yl, neopentyl, 2,2-dimethylbutyl, 2,2-dimethylpentyl, 2,2-dimethylhexyl, 2,2-dimethylheptyl, 2,2-dimethyloctyl, 3,3-dimethylbutyl, 3,3-dimethylpentyl, 3,3-dimethylhexyl, 3,3-dimethylheptyl, 3,3-dimethyloctyl, 4,4-dimethylpentyl, 4,4-dimethylhexyl, 4,4-dimethyloctyl, 5,5-dimethylhexyl, 5,5-dimethylheptyl, 5,5-dimethyloctyl, 6,6-dimethylheptyl, 6,6-dimethyloctyl, 7,7-dimethyloctyl, 3-methylbutane-2-yl, 3-methylpentane-2-yl, 3-methylhexane-2-yl, 3-methylheptane-2-yl, 3-methyloctane-2-yl, 2,3-dimethylbutyl, 2,3-dimethylpentyl, 2,3-dimethylhexyl, 2,3-dimethylheptyl, 2,3-dimethyloctyl, 3,4-dimethylpentyl, 3,4-dimethylhexyl, 3,4-dimethylheptyl, 3,4-dimethyloctyl, 4,5-dimethylhexyl, 4,5-dimethylheptyl, 4,5-dimethyloctyl, 5,6-dimethylheptyl, 5,6-dimethyloctyl or 6,7-dimethyloctyl.

Specific examples of R¹ also include methoxy, ethoxy, propoxy, butoxy, pentyloxy, hexyloxy, heptyloxy, isopropoxy, s-butoxy, pentane-2-yloxy, hexane-2-yloxy, heptane-2-yloxy, octane-2-yloxy, isobutoxy, 2-methylbutoxy, 2-methylpentyloxy, 2-methylhexyloxy, 2-methylheptyloxy, isopentyloxy, 3-methylpentyloxy, 3-methylhexyloxy, 4-methylpentyloxy, 4-methylhexyloxy, 5-methylhexyloxy, 6-methylheptyloxy, methoxymethyl, methoxyethyl, methoxypropyl, ethoxymethyl, ethoxyethyl, ethoxypropyl, propoxymethyl, 2-propoxyethyl, butoxymethyl, pentoxymethyl, 1-methoxyethyl, 1-ethoxyethyl, 1-propoxyethyl, 1-butoxyethyl, 1-pentyloxyethyl, 1-hexyloxyethyl, 1-methoxypropyl, 1-ethoxypropyl, 1-propoxypropyl, 1-butoxypropyl, 1-pentyloxypropyl, 1-methoxybutyl, 1-ethoxybutyl, 1-propoxybutyl, 1-butoxybutyl, 1-pentyloxybutyl, 1-methoxypentyl, 1-ethoxypentyl, 1-propoxypentyl, 1-butoxypentyl, 1-methoxyhexyl, 1-ethoxyhexyl, 1-propoxyhexyl, 1-methoxyheptyl, 1-ethoxyheptyl, 1-methoxypropane-2-yl, 1-ethoxypropane-2-yl, 1-propoxypropane-2-yl, 1-butoxypropane-2-yl, 1-pentyloxypropane-2-yl, 1-hexyloxypropane-2-yl, 1-heptyloxypropane-2-yl, 1-methoxybutane-2-yl, 1-ethoxybutane-2-yl, 1-propoxybutane-2-yl, 1-butoxybutane-2-yl, 1-pentyloxybutane-2-yl, 1-hexyloxybutane-2-yl, 1-methoxypentane-2-yl, 1-ethoxypentane-2-yl, 1-propoxypentane-2-yl, 1-butoxypentane-2-yl, 1-pentyloxypentane-2-yl, 1-methoxyhexane-2-yl, 1-ethoxyhexane-2-yl, 1-propoxyhexane-2-yl, 1-butoxyhexane-2-yl, 1-methoxyheptane-2-yl, 1-ethoxyheptane-2-yl, 1-propoxyheptane-2-yl, 1-butoxyheptane-2-yl, 1-methoxyoctane-2-yl, 1-ethoxyoctane-2-yl, 1-propoxyoctane-2-yl or 1-butoxyoctane-2-yl.

Specific examples of R¹ also include 2-methoxypropyl, 2-ethoxypropyl, 2-propoxypropyl, 2-butoxypropyl, 2-pentyloxypropyl, 2-hexyloxypropyl, 2-heptyloxypropyl, 2-methoxybutyl, 2-ethoxybutyl, 2-propoxybutyl, 2-butoxybutyl, 2-pentyloxybutyl, 2-hexyloxybutyl, 2-heptyloxybutyl, 2-methoxypentyl, 2-ethoxyoxypentyl, 2-propoxypentyl, 2-butoxypentyl, 2-pentyloxypentyl, 2-hexyloxypentyl, 2-heptyloxypentyl, 2-methoxyhexyl, 2-ethoxyhexyl, 2-propoxyhexyl, 2-butoxyhexyl, 2-pentyloxyhexyl, 2-hexyloxyhexyl, 2-heptyloxyhexyl, 2-methoxyheptyl, 2-ethoxyheptyl, 2-propoxyheptyl, 2-butoxyheptyl, 2-pentyloxyheptyl, 3-methoxybutyl, 3-ethoxybutyl, 3-propoxybutyl, 3-methoxypentyl, 3-ethoxypentyl, 3-propoxypentyl, 3-methoxyhexyl, 3-ethoxyhexyl, 3-propoxyhexyl, 3-methoxyheptyl, 3-ethoxyheptyl or 3-propoxyheptyl.

Specific examples of R¹ also include vinyl, 1-propenyl, 2-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl, 5-hexenyl, prop-1-en-2-yl, but-1-en-2-yl, pent-1-en-2-yl, hexy-1-en-2-yl, hept-1-en-2-yl, oct-1-en-2-yl, 2-methylpropyl-1-en-1-yl, 2-methylbut-1-en-1-yl, 2-methylpent-1-en-1-yl, 2-methylhexy-1-en-1-yl, 2-methylhept-1-en-1-yl, 2-methylallyl, 2-methylenebutyl, 2-methylenepentyl, 2-methylenehexyl, 2-methyleneheptyl, 3-methylbut-1-en-1-yl, 3-methylpent-1-en-1-yl, 3-methylhexy-1-en-1-yl, 3-methylhept-1-en-1-yl, 3-methylbut-2-en-1-yl, 3-methylpent-2-en-1-yl, 3-methylhexy-2-en-1-yl, 3-methylhept-2-en-1-yl, 3-methylbut-3-en-1-yl, 3-methylpent-3-en-1-yl, 3-methylhexy-3-en-1-yl, 3-methylhept-3-en-1-yl, 4-methylpent-1-en-1-yl, 4-methylhexy-1-en-1-yl, 4-methylhept-1-en-1-yl, 4-methylpent-2-en-1-yl, 4-methylhexy-2-en-1-yl, 4-methylhept-2-en-1-yl, 4-methylpent-3-en-1-yl, 4-methylhexy-3-en-1-yl, 4-methylhept-3-en-1-yl, 4-methylpent-4-en-1-yl, 4-methylhexy-4-en-1-yl or 4-methylhept-4-en-1-yl.

Specific examples of R¹ also include 5-methylhexy-1-en-1-yl, 5-methylhept-1-en-1-yl, 5-methylhexy-2-en-1-yl, 5-methylhept-2-en-1-yl, 5-methylhexy-3-en-1-yl, 5-methylhept-3-en-1-yl, 5-methylhexy-4-en-1-yl, 5-methylhept-4-en-1-yl, 5-methylhexy-5-en-1-yl, 5-methylhept-5-en-1-yl, 6-methylhept-1-en-1-yl, 6-methylhept-2-en-1-yl, 6-methylhept-3-en-1-yl, 6-methylhept-4-en-1-yl, 6-methylhept-5-en-1-yl, 6-methylhept-6-en-1-yl, pent-1-ene-3-yl, hexy-1-ene-3-yl, hept-1-ene-3-yl, oct-1-ene-3-yl, non-1-ene-3-yl, pent-2-ene-3-yl, hexy-2-ene-3-yl, hept-2-ene-3-yl, oct-2-ene-3-yl, non-2-ene-3-yl, hexy-3-ene-3-yl, hept-3-ene-3-yl, oct-3-ene-3-yl, non-3-ene-3-yl, 2-ethylbut-1-en-1-yl, 2-ethylpent-1-en-1-yl, 2-ethylhexy-1-en-1-yl, 2-ethylhept-1-en-1-yl, 2-ethylbut-2-en-1-yl, 2-ethylpent-2-en-1-yl, 2-ethylhexy-2-en-1-yl, 2-ethylhept-2-en-1-yl, 2-ethylbut-3-en-1-yl, 2-ethylpent-3-en-1-yl, 2-ethylhexy-3-en-1-yl, 2-ethylhept-3-en-1-yl, 2-ethylidenepentyl, 2-ethylidenehexyl or 2-ethylideneheptyl.

Specific examples of R¹ also include 3-ethylpent-1-en-1-yl, 3-ethylhexy-1-en-1-yl, 3-ethylhept-1-en-1-yl, 3-ethylpent-2-en-1-yl, 3-ethylhexy-2-en-1-yl, 3-ethylhept-2-en-1-yl, 3-ethylpent-3-en-1-yl, 3-ethylhexy-3-en-1-yl, 3-ethylhept-3-en-1-yl, 3-ethylpent-4-en-1-yl, 3-ethylhexy-4-en-1-yl, 3-ethylhept-4-en-1-yl, 3-ethylidenehexyl, 3-ethylideneheptyl, 4-ethylhexy-1-en-1-yl, 4-ethylhept-1-en-1-yl, 4-ethylhexy-2-en-1-yl, 4-ethylhept-2-en-1-yl, 4-ethylhexy-3-en-1-yl, 4-ethylhept-3-en-1-yl, 4-ethylhexy-4-en-1-yl, 4-ethylhept-4r-en-1-yl, 4-ethylhexy-5-en-1-yl, 4-ethylhept-5-en-1-yl, 4-ethylideneheptyl, 4-vinylheptyl, hept-1-ene-4-yl, oct-1-ene-4-yl, non-1-ene-4-yl, dec-1-ene-4-yl, hept-2-ene-4-yl, oct-2-ene-4-yl, non-2-ene-4-yl, dec-2-ene-4-yl, hept-3-ene-4-yl, oct-3-ene-4-yl, non-3-ene-4-yl, dec-3-ene-4-yl, oct-5-ene-4-yl, non-5-ene-4-yl or dec-5-ene-4-yl.

Specific examples of R¹ also include 2-propylpent-4-en-1-yl, 2-allylhexyl, 2-allylheptyl, 2-propylpent-3-en-1-yl, 2-(prop-1-en-1-yl)hexyl, 2-(prop-1-en-1-yl)heptyl, 2-propylpent-2-en-1-yl, 2-propylidenehexyl, 2-propylideneheptyl, 2-propylpent-1-en-1-yl, 2-propylhexy-1-en-1-yl, 2-propylhept-1-en-1-yl, 2-propylhexy-2-en-1-yl, 2-propylhept-2-en-1-yl, 2-propylhexy-3-en-1-yl, 2-propylhept-3-en-1-yl, 2-methylbut-3-en-2-yl, 2-methylpent-3-en-2-yl, 2-methylhexy-3-en-2-yl, 2-methylhept-3-en-2-yl, 2-methyloct-3-en-2-yl, 2-methylpent-4-en-2-yl, 2-methylhexy-4-en-2-yl, 2-methylhept-4-en-2-yl, 2-methyloct-4-en-2-yl, 2-methylhexy-5-en-2-yl, 2-methylhept-5-en-2-yl, 2-methyloct-5-en-2-yl, 2-methylhept-6-en-2-yl, 2-methyloct-6-en-2-yl or 2-methyloct-7-en-2-yl.

Specific examples of R¹ also include 2,2-dimethylbut-3-en-1-yl, 2,2-dimethylpent-3-en-1-yl, 2,2-dimethylhexy-3-en-1-yl, 2,2-dimethylhept-3-en-1-yl, 2,2-dimethylpent-4-en-1-yl, 2,2-dimethylhexy-4-en-1-yl, 2,2-dimethylhept-4-en-1-yl, 2,2-dimethylhexy-5-en-1-yl, 2,2-dimethylhept-5-en-1-yl, 2,2-dimethylhept-6-en-1-yl, 3,3-dimethylbut-1-en-1-yl, 3,3-dimethylpent-1-en-1-yl, 3,3-dimethylhexy-1-en-1-yl, 3,3-dimethylhept-1-en-1-yl, 3,3-dimethylpent-4-en-1-yl, 3,3-dimethylhexy-4-en-1-yl, 3,3-dimethylhept-4-en-1-yl, 3,3-dimethylhexy-5-en-1-yl, 3,3-dimethylhept-5-en-1-yl, 3,3-dimethylhept-6-en-1-yl, 4,4-dimethylpent-1-en-1-yl, 4,4-dimethylhexy-1-en-1-yl, 4,4-dimethylhept-1-en-1-yl, 4,4-dimethylpent-2-en-1-yl, 4,4-dimethylhexy-2-en-1-yl, 4,4-dimethylhept-2-en-1-yl, 4,4-dimethylhexy-5-en-1-yl, 4,4-dimethylhept-5-en-1-yl, 4,4-dimethylhept-6-en-1-yl, 5,5-dimethylhexy-1-en-1-yl, 5,5-dimethylhept-1-en-1-yl, 5,5-dimethylhexy-2-en-1-yl, 5,5-dimethylhept-2-en-1-yl, 5,5-dimethylhexy-3-en-1-yl, 5,5-dimethylhept-3-en-1-yl or 5,5-dimethylhept-6-en-1-yl.

Specific examples of R¹ also include 3-methylbut-1-en-2-yl, 3-methylpent-1-en-2-yl, 3-methylhexy-1-en-2-yl, 3-methylhept-1-en-2-yl, 3-methyloct-1-en-2-yl, 3-methylbut-2-en-2-yl, 3-methylpent-2-en-2-yl, 3-methylhexy-2-en-2-yl, 3-methylhept-2-en-2-yl, 3-methyloct-2-en-2-yl, 3-methylbut-3-en-2-yl, 3-methylpent-3-en-2-yl, 3-methylhexy-3-en-2-yl, 3-methylhept-3-en-2-yl, 3-methyloct-3-en-2-yl, 3-methylpent-3-en-2-yl, 3-methylhexy-3-en-2-yl, 3-methylhept-3-en-2-yl, 3-methyloct-3-en-2-yl, 3-methylpent-4-en-2-yl, 3-methylhexy-4-en-2-yl, 3-methylhept-4-en-2-yl, 3-methyloct-4-en-2-yl, 3-methylhexy-5-en-2-yl, 3-methylhept-5-en-2-yl, 3-methyloct-5-en-2-yl, 3-methylhept-6-en-2-yl, 3-methyloct-6-en-2-yl, 3-methyloct-7-en-2-yl, 2,3-dimethylbut-1-en-1-yl, 2,3-dimethylpent-1-en-1-yl, 2,3-dimethylhexy-1-en-1-yl, 2,3-dimethylhept-1-en-1-yl, 3-methyl-2-methylenebutyl, 3-methyl-2-methylenepentyl, 3-methyl-2-methylenehexyl, 3-methyl-2-methyleneheptyl, 2,3-dimethylbut-2-en-1-yl, 2,3-dimethylpent-2-en-1-yl, 2,3-dimethylhexy-2-en-1-yl, 2,3-dimethylhept-2-en-1-yl or 2,3-dimethylbut-3-en-1-yl.

Specific examples of R¹ also include 2-methyl-3-methylenepentyl, 2-methyl-3-methylenehexyl, 2-methyl-3-methyleneheptyl, 2,3-dimethylpent-3-en-1-yl, 2,3-dimethylhexy-3-en-1-yl, 2,3-dimethylhept-3-en-1-yl, 2,3-dimethylpent-4-en-1-yl, 2,3-dimethylhexy-4-en-1-yl, 2,3-dimethylhept-4-en-1-yl, 2,3-dimethylhexy-5-en-1-yl, 2,3-dimethylhept-5-en-1-yl, 2,3-dimethylhept-6-en-1-yl, 3,4-dimethylpent-1-en-1-yl, 3,4-dimethylhexy-1-en-1-yl, 3,4-dimethylhept-1-en-1-yl, 3,4-dimethylpent-2-en-1-yl, 3,4-dimethylhexy-2-en-1-yl, 3,4-dimethylhept-2-en-1-yl, 4-methyl-3-methylenepentyl, 4-methyl-3-methylenehexyl, 4-methyl-3-methyleneheptyl, 3,4-dimethylpent-3-en-1-yl, 3,4-dimethylhexy-3-en-1-yl, 3,4-dimethylhept-3-en-1-yl, 3,4-dimethylpent-4-en-1-yl, 3-methyl-4-methylenehexyl, 3-methyl-4-methyleneheptyl, 3,4-dimethylhexy-4-en-1-yl, 3,4-dimethylhept-4-en-1-yl, 3,4-dimethylhexy-5-en-1-yl, 3,4-dimethylhept-5-en-1-yl, 3,4-dimethylhept-6-en-1-yl, 4,5-dimethylhexy-1-en-1-yl, 4,5-dimethylhept-1-en-1-yl, 4,5-dimethylhexy-2-en-1-yl, 4,5-dimethylhept-2-en-1-yl, 4,5-dimethylhexy-3-en-1-yl, 4,5-dimethylhept-3-en-1-yl, 5-methyl-4-methylenehexyl, 5-methyl-4-methyleneheptyl, 4,5-dimethylhexy-4-en-1-yl, 4,5-dimethylhept-4-en-1-yl, 4,5-dimethylhexy-5-en-1-yl, 4-methyl-5-methyleneheptyl, 4,5-dimethylhept-5-en-1-yl, 4,5-dimethylhept-6-en-1-yl, 5,6-dimethylhept-1-en-1-yl, 5,6-dimethylhept-2-en-1-yl, 5,6-dimethylhept-3-en-1-yl, 5,6-dimethylhept-4-en-1-yl, 6-methyl-5-methyleneheptyl, 5,6-dimethylhept-5-en-1-yl, 5,6-dimethylhept-6-en-1-yl, 5,6-dimethylhept-4-en-1-yl, 6-methyl-5-methyleneheptyl, 5,6-dimethylhept-5-en-1-yl or 5,6-dimethylhept-6-en-1-yl.

Specific examples of R¹ also include 2-propenyloxy, 2-butenyloxy, 2-pentenyloxy, 1-propynyl, 1-pentenyl, 1-methoxyvinyl, 1-ethoxy-vinyl, 1-propoxyvinyl, 1-butoxyvinyl, 1-pentyloxyvinyl, 1-hexyloxy vinyl, 1-methoxyallyl, 1-ethoxyallyl, 1-propoxyallyl, 1-butoxyallyl, 1-pentyloxyallyl, 1-hexyloxyallyl, 1-(vinyloxy)ethyl, 1-(prop-1-en-1-yloxy)ethyl, 1-(but-1-en-1-yloxy)ethyl, 1-(pent-1-en-1-yloxy)ethyl, 1-(allyloxy)ethyl, 1-(but-2-en-1-yloxy)ethyl, 1-(pent-2-en-1-yloxy)ethyl, 1-(but-3-en-1-yloxy)ethyl, 1-(pent-3-en-1-yloxy)ethyl or 1-(pent-4-en-1-yloxy)ethyl.

Specific examples of R¹ also include 2-fluoroethyl, 2-fluoropropyl, 3-fluoropropyl, 2-fluorobutyl, 3-fluorobutyl, 4-fluorobutyl, 2-fluoropentyl, 3-fluoropentyl, 4-fluoropentyl, 5-fluoropentyl, 2-fluorohexyl, 3-fluorohexyl, 4-fluorohexyl, 5-fluorohexyl, 6-fluorohexyl, 2-fluoroheptyl, 3-fluoroheptyl, 4-fluoroheptyl, 5-fluoroheptyl, 6-fluoroheptyl, 7-fluoroheptyl, 2-fluorooctyl, 3-fluorooctyl, 4-fluorooctyl, 5-fluorooctyl, 6-fluorooctyl, 7-fluorooctyl, 8-fluorooctyl, 1-fluoropropane-2-yl, 2-fluorobutane-2-yl, 2-fluoropentane-2-yl, 2-fluorohexane-2-yl, 2-fluoroheptane-2-yl, 2-fluorooctane-2-yl, 4-fluorobutane-2-yl, 4-fluoropentane-2-yl, 4-fluorohexane-2-yl, 4-fluoroheptane-2-yl, 4-fluorooctane-2-yl, 5-fluoropentane-2-yl, 5-fluorohexane-2-yl, 5-fluoroheptane-2-yl, 5-fluorooctane-2-yl, 6-fluorohexane-2-yl, 6-fluoroheptane-2-yl or 6-fluorooctane-2-yl.

Specific examples of R¹ also include 3-fluoro-2-methylpropyl, 3-fluoro-2-methylbutyl, 3-fluoro-2-methylpentyl, 3-fluoro-2-methylhexyl, 3-fluoro-2-methylheptyl, 2-fluoro-3-methylbutyl, 2-fluoro-3-methylpentyl, 2-fluoro-3-methylhexyl, 2-fluoro-3-methylheptyl, 4-fluoro-2-methylbutyl, 4-fluoro-2-methylpentyl, 4-fluoro-2-methylhexyl, 4-fluoro-2-methylheptyl, 4-fluoro-3-methylbutyl, 4-fluoro-3-methylpentyl, 4-fluoro-3-methylhexyl, 4-fluoro-3-methylheptyl, 3-fluoro-4-methylpentyl, 3-fluoro-4-methylhexyl, 3-fluoro-4-methylheptyl, 5-fluoro-3-methylpentyl, 5-fluoro-3-methylhexyl, 5-fluoro-3-methylheptyl, 3-fluoro-5-methylhexyl, 3-fluoro-5-methylheptyl, 4-fluoro-3-methylbutane-2-yl, 5-fluoro-3-methylpentane-2-yl, 6-fluoro-3-methylhexane-2-yl, 7-fluoro-3-methylheptane-2-yl, 3-fluoro-2-methylbutyl, 4-fluoro-2,3-dimethylbutyl, 5-fluoro-2,3-dimethylpentyl, 6-fluoro-2,3-dimethylhexyl, 7-fluoro-2,3-dimethylheptyl, 4-fluoro-3-methylpentyl, 5-fluoro-3,4-dimethylpentyl, 6-fluoro-3,4-dimethylhexyl or 7-fluoro-3,4-dimethylheptyl.

Specific examples of R¹ also include difluoromethyl, 1,1-difluoroethyl, 1,1-difluoropropyl, 1,1-difluorobutyl, 1,1-difluoropentyl, 1,1-difluorohexyl, 1,1-difluoroheptyl, 2,2-difluoroethyl, 2,2-difluoropropyl, 2,2-difluorobutyl, 2,2-difluoropentyl, 2,2-difluorohexyl, 2,2-difluoroheptyl, 3,3-difluoropropyl, 3,3-difluorobutyl, 3,3-difluoropentyl, 3,3-difluorohexyl, 3,3-difluoroheptyl, 4,4-difluorobutyl, 4,4-difluoropentyl, 4,4-difluorohexyl, 4,4-difluoroheptyl, 5,5-difluoropentyl, 5,5-difluorohexyl, 5,5-difluoroheptyl, 6,6-difluorohexyl, 6,6-difluoroheptyl, 7,7-difluoroheptyl, 2,2-difluoro-3-methylbutyl, 2,2-difluoro-3-methylpentyl, 2,2-difluoro-3-methylhexyl, 2,2-difluoro-3,3-dimethylbutyl, 2,2-difluoro-3,3-dimethylpentyl, 2,2-difluoro-3,3-dimethylhexyl, 3,3-difluoropropyl, 3,3-difluorobutyl, 3,3-difluoropentyl, 3,3-difluorohexyl, 3,3-difluoroheptyl, 2,3-difluoropropyl, 2,3-difluorobutyl, 2,3-difluoropentyl, 2,3-difluorohexyl or 2,3-difluoroheptyl.

Specific examples of R¹ also include 2,4-difluorobutyl, 2,4-difluoropentyl, 2,4-difluorohexyl, 2,4-difluoroheptyl, 2,5-difluoropentyl, 2,5-difluorohexyl, 2,5-difluoroheptyl, 3,4-difluorobutyl, 3,4-difluoropentyl, 3,4-difluorohexyl, 3,4-difluoroheptyl, 3,5-difluoropentyl, 3,5-difluorohexyl, 3,5-difluoroheptyl, 3,3-difluoro-4-methylpentyl, 3,3-difluoro-4-methylhexyl, 3,3-difluoro-4-methylheptyl, 3,3-difluoro-4,4-dimethylpentyl, 3,3-difluoro-4,4-dimethylhexyl, 3,3-difluoro-4,4-dimethylheptyl, 1,1-difluoropropane-2-yl, 3,3-difluorobutane-2-yl, 3,3-difluoropentane-2-yl, 3,3-difluorohexane-2-yl, 3,3-difluoroheptane-2-yl, 3,3-difluorooctane-2-yl, 3,3-difluoro-4-methylpentane-2-yl, 3,3-difluoro-4-methylhexane-2-yl, 3,3-difluoro-4-methylheptane-2-yl, 3,3-difluoro-4-methyloctane-2-yl, 4,4-difluoro-3-methylbutane-2-yl, 4,4-difluoro-3-methylpentane-2-yl, 4,4-difluoro-3-methylhexane-2-yl, 4,4-difluoro-3-methylheptane-2-yl, 4,4-difluoro-3-methyloctane-2-yl, 3,3-difluoro-4,4-dimethylpentane-2-yl, 3,3-difluoro-4,4-dimethylhexane-2-yl or 3,3-difluoro-4,4-dimethylheptane-2-yl.

Specific examples of R¹ also include trifluoromethyl, 2,2,2-trifluoroethyl, 3,3,3-trifluoropropyl, 4,4,4-trifluorobutyl, 5,5,5-trifluoropentyl, 6,6,6-trifluorohexyl, 7,7,7-trifluoroheptyl, methyl(trifluoromethoxy), 2-(trifluoromethoxy)ethyl, 3-(trifluoromethoxy)propyl, 4-(trifluoromethoxy)butyl, 5-(trifluoromethoxy)pentyl, 6-(trifluoromethoxy)hexyl, 7-(trifluoromethoxy)heptyl, 2,2,3-trifluoropropyl, 2,2,3-trifluorobutyl, 2,2,3-trifluoropentyl, 2,2,3-trifluorohexyl, 2,2,3-trifluoroheptyl, 2,2,3,3-tetrafluoropropyl, 2,2,3,3-tetrafluorobutyl, 2,2,3,3-tetrafluoropentyl, 2,2,3,3-tetrafluorohexyl, 2,2,3,3-tetrafluoroheptyl, 3,3,4,4-tetrafluorobutyl, 3,3,4,4-tetrafluoropentyl, 3,3,4,4-tetrafluorohexyl or 3,3,4,4-tetrafluoroheptyl.

Specific examples of R¹ also include 2-fluorovinyl, 2,2-difluorovinyl, 2-fluoro-2-vinyl, 3-fluoroprop-1-en-1-yl, 3-fluoroallyl, 2-fluoroprop-1-en-1-yl, 2-fluoroallyl, 4-fluorobut-1-en-1-yl, 4-fluorobut-2-en-1-yl, 4-fluorobut-3-en-1-yl, 2-fluorobut-1-en-1-yl, 2-fluorobut-2-en-1-yl, 2-fluorobut-3-en-1-yl, 3-fluorobut-1-en-1-yl, 3-fluorobut-2-en-1-yl, 3-fluorobut-3-en-1-yl, 5-fluoropent-1-en-1-yl, 5-fluoropent-2-en-1-yl, 5-fluoropent-3-en-1-yl, 5-fluoropent-4-en-1-yl, 2-fluoropent-1-en-1-yl, 2-fluoropent-2-en-1-yl, 2-fluoropent-3-en-1-yl, 2-fluoropent-4-en-1-yl, 3-fluoropent-1-en-1-yl, 3-fluoropent-2-en-1-yl, 3-fluoropent-3-en-1-yl, 3-fluoropent-4-en-1-yl, 4-fluoropent-1-en-1-yl, 4-fluoropent-2-en-1-yl, 4-fluoropent-3-en-1-yl, 4-fluoropent-4-en-1-yl, 6-fluorohexy-1-en-1-yl, 6-fluorohexy-2-en-1-yl, 6-fluorohexy-3-en-1-yl, 6-fluorohexy-4-en-1-yl, 6-fluorohexy-5-en-1-yl, 2-fluorohexy-1-en-1-yl, 2-fluorohexy-2-en-1-yl, 2-fluorohexy-3-en-1-yl, 2-fluorohexy-4-en-1-yl, 2-fluorohexy-5-en-1-yl, 3-fluorohexy-1-en-1-yl, 3-fluorohexy-2-en-1-yl, 3-fluorohexy-3-en-1-yl, 3-fluorohexy-4-en-1-yl, 3-fluorohexy-5-en-1-yl, 4-fluorohexy-1-en-1-yl, 4-fluorohexy-2-en-1-yl, 4-fluorohexy-3-en-1-yl, 4-fluorohexy-4-en-1-yl, 4-fluorohexy-5-en-1-yl, 5-fluorohexy-1-en-1-yl, 5-fluorohexy-2-en-1-yl, 5-fluorohexy-3-en-1-yl, 5-fluorohexy-4-en-1-yl or 5-fluorohexy-5-en-1-yl.

Specific examples of R¹ also include 2,2-difluorobut-3-en-1-yl, 2,2-difluoro-3-methylbut-3-en-1-yl, 2,2-difluoropent-3-en-1-yl, 2,2-difluoro-3-methylpent-3-en-1-yl, 2,2-difluoro-4-methylpent-3-en-1-yl, 2,2-difluoropent-4-en-1-yl, 2,2-difluoro-3-methylpent-4-en-1-yl, 2,2-difluoro-4-methylpent-4-en-1-yl, 2,2-difluorohex-3-en-1-yl, 2,2-difluorohex-4-en-1-yl, 2,2-difluorohex-5-en-1-yl, 2,2-difluoro-3-methylhex-3-en-1-yl, 2,2-difluoro-4-methylhex-3-en-1-yl, 2,2-difluoro-5-methylhex-3-en-1-yl, 2,2-difluoro-3-methylhex-4-en-1-yl, 2,2-difluoro-4-methylhex-4-en-1-yl, 2,2-difluoro-5-methylhex-4-en-1-yl, 2,2-difluoro-3-methylhex-5-en-1-yl, 2,2-difluoro-4-methylhex-5-en-1-yl, 2,2-difluoro-5-methylhex-5-en-1-yl, 3,3-difluoroprop-1-yl, 3,3-difluorobut-1-yl, 3,3-difluoropent-1-yl, 3,3-difluorohexy-1-yl, 3,3-difluorohept-1-yl, 3,3-difluoropent-4-en-1-yl, 3,3-difluorohexy-4-en-1-yl, 3,3-difluorohept-4-en-1-yl, 3,3-difluorohexy-5-en-1-yl, 3,3-difluorohept-5-en-1-yl or 3,3-difluorohept-6-en-1-yl.

Specific examples of R¹ also include 1,2-difluorovinyl, 1,2-difluoroprop-1-en-1-yl, 1,2-difluorobut-1-en-1-yl, 1,2-difluoropent-1-en-1-yl, 1,2-difluorohexy-1-en-1-yl, 1,2-difluorohept-1-en-1-yl, 2,3-difluoroallyl, 2,3-difluorobut-2-en-1-yl, 2,3-difluoropent-2-en-1-yl, 2,3-difluorohexy-2-en-1-yl, 2,3-difluorohept-2-en-1-yl, 3,4-difluorobut-3-en-1-yl, 3,4-difluoropent-3-en-1-yl, 3,4-difluorohexy-3-en-1-yl, 3,4-difluorohept-3-en-1-yl, 4,5-difluoropent-4-en-1-yl, 4,5-difluorohexy-4-en-1-yl, 4,5-difluorohept-4-en-1-yl, 5,6-difluorohexy-5-en-1-yl, 5,6-difluorohept-5-en-1-yl, 2,2-difluoro-3-methylpent-3-en-1-yl, 2,2-difluoro-3-methylhexy-3-en-1-yl, 2,2-difluoro-3-methylhept-3-en-1-yl, 2,2-difluoro-3-methylhexy-4-en-1-yl, 2,2-difluoro-3-methylhept-4-en-1-yl, 2,2-difluoro-3-methylhept-5-en-1-yl, 3,3,3-trifluoroprop-1-en-1-yl, 3,3,3-trifluorobut-1-en-1-yl or 3,3,3-trifluoropent-1-en-1-yl.

Specific examples of R¹ also include fluoromethoxy, 2-fluoroethoxy, 3-fluoropropoxy, 4-fluorobutoxy, 5-fluoropentyloxy, 6-fluorohexyloxy, 7-fluoroheptyloxy, difluoromethoxy, trifluoromethoxy, (fluoromethoxy)methyl, 2-(fluoromethoxy)ethyl, 3-(fluoromethoxy)propyl, 4-(fluoromethoxy)butyl, 5-(fluoromethoxy)pentyl, 6-(fluoromethoxy)hexyl, methyl(difluoromethoxy), 2-(difluoromethoxy)ethyl, 3-(difluoromethoxy)propyl, 4-(difluoromethoxy)butyl, 5-(difluoromethoxy)pentyl, 6-(difluoromethoxy)hexyl, methyl(trifluoromethoxy), 2-(trifluoromethoxy)ethyl, 3-(trifluoromethoxy)propyl, 4-(trifluoromethoxy)butyl, 5-(trifluoromethoxy)pentyl or 6-(trifluoromethoxy)hexyl.

Specific examples of preferred R¹ include ethyl, propyl, butyl, pentyl, hexyl, methoxy, ethoxy, propoxy, butoxy, pentyloxy, methoxymethyl, methoxyethyl, methoxypropyl, ethoxymethyl, ethoxyethyl, ethoxypropyl, propoxymethyl, propoxyethyl, butoxymethyl, vinyl, 1-propenyl, 2-propenyl, 1-butenyl, 2-butenyl, 3-butenyl, 1-pentenyl, 2-pentenyl, 3-pentenyl, 4-pentenyl, 2-propenyloxy, 2-butenyloxy, 2-pentenyloxy, —OCF₃, —OCHF₂, —OCH₂F, —OCF₂CF₃, —OCF₂CHF₂, —OCF₂CH₂F, —OCF₂CF₂CF₃, —OCF₂CHFCF₃ or —OCHFCF₂CF₃. Specific examples of most preferred R¹ include ethyl, propyl, butyl, pentyl, methoxy, ethoxy, propoxy, butoxy, pentyloxy, methoxymethyl, methoxyethyl, methoxypropyl, ethoxymethyl, ethoxyethyl, propoxymethyl, vinyl, 1-propenyl, 3-butenyl, 3-pentenyl, —OCF₃, —OCHF₂, —CF₃, —CHF₂, —CH₂F, —OCF₂CHF₂ or —OCF₂CHFCF₃.

In formula (1), A¹ and A² are independently 1,2-cyclopropylene, 1,2-cyclopropenylene, 1,3-cyclobutylene, 1,3-cyclobutenylene, 1,3-cyclopentylene or 1,3-cyclopentenylene.

Preferred A¹ or A² is 1,2-cyclopropylene, 1,3-cyclobutylene or 1,3-cyclopentylene.

In formula (1), Z¹ and Z² are independently a single bond or alkylene having 1 to 15 carbons, and in the alkylene, at least one —CH₂— may be replaced by —O— or —S—, and at least one —CH₂CH₂— may be replaced by —CH═CH—, —C≡C—, —COO— or —OCO—, and in the divalent groups, at least one hydrogen may be replaced by fluorine or chlorine.

Specific examples of Z¹ or Z² include a single bond, —COO—, —OCO—, —CH₂O—, —OCH₂—, —CF₂O—, —OCF₂—, —CH₂CH₂—, —CH═CH—, —CF═CH—, —CH═CF—, —CF═CF—, —C≡C—, —CH₂CO—, —COCH₂—, —CH₂SiH₂—, —SiH₂CH₂—, —(CH₂)₄—, —(CH₂)₂COO—, —(CH₂)₂OCO—, —OCO(CH₂)₂—, —COO(CH₂)₂—, —(CH₂)₂CF₂O—, —(CH₂)₂OCF₂—, —OCF₂(CH₂)₂—, —CF₂O(CH₂)₂—, —(CH₂)₃O— or —O(CH₂)₃—. With regard to a configuration of a double bond of a bonding group such as —CH═CH—, —CF═CF—, —CH═CH—CH₂O— and —OCH₂—CH═CH—, trans is preferred to cis.

Specific examples of preferred Z¹ or Z² include a single bond, —COO—, —OCO—, —CH₂O—, —OCH₂—, —CF₂O—, —OCF₂—, —CH₂CH₂—, —CH═CH—, —CF═CF—, —C≡C— and —(CH₂)₄—. Specific examples of further preferred Z¹ or Z² include a single bond, —COO—, —OCO—, —CF₂O—, —OCF₂—, —CH═CH—, —CH₂CH₂— and —C≡C—. Preferred Z¹ or Z² is a single bond.

In formula (1), L¹ and L² are independently fluorine, chlorine, —OCF₃ or —OCH₂F. Preferred L¹ or L² is fluorine, —OCF₃ or —OCH₂F. Further preferred L¹ or L² is fluorine or —OCF₃. Particularly preferred L¹ or L² is fluorine.

In formula (1), X¹ and X² are independently oxygen or sulfur. Preferred X¹ or X² is oxygen.

In formula (1), a is 0 or 1, b is 0 or 1, and a sum of a and b is 0, 1 or 2; R¹ is hydrogen when a is 1, and R² is hydrogen when b is 1, and X¹ may be a single bond when b is 1.

Examples of a subordinate formula of formula (1) include formula (1-1) to formula (1-5). Compound (1-1) has a 2,3-disubstituted-1,4-phenylene ring. Compound (1-5) further has two aliphatic rings. More specifically, compound (1) has one to three rings. When compound (1) has one ring, compatibility with other liquid crystal compounds is good, and viscosity is small. When compound (1) has two rings, the viscosity is small. When compound (1) has three rings, a maximum temperature is high.

The physical properties such as the optical anisotropy and the dielectric anisotropy can be arbitrarily adjusted by appropriately selecting the terminal groups (R¹ and R²), the aliphatic rings (A¹ and A²), the bonding groups (Z¹ and Z²), the divalent groups (X¹ and X²), the lateral groups (L¹ and L²) and the subscripts (a and b). An effect of a kind of the terminal group or the like and symmetry of compound (1) on the physical properties of compound (1) will be described below.

In compound (1), when R¹ or R² has the straight chain, a temperature range of the liquid crystal phase is wide, the maximum temperature is high, and the viscosity is small. When R¹ or R² has the branched chain, the compatibility with other liquid crystal compounds is good. A compound in which R¹ or R² is an optically active group is useful as a chiral dopant. A reverse twisted domain to be generated in the device can be prevented by adding the compound to the composition. A compound in which R¹ or R² is not the optically active group is useful as a component of the composition. The compound in which one hydrogen of R¹ or R² is replaced by fluorine has a high maximum temperature. The compound in which 2 to 4 hydrogens of R¹ or R² are replaced by fluorine has large negative dielectric anisotropy.

When R¹ or R² is alkenyl, a preferred configuration of —CH═CH— depends on a position of a double bond. A trans configuration is preferred in the alkenyl such as 1-propenyl, 1-butenyl, 1-pentenyl, 1-hexenyl, 3-pentenyl and 3-hexenyl. A cis configuration is preferred in the alkenyl such as 2-butenyl, 2-pentenyl and 2-hexenyl. An alkenyl compound having the preferred configuration has a high maximum temperature or a wide temperature range of the liquid crystal phase. A detailed description is found in Mol. Cryst. Liq. Cryst., 1985, 131, 109 and Mol. Cryst. Liq. Cryst., 1985, 131 and 327.

When A¹ or A² is 1,2-cyclopropylene, 1,2-cyclopropenylene, 1,3-cyclobutylene or 1,3-cyclobutenylene, the viscosity is small, and the compatibility with other liquid crystal compounds is good. When A¹ or A² is 1,3-cyclopentylene or 1,3-cyclopentenylene, the maximum temperature is high.

When the bonding group Z¹ or Z² is a single bond, —CH₂O—, —CF₂O—, —OCF₂—, —CH₂CH₂—, —CH═CH—, —CF═CF— or —(CH₂)₄—, the viscosity is small. When the bonding group is a single bond, —OCF₂—, —CF₂O—, —CH₂CH₂— or —CH═CH—, the viscosity is smaller. When the bonding group is —CH═CH—, the temperature range of the liquid crystal phase is wide, and an elastic constant ratio K₃₃/K₁₁ (K₃₃: a bend elastic constant, K₁₁: a splay elastic constant) is large. When the bonding group is —C≡C—, the optical anisotropy is large.

When compound (1) is symmetrical, the maximum temperature is high. When compound (1) has right-left asymmetry, the compatibility with other liquid crystal compounds is good.

When compound (1) has one or two rings, the viscosity is small. When compound (1) has three rings, the maximum temperature is high. As described above, a compound having required physical properties can be obtained by suitably selecting a kind of the terminal group, the ring and the bonding group, and the number of the rings. Accordingly, compound (1) is useful as a component of a composition used in a device having a mode such as the PC mode, the TN mode, the STN mode, the ECB mode, the OCB mode, the IPS mode and the VA mode.

### 2. Synthesis of Compound (1)

A synthetic method of compound (1) will be described. Compound (1) can be prepared by suitably combining methods in synthetic organic chemistry. A method for introducing a required terminal group, ring and bonding group into a starting material is described in books such as “Organic Syntheses” (John Wiley & Sons, Inc.), “Organic Reactions” (John Wiley & Sons, Inc.), “Comprehensive Organic Synthesis” (Pergamon Press) and “New Experimental Chemistry Course (Shin Jikken Kagaku Koza in Japanese)” (Maruzen Co., Ltd.).

### 2-1. Formation of a Bonding Group

First, a scheme is shown with regard to a method for forming the bonding group (Z¹ or Z²). Next, reactions described in the scheme in methods (1) to (11) will be described. In the scheme, MSG¹ (or MSG²) is a monovalent organic group having at least one ring. The monovalent organic groups represented by a plurality of MSG¹ (or MSG²) used in the scheme may be identical or different. Compounds (1A) to (1J) correspond to compound (1).

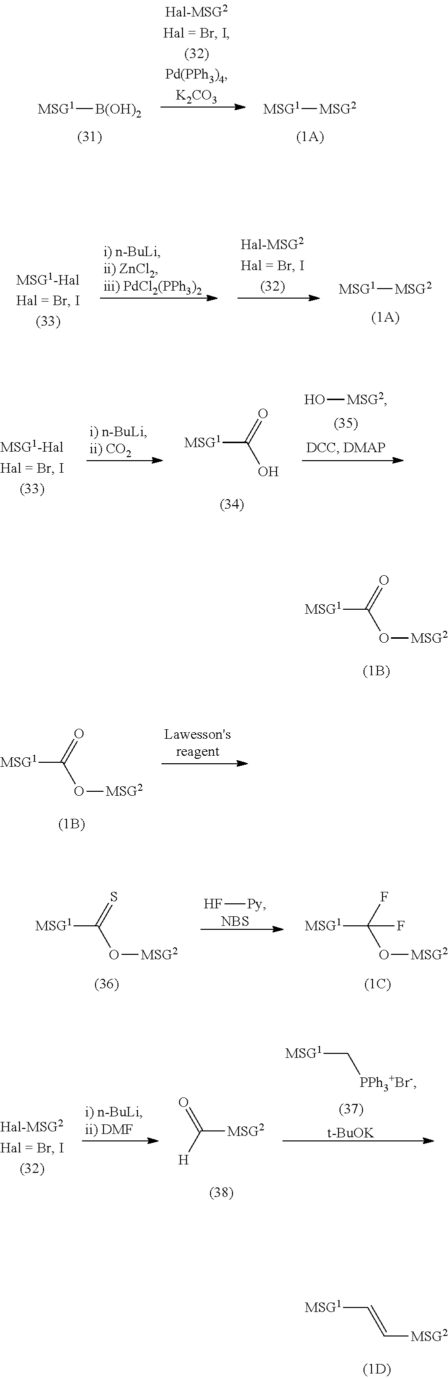

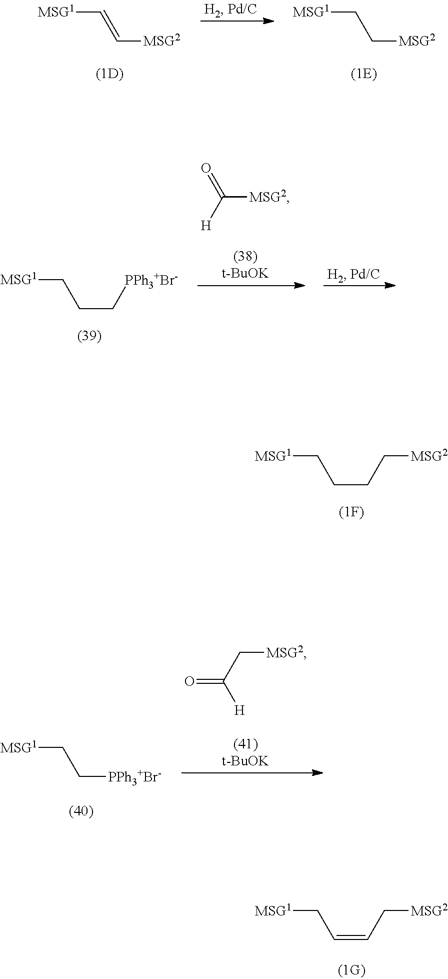

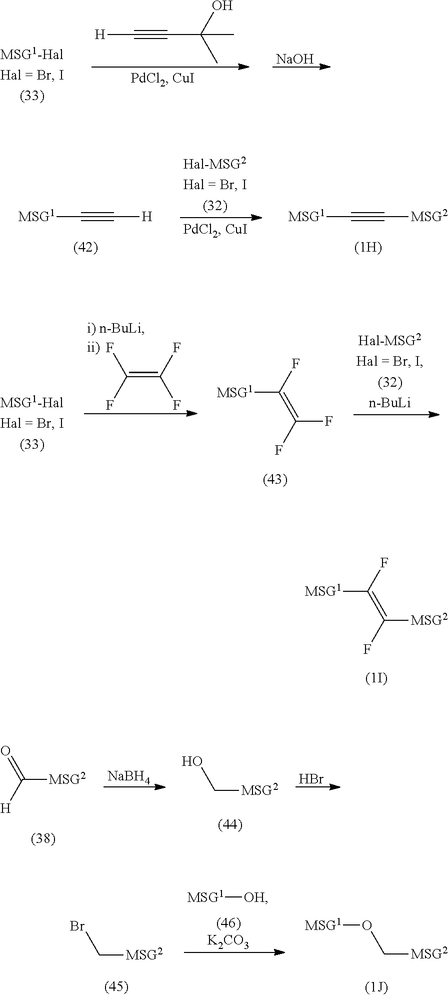

### (1) Formation of a Single Bond

Compound (1A) is prepared by allowing aryl boronic acid (31) prepared according to a publicly known method to react with halide (32), in the presence of carbonate and a catalyst such as tetrakis(triphenylphosphine)palladium. Compound (1A) is also prepared by allowing halide (33) prepared according to a publicly known method to react with n-butyllithium and subsequently with zinc chloride, and further with halide (32) in the presence of a catalyst such as dichlorobis(triphenylphosphine)palladium.

### (2) Formation of —COO—

Carboxylic acid (34) is obtained by allowing halide (33) to react with n-butyllithium and subsequently with carbon dioxide. Compound (1B) is prepared by dehydration of compound (35) prepared according to a publicly known method and carboxylic acid (34) in the presence of 1,3-dicyclohexylcarbodiimide (DCC) and 4-dimethylaminopyridine (DMAP).

### (3) Formation of —CF₂O—

Thionoester (36) is obtained by treating compound (1B) with a thiation reagent such as Lawesson's reagent. Compound (1C) is prepared by fluorinating thionoester (36) with a hydrogen fluoride-pyridine complex and N-bromosuccinimide (NBS). Refer to M. Kuroboshi et al., Chem. Lett., 1992, 827. Compound (1C) is also prepared by fluorinating thionoester (36) with (diethylamino)sulfur trifluoride (DAST). Refer to W. H. Bunnelle et al., J. Org. Chem. 1990, 55, 768. The bonding group can also be formed according to the method described in Peer. Kirsch et al., Angew. Chem. Int. Ed. 2001, 40, 1480.

### (4) Formation of —CH═CH—

Aldehyde (38) is obtained by treating halide (32) with n-butyllithium, and then allowing the treated halide to react with N,N-dimethylformamide (DMF). Phosphorus ylide is generated by treating phosphonium salt (37) prepared according to a publicly known method with a base such as potassium t-butoxide. Compound (1D) is prepared by allowing the phosphorus ylide to react with aldehyde (38). A cis isomer may be generated depending on reaction conditions, and therefore the cis isomer is isomerized into a trans isomer according to a publicly known method when necessary.

(5) Formation of —CH₂CH₂—

Compound (1E) is prepared by hydrogenating compound (ID) in the presence of a catalyst such as palladium on carbon.

(6) Formation of —(CH₂)₄—

A compound having —(CH₂)₂—CH═CH— is obtained by using phosphonium salt (39) in place of phosphonium salt (37) according to the method in method (4). Compound (1F) is prepared by performing catalytic hydrogenation of the compound obtained.

(7) Formation of —CH₂CH═CHCH₂—

Compound (1G) is prepared by using phosphonium salt (40) in place of phosphonium salt (37) and aldehyde (41) in place of aldehyde (38) according to the method of method (4). A trans isomer may be generated depending on reaction conditions, and therefore the trans isomer is isomerized to a cis isomer according to a publicly known method when necessary.

### (8) Formation of —C≡C—

Compound (42) is obtained by allowing halide (33) to react with 2-methyl-3-butyn-2-ol in the presence of a catalyst of dichloropalladium and copper halide, and then performing deprotection under basic conditions. Compound (1H) is prepared by allowing compound (42) to react with halide (32) in the presence of the catalyst of dichloropalladium and copper halide.

### (9) Formation of —CF═CF—

Compound (43) is obtained by treating halide (33) with n-butyllithium, and then allowing the treated halide to react with tetrafluoroethylene. Compound (1I) is prepared by treating halide (32) with n-butyllithium, and then allowing the treated halide to react with compound (43).

### (10) Formation of —OCH₂—

Compound (44) is obtained by reducing aldehyde (38) with a reducing agent such as sodium borohydride. Bromide (45) is obtained by brominating compound (44) with hydrobromic acid or the like. Compound (1J) is prepared by allowing bromide (45) to react with compound (46) in the presence of a base such as potassium carbonate.

(11) Formation of —(CF₂)₂—

A compound having —(CF₂)₂— is obtained by fluorinating diketone (—COCO—) with sulfur tetrafluoride, in the presence of a hydrogen fluoride catalyst, according to a method described in J. Am. Chem. Soc., 2001, 123, 5414.

### 2.2 Formation of 2,3-disubstituted-1,4-phenylene

Next, a formation method with regard to 2,3-disubstituted-1,4-phenylene will be described. A starting material is commercially available or the formation method is well known with regard to a ring such as 1,4-cyclohexylene, 1,3-dioxane-2,5-diyl, 1,4-phenylene, 2-fluoro-1,4-phenylene, 2,3-difluoro-1,4-phenylene, pyridine-2,5-diyl and pyrimidine-2,5-diyl. Then, compounds (64) and (70) described below will be described.

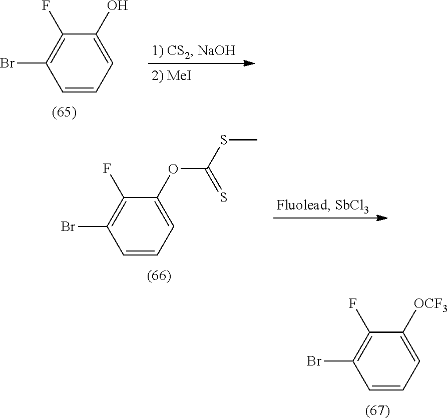

A structural unit of 2-fluoro-3-trifluoromethoxyphenylene is prepared according to the method described in Synlett, 2017, 28, and 2281. Compound (66) is prepared by allowing compound (65) to act on carbon disulfide and methyl iodide under basic conditions. Compound (67) is obtained by fluorinating the compound obtained according to the method described in J. Am. Chem. Soc., 2010, 132(51), 18199. The compound obtained is converted into compound (1) according to an ordinary method.

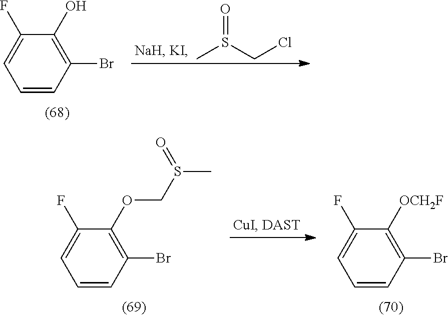

The structural unit of 2-fluoro-3-fluoromethoxyphenylene is prepared according to the method described in J. Org. Chem. 2017, 82, 8604. Compound (69) is prepared by allowing compound (68) to act on chloro(methanesulfinyl)methane and potassium iodide under basic conditions. Compound (70) is obtained by fluorinating the compound obtained with copper iodide and diethylamino sulfur trifluoride (DAST). The compound obtained is converted into compound (1) according to an ordinary method.

### 3. Liquid Crystal Composition

### 3-1. Component Compound

A liquid crystal composition of the invention will be described. The composition contains at least one compound (1) as component (a). The composition may contain two, three or more compounds (1). A component in the composition may be only compound (1). The composition preferably contains at least one of compounds (1) in a range of about 1% by weight to about 99% by weight in order to develop good physical properties. In a composition having negative dielectric anisotropy, a preferred content of compound (1) is in a range of about 5% by weight to about 60% by weight. In a composition having positive dielectric anisotropy, a preferred content of compound (1) is about 30% by weight or less.

TABLE 1
Component compounds of a composition

| Components | Component compounds | Dielectric anisotropy |
|---|---|---|
| Component (a) | Compound (1) | Negatively large |
| Component (b) | Compound (2) to | Small |
| | compound (4) | |
| Component (c) | Compound (5) to | Negatively large |
| | compound (13) | |
| Component (d) | Compound (21) to | Positively large |
| | compound (23) | |
| Component (e) | Compound (24) | Positively large |

The composition contains compound (1) as component (a). The composition further preferably contains a liquid crystal compound selected from components (b) to (e) described in Table 1. When the composition is prepared, components (b) to (e) are preferably selected by taking into account the positive or negative dielectric anisotropy and magnitude of the dielectric anisotropy. The composition may contain a liquid crystal compound different from components (a) to (e). The composition may not contain such a liquid crystal compound.

Component (b) includes a compound in which two terminal groups are alkyl or the like. Specific examples of preferred component (b) include compounds (2-1) to (2-11), compounds (3-1) to (3-19) and compounds (4-1) to (4-7). In the compounds, R¹¹ and R¹² are independently alkyl having 1 to 10 carbons or alkenyl having 2 to 10 carbons, and in the alkyl and the alkenyl, at least one —CH₂— may be replaced by —O—, and in the groups, at least one hydrogen may be replaced by fluorine.

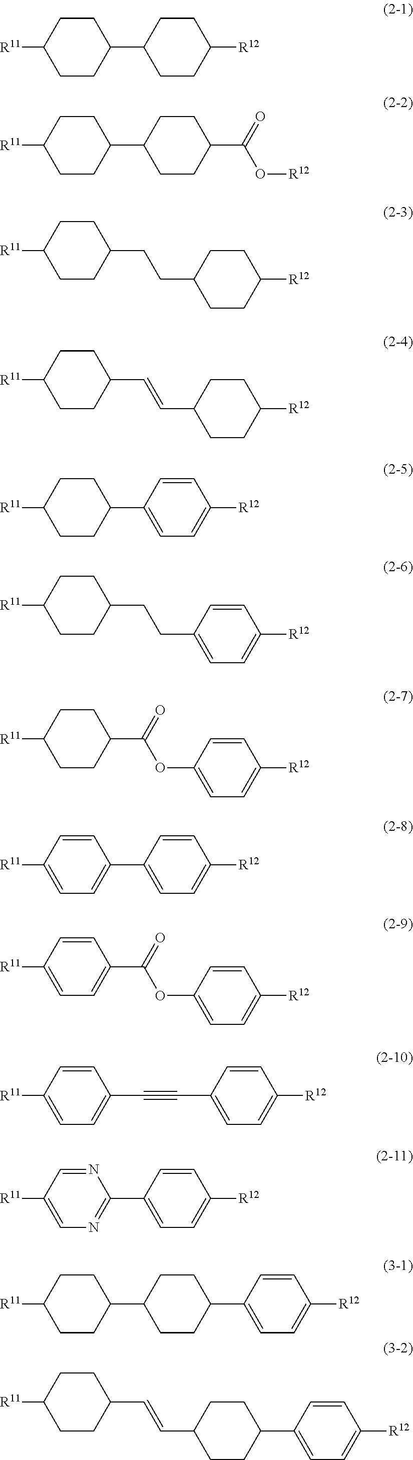

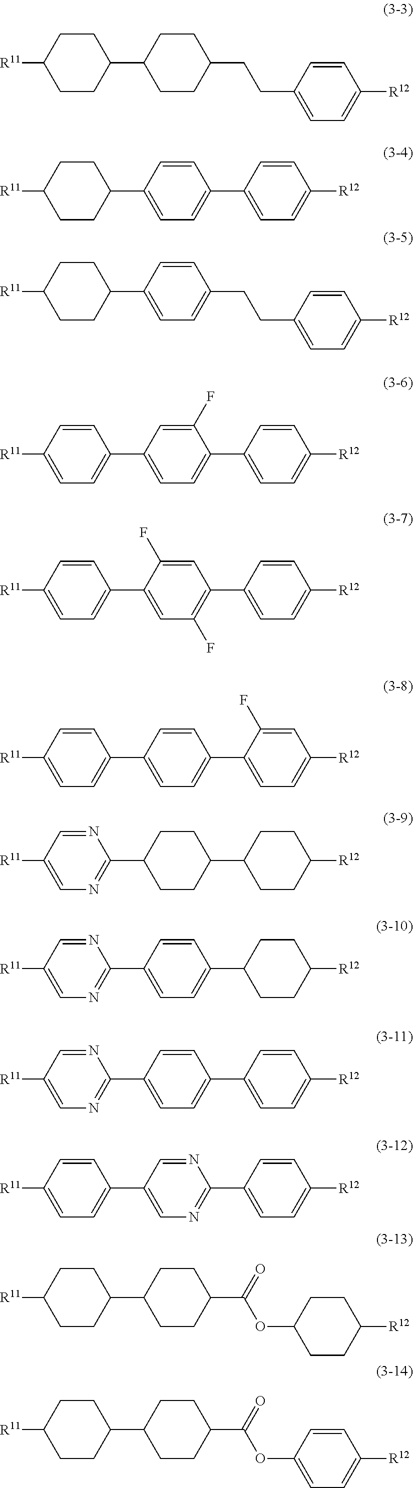

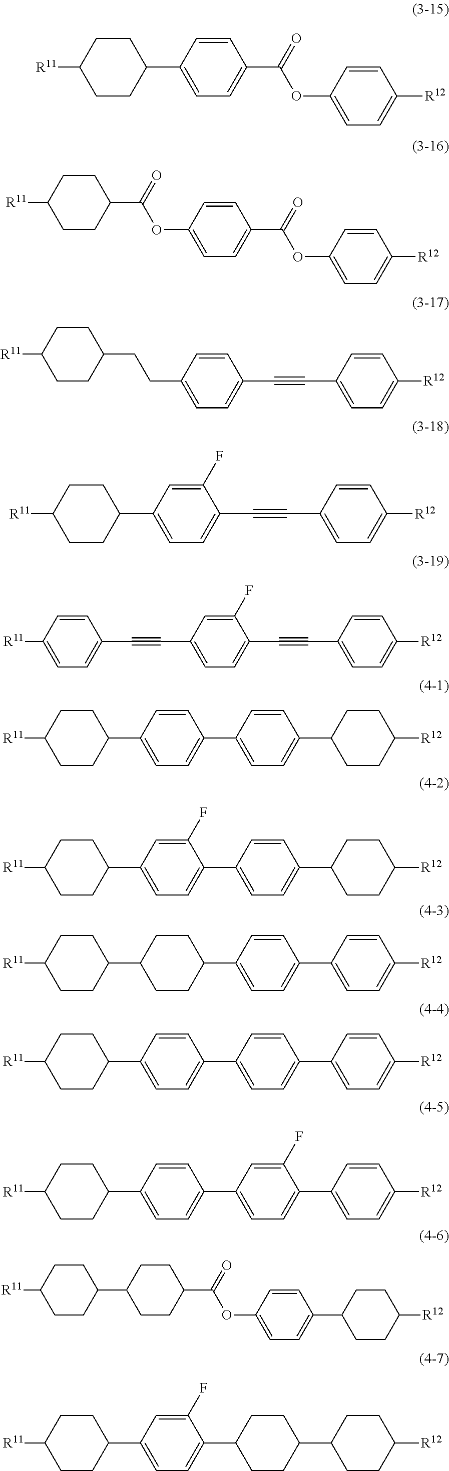

Component (b) has small dielectric anisotropy. Component (b) is close to neutrality. Compound (2) is effective in decreasing the viscosity or adjusting the optical anisotropy. Compounds (3) and (4) are effective in extending the temperature range of the nematic phase by increasing the maximum temperature, or in adjusting the optical anisotropy.

As a content of component (b) is increased, the viscosity of the composition is decreased, but the dielectric anisotropy is decreased. Thus, as long as a desired value of threshold voltage of a device is met, the content is preferably as large as possible. When a composition for the IPS mode, the VA mode or the like is prepared, the content of component (b) is preferably about 30% by weight or more, and further preferably about 40% by weight or more, based on the weight of the liquid crystal composition.

Component (c) includes compounds (5) to (13). The compounds have phenylene in which hydrogen in lateral positions are replaced by two halogens, such as 2,3-difluoro-1,4-phenylene. Specific examples of preferred component (c) include compounds (5-1) to (5-9), compounds (6-1) to (6-19), compounds (7-1) and (7-2), compounds (8-1) to (8-3), compounds (9-1) to (9-3), compounds (10-1) to (10-11), compounds (11-1) to (11-3), compounds (12-1) to (12-3), and compound (13-1). In the compounds, R¹³, R¹⁴ and R¹⁵ are independently alkyl having 1 to 10 carbons or alkenyl having 2 to 10 carbons, and in the alkyl and the alkenyl, at least one —CH₂— may be replaced by —O—, and in the groups, at least one hydrogen may be replaced by fluorine, and R¹⁵ may be hydrogen or fluorine.

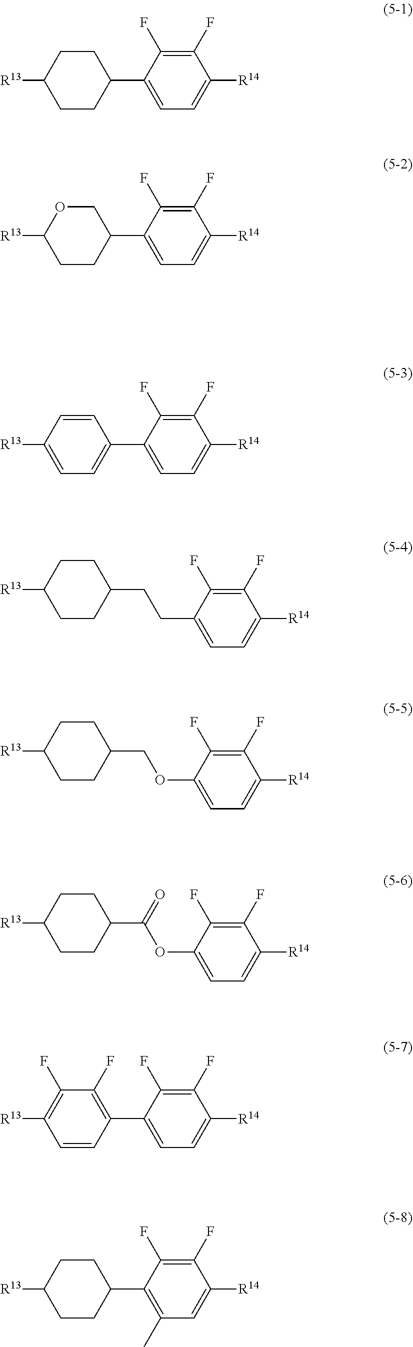

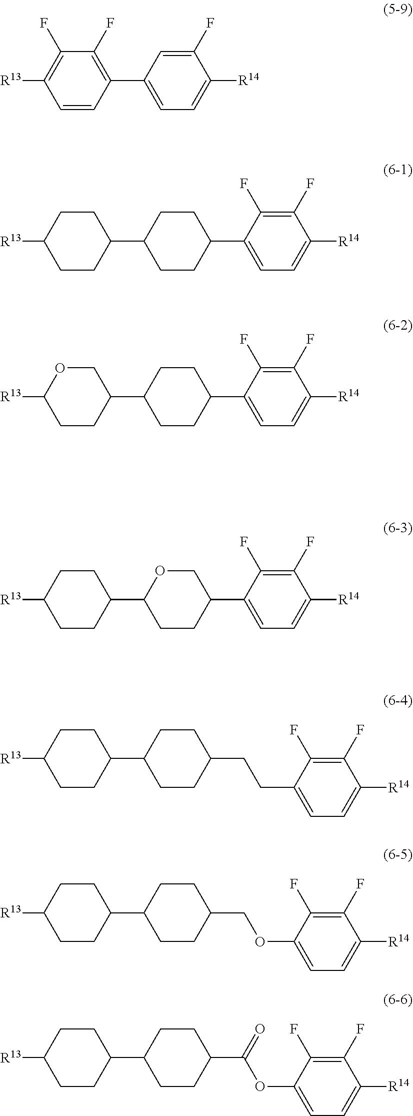

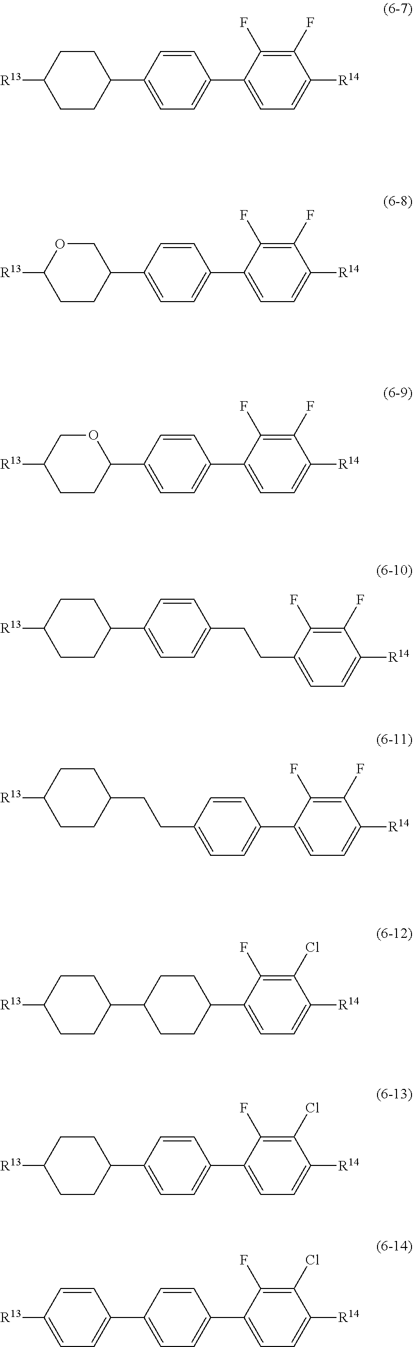

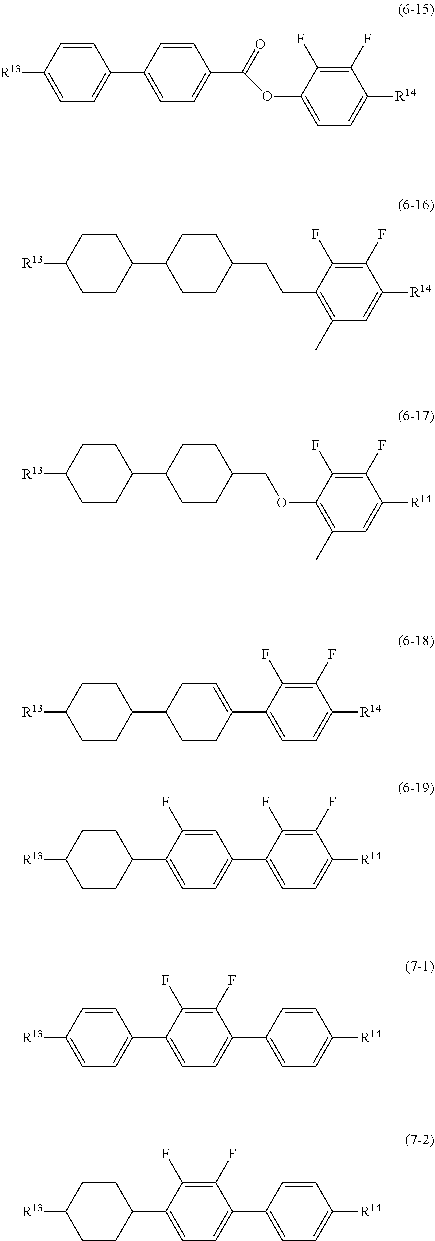

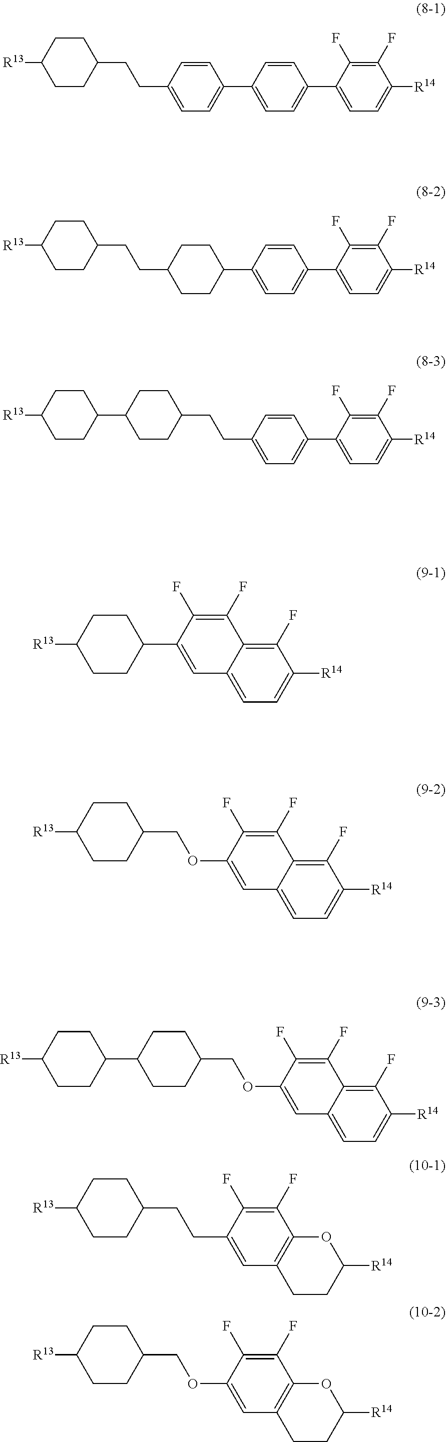

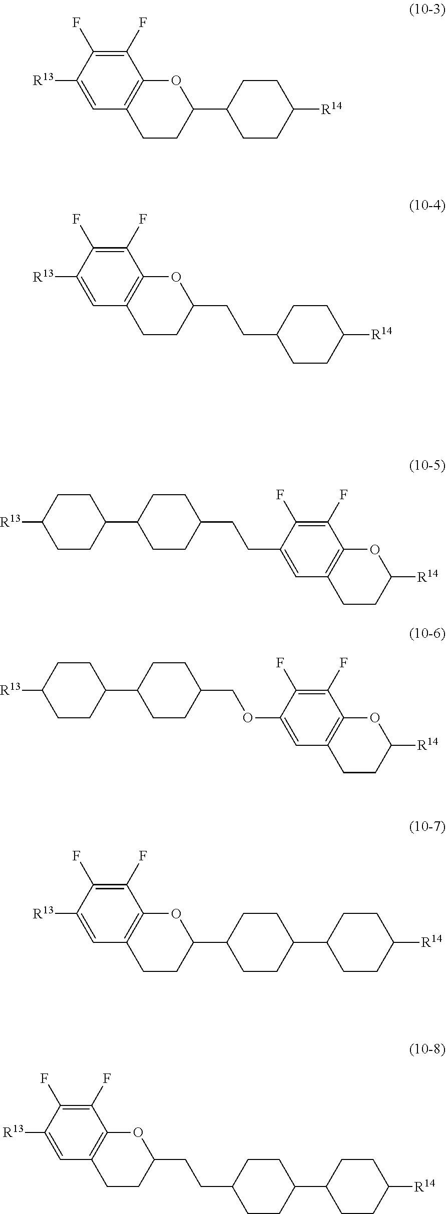

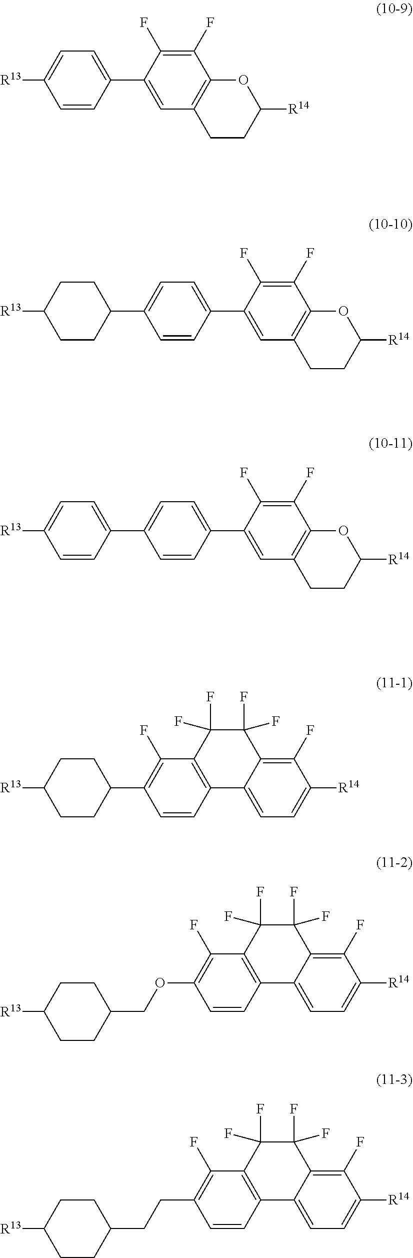

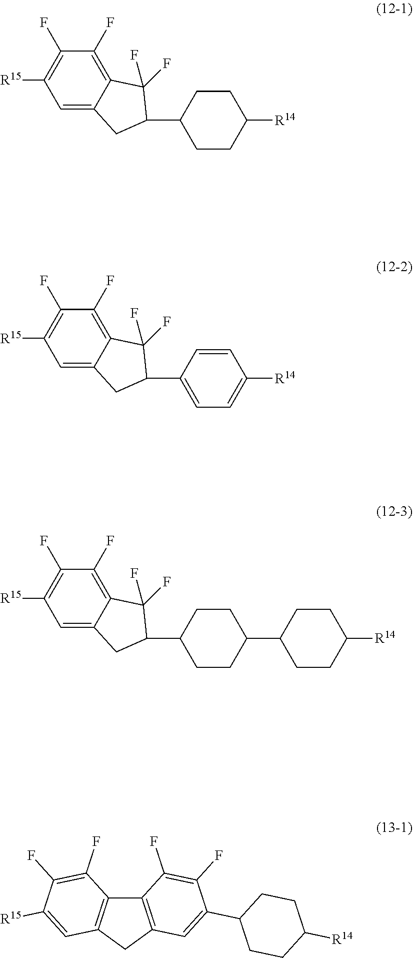

Component (c) has negatively large dielectric anisotropy. Component (c) is used when a composition for the IPS mode, the VA mode, the PSA mode or the like is prepared. As a content of component (c) is increased, the dielectric anisotropy of the composition is negatively increased, but the viscosity is increased. Thus, as long as a desired value of threshold voltage of the device is met, the content is preferably as small as possible. When the dielectric anisotropy at a degree of −5 is taken into account, the content is preferably about 40% by weight or more in order to allow a sufficient voltage driving.

Among types of component (c), compound (5) is a bicyclic compound, and therefore is effective in decreasing the viscosity, adjusting the optical anisotropy or increasing the dielectric anisotropy. Compounds (6) and (7) are a tricyclic compound, and compound (8) is a tetracyclic compound, and therefore are effective in increasing the maximum temperature, the optical anisotropy or the dielectric anisotropy. Compounds (9) to (13) are effective in increasing the dielectric anisotropy.

When a composition for the IPS mode, the VA mode, the PSA mode or the like is prepared, the content of component (c) is preferably about 40% by weight or more, and further preferably in the range of about 50% by weight to about 95% by weight, based on the weight of the liquid crystal composition. When component (c) is added to the composition having positive dielectric anisotropy, the content of component (c) is preferably about 30% by weight or less. Addition of component (c) allows adjustment of the elastic constant of the composition and adjustment of a voltage-transmittance curve of the device.

Component (d) is a compound having a halogen-containing group or a fluorine-containing group at a right terminal. Specific examples of preferred component (d) include compounds (21-1) to (21-16), compounds (22-1) to (22-116) and compounds (23-1) to (23-59). In the compounds, R¹⁶ is alkyl having 1 to 10 carbons or alkenyl having 2 to 10 carbons, and in the alkyl and the alkenyl, at least one —CH₂— may be replaced by —O—, and in the groups, at least one hydrogen may be replaced by fluorine. X¹¹ is fluorine, chlorine, —OCF₃, —OCHF₂, —CF₃, —CHF₂, —CH₂F, —OCF₂CHF₂ or —OCF₂CHFCF₃.

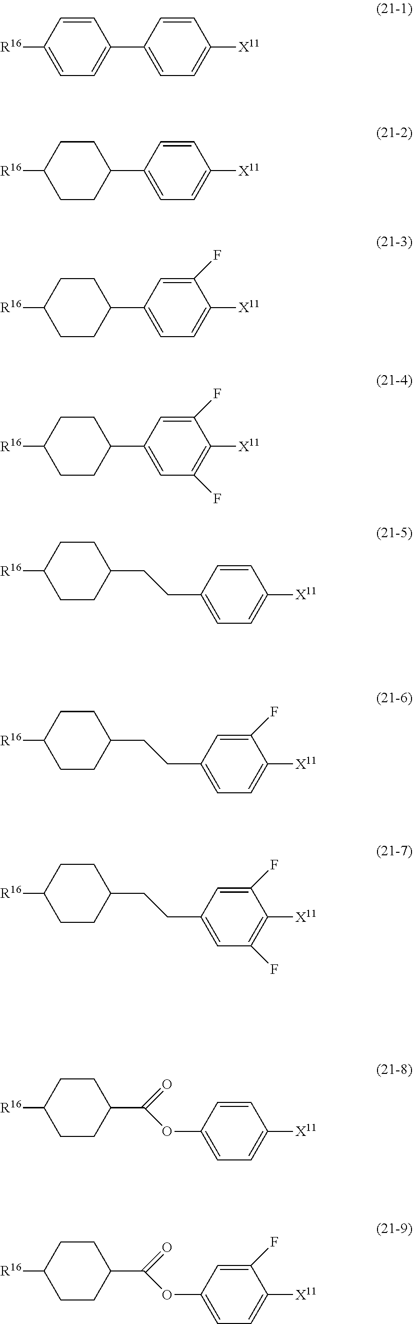

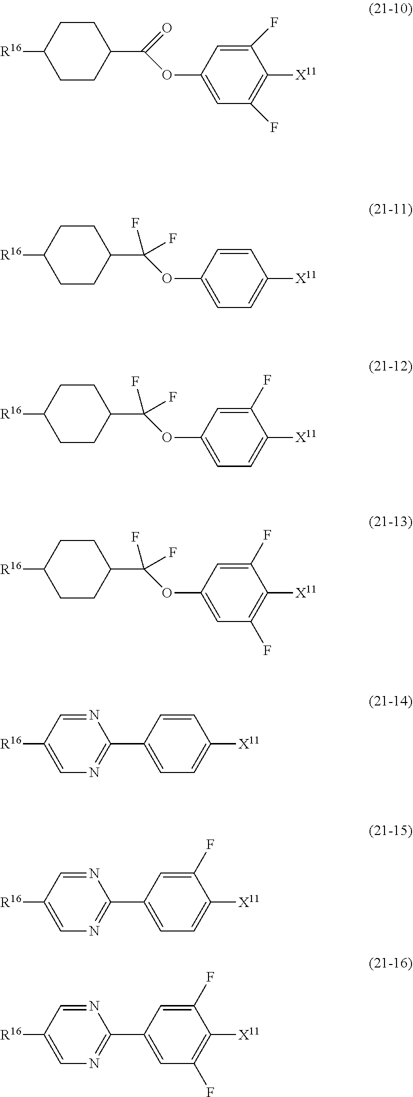

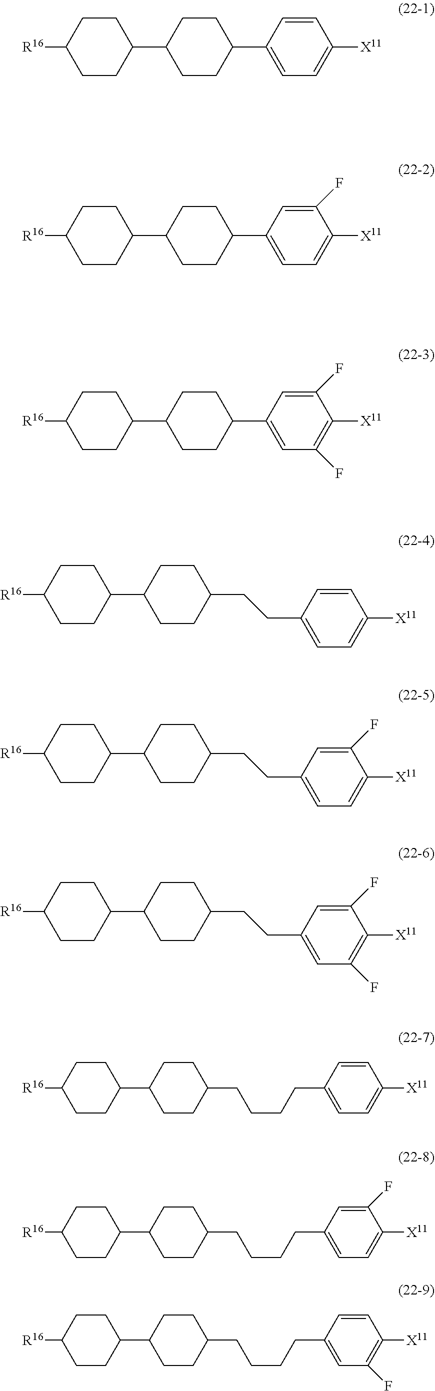

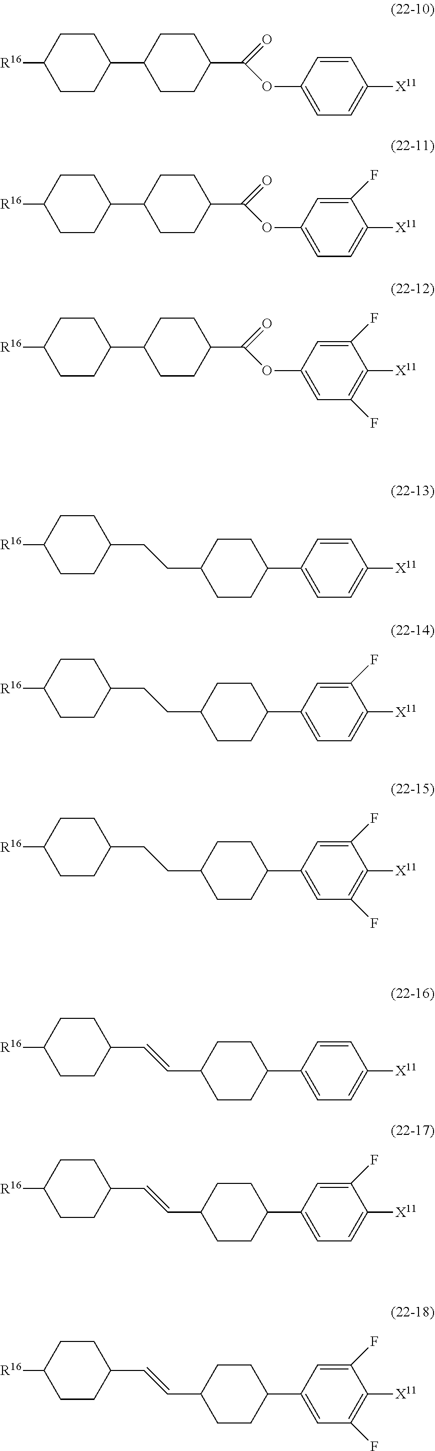

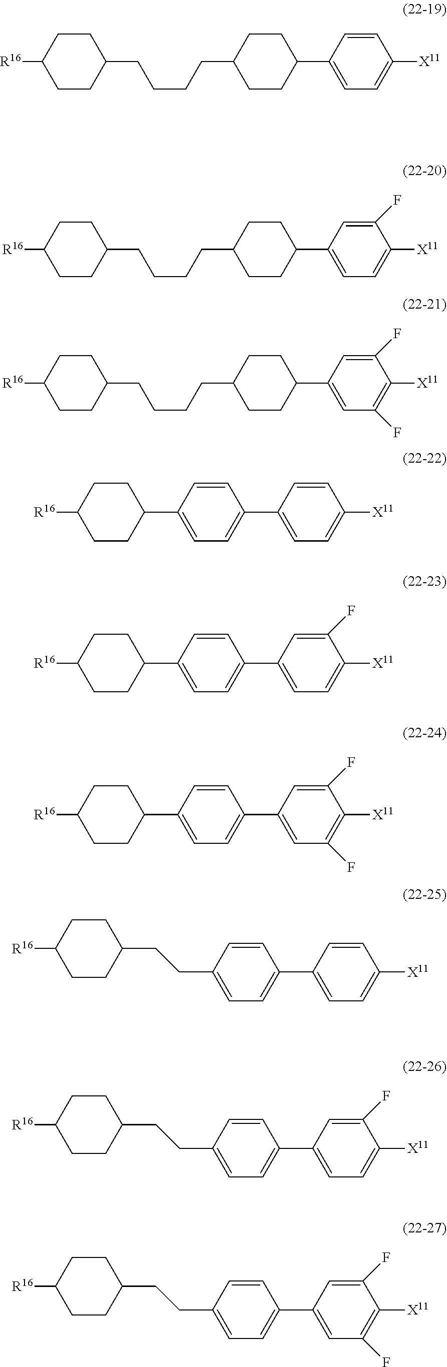

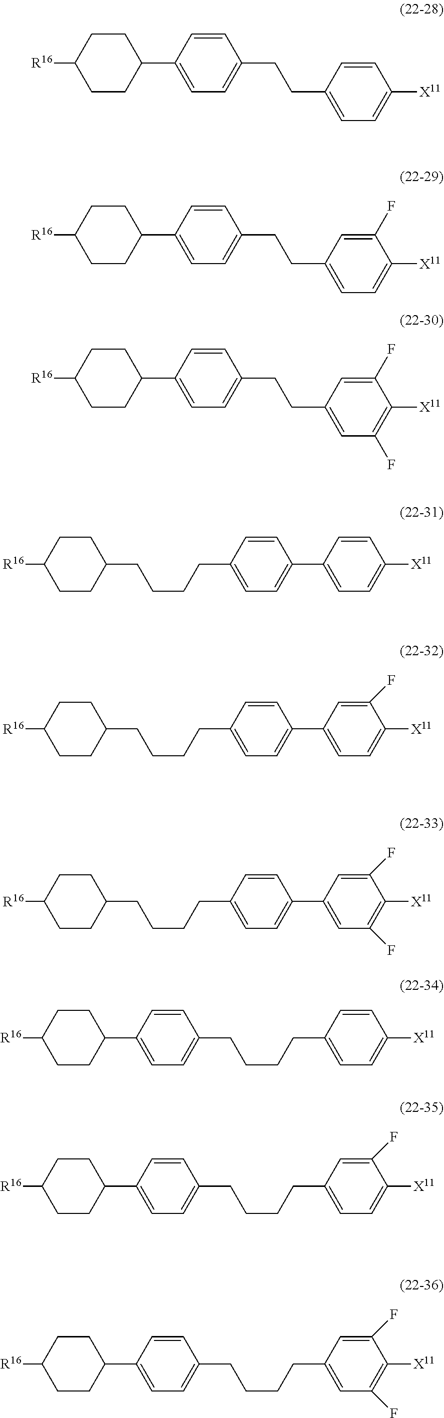

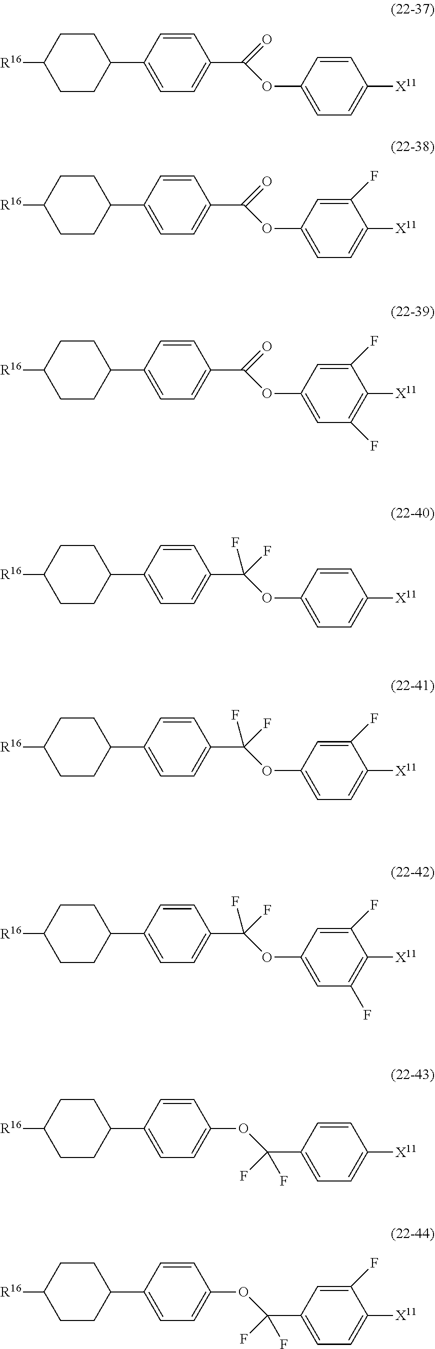

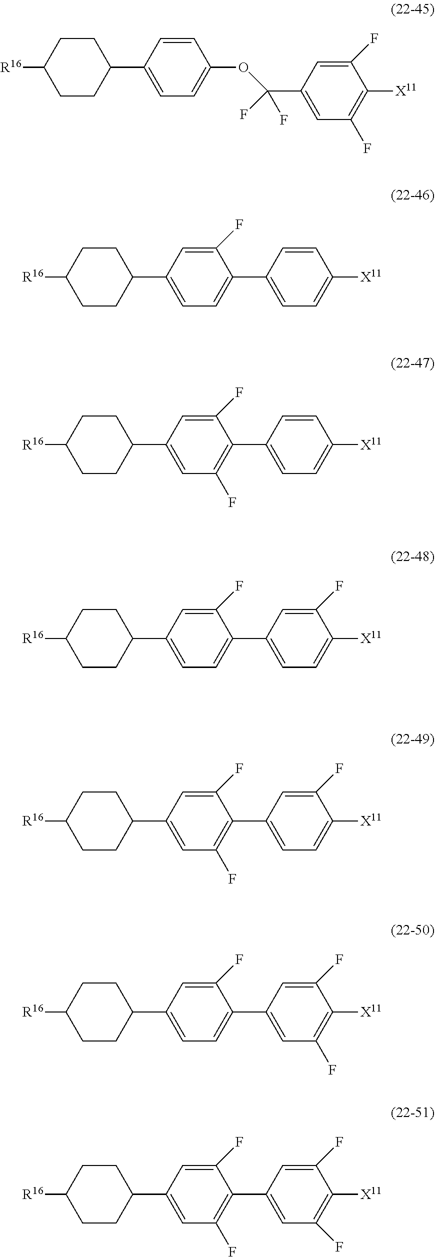

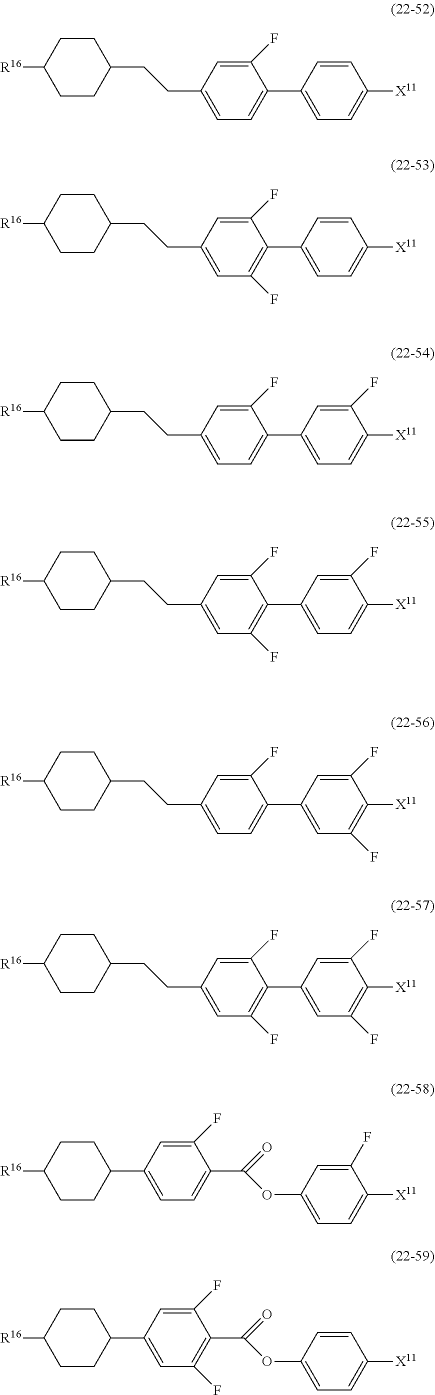

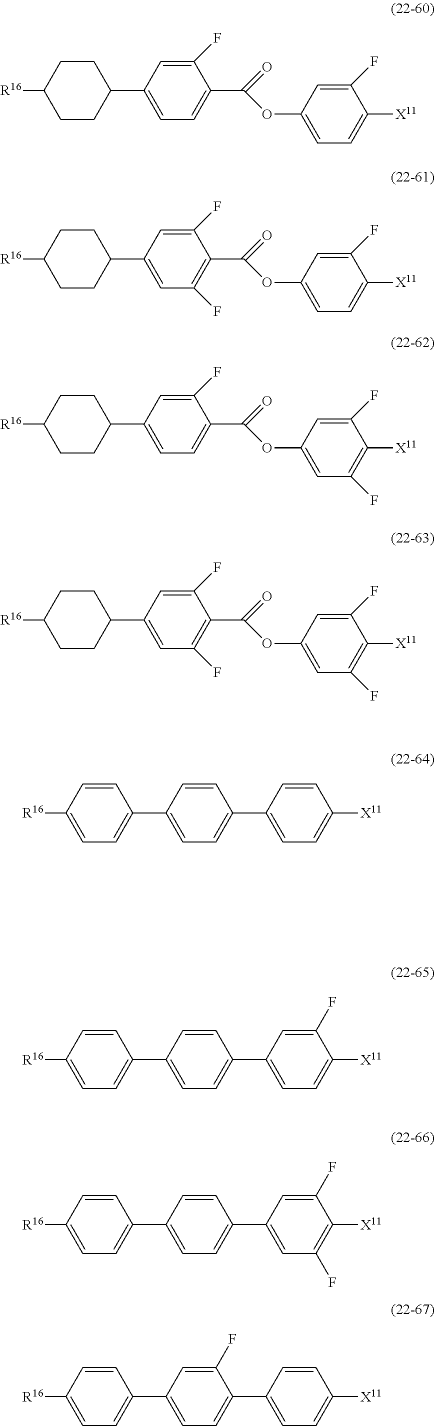

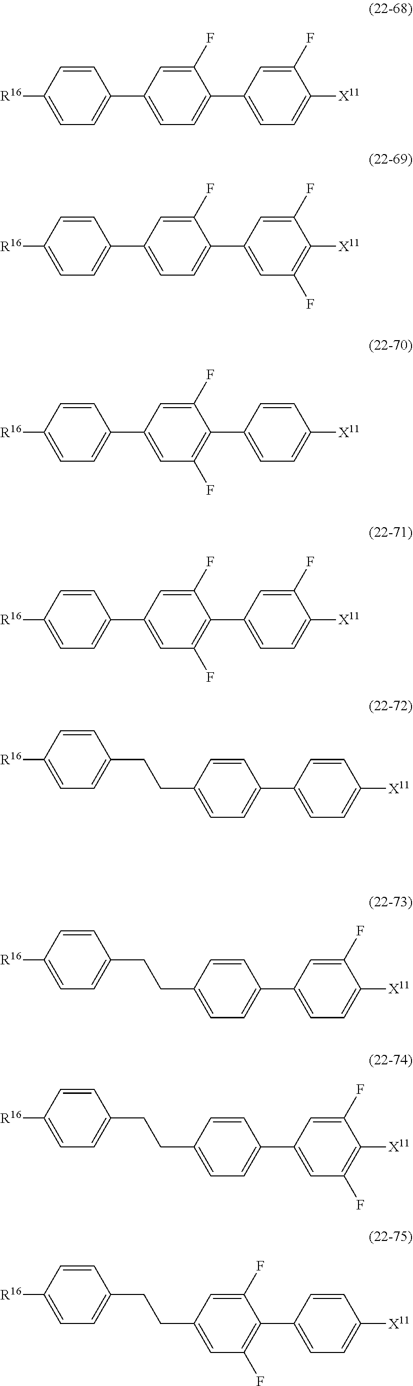

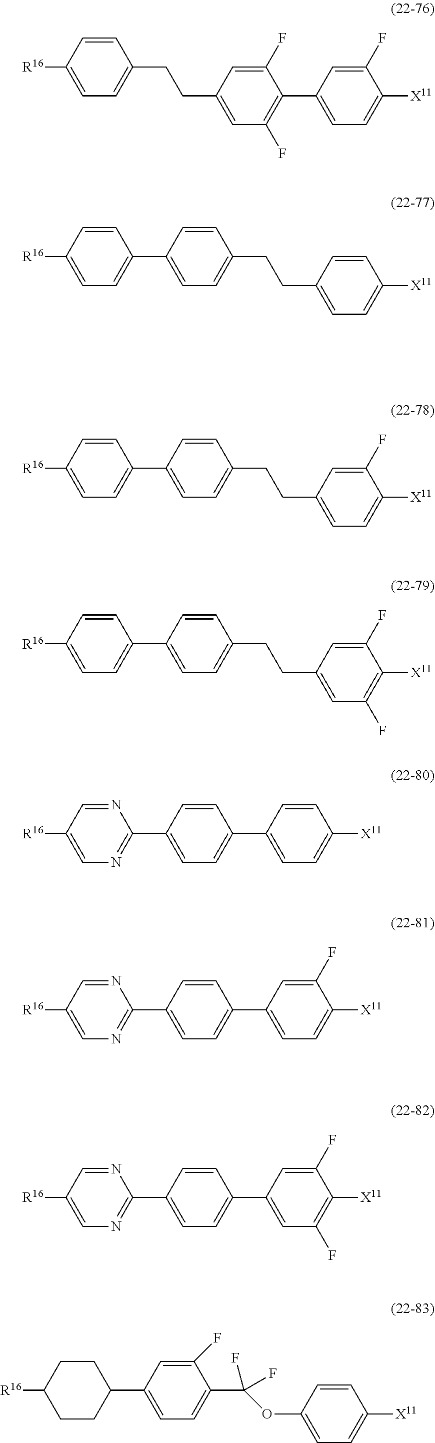

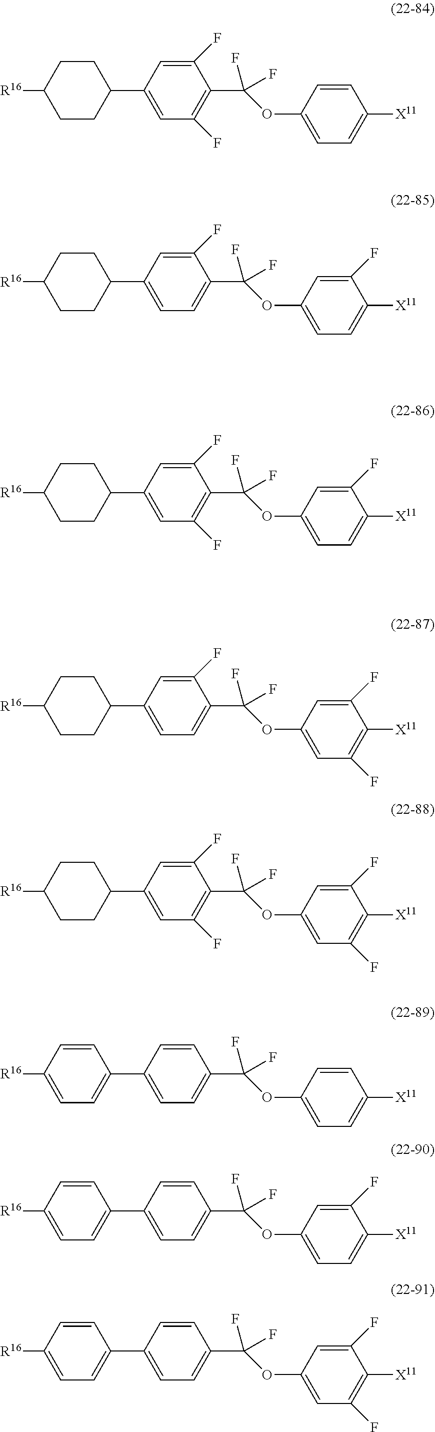

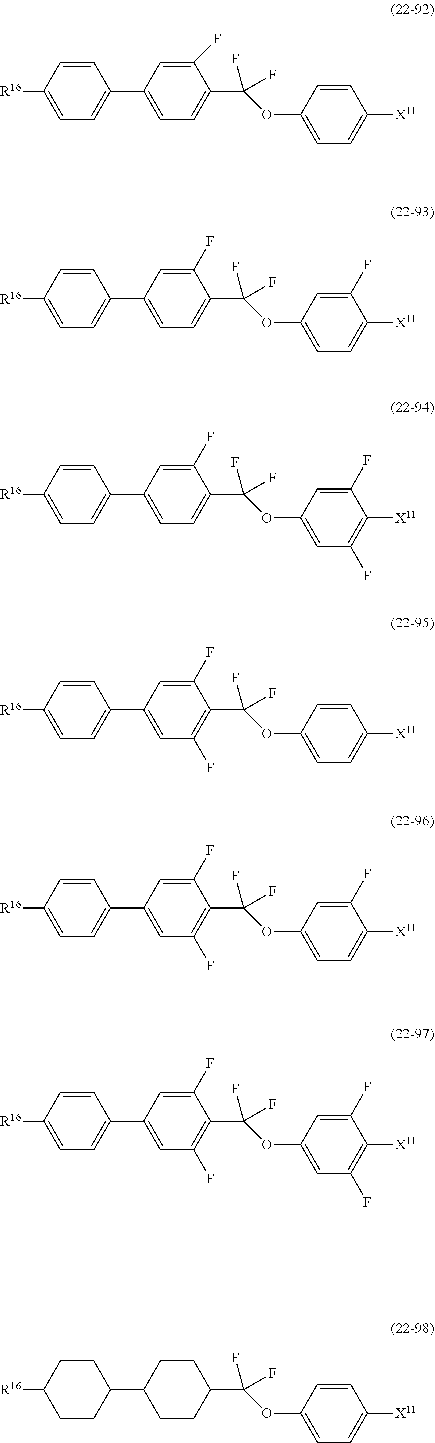

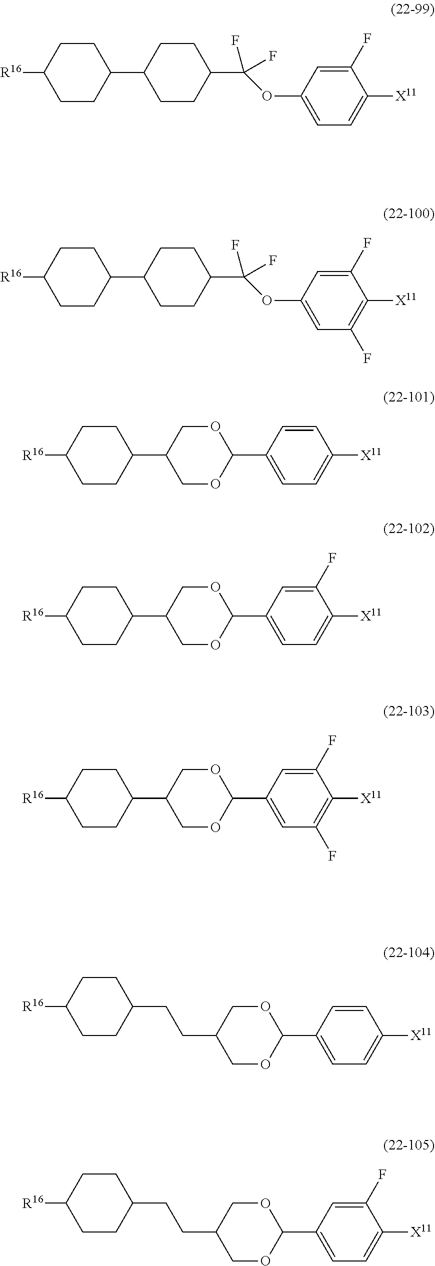

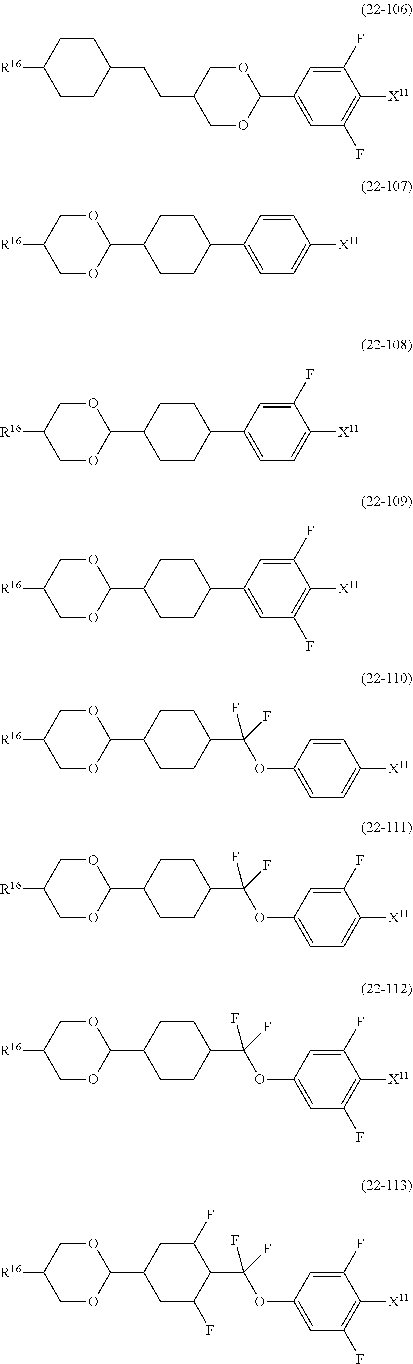

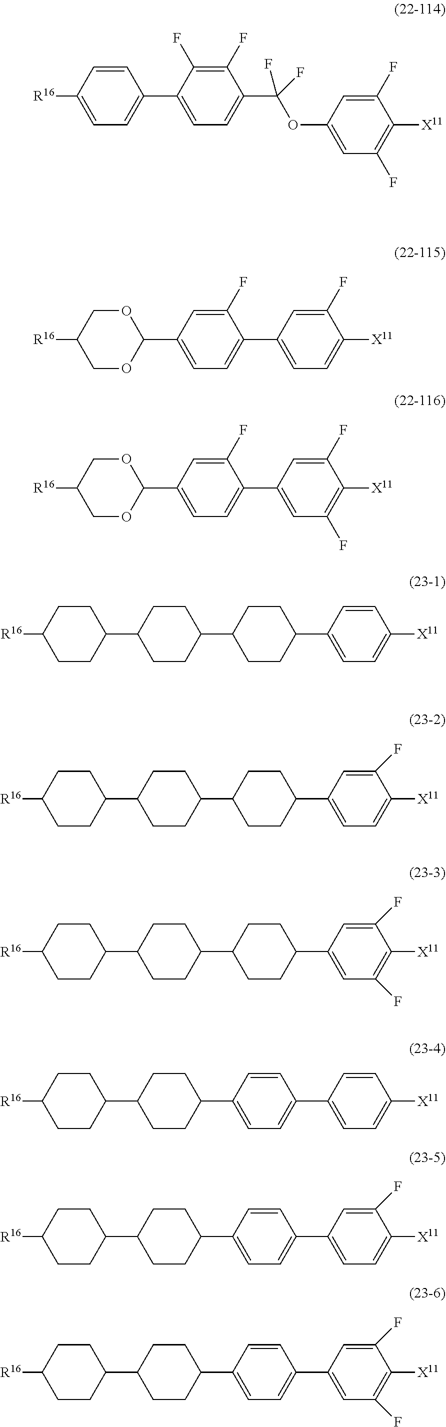

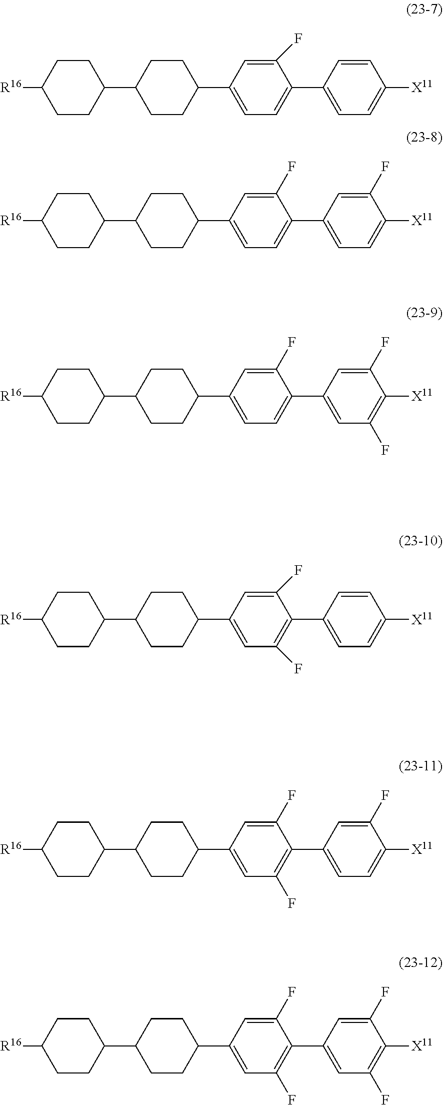

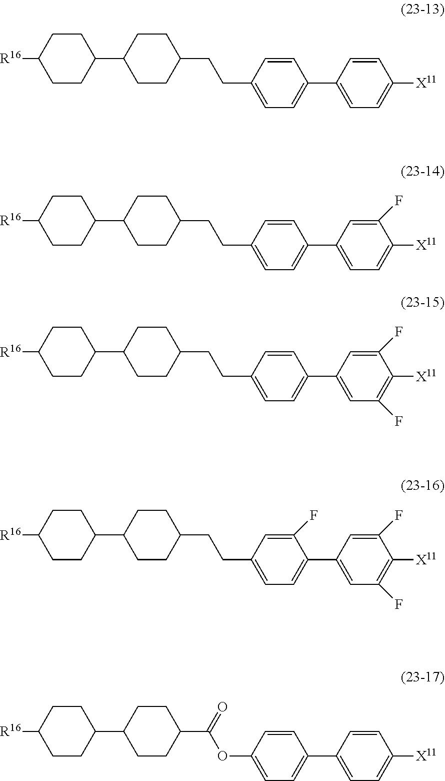

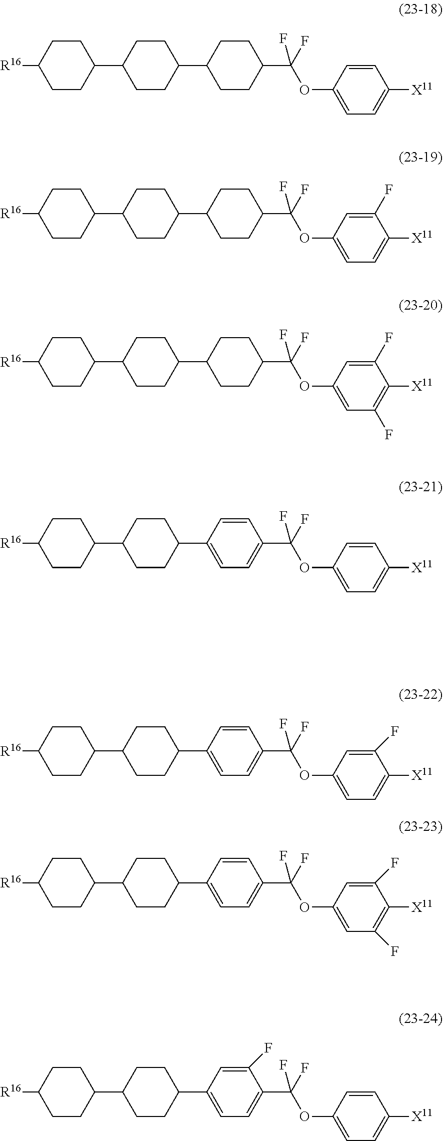

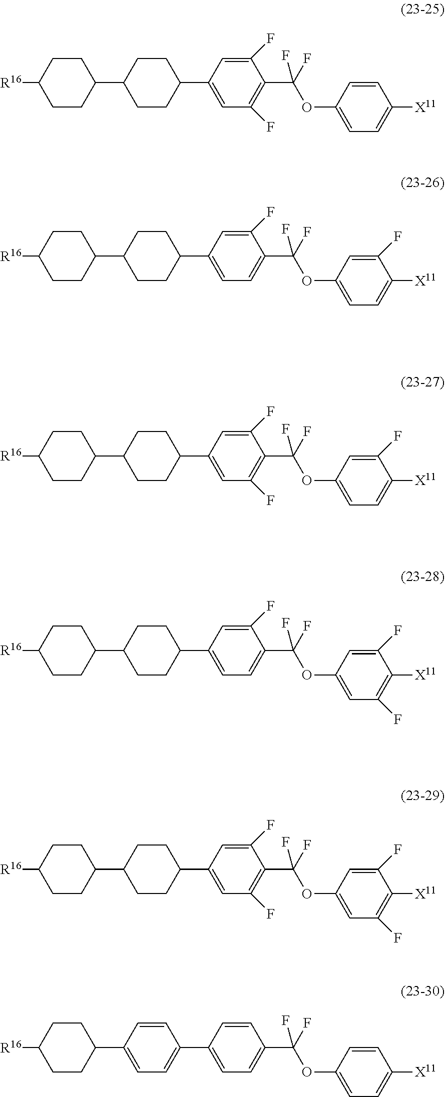

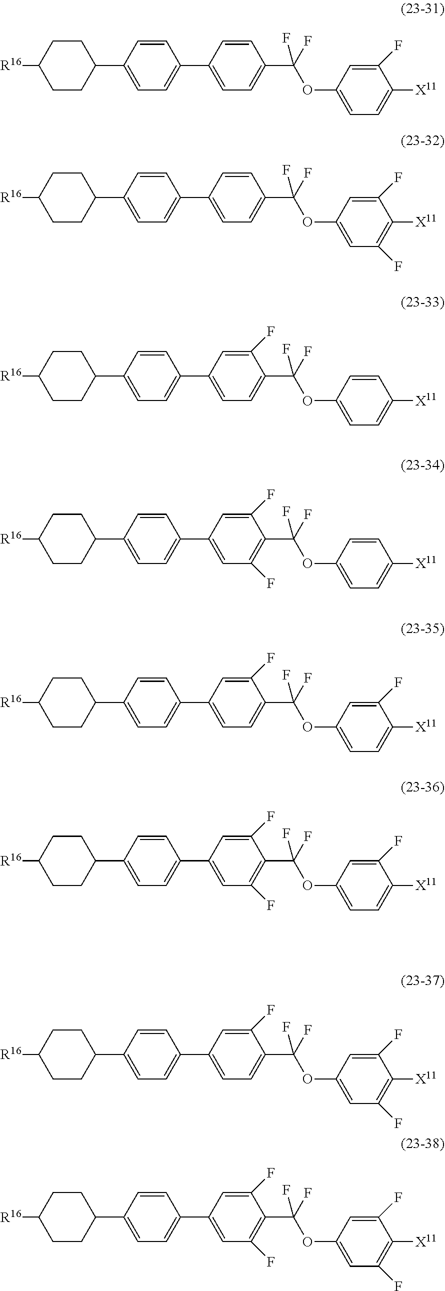

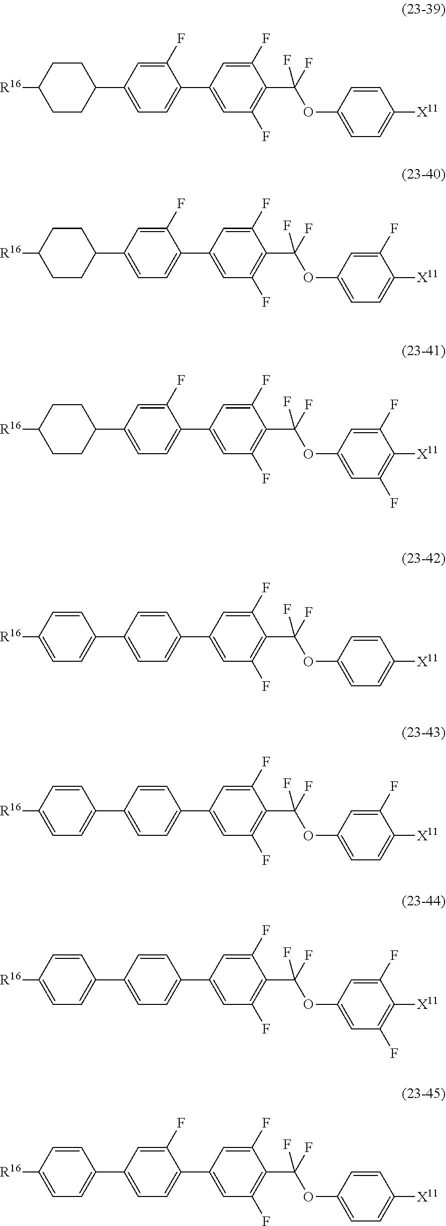

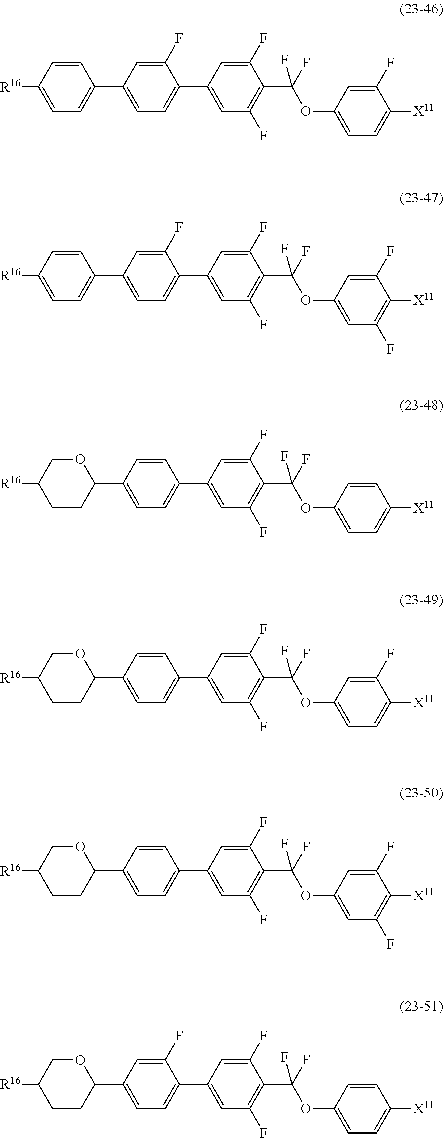

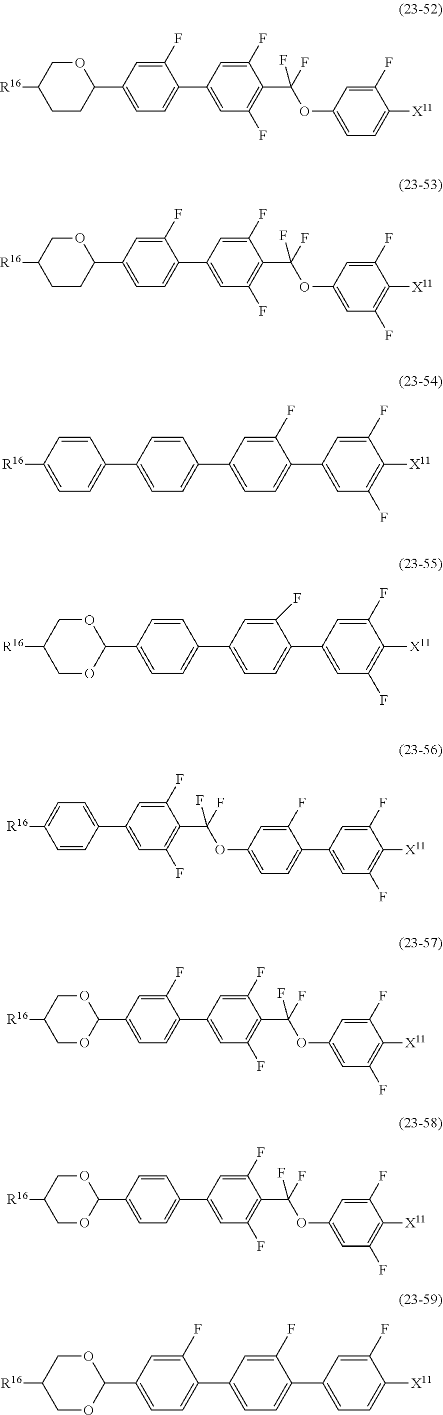

Component (d) has positive dielectric anisotropy, and significantly satisfactory stability to heat or light, and therefore is used when a composition for the IPS mode, the FFS mode, the OCB mode or the like is prepared. A content of component (d) is suitably in the range of about 1% by weight to about 99% by weight, preferably in the range of about 10% by weight to about 97% by weight, and further preferably in the range of about 40% by weight to about 95% by weight, based on the weight of the liquid crystal composition. When component (d) is added to the composition having negative dielectric anisotropy, the content of component (d) is preferably about 30% by weight or less. Addition of component (d) allows adjustment of the elastic constant of the composition and adjustment of the voltage-transmittance curve of the device.

Component (e) is compound (15) in which a right-terminal group is —C≡N or —C≡C—C≡N. Specific examples of preferred component (e) include compounds (24-1) to (24-64). In the compounds, R¹⁷ is alkyl having 1 to 10 carbons or alkenyl having 2 to 10 carbons, and in the alkyl and the alkenyl, at least one —CH₂— may be replaced by —O—, and in the groups, at least one hydrogen may be replaced by fluorine. X¹² is —C≡N or —C≡C—C≡N.

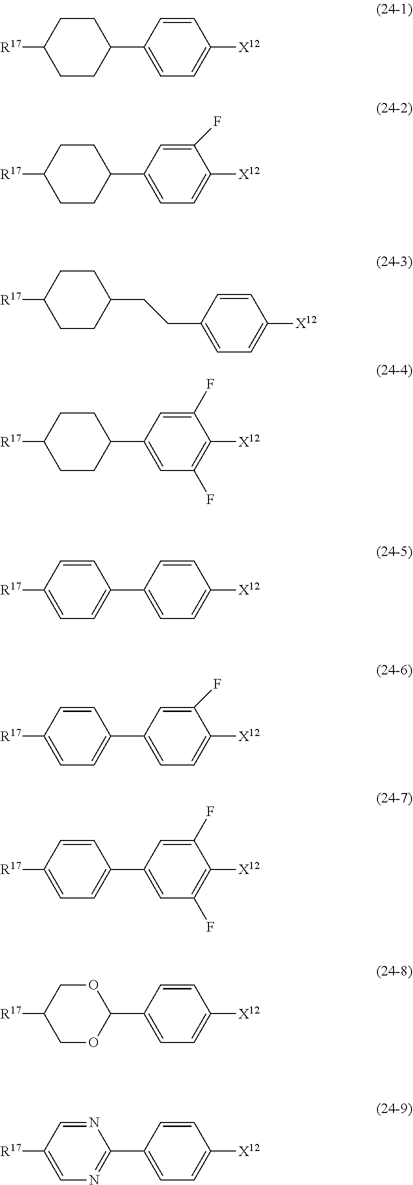

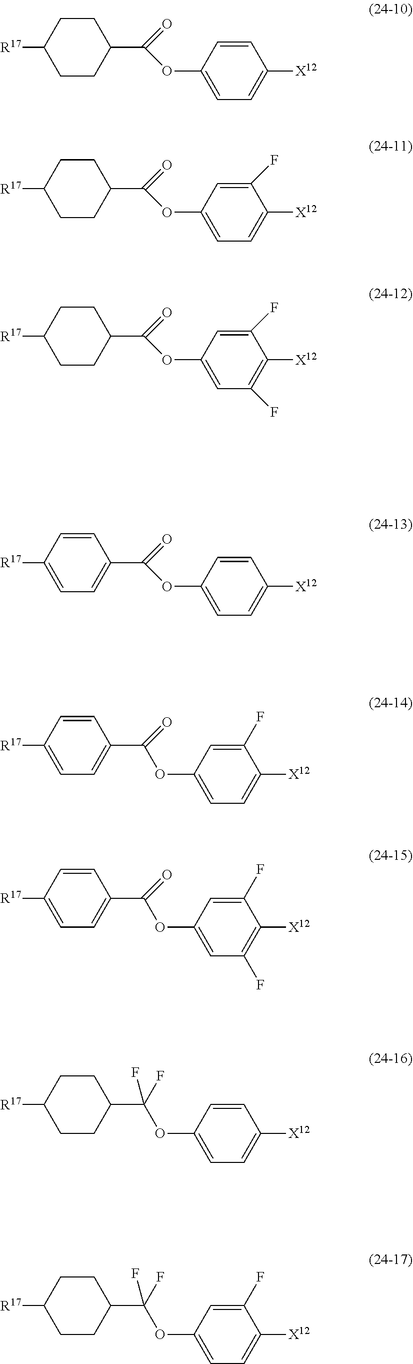

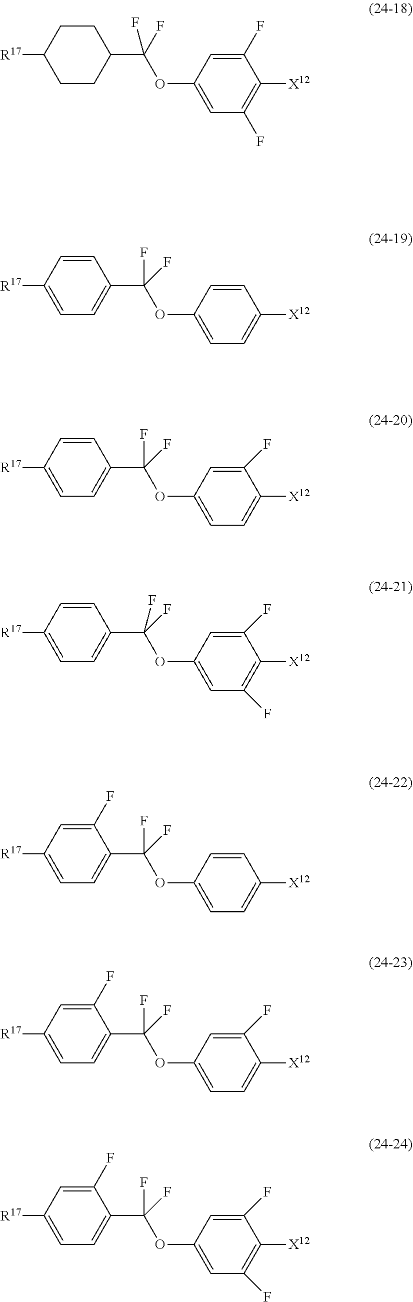

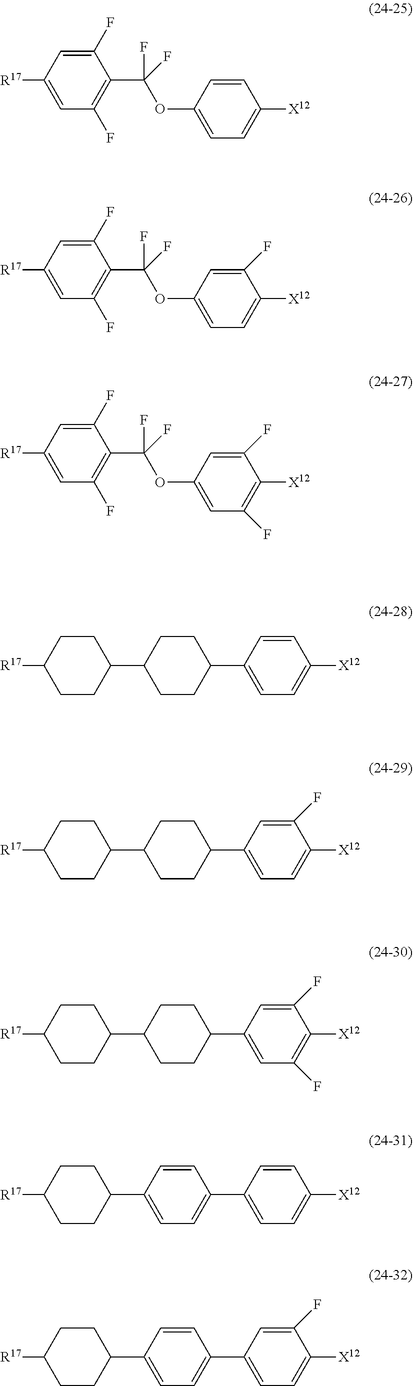

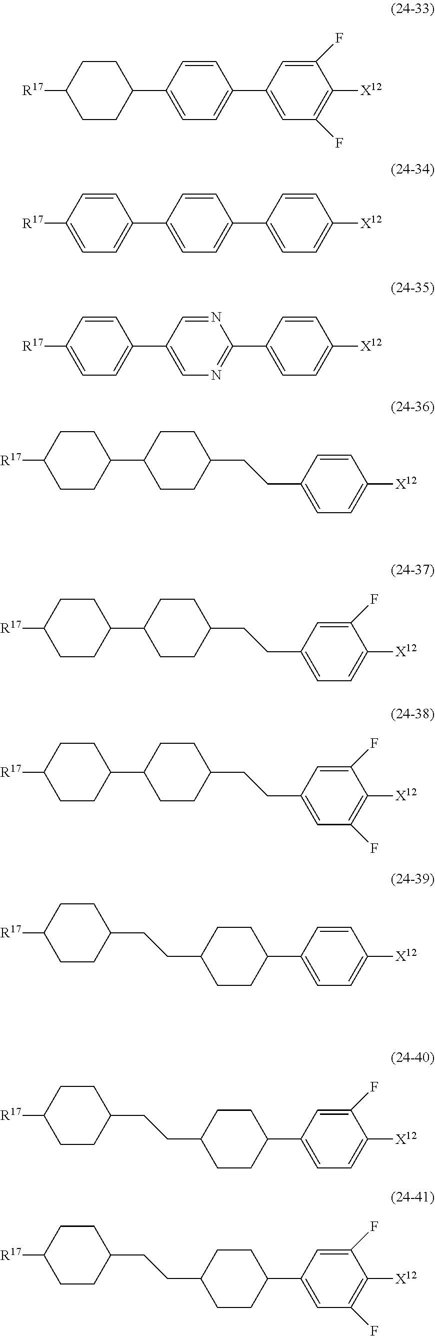

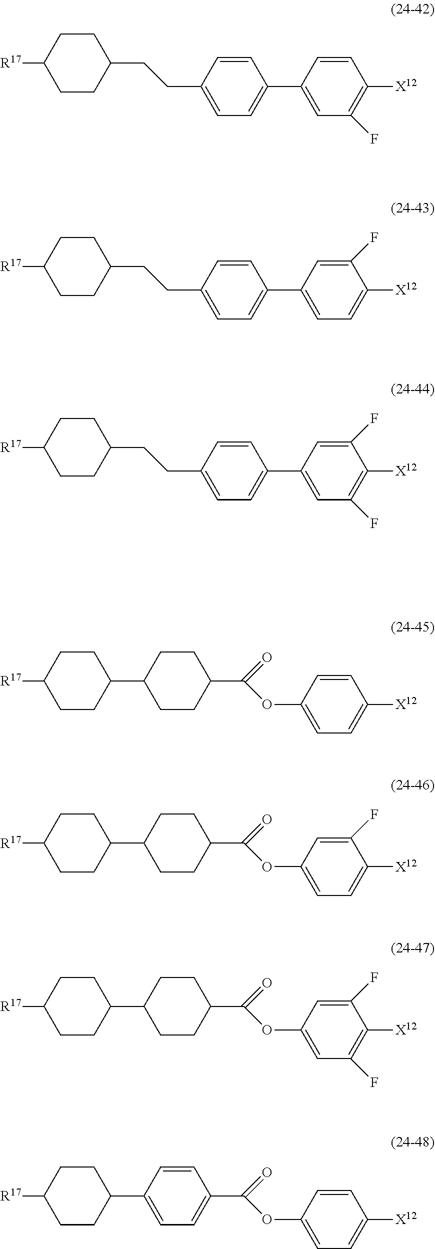

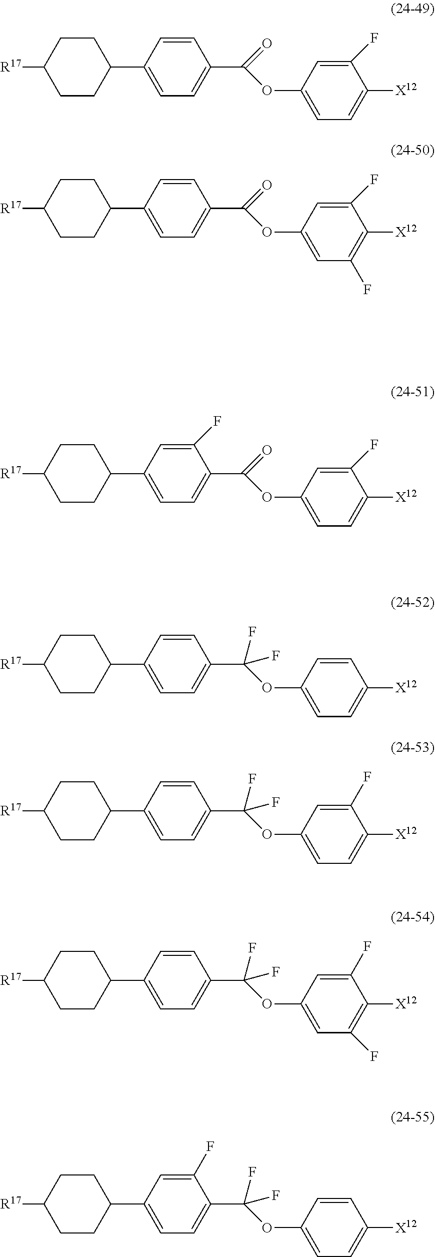

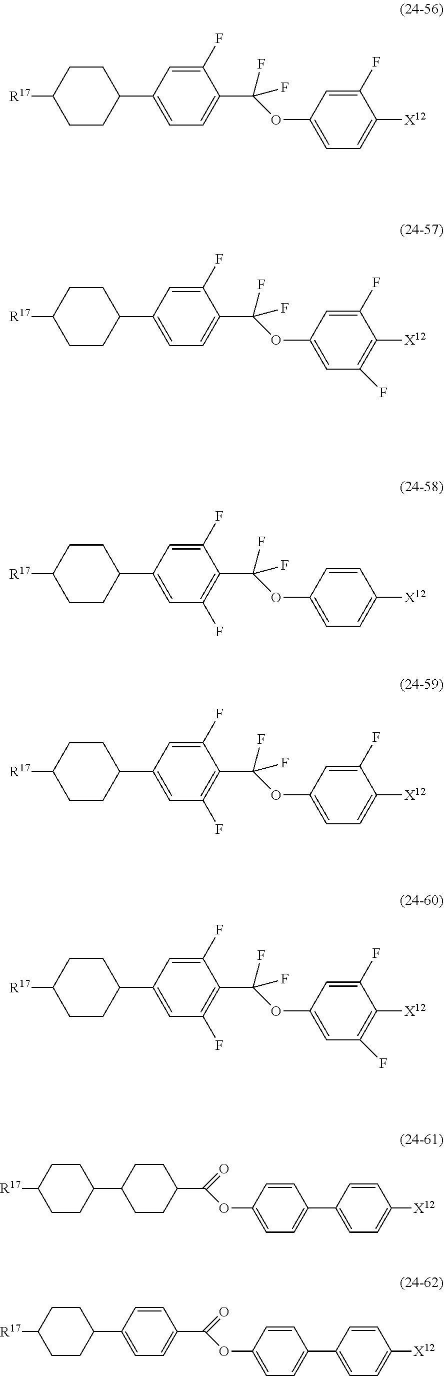

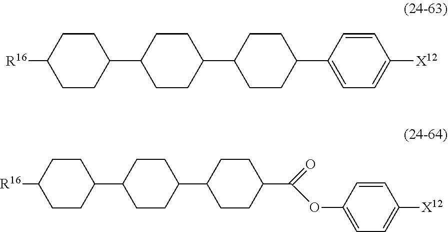

Component (e) has positive dielectric anisotropy and a value thereof is large, and therefore component (e) is used when a composition for the TN mode or the like is prepared. Addition of component (e) can increase the dielectric anisotropy of the composition. Component (e) is effective in extending the temperature range of the liquid crystal phase, adjusting the viscosity or adjusting the optical anisotropy. Component (e) is also useful for adjustment of the voltage-transmittance curve of the device.

When the composition for the TN mode or the like is prepared, a content of component (e) is suitably in the range of about 1% by weight to about 99% by weight, preferably in the range of about 10% by weight to about 97% by weight, and further preferably in the range of about 40% by weight to about 95% by weight, based on the weight of the liquid crystal composition. When component (e) is added to a composition having negative dielectric anisotropy, the content of component (e) is preferably about 30% by weight or less. Addition of component (e) allows adjustment of the elastic constant of the composition and adjustment of the voltage-transmittance curve of the device.

A liquid crystal composition satisfying at least one of physical properties such as high stability to heat or light, high maximum temperature, low minimum temperature, small viscosity, suitable optical anisotropy (more specifically, large optical anisotropy or small optical anisotropy), large positive or negative dielectric anisotropy, large specific resistance and a suitable elastic constant (more specifically, a large elastic constant or a small elastic constant) can be prepared by combining a compound suitably selected from components (b) to (e) described above with compound (1). A device including such a composition has a wide temperature range in which the device can be used, a short response time, a large voltage holding ratio, low threshold voltage, a large contrast ratio, a small flicker rate and a long service life.

### 3-2. Additive

A liquid crystal composition is prepared according to a publicly known method. For example, the component compounds are mixed and dissolved in each other by heating. According to an application, an additive may be added to the composition. Specific examples of the additives include the polymerizable compound, the polymerization initiator, the polymerization inhibitor, the optically active compound, the antioxidant, the ultraviolet light absorber, the light stabilizer, the heat stabilizer, the dye and the antifoaming agent. Such additives are well known to those skilled in the art, and described in literature.

In a liquid crystal display device having the polymer sustained alignment (PSA) mode, the composition contains a polymer. The polymerizable compound is added for the purpose of forming the polymer in the composition. The polymerizable compound is polymerized by irradiation with ultraviolet light while voltage is applied between electrodes, and thus the polymer is formed in the composition. A suitable pretilt is achieved by the method, and therefore the device in which a response time is shortened and the image persistence is improved is prepared.

Preferred examples of the polymerizable compound include acrylate, methacrylate, a vinyl compound, a vinyloxy compound, propenyl ether, an epoxy compound (oxirane, oxetane) and vinyl ketone. Further preferred examples include a compound having at least one acryloyloxy, and a compound having at least one methacryloyloxy. Still further preferred examples also include a compound having both acryloyloxy and methacryloyloxy.

Still further preferred examples include compounds (M-1) to (M-18). In the compounds, R²⁵ to R³¹ are independently hydrogen or methyl; R³², R³³ and R³⁴ are independently hydrogen or alkyl having 1 to 5 carbons, and at least one of R³², R³³ and R³⁴ is alkyl having 1 to 5 carbons; v, w and x are independently 0 or 1; and u and y are independently an integer from 1 to 10. L²¹ to L²⁶ are independently hydrogen or fluorine; and L²⁷ and L²⁸ are independently hydrogen, fluorine or methyl.

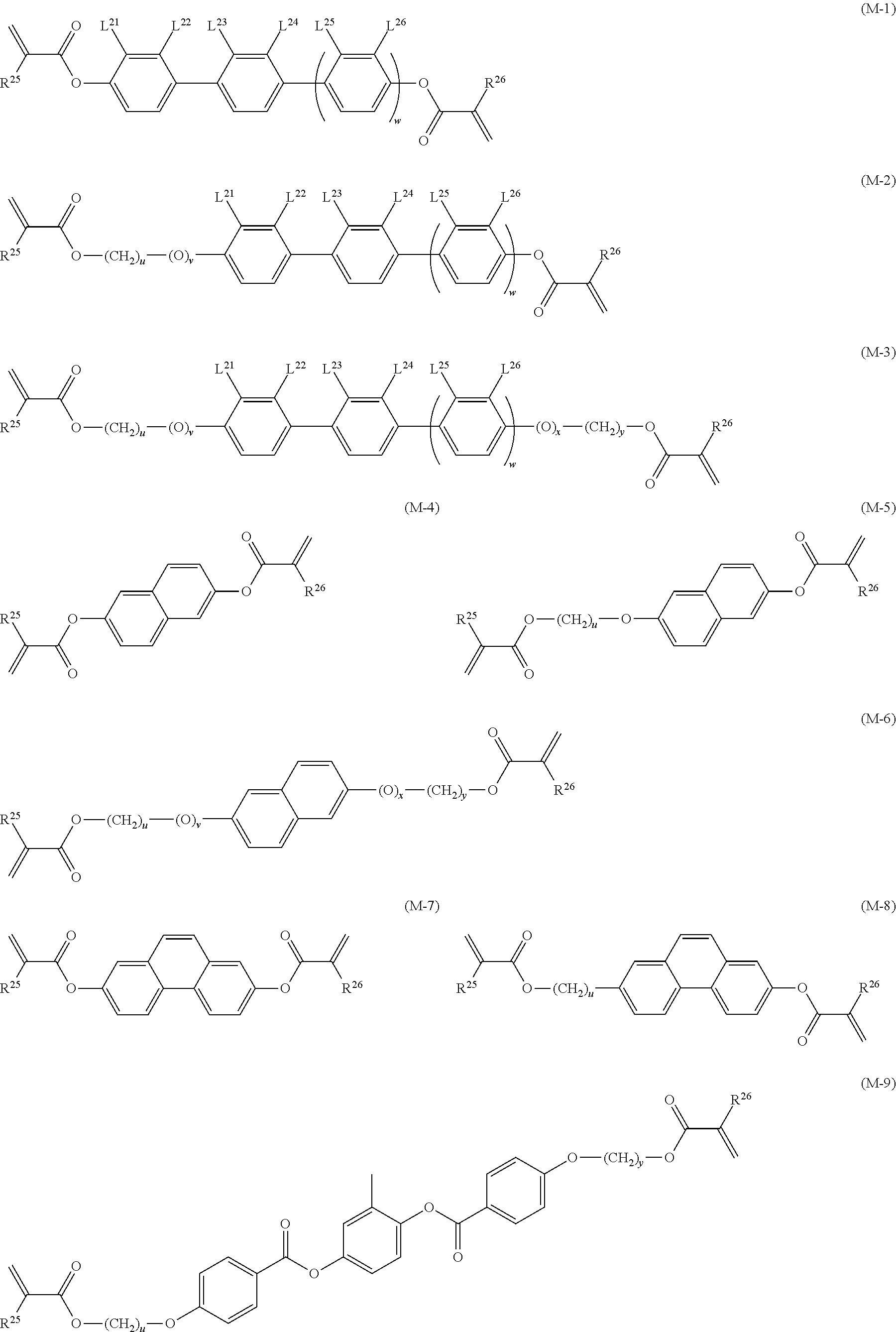

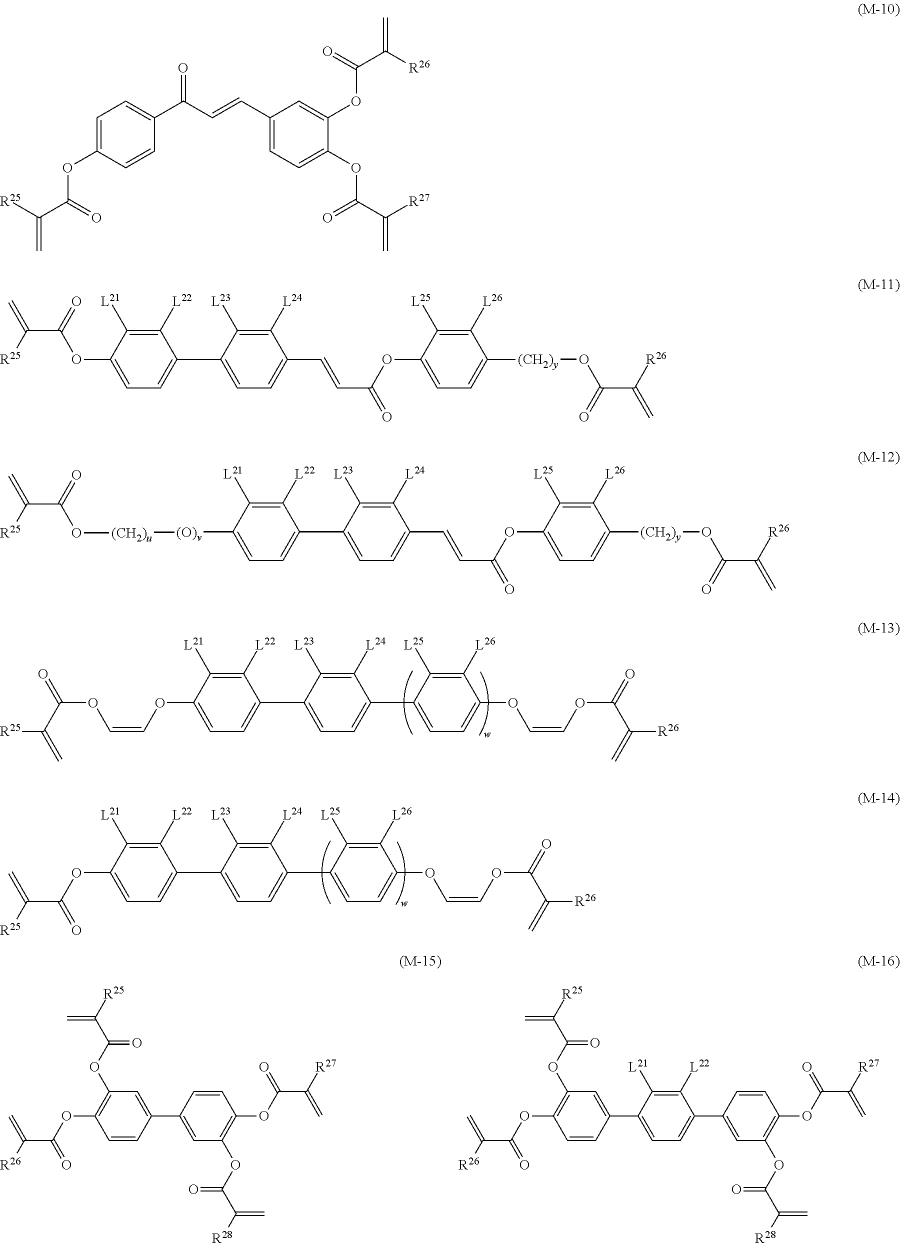

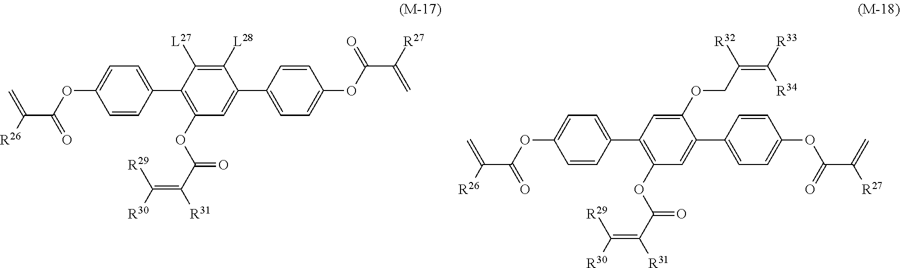

The polymerizable compound can be rapidly polymerized by adding the polymerization initiator. An amount of a remaining polymerizable compound can be reduced by optimizing reaction conditions. Examples of a photoradical polymerization initiator include TPO, 1173 and 4265 from Darocur series of BASF SE, and 184, 369, 500, 651, 784, 819, 907, 1300, 1700, 1800, 1850 and 2959 from Irgacure series thereof.

Additional examples of the photoradical polymerization initiator include 4-methoxyphenyl-2,4-bis(trichloromethyl)triazine, 2-(4-butoxystyryl)-5-trichloromethyl-1,3,4-oxadiazole, 9-phenylacridine, 9,10-benzphenazine, a benzophenone-Michler's ketone mixture, a hexaarylbiimidazole-mercaptobenzimidazole mixture, 1-(4-isopropylphenyl)-2-hydroxy-2-methylpropane-1-one, benzyl dimethyl ketal, 2-methyl-1-[4-(methylthio)phenyl]-2-morpholinopropane-1-one, a mixture of 2,4-diethylxanthone and methyl p-dimethylaminobenzoate, and a mixture of benzophenone and methyltriethanolamine.

After the photoradical polymerization initiator is added to the liquid crystal composition, polymerization can be performed by irradiation with ultraviolet light while an electric field is applied. However, an unreacted polymerization initiator or a decomposition product of the polymerization initiator may cause poor display such as image persistence in the device. In order to prevent such an event, photopolymerization may be performed with no addition of the polymerization initiator. A preferred wavelength of irradiation light is in the range of about 150 nanometers to about 500 nanometers. A further preferred wavelength is in the range of about 250 nanometers to about 450 nanometers, and a most preferred wavelength is in the range of about 300 nanometers to about 400 nanometers.

Upon storing the polymerizable compound, the polymerization inhibitor may be added thereto for preventing polymerization. The polymerizable compound is ordinarily added to the composition without removing the polymerization inhibitor. Examples of the polymerization inhibitor include hydroquinone, a hydroquinone derivative such as methylhydroquinone, 4-t-butylcatechol, 4-methoxyphenol and phenothiazine.

The optically active compound is effective in inducing helical structure in liquid crystal molecules to give a required twist angle, and thereby preventing a reverse twist. A helical pitch can be adjusted by adding the optically active compound thereto. Two or more optically active compounds may be added for the purpose of adjusting temperature dependence of the helical pitch. Specific examples of a preferred optically active compound include compounds (Op-1) to (Op-18) described below. In compound (Op-18), ring J is 1,4-cyclohexylene or 1,4-phenylene, and R²⁸ is alkyl having 1 to 10 carbons. Asterisk mark (*) represents asymmetrical carbon.

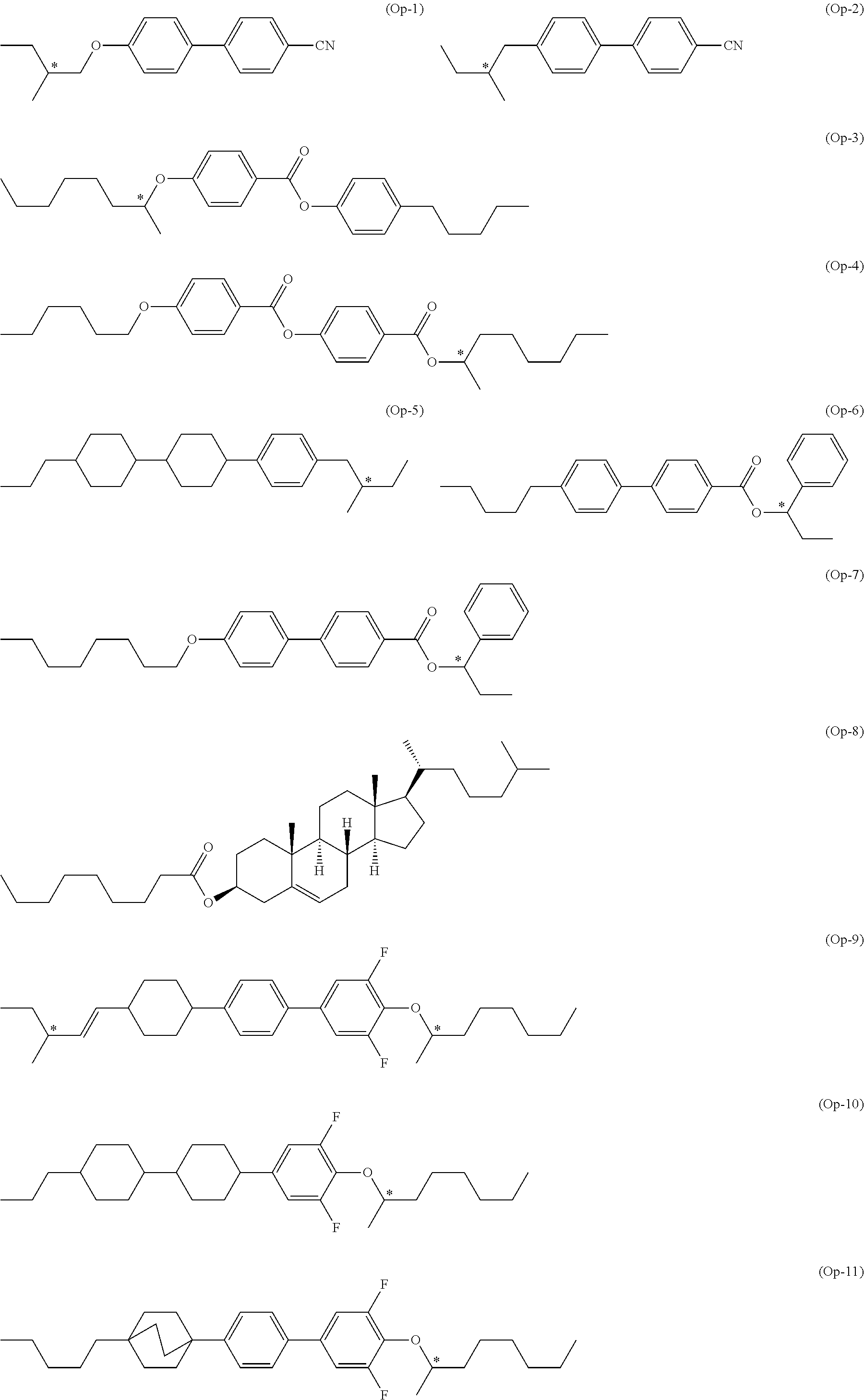

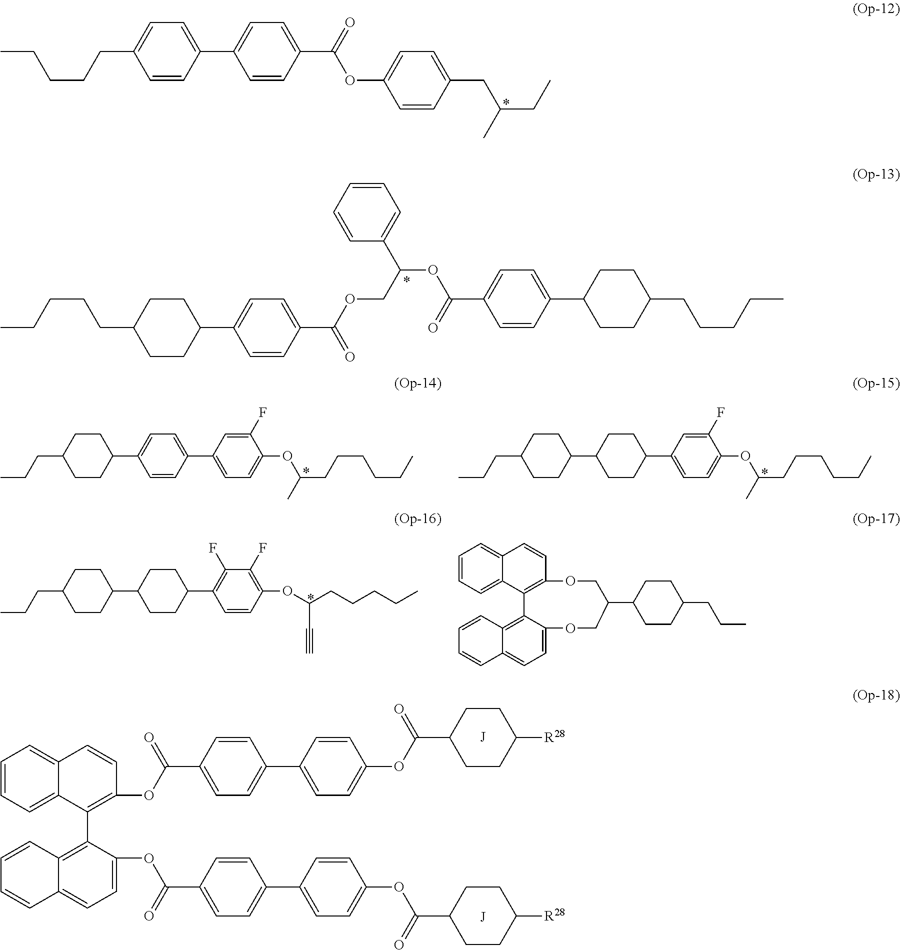

The antioxidant is effective for maintaining the large voltage holding ratio. Specific examples of a preferred antioxidant include compounds (AO-1) and (AO-2) described below; and Irganox 415, Irganox 565, Irganox 1010, Irganox 1035, Irganox 3114 and Irganox 1098 (trade names; BASF SE). The ultraviolet light absorber is effective for preventing a decrease of the maximum temperature. Preferred examples of the ultraviolet light absorber include a benzophenone derivative, a benzoate derivative and a triazole derivative, and specific examples include compounds (AO-3) and (AO-4) described below; Tinuvin 329, Tinuvin P, Tinuvin 326, Tinuvin 234, Tinuvin 213, Tinuvin 400, Tinuvin 328 and Tinuvin 99-2 (trade names; BASF SE); and 1,4-diazabicyclo[2.2.2]octane (DABCO).

The light stabilizer such as an amine having steric hindrance is preferred for maintaining the large voltage holding ratio. Specific examples of the preferred light stabilizer include compound (AO-5), compound (AO-6) and compound (AO-7) described below; Tinuvin 144, Tinuvin 765, Tinuvin 770DF (trade name; BASF A.G.); and LA-77Y and LA-77G (trade name; ADEKA). The heat stabilizer is also effective for maintaining the large voltage holding ratio, and specific preferred examples include Irgafos 168 (trade name; BASF SE). A dichroic dye such as an azo dye or an anthraquinone dye is added to the composition to be adapted for a device having a guest host (GH) mode. The antifoaming agent is effective for preventing foam formation. Preferred examples of the antifoaming agent include dimethyl silicone oil and methylphenyl silicone oil.

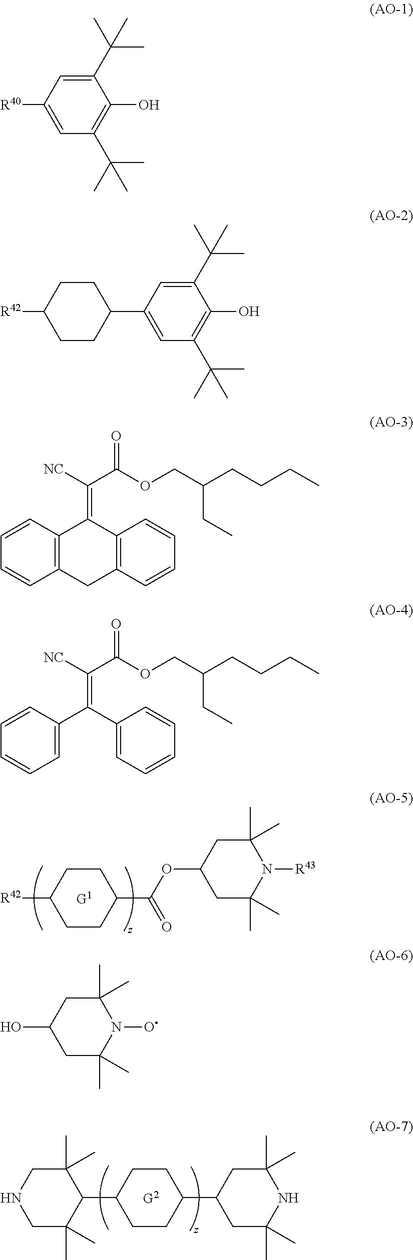

In compound (AO-1), R⁴⁰ is alkyl having 1 to 20 carbons, alkoxy having 1 to 20 carbons, —COOR⁴¹ or —CH₂CH₂COOR⁴¹, in which R⁴¹ is alkyl having 1 to 20 carbons. In compounds (AO-2) and (AO-5), R⁴² is alkyl having 1 to 20 carbons. In compound (AO-5), R⁴³ is hydrogen, methyl or O* (oxygen radical); and ring G¹ is 1,4-cyclohexylene or 1,4-phenylene; in compound (AO-7), ring G² is 1,4-cyclohexylene, 1,4-phenylene, or 1,4-phenylene in which at least one hydrogen is replaced by fluorine; and in compounds (AO-5) and (AO-7), z is 1, 2 or 3.

### 4. Liquid Crystal Display Device

The liquid crystal composition can be used in a liquid crystal display device having an operating mode such as the PC mode, the TN mode, the STN mode, the OCB mode and the PSA mode, and driven by an active matrix mode. The composition can also be used in a liquid crystal display device having the operating mode such as the PC mode, the TN mode, the STN mode, the OCB mode, the VA mode and the IPS mode, and driven by a passive matrix mode. The devices can be applied to any of a reflective type, a transmissive type and a transflective type.

The composition is also suitable for a nematic curvilinear aligned phase (NCAP) device, and the composition is microencapsulated herein. The composition can also be used in a polymer dispersed liquid crystal display device (PDLCD) or a polymer network liquid crystal display device (PNLCD). In the compositions, a large amount of polymerizable compound is added. On the other hand, when a proportion of the polymerizable compound is about 10% by weight or less based on the weight of the liquid crystal composition, the liquid crystal display device having the PSA mode is prepared. A preferred proportion is in the range of about 0.1% by weight to about 2% by weight based thereon. A further preferred proportion is in the range of about 0.2% by weight to about 1.0% by weight based thereon. The device having the PSA mode can be driven by the driving mode such as the active matrix mode and the passive matrix mode. Such devices can be applied to any of the reflective type, the transmissive type and the transflective type.

If the device is used for a long period of time, a flicker may be occasionally generated on a display screen. The flicker rate (%) can be represented by a formula (luminance when applying positive voltage−luminance when applying negative voltage|/average luminance)×100. In a device having the flicker rate in the range of about 0% to about 1%, a flicker is hard to be generated on the display screen even if the device is used for a long period of time. The flicker is associated with image persistence, and is presumed to be generated according to a potential difference between a positive frame and a negative frame in driving at alternating current. The composition containing compound (1) is also useful for reducing generation of the flicker.

### EXAMPLES

### 1. Example of Compound (1)

The invention will be described in greater detail by way of Examples. The Examples include a typical example, and therefore the invention is not limited by the Examples. Compound (1) was prepared according to procedures described below. The thus prepared compound was identified by methods such as an NMR analysis. Characteristics of the compound, the composition and a device were measured by methods described below.

NMR analysis: For measurement, DRX-500 made by Bruker BioSpin Corporation was used. In ¹H-NMR measurement, a sample was dissolved in a deuterated solvent such as CDCl₃, and measurement was carried out under conditions of room temperature, 500 MHz and 16 times of accumulation. Tetramethylsilane was used as an internal standard. In ¹⁹F-NMR measurement, CFCl₃ was used as an internal standard, and measurement was carried out under conditions of 24 times of accumulation. In explaining nuclear magnetic resonance spectra obtained, s, d, t, q, quin, sex and m stand for a singlet, a doublet, a triplet, a quartet, a quintet, a sextet and a multiplet, and br being broad, respectively.

Gas chromatographic analysis: For measurement, GC-2010 Gas Chromatograph made by Shimadzu Corporation was used. As a column, a capillary column DB-1 (length 60 m, bore 0.25 mm, film thickness 0.25 μm) made by Agilent Technologies, Inc. was used. As a carrier gas, helium (1 mL/minute) was used. A temperature of a sample vaporizing chamber and a temperature of a detector (FID) were set to 300° C. and 300° C., respectively. A sample was dissolved in acetone and prepared to be a 1 wt % solution, and then 1 microliter of the solution obtained was injected into the sample vaporizing chamber. As a recorder, GC Solution System made by Shimadzu Corporation or the like was used.

Gas chromatography mass analysis: For measurement, QP-2010 Ultra Gas Chromatograph Mass Spectrometer made by Shimadzu Corporation was used. As a column, a capillary column DB-1 (length 60 m, bore 0.25 mm, film thickness 0.25 μm) made by Agilent Technologies, Inc. was used. As a carrier gas, helium (1 mL/minute) was used. A temperature of a sample vaporizing chamber, a temperature of an ion source, ionizing voltage and emission current were set to 300° C., 200° C., 70 eV and 150 uA, respectively. A sample was dissolved in acetone and prepared to be a 1 wt % solution, and then 1 microliter of the solution obtained was injected into the sample vaporizing chamber. As a recorder, GCMS solution system made by Shimadzu Corporation was used.

HPLC Analysis: For measurement, Prominence (LC-20AD; SPD-20A) made by Shimadzu Corporation was used. As a column, YMC-Pack ODS-A (length 150 mm, bore 4.6 mm, particle diameter 5 μm) made by YMC Co., Ltd. was used. As an eluate, acetonitrile and water were appropriately mixed and used. As a detector, a UV detector, an RI detector, a CORONA detector or the like was appropriately used. When the UV detector was used, a detection wavelength was set to 254 nanometers. A sample was dissolved in acetonitrile and prepared to be a 0.1 wt % solution, and then 1 microliter of the solution was introduced into a sample chamber. As a recorder, C-R7A plus made by Shimadzu Corporation was used.

Ultraviolet-Visible spectrophotometry: For measurement, PharmaSpec UV-1700 made by Shimadzu Corporation was used. A detection wavelength was adjusted in the range of 190 nanometers to 700 nanometers. A sample was dissolved in acetonitrile and prepared to be a 0.01 mmol/L solution, and measurement was carried out by putting the solution in a quartz cell (optical path length: 1 cm).

Sample for measurement: Upon measuring phase structure and a transition temperature (a clearing point, a melting point, a polymerization starting temperature or the like), the compound itself was used as a sample. Upon measuring physical properties such as maximum temperature of a nematic phase, viscosity, optical anisotropy and dielectric anisotropy, a mixture of the compound and a base liquid crystal was used as a sample.

Extrapolation method: When the sample prepared by mixing the compound with the base liquid crystal was used, measurement was carried out as described below. The sample was prepared by mixing 15% by weight of the compound and 85% by weight of the base liquid crystal. From a measured value of the sample, an extrapolated value was calculated according to the following equation, and the calculated value was described: [Extrapolated value]=(100×[measured value of a sample]−[% by weight of a base liquid crystal]×[measured value of the base liquid crystal])/[% by weight of a compound].

When crystals (or a smectic phase) precipitated at 25° C. at the ratio, a ratio of the compound to the base liquid crystal was changed in the order of (10% by weight:90% by weight), (5% by weight:95% by weight), and (1% by weight:99% by weight), and the physical properties of the sample were measured at a ratio at which no crystal (or no smectic phase) precipitated at 25° C. In addition, unless otherwise noted, the ratio of the compound to the base liquid crystal was (15% by weight:85% by weight)

Base liquid crystal (A): When the dielectric anisotropy of the compound was zero or positive, base liquid crystal (A) described below was used. A proportion of each component was expressed in terms of weight percent (% by weight).

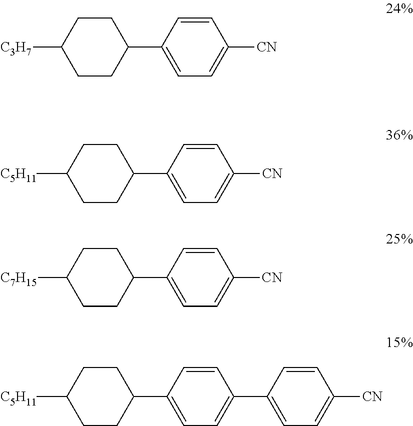

Base liquid crystal (B): When the dielectric anisotropy of the compound was zero or negative, base liquid crystal (B) described below was used. A proportion of each component was expressed in terms of weight percent (% by weight).

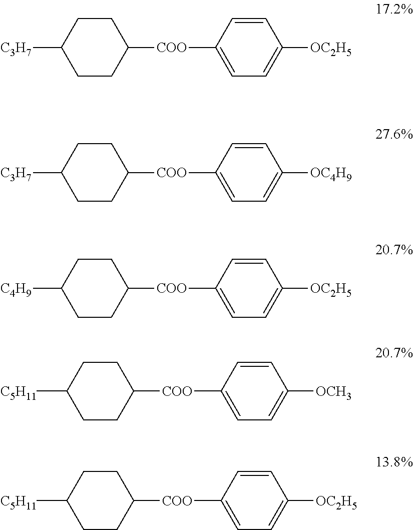

Measuring method: Physical properties were measured according to methods described below. Most of the methods are described in the Standard of Japan Electronics and Information Technology Industries Association (JEITA) discussed and established in JEITA (JEITA ED-2521B). A modification of the methods were also used. No thin film transistor (TFT) was attached to a TN device used for measurement.

(1) Phase structure: A sample was placed on a hot plate in a melting point apparatus (FP-52 Hot Stage made by Mettler-Toledo International Inc.) equipped with a polarizing microscope. A state of phase and a change thereof were observed with the polarizing microscope while the sample was heated at a rate of 3° C. per minute, and a kind of the phase was specified.

(2) Transition temperature (° C.): For measurement, a differential scanning calorimeter, Diamond DSC System, made by PerkinElmer, Inc., or a high sensitivity differential scanning calorimeter, X-DSC7000, made by SII NanoTechnology Inc. was used. A sample was heated, and then cooled at a rate of 3° C. per minute, and a starting point of an endothermic peak or an exothermic peak caused by a phase change of the sample was determined by extrapolation, and thus a transition temperature was determined. A melting point and a polymerization starting temperature of a compound were also measured using the apparatus. Temperature at which a compound undergoes transition from a solid to a liquid crystal phase such as the smectic phase and the nematic phase may be occasionally abbreviated as “minimum temperature of the liquid crystal phase.” Temperature at which the compound undergoes transition from the liquid crystal phase to liquid may be occasionally abbreviated as “clearing point.”

A crystal was expressed as C. When the crystals were distinguishable into two kinds, each of the crystals was expressed as C₁ or C₂. The smectic phase or the nematic phase was expressed as S or N. When a phase was distinguishable such as smectic A phase, smectic B phase, smectic C phase and smectic F, the phase was expressed as SA, SB, SC and SF, respectively. A liquid (isotropic) was expressed as I. A transition temperature was expressed as “C 50.0 N 100.0 I,” for example. The expression indicates that a transition temperature from the crystals to the nematic phase is 50.0° C., and a transition temperature from the nematic phase to the liquid is 100.0° C.

(3) Compatibility of a compound: Samples in which the base liquid crystal and the compound were mixed for proportions of the compounds to be 20% by weight, 15% by weight, 10% by weight, 5% by weight, 3% by weight or 1% by weight were prepared. The samples were put in glass vials, and kept in freezers at −10° C. or −20° C. for a predetermined period of time. Whether a nematic phase of the samples was maintained or crystals (or a smectic phase) precipitated was observed. Conditions on which the nematic phase was maintained were used as a measure of the compatibility. Proportions of the compounds and each temperature in the freezers may be occasionally changed when necessary.

(4) Maximum temperature of a nematic phase (NI; ° C.): A sample was prepared by adding compound (1) to the base liquid crystal having a nematic phase. The sample was placed on a hot plate in a melting point apparatus equipped with a polarizing microscope, and heated at a rate of 1° C. per minute. Temperature when part of the sample began to change from a nematic phase to an isotropic liquid was measured. The measured value was extrapolated based on a content of compound (1), and a maximum temperature of compound (1) was calculated. When the sample was a composition described in Use Examples, the measured value was described as was. A higher limit of the temperature range of the nematic phase may be occasionally abbreviated as “maximum temperature.”

(5) Minimum temperature of a nematic phase (T_{C}; ° C.): Samples each having a nematic phase were put in glass vials and kept in freezers at temperatures of 0° C., −10° C., −20° C., −30° C. and −40° C. for 10 days, and then liquid crystal phases were observed. For example, when the sample was maintained in the nematic phase at −20° C. and changed to crystals or a smectic phase at −30° C., T_{C} was expressed as T_{C}<−20° C. A lower limit of the temperature range of the nematic phase may be occasionally abbreviated as “minimum temperature.”

(6) Viscosity (bulk viscosity; η; measured at 20° C.; mPa·s): For measurement, a cone-plate (E type) rotational viscometer made by Tokyo Keiki Inc. was used.

(7) Optical anisotropy (refractive index anisotropy; measured at 25° C.; Δn): Measurement was carried out by an Abbe refractometer with a polarizing plate mounted on an ocular, using light at a wavelength of 589 nanometers. A surface of a main prism was rubbed in one direction, and then a sample was added dropwise onto the main prism. A refractive index (n∥) was measured when a direction of polarized light was parallel to a direction of rubbing. A refractive index (n⊥) was measured when the direction of polarized light was perpendicular to the direction of rubbing. A value of optical anisotropy (Δn) was calculated from an equation: Δn=n∥−n⊥.

(8) Specific resistance (p; measured at 25° C.; Ωcm): Into a vessel equipped with electrodes, 1.0 milliliter of sample was injected. A direct current voltage (10 V) was applied to the vessel, and a direct current after 10 seconds was measured. Specific resistance was calculated from the following equation: (specific resistance)={(voltage)×(electric capacity of a vessel)}/{(direct current)×(dielectric constant of vacuum)}.

(9) Voltage holding ratio (VHR-1; measured at 25° C.; %): A TN device used for measurement had a polyimide alignment film, and a distance (cell gap) between two glass substrates was 5 micrometers. A sample was put in the device, and then the device was sealed with an ultraviolet-curable adhesive. The device was charged by applying a pulse voltage (60 microseconds at 5 V). A decaying voltage was measured for 16.7 milliseconds with a high-speed voltmeter, and area A between a voltage curve and a horizontal axis in a unit cycle was determined. Area B is an area without decay. A voltage holding ratio is expressed in terms of a percentage of area A to area B.

(10) Voltage holding ratio (VHR-2; measured at 80° C.; %): A voltage holding ratio was measured according to the method described above except that the voltage holding ratio was measured at 80° C. in place of 25° C. The results obtained were expressed in terms of a symbol VHR-2.

(11) Flicker rate (measured at 25° C.; %): For measurement, 3298F Multimedia Display Tester made by Yokogawa Electric Corporation was used. A light source was an LED. A sample was put in a normally black mode FFS device in which a distance (cell gap) between two glass substrates was 3.5 micrometers, and a rubbing direction was anti-parallel. The device was sealed with an ultraviolet-curable adhesive. Voltage was applied to the device, and a voltage having a maximum amount of light transmitted through the device was measured. A sensor part was brought close to the device while the voltage was applied, and a flicker rate displayed thereon was read.

The measuring method of the physical properties may be different between a sample having positive dielectric anisotropy and a sample having negative dielectric anisotropy. When the dielectric anisotropy was positive, the measuring method was described in measurement (12a) to measurement (16a). When the dielectric anisotropy was negative, the measuring method was described in measurement (12b) to measurement (16b).

(12a) Viscosity (rotational viscosity; yl; measured at 25° C.; mPa·s; a sample having positive dielectric anisotropy): Measurement was carried out according to a method described in M. Imai et al., Molecular Crystals and Liquid Crystals, Vol. 259, p. 37 (1995). A sample was put in a TN device in which a twist angle was 0 degrees and a distance (cell gap) between two glass substrates was 5 micrometers. Voltage was applied stepwise to the device from 16 V to 19.5 V at an increment of 0.5 V. After a period of 0.2 second with no voltage application, voltage was repeatedly applied under conditions of only one rectangular wave (rectangular pulse; 0.2 second) and no voltage application (2 seconds). A peak current and a peak time of transient current generated by the applied voltage were measured. A value of rotational viscosity was obtained from the measured values and equation (8) on page 40 of the paper presented by M. Imai et al. A value of dielectric anisotropy required for the calculation was determined using the device by which the rotational viscosity was measured and by a method described below.

(12b) Viscosity (rotational viscosity; yl; measured at 25° C.; mPa·s; a sample having positive dielectric anisotropy): Measurement was carried out according to a method described in M. Imai et al., Molecular Crystals and Liquid Crystals, Vol. 259, p. 37 (1995). A sample was put in a VA device in which a distance (cell gap) between two glass substrates was 20 micrometers. Voltage was applied stepwise to the device from 39 V to 50 V at an increment of 1 V. After a period of 0.2 second with no voltage application, voltage was repeatedly applied under conditions of only one rectangular wave (rectangular pulse; 0.2 second) and no voltage application (2 seconds). A peak current and a peak time of transient current generated by the applied voltage were measured. A value of rotational viscosity was obtained from the measured values and equation (8) on page 40 of the paper presented by M. Imai et al. Dielectric anisotropy required for the calculation was measured in a section of dielectric anisotropy described below.

(13a) Dielectric anisotropy (Δε; measured at 25° C.; a sample having positive dielectric anisotropy): A sample was put in a TN device in which a distance (cell gap) between two glass substrates was 9 micrometers and a twist angle was 80 degrees. Sine waves (10 V, 1 kHz) were applied to the device, and after 2 seconds, a dielectric constant (ε∥) of liquid crystal molecules in a major axis direction was measured. Sine waves (0.5 V, 1 kHz) were applied to the device, and after 2 seconds, a dielectric constant (ε⊥) of liquid crystal molecules in a minor axis direction was measured. A value of dielectric anisotropy was calculated from an equation: Δε=ε∥−ε⊥.

(13b) Dielectric anisotropy (Δε; measured at 25° C.; a sample having negative dielectric anisotropy): A value of dielectric anisotropy was calculated from the equation: Δε=ε∥−ε⊥. A dielectric constant (ε∥ and ε⊥) was measured as described below. (1) Measurement of a dielectric constant (ε∥): An ethanol (20 mL) solution of octadecyltriethoxysilane (0.16 mL) was applied to a well-cleaned glass substrate. After rotating the glass substrate with a spinner, the glass substrate was heated at 150° C. for 1 hour. A sample was put in a VA device in which a distance (cell gap) between two glass substrates was 4 micrometers, and the device was sealed with an ultraviolet-curable adhesive. Sine waves (0.5 V, 1 kHz) were applied to the device, and after 2 seconds, a dielectric constant (ε∥) of liquid crystal molecules in a major axis direction was measured. (2) Measurement of a dielectric constant (ε⊥): A polyimide solution was applied to a well-cleaned glass substrate. After calcining the glass substrate, rubbing treatment was applied to the alignment film obtained. A sample was put in a TN device in which a distance (cell gap) between two glass substrates was 9 micrometers and a twist angle was 80 degrees. Sine waves (0.5 V, 1 kHz) were applied to the device, and after 2 seconds, a dielectric constant (ε⊥) of liquid crystal molecules in a minor axis direction was measured.

(14a) Elastic constant (K; measured at 25° C.; pN; a sample having positive dielectric anisotropy): For measurement, HP4284A LCR Meter made by Yokogawa-Hewlett-Packard Co. was used. A sample was put in a horizontal alignment device in which a distance (cell gap) between two glass substrates was 20 micrometers. An electric charge from 0 V to 20 V was applied to the device, and electrostatic capacity (C) and applied voltage (V) were measured. The measured values were fitted to equation (2.98) and equation (2.101) on page 75 of “Liquid Crystal Device Handbook (Ekisho Debaisu Handobukku in Japanese; Nikkan Kogyo Shimbun, Ltd.),” and values of Ku₁₁ and K₃₃ were obtained from equation (2.99). Next, K₂₂ was calculated using the previously determined values of Ku₁₁ and K₃₃ in equation (3.18) on page 171. Elastic constant K was expressed in terms of a mean value of the thus determined K₁₁, K₂₂ and K₃₃.

(14b) Elastic constant (Ku₁₁ and K₃₃; measured at 25° C.; pN; a sample having negative dielectric anisotropy): For measurement, Elastic Constant Measurement System Model EC-1 made by TOYO Corporation was used. A sample was put in a vertical alignment device in which a distance (cell gap) between two glass substrates was 20 micrometers. An electric charge from 20 V to 0 V was applied to the device, and electrostatic capacity (C) and applied voltage (V) were measured. The measured values were fitted to equation (2.98) and equation (2.101) on page 75 of “Liquid Crystal Device Handbook (Ekisho Debaisu Handobukku in Japanese; Nikkan Kogyo Shimbun, Ltd.),” and values of elastic constants were obtained from equation (2.100).

(15a) Threshold voltage (Vth; measured at 25° C.; V; a sample having positive dielectric anisotropy): For measurement, an LCD-5100 luminance meter made by Otsuka Electronics Co., Ltd. was used. A light source was a halogen lamp. A sample was put in a normally white mode TN device in which a distance (cell gap) between two glass substrates was 0.45/Δn (μm) and a twist angle was 80 degrees. A voltage (32 Hz, rectangular waves) to be applied to the device was stepwise increased from 0 V to 10 V at an increment of 0.02 V. On the occasion, the device was irradiated with light from a direction perpendicular to the device, and an amount of light transmitted through the device was measured. A voltage-transmittance curve was prepared, in which the maximum amount of light corresponds to 100% transmittance and the minimum amount of light corresponds to 0% transmittance. A threshold voltage is expressed in terms of voltage at 90% transmittance.

(15b) Threshold voltage (Vth; measured at 25° C.; V; a sample having negative dielectric anisotropy): For measurement, an LCD-5100 luminance meter made by Otsuka Electronics Co., Ltd. was used. A light source was a halogen lamp. A sample was put in a normally black mode VA device in which a distance (cell gap) between two glass substrates was 4 micrometers and a rubbing direction was anti-parallel, and the device was sealed with an ultraviolet-curable adhesive. A voltage (60 Hz, rectangular waves) to be applied to the device was stepwise increased from 0 V to 20 V at an increment of 0.02 V. On the occasion, the device was irradiated with light from a direction perpendicular to the device, and an amount of light transmitted through the device was measured. A voltage-transmittance curve was prepared, in which the maximum amount of light corresponds to 100% transmittance and the minimum amount of light corresponds to 0% transmittance. A threshold voltage is expressed in terms of voltage at 10% transmittance.

(16a) Response time (T; measured at 25° C.; ms; a sample having positive dielectric anisotropy): For measurement, an LCD-5100 luminance meter made by Otsuka Electronics Co., Ltd. was used. A light source was a halogen lamp. A low-pass filter was set to 5 kHz. A sample was put in a normally white mode TN device in which a distance (cell gap) between two glass substrates was 5.0 micrometers and a twist angle was 80 degrees. A voltage (rectangular waves; 60 Hz, 5 V, 0.5 second) was applied to the device. On the occasion, the device was irradiated with light from a direction perpendicular to the device, and an amount of light transmitted through the device was measured. The maximum amount of light corresponds to 100% transmittance, and the minimum amount of light corresponds to 0% transmittance. A rise time (τr; millisecond) was expressed in terms of time required for a change from 90% transmittance to 10% transmittance. A fall time (τf; millisecond) was expressed in terms of time required for a change from 10% transmittance to 90% transmittance. A response time was expressed by a sum of the rise time and the fall time thus determined.

(16b) Response time (T; measured at 25° C.; ms; a sample having negative dielectric anisotropy): For measurement, an LCD-5100 luminance meter made by Otsuka Electronics Co., Ltd. was used. A light source was a halogen lamp. A low-pass filter was set to 5 kHz. A sample was put in a normally black mode PVA device in which a distance (cell gap) between two glass substrates was 3.2 micrometers, and a rubbing direction was anti-parallel. The device was sealed with an ultraviolet-curable adhesive. The device was applied with a voltage just over a threshold voltage for 1 minute, and then was irradiated with ultraviolet light of 23.5 mW/cm² for 8 minutes, while applying a voltage of 5.6 V. A voltage (rectangular waves; 60 Hz, 10 V, 0.5 second) was applied to the device. On the occasion, the device was irradiated with light from a direction perpendicular to the device, and an amount of light transmitted through the device was measured. The maximum amount of light corresponds to 100% transmittance, and the minimum amount of light corresponds to 0% transmittance. A response time was expressed in terms of time required for a change from 90% transmittance to 10% transmittance (fall time; millisecond).

### Synthesis Example 1

### Synthesis of Compound (No. 139)

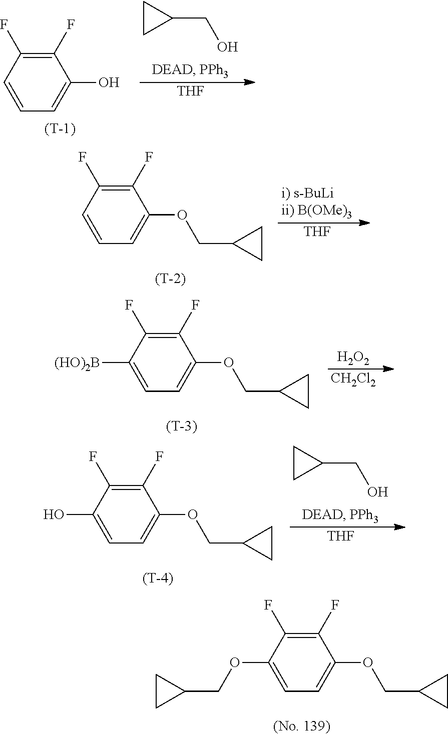

### First Step: Synthesis of Compound (T-2)

Compound (T-1) (36 g, 277 mmol) prepared according to a publicly known method, cyclopropanemethanol (20 g, 277 mmol) and triphenylphosphine (109 g, 416 mmol) were dissolved into tetrahydrofuran (200 mL). While keeping the solution at 0° C. to 15° C., diethyl azodicarboxylate (DEAD, 72 g, 413 mmol) was added thereto, and the resulting solution was stirred at room temperature for 2 hours. The reaction mixture was poured into water, and the resulting mixture was subjected to extraction with methyl t-butyl ether. The extract was washed with a 10% sodium hydroxide aqueous solution and water, then dried over anhydrous magnesium sulfate, and concentrated under reduced pressure. The residue was purified by silica gel chromatography (hexane) to obtain compound (T-2) (36 g, 195 mmol; 70%) as a colorless liquid.

### Second Step: Synthesis of Compound (T-3)

Compound (T-2) (36 g, 195 mmol) was dissolved into tetrahydrofuran (200 mL). The resulting mixture was cooled to 70° C., and s-BuLi (1.05 M; n-hexane solution, 188 mL, 197 mmol) was added dropwise thereto, and then the resulting mixture was stirred at −70° C. for 2 hours. Trimethyl borate (33 g, 318 mmol) was added dropwise thereto at −70° C., and then the resulting mixture was stirred at −70° C. for 1 hour. The reaction mixture was poured into 10% hydrochloric acid, and the resulting mixture was subjected to extraction with ethyl acetate. The extract was washed with water, then dried over anhydrous magnesium sulfate, and concentrated under reduced pressure. The residue was washed with hexane twice to obtain compound (T-3) (27 g, 118 mmol; 61%) as a colorless solid.

### Third Step: Synthesis of Compound (T-4)

Compound (T-3) (27 g, 118 mmol) was dissolved into dichloromethane (100 mL), and a 27% hydrogen peroxide aqueous solution (45 g, 357 mmol) was added thereto at 30° C. The resulting mixture was stirred at 35° C. for 3 hours. The reaction solution was poured into water, and the resulting mixture was subjected to extraction with ethyl acetate. The extract was washed with a sodium sulfite aqueous solution and water, then dried over anhydrous magnesium sulfate, and concentrated under reduced pressure. Compound (T-4) (19 g, 94.9 mmol; 80%) was thus obtained as a colorless solid.

### Fourth Step: Synthesis of Compound (No. 139)

Compound (T-4) (14 g, 69.9 mmol), cyclopropanemethanol (6 g, 83.2 mmol) and triphenylphosphine (28 g, 107 mmol) were dissolved into tetrahydrofuran (150 mL). While keeping the solution at 0° C. to 15° C., diethyl azodicarboxylate (DEAD, 18 g, 103 mmol) was added thereto, and the resulting mixture was stirred at room temperature for 2 hours. The reaction mixture was poured into water, and the resulting mixture was subjected to extraction with methyl t-butyl ether. The extract was washed with a sodium hydroxide aqueous solution and water, then dried over anhydrous magnesium sulfate, and concentrated under reduced pressure. The residue was purified by silica gel chromatography (hexane) and recrystallization (ethanol) to obtain compound (No. 139) (9 g, 35.4 mmol; 51%) as a colorless liquid.

¹H-NMR (CDCl₃; δ ppm): 6.64-6.59 (m, 2H), 3.82 (d, J=7.1 Hz, 1H), 1.31-1.23 (m, 2H), 0.68-0.59 (m, 4H), 0.38-0.29 (m, 4H).

Phase transition temperature: C 36.3 I. Maximum temperature (NI)=−187° C.; dielectric anisotropy (Δε)=−2.3; optical anisotropy (Δn)=−0.073; viscosity (η)=53.0 mPa·s.

### Synthesis Example 2

### Synthesis of Compound (No. 224)

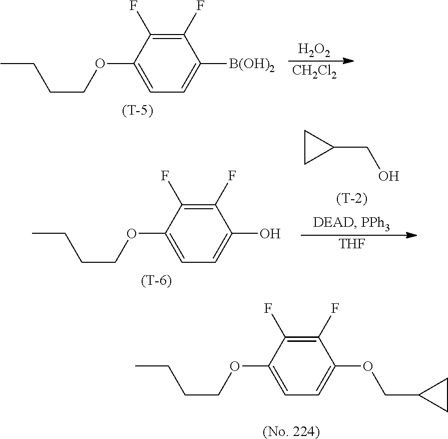

### First Step: Synthesis of Compound (T-6)

Compound (T-5) (50 g, 217 mmol) was dissolved into dichloromethane (200 mL), and a 27% hydrogen peroxide aqueous solution (55 g, 437 mmol) was added thereto at 30° C. The resulting mixture was stirred at 35° C. for 3 hours. The reaction mixture was poured into water, and the resulting mixture was subjected to extraction with ethyl acetate. The extract was washed with a sodium sulfite aqueous solution and water, then dried over anhydrous magnesium sulfate, and concentrated under reduced pressure. Compound (T-6) (34 g, 168 mmol; 77%) was thus obtained as a colorless solid.

### Second Step: Synthesis of Compound (No. 224)

Compound (T-6) (20 g, 98.9 mmol), cyclopropanemethanol (7 g, 97.1 mmol) and triphenylphosphine (35 g, 133 mmol) were dissolved into tetrahydrofuran (100 mL). While keeping the solution at 0° C. to 15° C., diethyl azodicarboxylate (DEAD, 24 g, 138 mmol) was added thereto, and the resulting mixture was stirred at room temperature for 2 hours. The reaction mixture was poured into water, and the resulting mixture was subjected to extraction with methyl t-butyl ether. The extract was washed with a 10% sodium hydroxide aqueous solution and water, then dried over anhydrous magnesium sulfate, and concentrated under reduced pressure. The residue was purified by silica gel chromatography (hexane) and recrystallization (ethanol) to obtain compound (No. 224) (6 g, 23.4 mmol; 24%) as a colorless liquid.

¹H-NMR (CDCl₃; δ ppm): 6.65-6.59 (m, 2H), 3.98 (t, J=6.6 Hz, 2H), 3.82 (d, J=7.0 Hz, 2H), 1.77 (quin, J=6.6 Hz, 2H), 1.49 (sext, J=7.5 Hz, 2H), 1.31-1.23 (m, 1H), 0.97 (t, J=7.5 Hz, 3H), 0.68-0.58 (m, 2H), 0.38-0.29 (m, 2H).

Phase transition temperature: C 6.1 I. Maximum temperature (NI)=−155.7° C.; dielectric anisotropy (Δε)=−4.1; optical anisotropy (Δn)=−0.053; viscosity (η)=30.3 mPa·s.

### Synthesis Example 3

### Synthesis of Compound (No. 994)

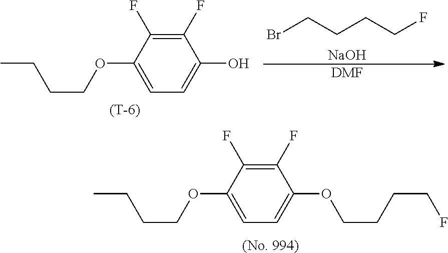

### First Step: Synthesis of Compound (No. 994)

Compound (T-6) (35 g, 173 mmol) prepared according to a publicly known method and 1-bromo-4-fluorobutane (30 g, 194 mmol) were dissolved into N,N-dimethylformamide (100 mL), and the resulting mixture was stirred at 138° C. for 5 hours. The reaction mixture was poured into water, and the resulting mixture was subjected to extraction with ethyl acetate. The extract was washed with a 10% sodium hydroxide aqueous solution and water, then dried over anhydrous magnesium sulfate, and concentrated under reduced pressure. The residue was purified by silica gel chromatography (hexane) and distillation to obtain compound (No. 994) (13 g, 47.1 mmol; 27%) as a colorless liquid.

¹H-NMR (CDCl₃; δ ppm): 6.65-6.60 (m, 2H), 4.59-4.57 (m, 1H), 4.48 (t, J=5.7 Hz, 1H), 4.03 (t, J=5.7 Hz, 2H), 3.98 (t, J=6.6 Hz, 2H), 1.95-1.84 (m, 4H), 1.77 (quin, J=6.6 Hz, 2H), 1.49 (sext, J=7.5 Hz, 2H), 0.97 (t, J=7.5 Hz, 3H).

Phase transition temperature: C₁ −18.8 C₂ −11.5 I. Maximum temperature (NI)=−121.7° C.; dielectric anisotropy (Δε)=−5.6; optical anisotropy (Δn)=0.0003; viscosity (η)=29.9 mPa·s.

### Synthesis Example 4

### Synthesis of Compound (No. 993)

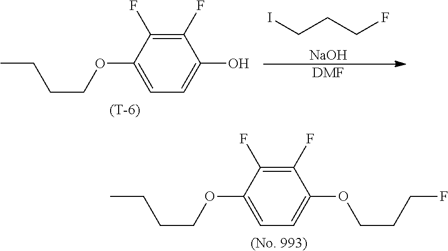

### First Step: Synthesis of Compound (No. 993)

Compound (T-6) (30 g, 148 mmol) prepared according to a publicly known method and 1-fluoro-3-iodopropane (29 g, 154 mmol) were dissolved into N,N-dimethylformamide (100 mL), and the resulting mixture was stirred at 138° C. for 5 hours. Then, the resulting mixture was cooled to room temperature, and subjected to extraction with ethyl acetate. The extract was washed with a 10% sodium hydroxide aqueous solution and water, then dried over anhydrous magnesium sulfate, and concentrated under reduced pressure. The residue was purified by silica gel chromatography (hexane) and distillation to obtain compound (No. 993) (15 g, 57.2 mmol; 39%) as a colorless liquid.

¹H-NMR (CDCl₃; δ ppm): 6.67-6.61 (m, 2H), 4.71 (t, J=5.7 Hz, 1H), 4.62 (t, J=5.7 Hz, 1H), 4.12 (t, J=6.1 Hz, 2H), 3.98 (t, J=6.6 Hz, 2H), 2.20 (quin, J=5.9 Hz, 1H), 2.15 (quin, J=5.9 Hz, 1H), 1.77 (quin, J=6.6 Hz, 2H), 1.49 (sext, J=7.5 Hz, 2H), 0.97 (t, J=7.5 Hz, 3H).

Phase transition temperature: C −1.3 I. Maximum temperature (NI)=−141.0° C.; dielectric anisotropy (Δε)=−3.5; optical anisotropy (Δn)=−0.020; viscosity (η)=30.6 mPa·s.

### Synthesis Example 5

### Synthesis of Compound (No. 1114)

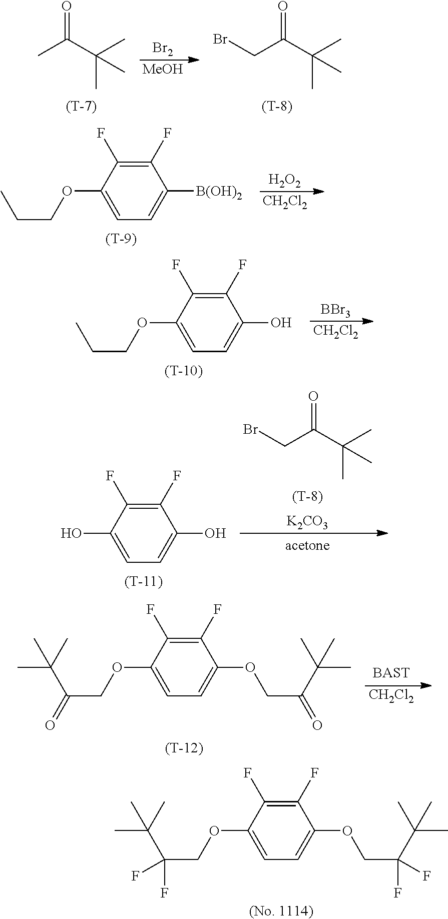

### First Step: Synthesis of Compound (T-8)

Compound (T-7) (30 g, 300 mmol) was dissolved into methanol (90 mL), and the resulting mixture was cooled to 0° C. Bromine (49 g, 307 mmol) was added thereto at 0 to 10° C. The resulting mixture was stirred at room temperature for 1 hour. The reaction mixture was poured into a sodium sulfite aqueous solution, and the resulting mixture was subjected to extraction with dichloromethane. The extract was washed with water, then dried over anhydrous magnesium sulfate, and concentrated under reduced pressure. The residue was purified by distillation to obtain compound (T-8) (52 g, 290 mmol; 97%) as a colorless liquid.

### Second Step: Synthesis of Compound (T-10)

Compound (T-9) (100 g, 463 mmol) prepared according to a publicly known method was dissolved into dichloromethane (500 mL) and a 27% hydrogen peroxide aqueous solution (126 g, 1.00 mol) was added thereto at 30° C. The resulting mixture was stirred at 35° C. for 3 hours. The reaction mixture was poured into water, and the resulting mixture was subjected to extraction with ethyl acetate. The extract was washed with a sodium sulfite aqueous solution and water, then dried over anhydrous magnesium sulfate, and concentrated under reduced pressure. Compound (T-10) (80 g, 425 mmol; 92%) was thus obtained as a colorless solid.

### Third Step: Synthesis of Compound (T-11)

Compound (T-10) (80 g, 425 mmol) was dissolved into dichloromethane (300 mL). Boron tribromide (128 g, 511 mmol) was added thereto at room temperature, and the resulting mixture was stirred at 60° C. for 2 hours. Then, the resulting mixture was cooled to room temperature, and the reaction mixture was poured into water, and the resulting mixture was subjected to extraction with ethyl acetate. The extract was washed with water, then dried over anhydrous magnesium sulfate, and concentrated under reduced pressure to obtain compound (T-11) (59 g, 404 mmol; 95%) as a colorless liquid.

### Fourth Step: Synthesis of Compound (T-12)

Compound (T-11) (23 g, 157 mmol) and potassium carbonate (38 g, 275 mmol) were dissolved into acetone (150 mL). Compound (T-8) (45 g, 251 mmol) prepared in the first step was added thereto, and the resulting mixture was refluxed for 4 hours. The resulting mixture was cooled to room temperature, and potassium carbonate was removed by filtration, and the filtrate was concentrated under reduced pressure. The residue was purified by silica gel chromatography (hexane/ethyl acetate) and recrystallization (ethanol/hexane) to obtain compound (T-12) (22 g, 64.3 mmol; 41%) as a colorless solid.

### Fifth Step: Synthesis of Compound (No. 1114)

Compound (T-12) (20 g, 58.4 mmol) was dissolved into dichloromethane (100 mL), and bis(2-methoxyethyl)amino sulfur trifluoride (BAST, 54 g, 244 mmol) was added thereto at room temperature, and the resulting mixture was stirred at room temperature for 50 hours. The reaction mixture was poured into a 15% sodium hydroxide aqueous solution, and the resulting mixture was subjected to extraction with dichloromethane. The extract was washed with water, then dried over anhydrous magnesium sulfate, and concentrated under reduced pressure. The residue was purified by silica gel chromatography (hexane) and recrystallization (ethanol/hexane) to obtain compound (No. 1114) (3 g, 7.76 mmol; 13%) as a colorless solid.

¹H-NMR (CDCl₃; δ ppm): 6.75-6.70 (m, 2H), 4.28 (t, J=13.3 Hz, 4H), 1.14 (s, 18H)

Phase transition temperature: C 50.8 I. Maximum temperature (NI)=180.4° C.; dielectric anisotropy (Δε)=−2.9; optical anisotropy (Δn)=−0.053; viscosity (η)=104 mPa·s.

### Synthesis Example 6

### Synthesis of Compound (No. 1104)

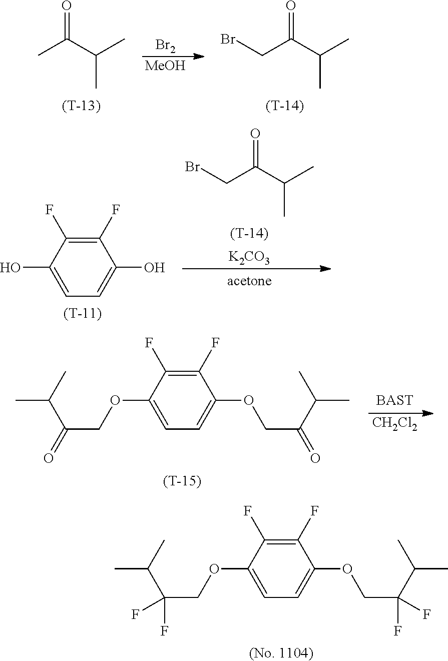

### First Step: Synthesis of Compound (T-14)

Compound (T-13) (43 g, 499 mmol) was dissolved into methanol (90 mL), and the resulting mixture was cooled to 0° C. Bromine (80 g, 501 mmol) was added thereto at 0 to 10° C. The resulting mixture was stirred at 10° C. for 1 hour. The reaction mixture was poured into a sodium sulfite aqueous solution, and the resulting mixture was subjected to extraction with dichloromethane. The extract was washed with water, then dried over anhydrous magnesium sulfate, and concentrated under reduced pressure. The residue was purified by distillation to obtain compound (T-14) (50 g, 303 mmol; 61%) as a colorless liquid.

### Second Step: Synthesis of Compound (T-15)

Compound (T-11) (25 g, 171 mmol) and potassium carbonate (52 g, 376 mmol) were dissolved into acetone (150 mL). Compound (T-14) (50 g, 303 mmol) was added thereto at room temperature, and the resulting mixture was refluxed for 4 hours. The resulting mixture was cooled to room temperature, and potassium carbonate was removed by filtration, and the filtrate was concentrated under reduced pressure. The residue was purified by silica gel chromatography (hexane/ethyl acetate) and recrystallization (ethanol/hexane) to obtain compound (T-15) (15 g, 47.7 mmol; 28%) as a colorless solid.

### Third Step: Synthesis of Compound (No. 1104)

Compound (T-15) (15 g, 47.7 mmol) prepared according to a publicly known method was dissolved into dichloromethane (90 mL), and bis(2-methoxyethyl)amino sulfur trifluoride (BAST, 43 g, 194 mmol) was added thereto at room temperature, and the resulting mixture was stirred at room temperature for 50 hours. The reaction mixture was poured into a 15% sodium hydroxide aqueous solution, and the resulting mixture was subjected to extraction with dichloromethane, and the organic layer was washed with water, then dried over anhydrous magnesium sulfate, and concentrated under reduced pressure. The residue was purified by silica gel chromatography (hexane) and recrystallization (ethanol/hexane) to obtain compound (No. 1104) (5 g, 14.0 mmol; 29%) as a colorless solid.

¹H-NMR (CDCl₃; δ ppm): 6.73-6.68 (m, 2H), 4.19 (t, J=12.0 Hz, 4H), 2.50-2.36 (m, 2H), 1.10 (d, J=7.0 Hz, 12H).

Phase transition temperature: C 42.9 I. Maximum temperature (NI)=−174.1° C.; dielectric anisotropy (Δε)=−1.7; optical anisotropy (Δn)=−0.073; viscosity (η)=84.3 mPa·s.

### Synthesis Example 7

### Synthesis of Compound (No. 1105)

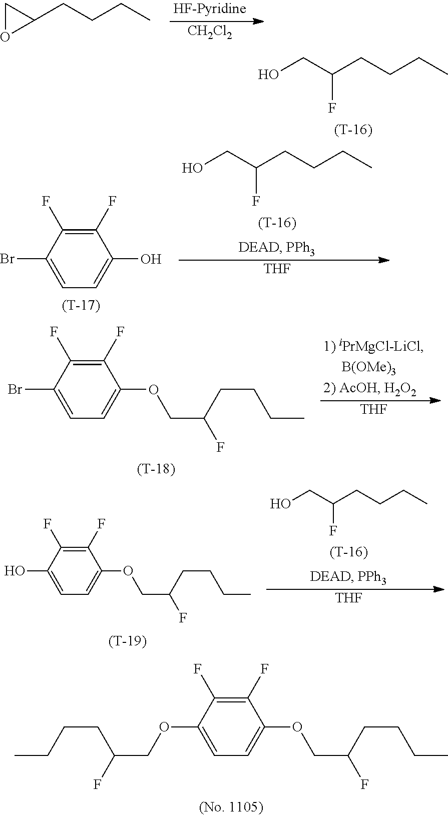

### First Step: Synthesis of Compound (T-16)

Under a nitrogen atmosphere, hydrogen fluoride pyridine (hydrogen fluoride content 70%, 41.5 g) and dichloromethane (200 mL) were put into a reaction vessel, and cooled to 0° C. Thereto, 1,2-epoxy hexane (20.8 g, 207 mmol) was added dropwise, and the resulting mixture was stirred for 12 hours. The reaction mixture was poured into water, and the resulting mixture was neutralized with sodium hydrogencarbonate, and the resulting solution was subjected to extraction with dichloromethane. The extract was washed with brine, then dried over anhydrous magnesium sulfate, and concentrated under reduced pressure. The residue was purified by silica gel chromatography (ethyl acetate:hexane=1:4 in a volume ratio), and further purified by vacuum distillation (5.3 kPa, 115° C.) to obtain compound (T-16) (9.80 g, 81.6 mmol; 39%).

### Second Step: Synthesis of Compound (T-18)

Under a nitrogen atmosphere, compound (T-17) (7.65 g, 36.6 mmol), compound (T-16) (4.00 g, 33.3 mmol), triphenylphosphine (9.60 g, 36.6 mmol) and tetrahydrofuran (70 mL) were put into a reaction vessel, and cooled on an ice bath. Diethyl azodicarboxylate (DEAD, 2.2 M; toluene solution; 16.6 mL, 36.5 mmol) was added thereto, and the resulting mixture was stirred at room temperature for 8 hours. After completion of the reaction, the reaction mixture was poured into water, and the aqueous layer was subjected to extraction with diethyl ether. The extract was washed with brine, then dried over anhydrous magnesium sulfate, and concentrated under reduced pressure. The residue was purified by silica gel chromatography (ethyl acetate:hexane=1:9 in a volume ratio) to obtain compound (T-18) (6.28 g, 20.2 mmol; 57%).

### Third Step: Synthesis of Compound (T-19)

Under a nitrogen atmosphere, an isopropyl chloride magnesium-lithium chloride complex (1.3 M, THF solution, 18.6 mL, 24.2 mmol) was put into a reaction vessel, and cooled to 0° C. Thereto, a THF (60 mL) solution of compound (T-18) (6.28 g, 20.2 mmol) was slowly added dropwise, and the resulting mixture was stirred until compound (T-18) disappeared. Then, trimethyl borate (2.73 g, 26.3 mmol) was added thereto, and the resulting mixture was returned to room temperature, and stirred for 12 hours. Acetic acid (1.82 g, 30.3 mmol) was added thereto at room temperature, and the resulting mixture was stirred for 30 minutes, and then hydrogen peroxide water (30% by weight; 4.6 g, 40.6 mmol) was added thereto, and the resulting mixture was stirred for 1 hour. The reaction mixture was poured into water, and the aqueous layer was subjected to extraction with ethyl acetate. The extract was washed with water, a saturated sodium thiosulfate aqueous solution and brine, and then subjected to back extraction with a 1N sodium hydroxide aqueous solution. The aqueous solution was neutralized with 1N hydrochloric acid, and the resulting solution was subjected to extraction with ethyl acetate. The extract was washed with brine, then dried over anhydrous magnesium sulfate, and concentrated under reduced pressure to obtain compound (T-19) (4.39 g, 17.7 mmol; 84%).

### Fourth Step: Synthesis of Compound (No. 1105)

Under a nitrogen atmosphere, compound (T-19) (4.39 g, 17.7 mmol), compound (T-16) (2.34 g, 19.5 mmol), triphenylphosphine (5.10 g, 19.4 mmol) and tetrahydrofuran (40 mL) were put into a reaction vessel, and cooled on an ice bath. Diethyl azodicarboxylate (DEAD, 2.2 M; toluene solution; 8.8 mL, 19.4 mmol) was added dropwise thereto, and the resulting mixture was stirred at room temperature for 8 hours. The reaction mixture was poured into water, and the aqueous layer was subjected to extraction with diethyl ether. The extract was washed with brine, then dried over anhydrous magnesium sulfate, and concentrated under reduced pressure. The residue was purified by silica gel chromatography (ethyl acetate:hexane=1:9 in a volume ratio), and further purified by recrystallization from a mixed solvent (2:1 in a volume ratio) of Solmix (registered trademark) A-11 and methanol to obtain compound (No. 1105) (2.05 g, 5.85 mmol; 33%).

Solmix A-11 is a mixture of ethanol (85.5%), methanol (13.4%) and isopropanol (1.1%), and was available from Japan Alcohol Trading Co., Ltd.

¹H-NMR (CDCl₃; δ ppm): 6.70-6.65 (m, 2H), 4.89-4.75 (m, 2H), 4.15-4.04 (m, 4H), 1.84-1.63 (m, 4H), 1.55-1.34 (m, 4H), 0.93 (t, J=7.1 Hz, 6H).

Phase transition temperature: C 40.9 I. Maximum temperature (NI)=−88.7° C.; dielectric anisotropy (Δε)=−9.2; optical anisotropy (Δn)=0.014; viscosity (η)=78.7 mPa·s.

### Synthesis Example 8

### Synthesis of Compound (No. 1092)

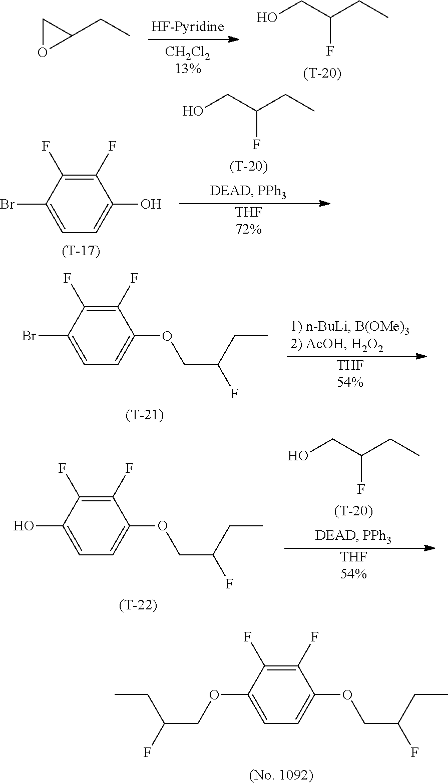

Compound (No. 1092) was prepared from 1,2-epoxy butane according to the procedure described in Synthesis Example 7. An overall yield was 2.7%.

¹H-NMR (CDCl₃; δ ppm) of compound (No. 1092): 6.70-6.66 (m, 2H), 4.82-4.69 (m, 2H), 4.17-4.05 (m, 4H), 1.88-1.69 (m, 4H), 1.05 (t, J=7.4 Hz, 6H).

Phase transition temperature: C 23.1 I. Maximum temperature (NI)=−111.0° C.; dielectric anisotropy (Δε)=−8.6; optical anisotropy (Δn)=0.007; viscosity (η)=62.6 mPa·s.

### Comparative Example 1

For comparison, compound (Ex-1) disclosed in Example 1 of WO 2011/098224 A was selected and prepared.

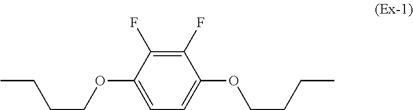 [SMILES: CCCCOc1ccc(OCCCC)c(F)c1F]

¹H-NMR (CDCl₃; δ ppm): 6.62 (dd, 2H), 3.98 (t, 4H), 1.77 (quin, 4H), 1.49 (sex, 4H), 0.97 (t, 6H).

Transition temperature: C −8.2 I. Maximum temperature (NI)=−124.1° C.; dielectric anisotropy (Δε)=−5.88; optical anisotropy (Δn)=−0.014; viscosity (η)=15.7 mPa·s.

### Comparative Example 2

For comparison, compound (1-1-3) disclosed on page 43 of JP 2017-19767 A was selected and prepared.

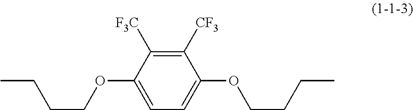 [SMILES: CCCCOc1ccc(OCCCC)c(C(F)(F)F)c1C(F)(F)F]

¹H-NMR (CDCl₃; δ ppm): 7.15 (s, 2H), 3.99 (t, 4H), 1.78 (quin, 4H), 1.50 (sex, 4H), 0.97 (t, 6H).

Transition temperature: C 17.7 I. Maximum temperature (NI)=−101.4° C.; dielectric anisotropy (Δε)=−10.1; optical anisotropy (Δn)=−0.003; viscosity (η)=55.7 mPa·s.

### Comparative Experiment

In order to compare compound (No. 1092), comparative compound (Ex-1) and comparative compound (1-1-3) with each other, the maximum temperature (NI) was measured according to measuring method (4). A sample was prepared by mixing 15% by weight of the compound with 85% by weight of the base liquid crystal (B).

The results were summarized in Table 2. The results found that compound (No. 1092) had the maximum temperature as much as 35.4° C. higher than comparative compound (Ex-1). The results found that compound (No. 1092) had the maximum temperature as much as 12.7° C. higher than comparative compound (1-1-3). Accordingly, compound (1) can be concluded to be excellent in comparison with the similar compounds.

TABLE 2
Comparison of maximum temperature

| | | Maximum |
|---|---|---|
| Examples | Compounds | temperature (NI) |
| Synthesis Example 1 | 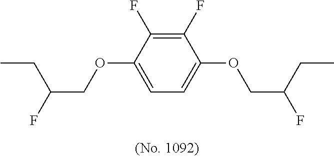 [SMILES: CCC(F)COc1ccc(OCC(F)CC)c(F)c1F] | −88.7° C. |
| Comparative Example 1 | 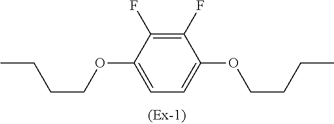 [SMILES: CCCCOc1ccc(OCCCC)c(F)c1F] | −124.1° C. |
| Comparative Example 2 | 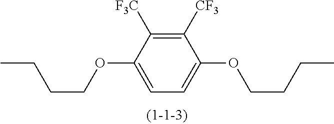 [SMILES: CCCCOc1ccc(OCCCC)c(C(F)(F)F)c1C(F)(F)F] | −101.4° C. |

Compounds shown below are prepared with reference to the methods described in Synthesis Examples and the section of “2. Synthesis of compound (1).”

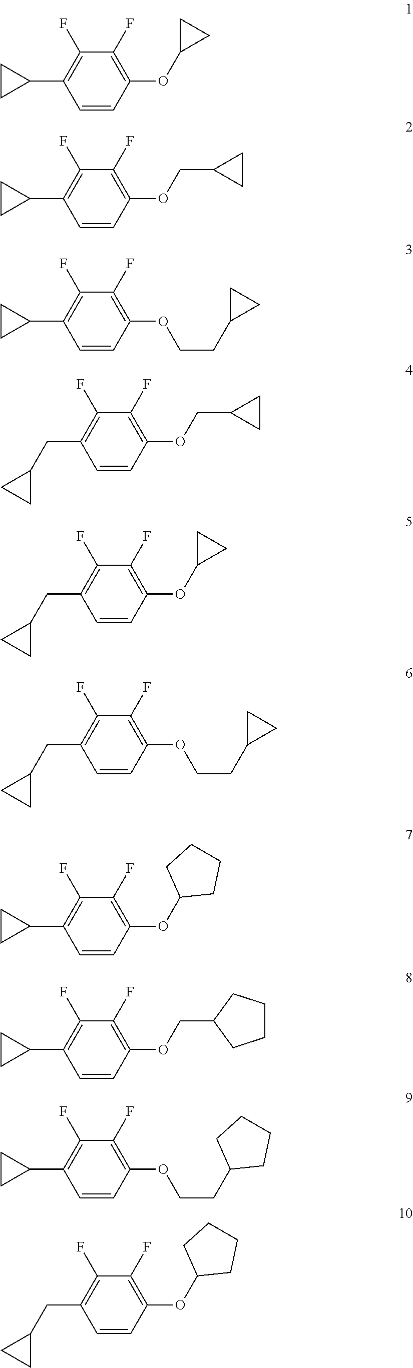

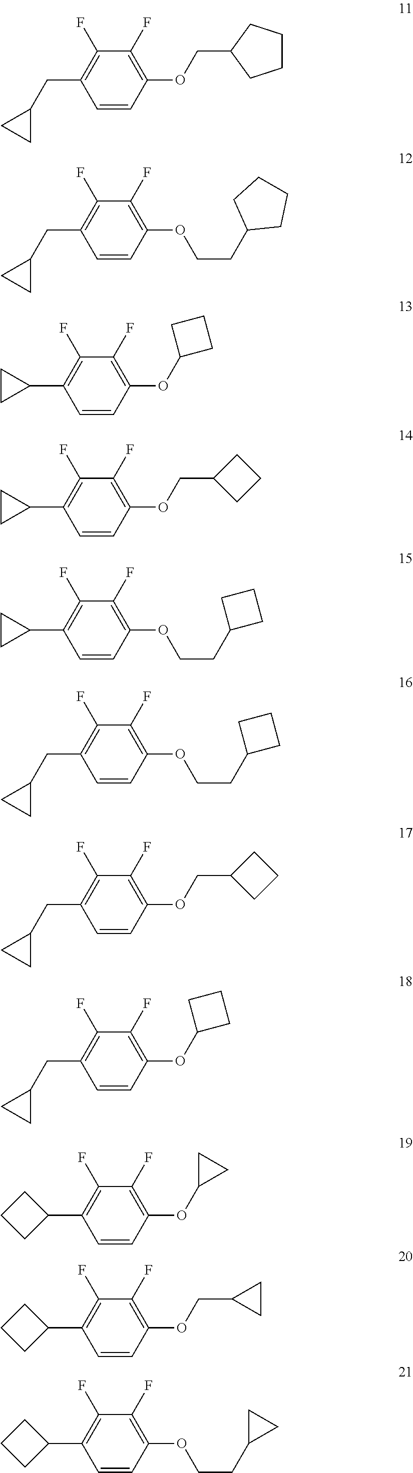

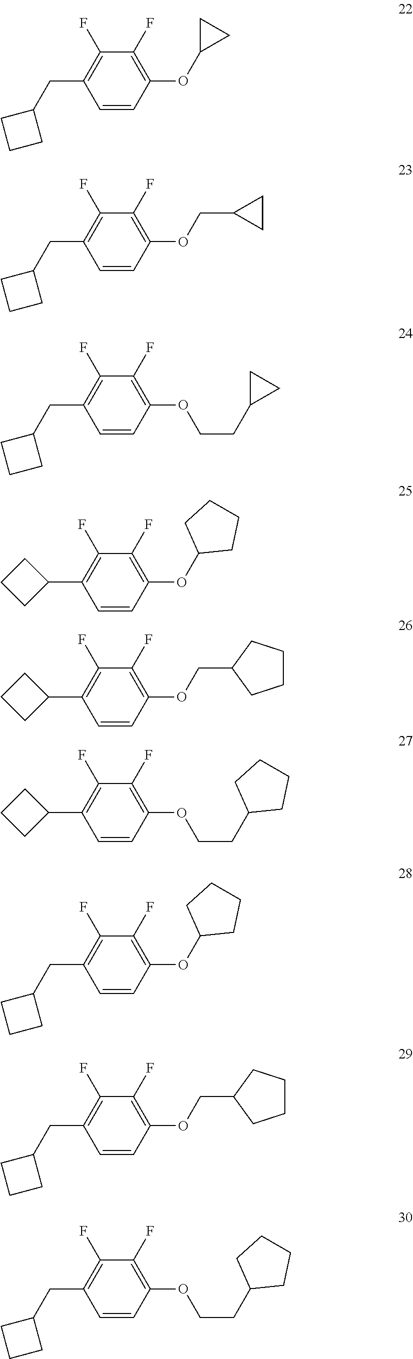

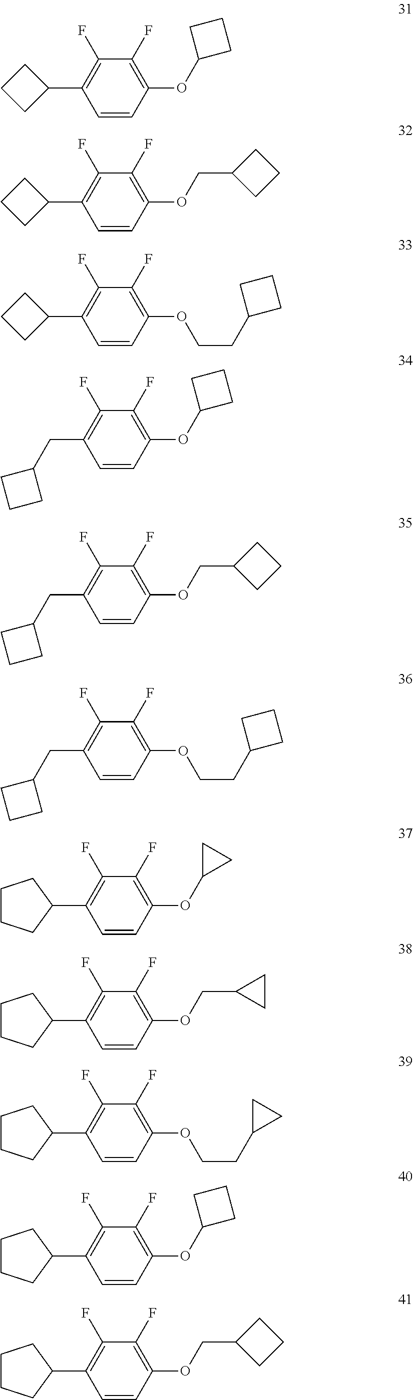

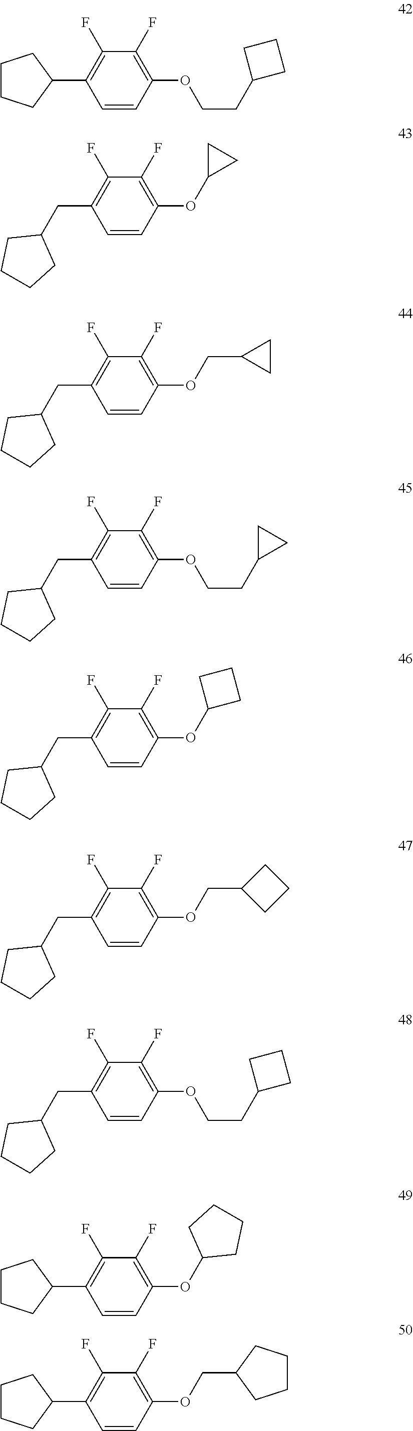

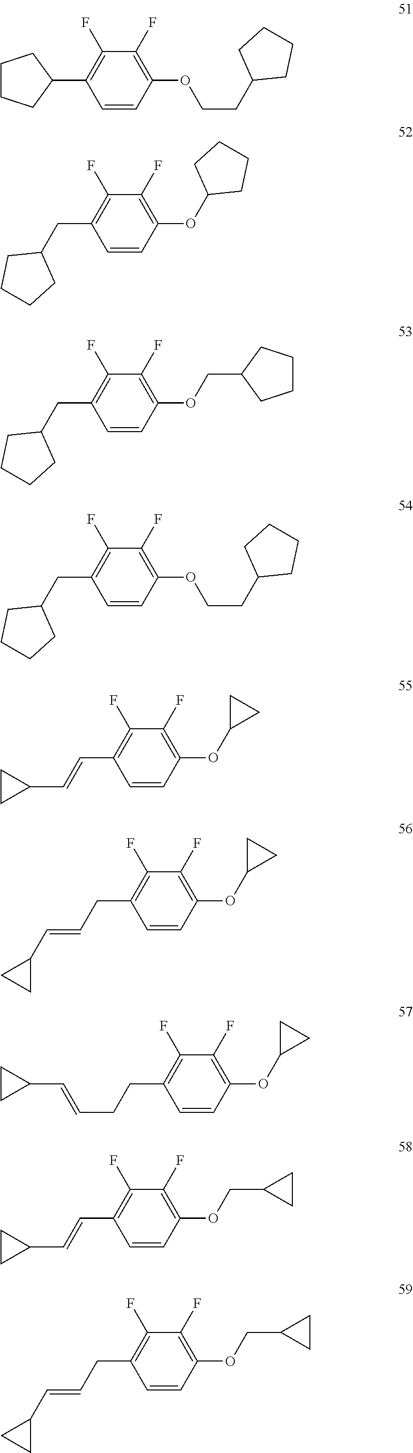

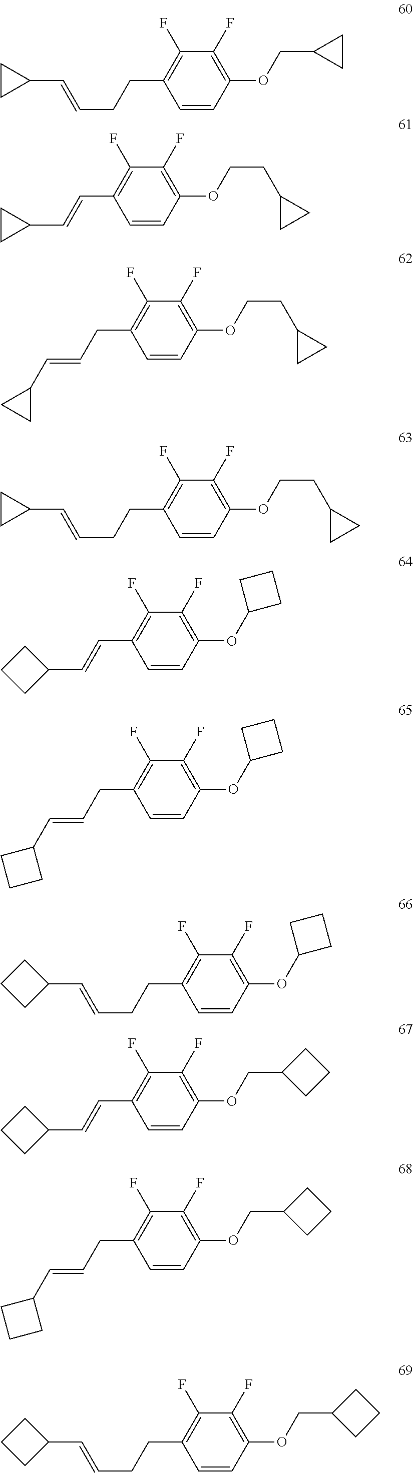

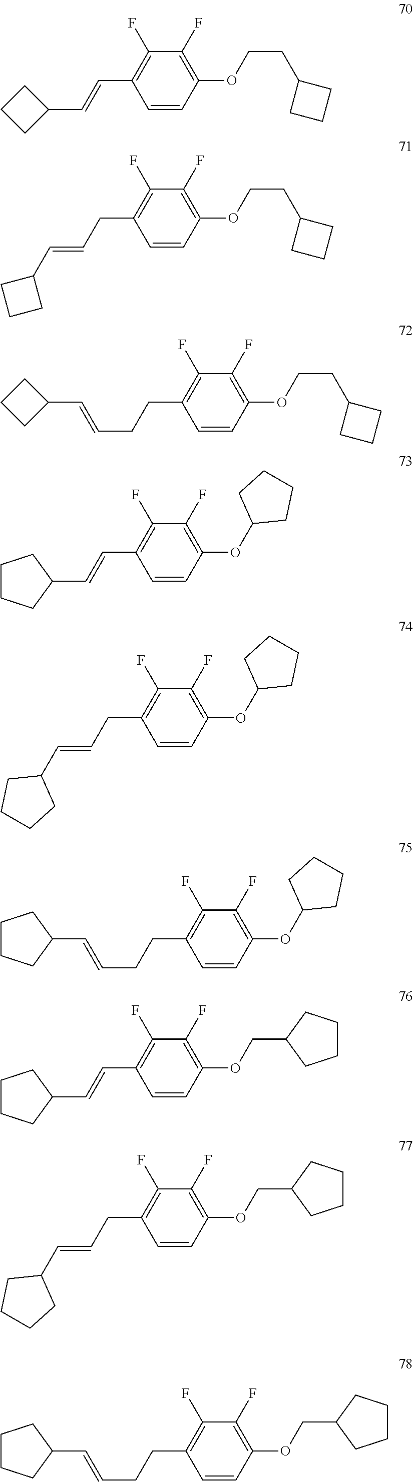

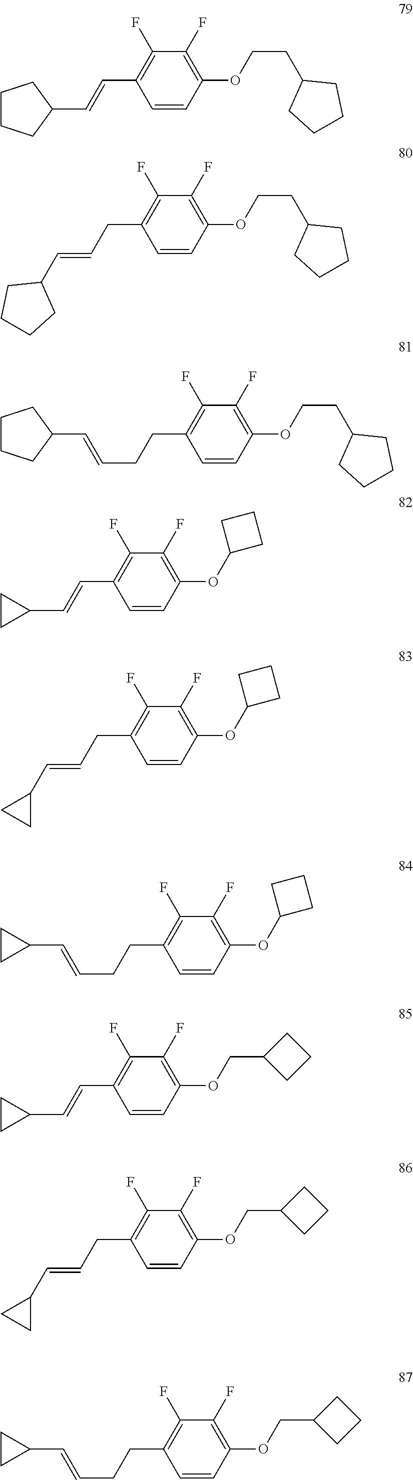

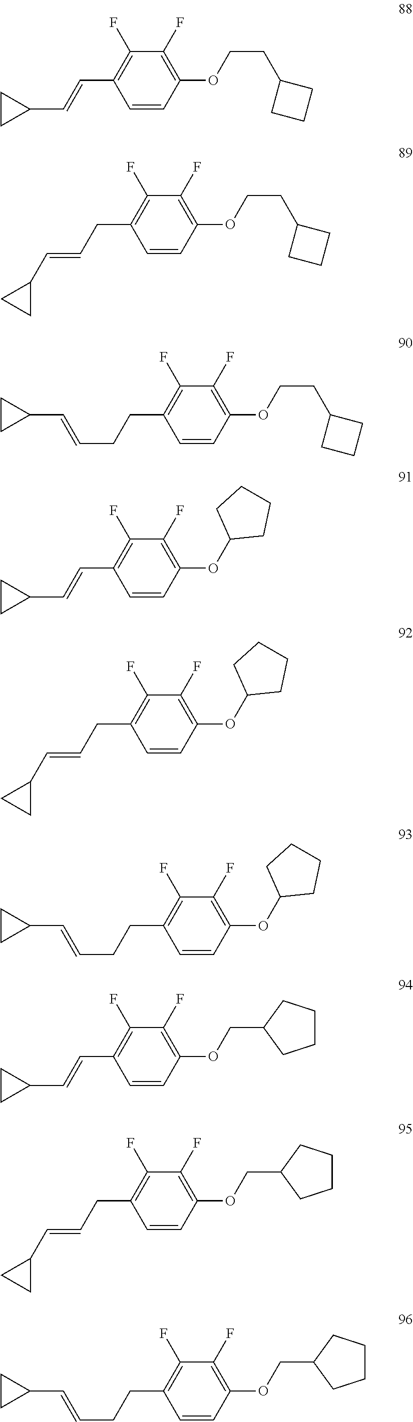

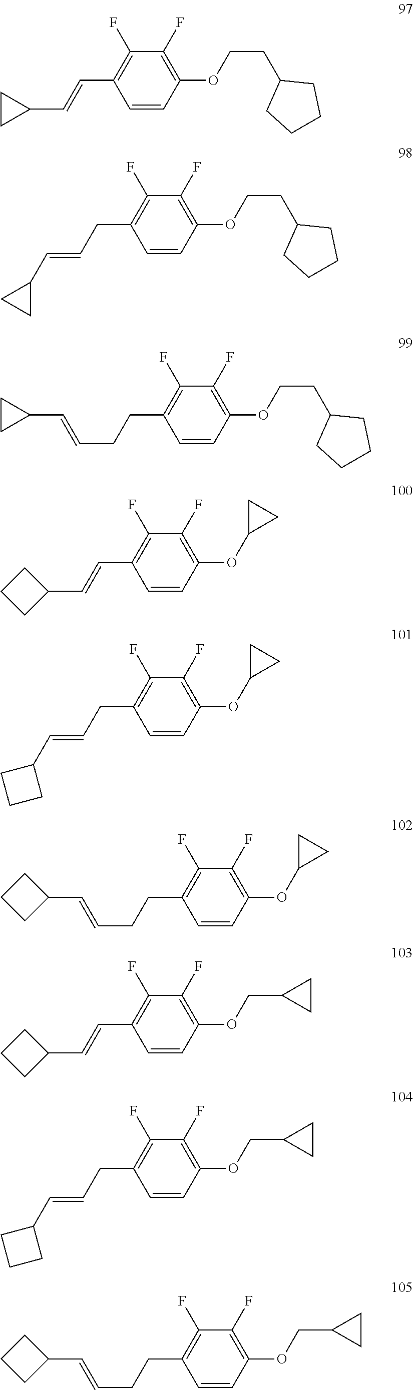

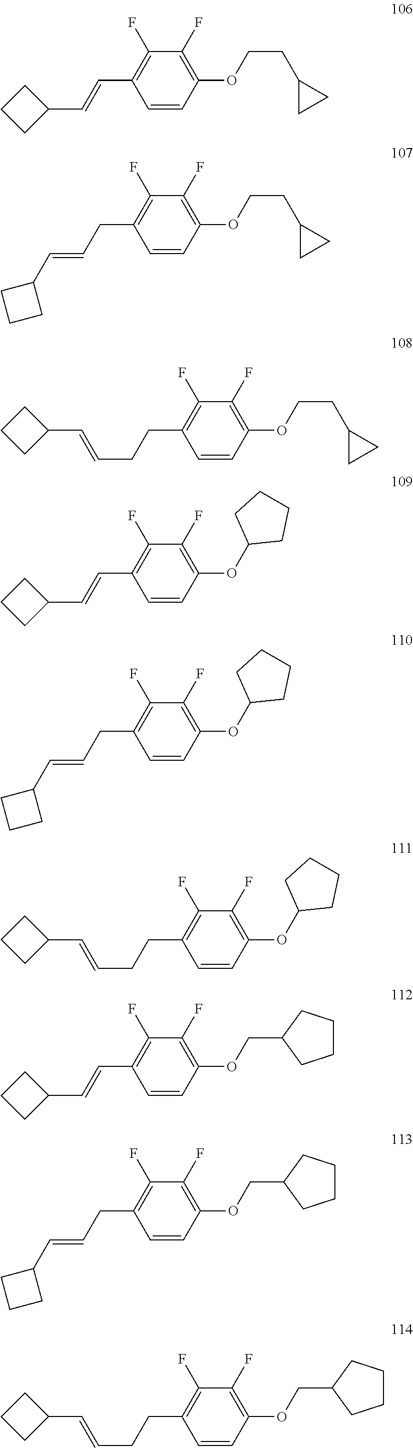

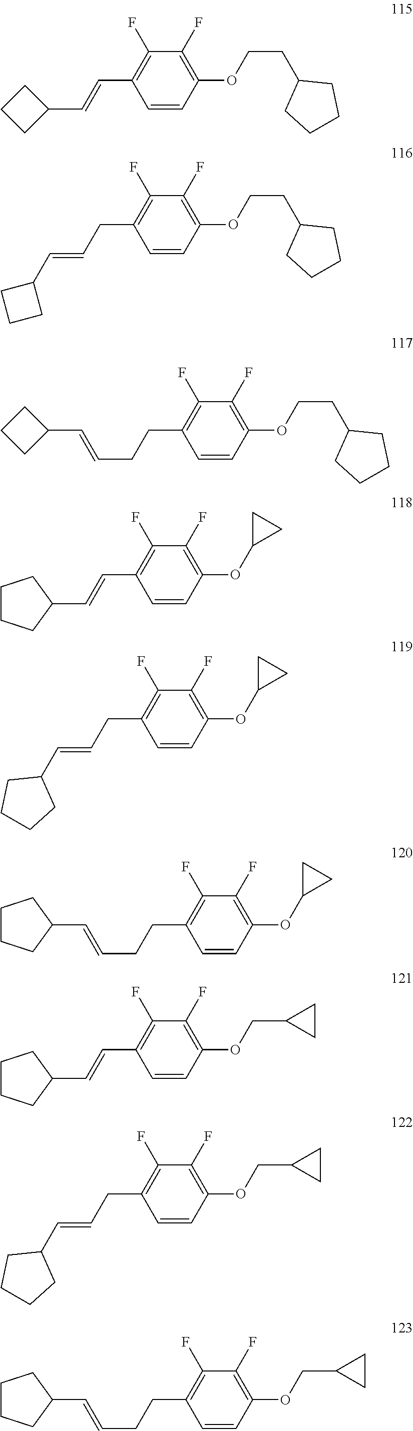

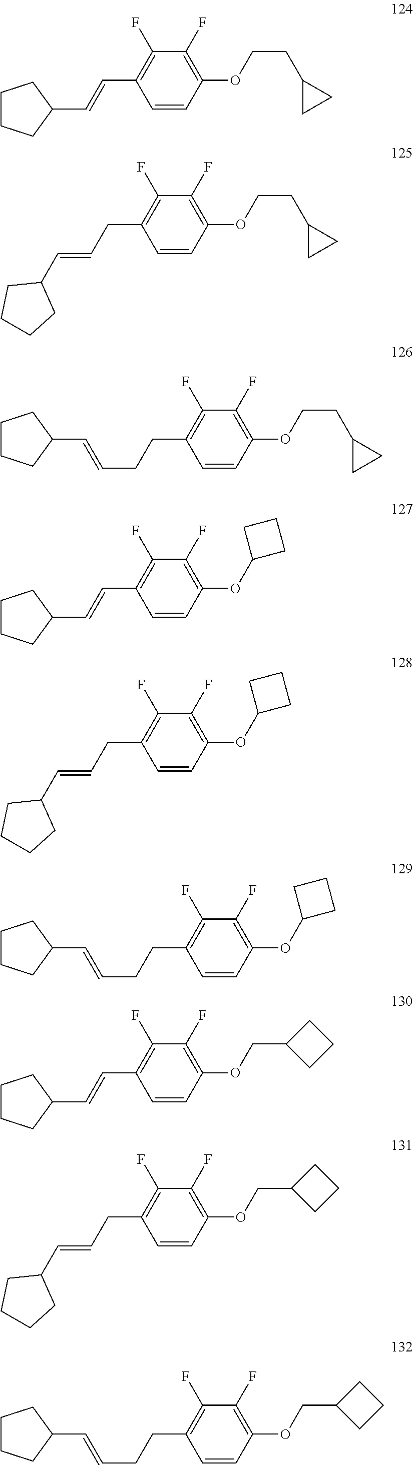

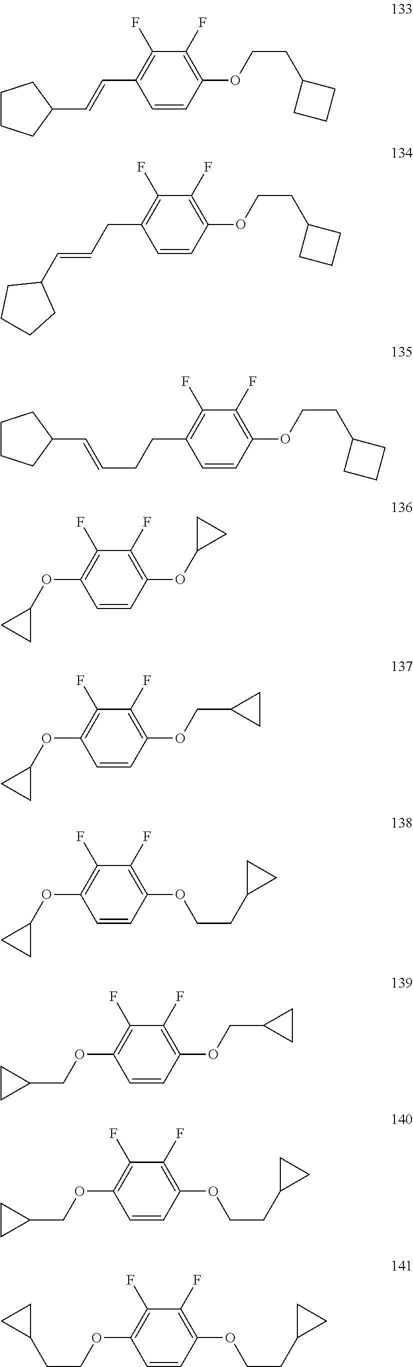

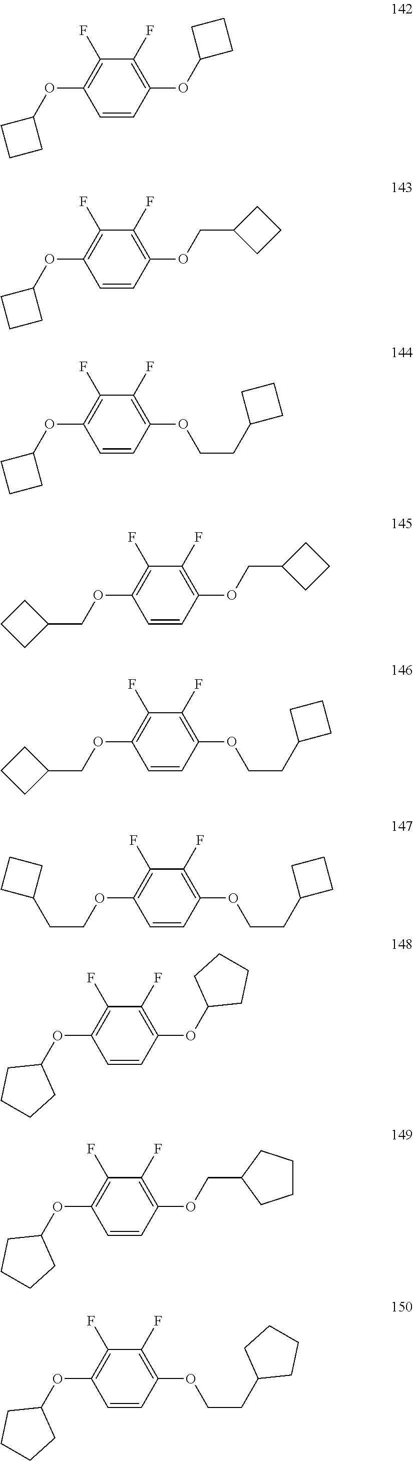

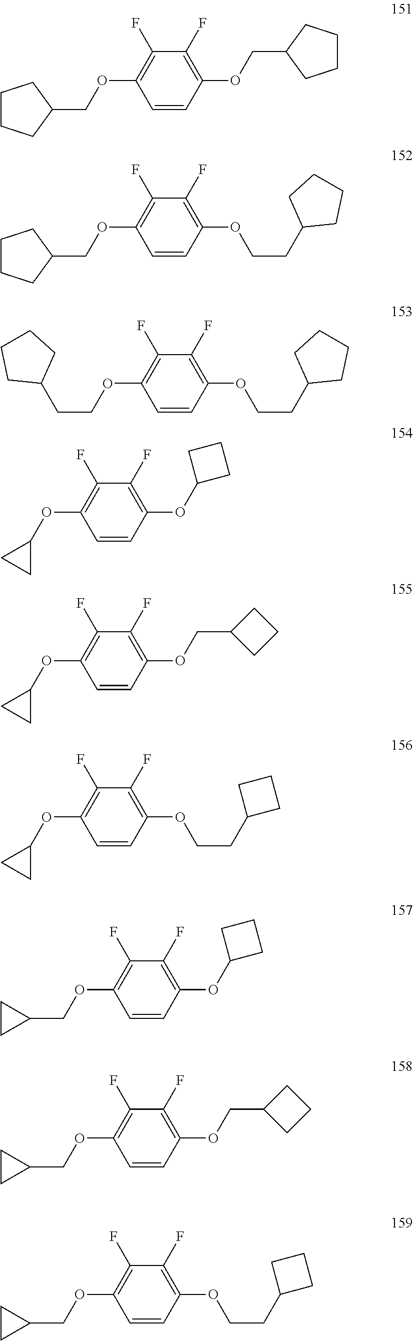

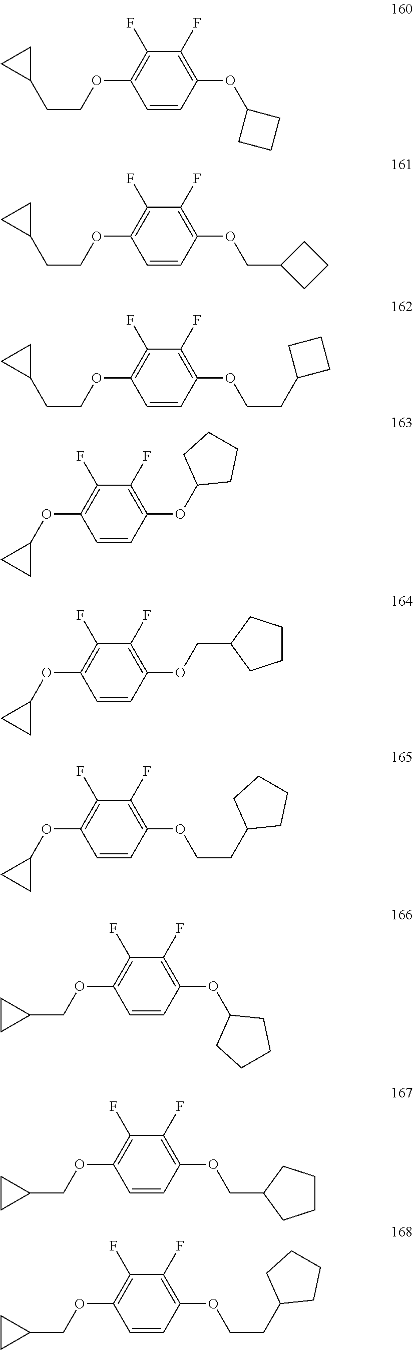

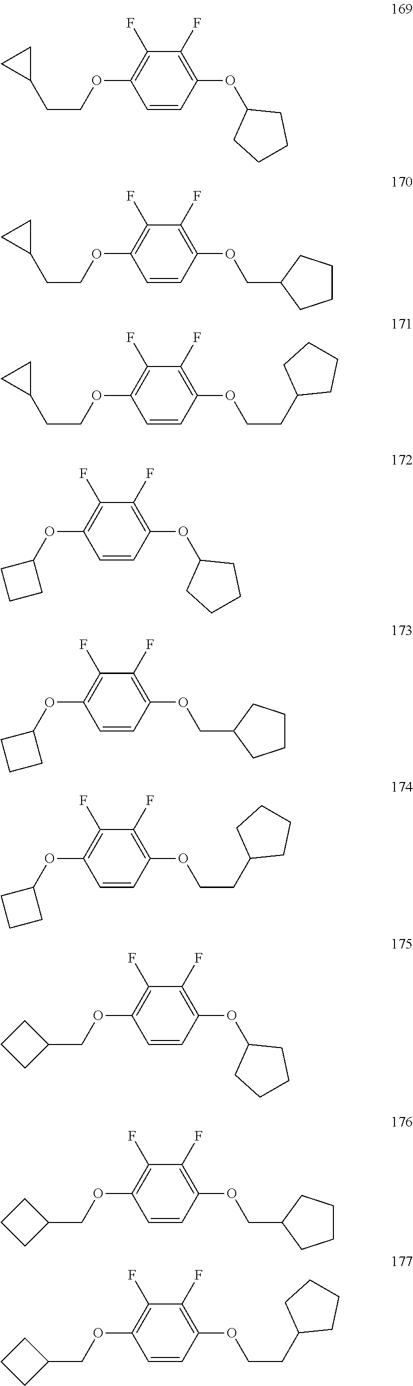

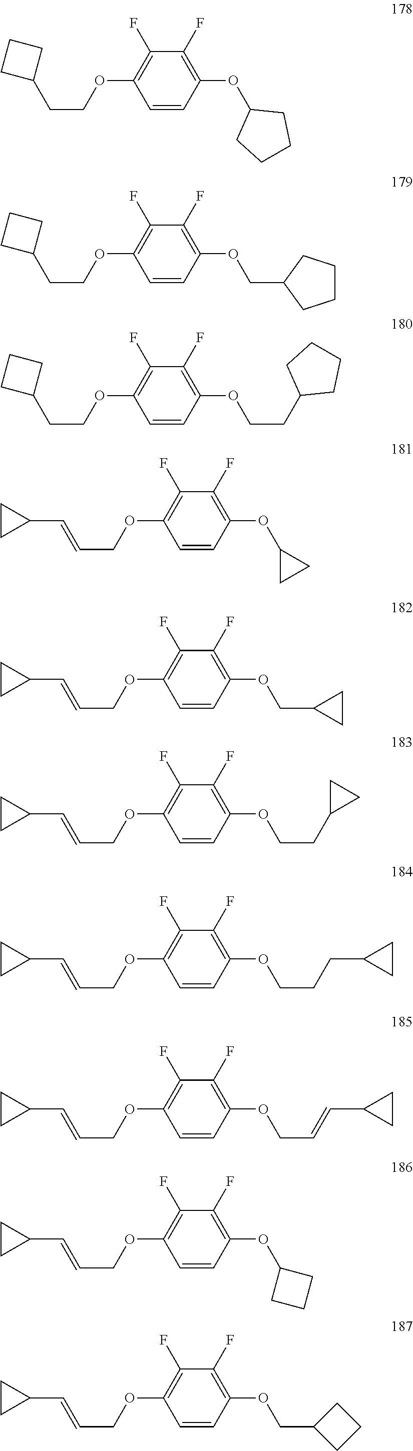

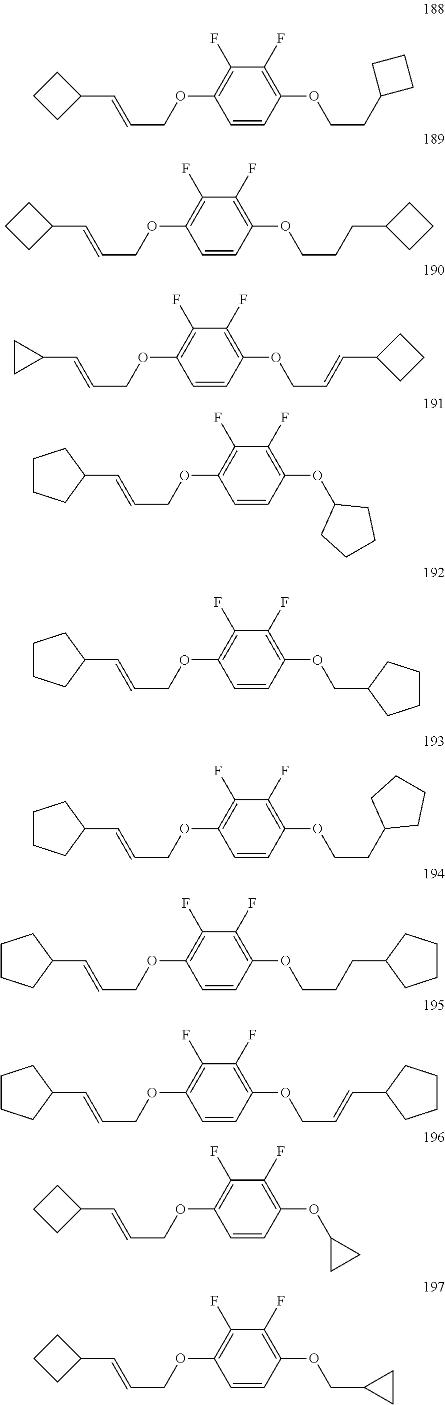

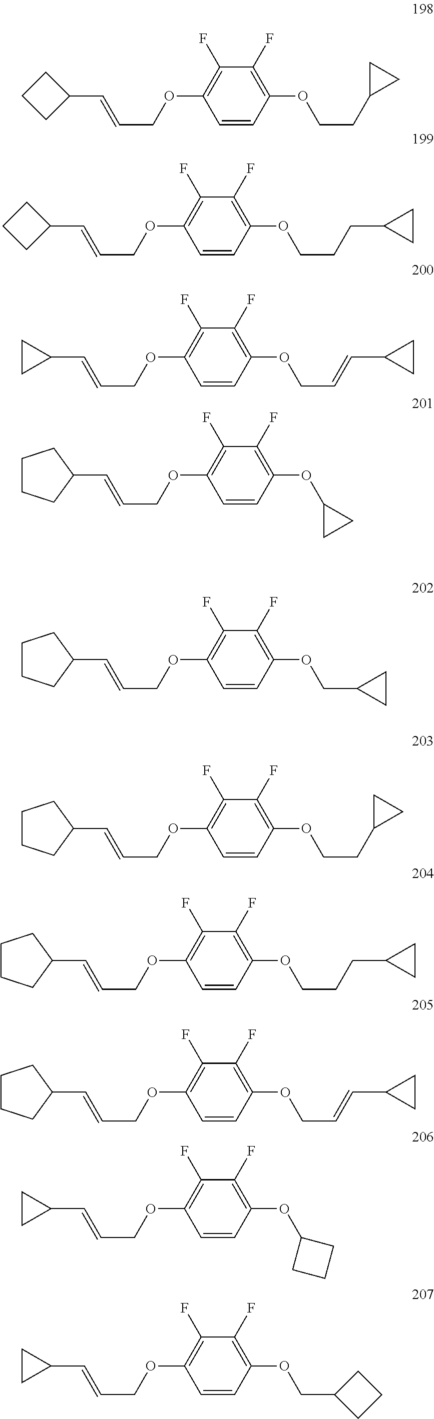

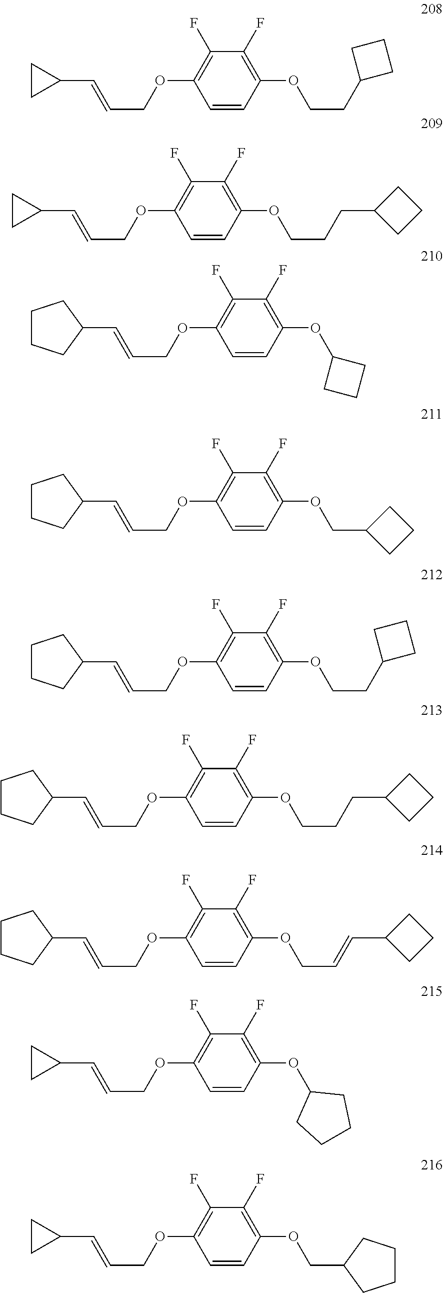

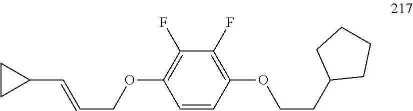 [SMILES: Fc1c(OC/C=C/C2CC2)ccc(OCCC2CCCC2)c1F]

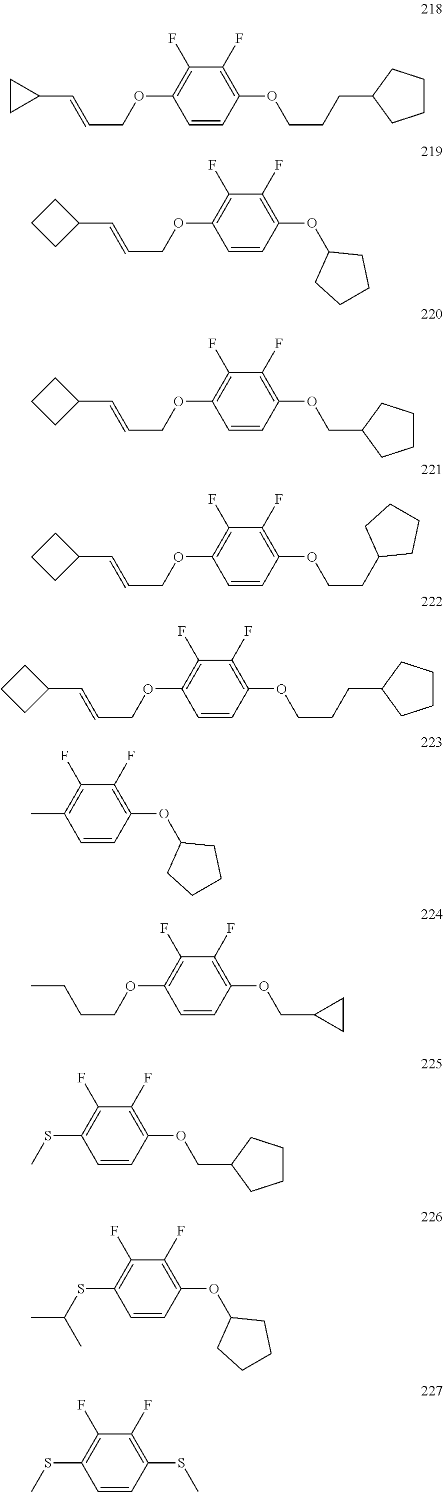

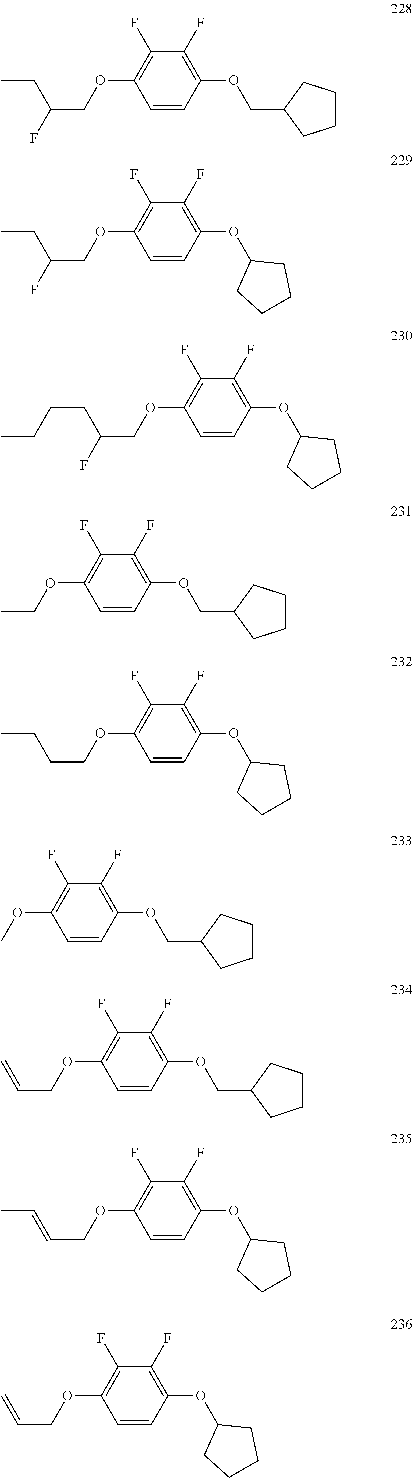

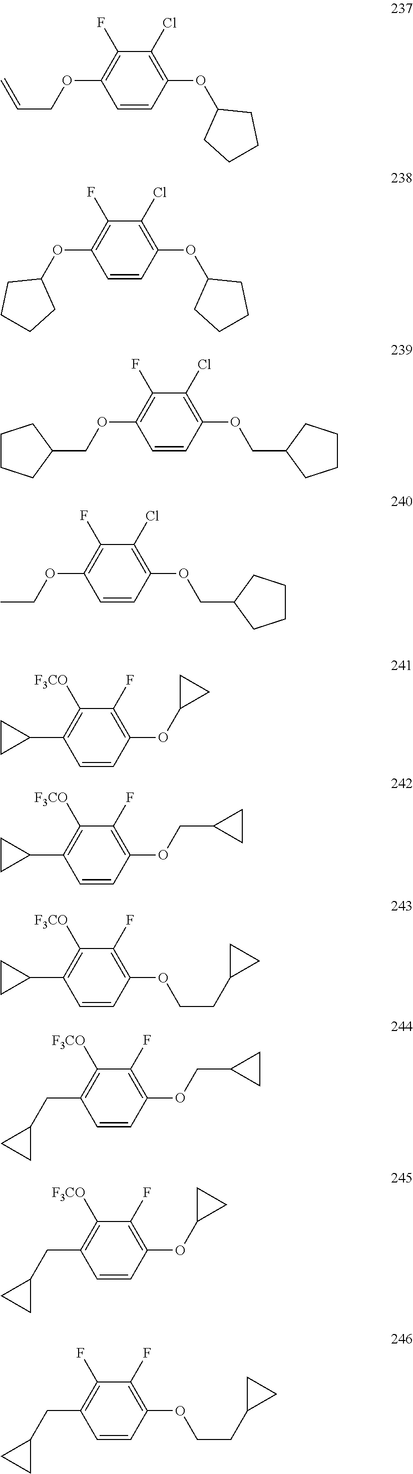

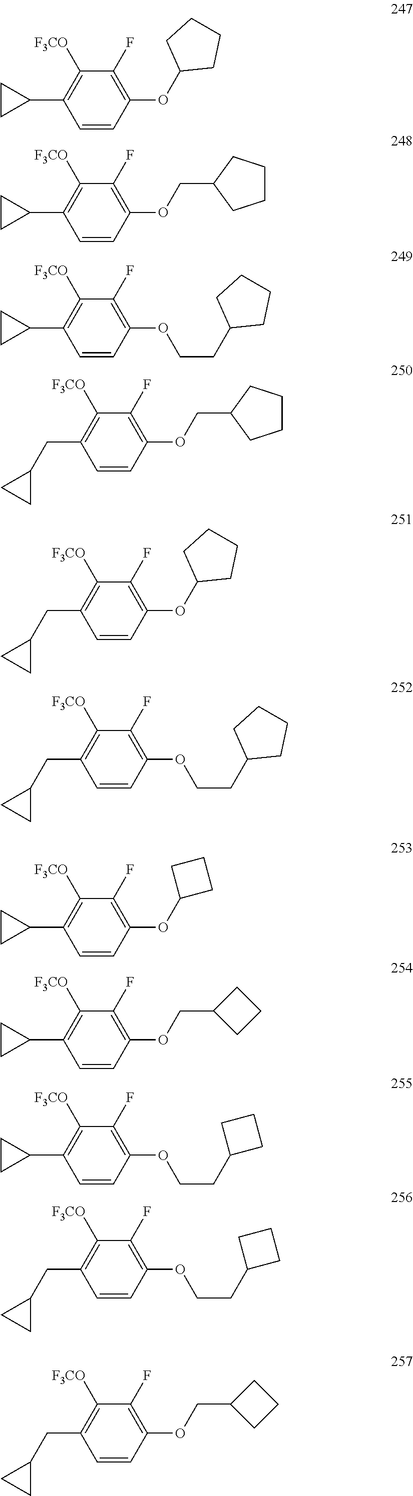

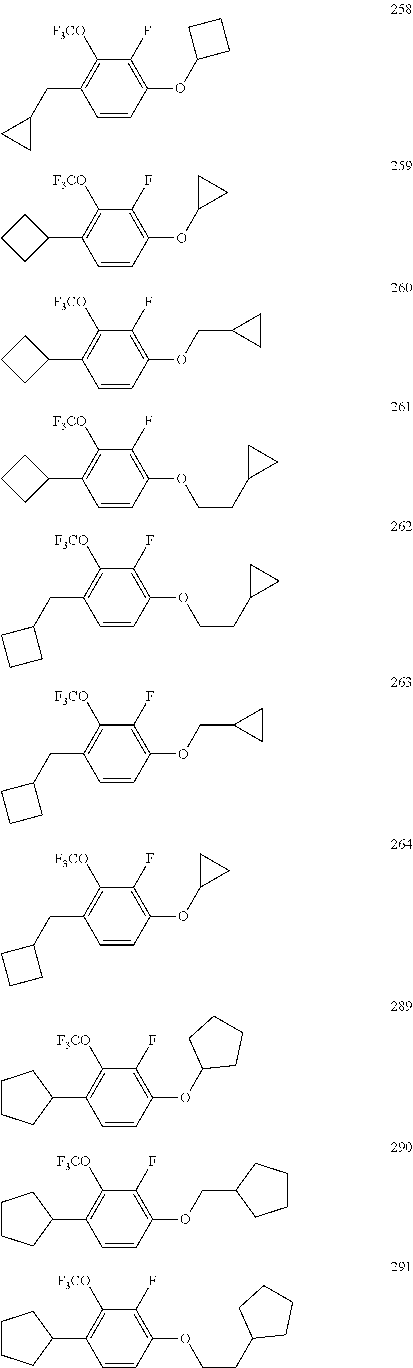

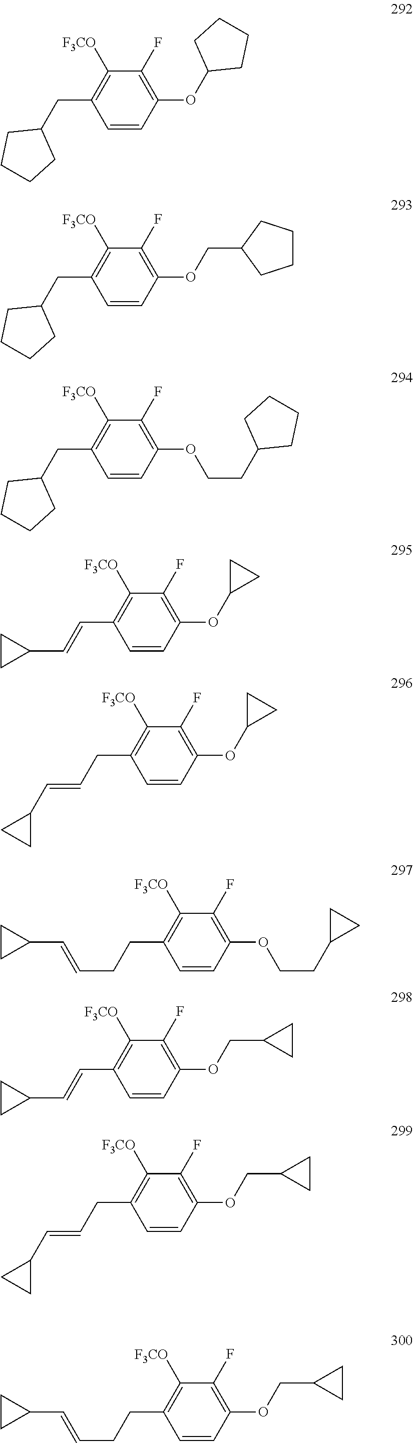

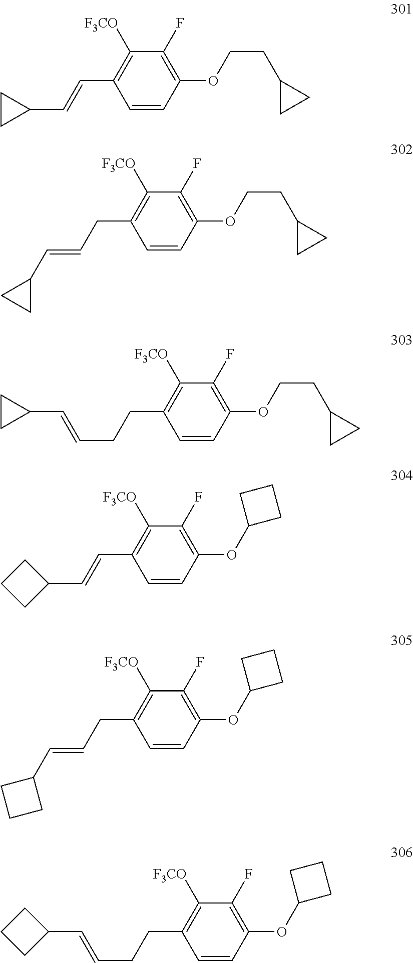 [SMILES: Fc1c(OCCC2CC2)ccc(/C=C/C2CC2)c1OC(F)(F)F ; Fc1c(OCCC2CC2)ccc(C/C=C/C2CC2)c1OC(F)(F)F ; Fc1c(OCCC2CC2)ccc(CC/C=C/C2CC2)c1OC(F)(F)F ; Fc1c(OC2CCC2)ccc(/C=C/C2CCC2)c1OC(F)(F)F ; Fc1c(OC2CCC2)ccc(C/C=C/C2CCC2)c1OC(F)(F)F ; Fc1c(OC2CCC2)ccc(CC/C=C/C2CCC2)c1OC(F)(F)F]

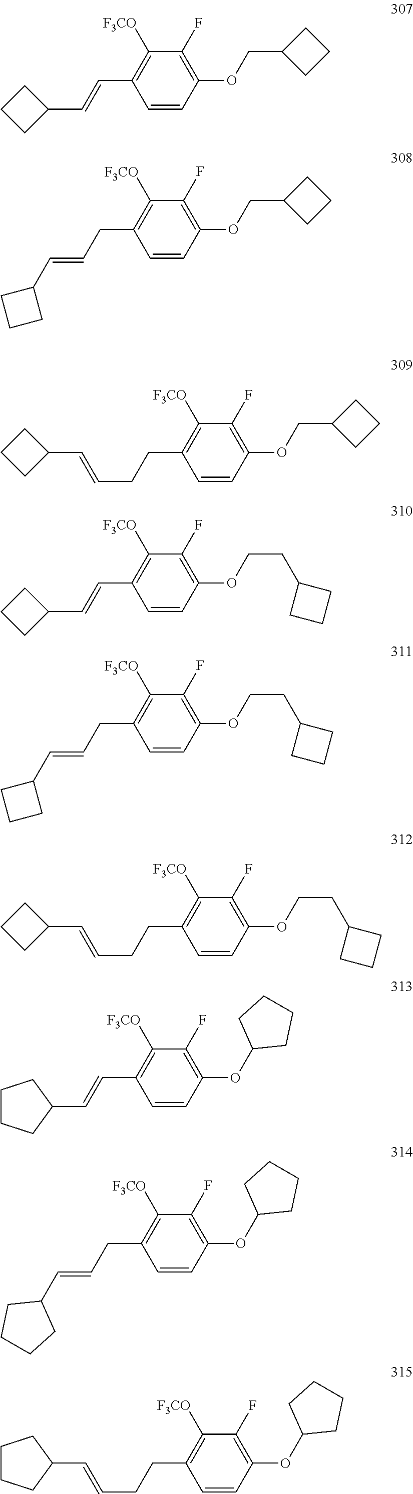

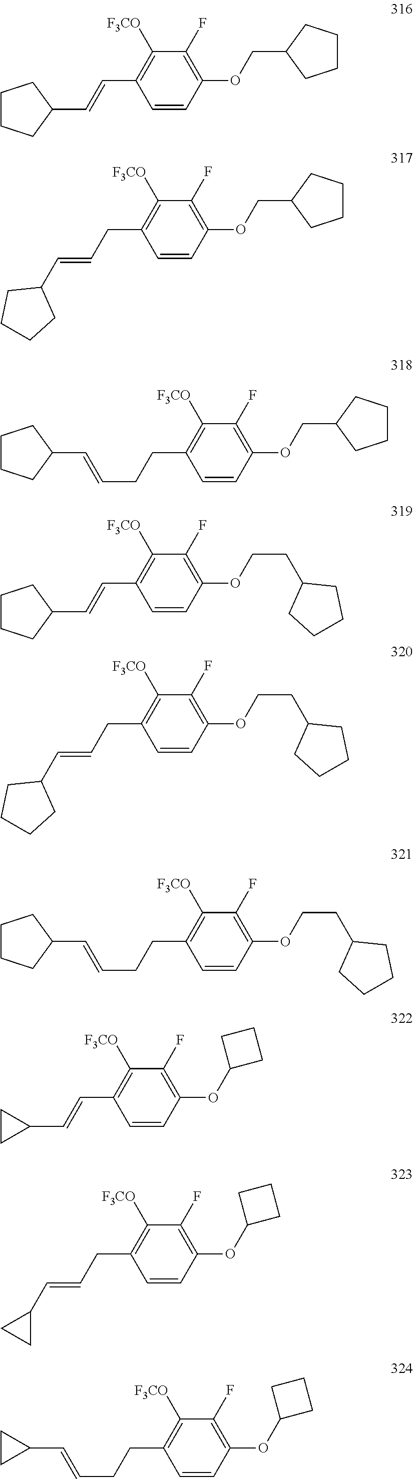

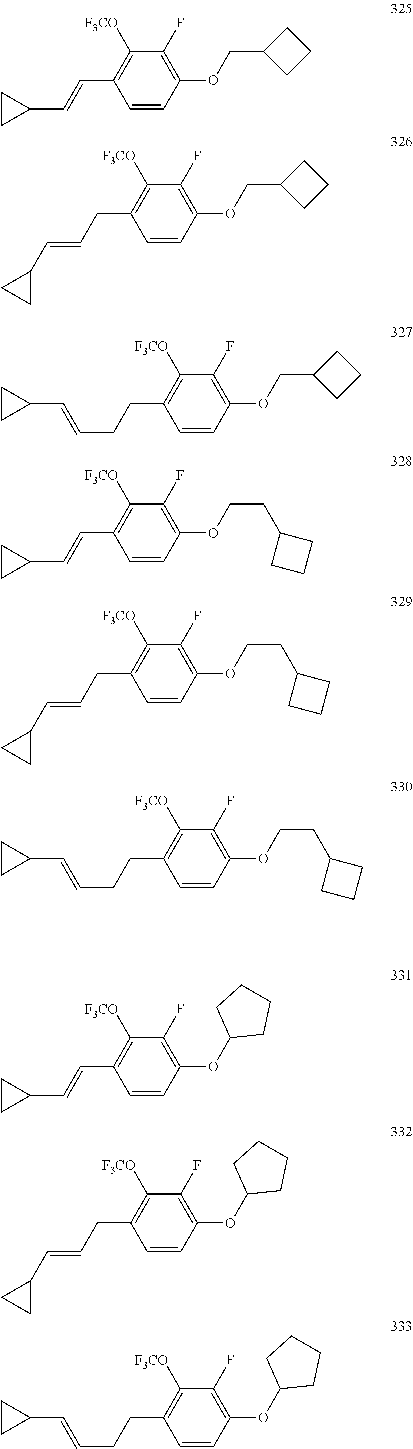

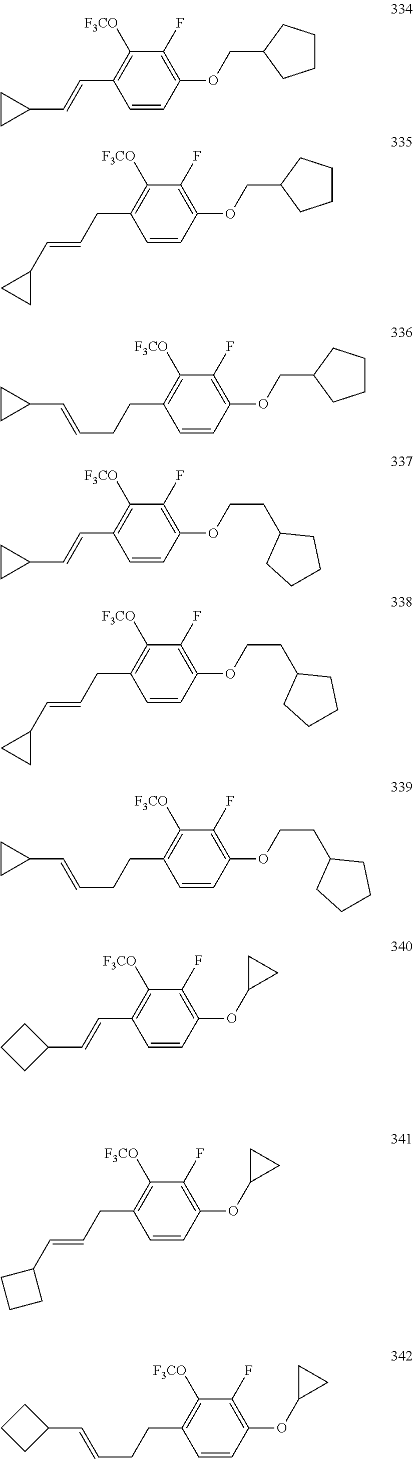

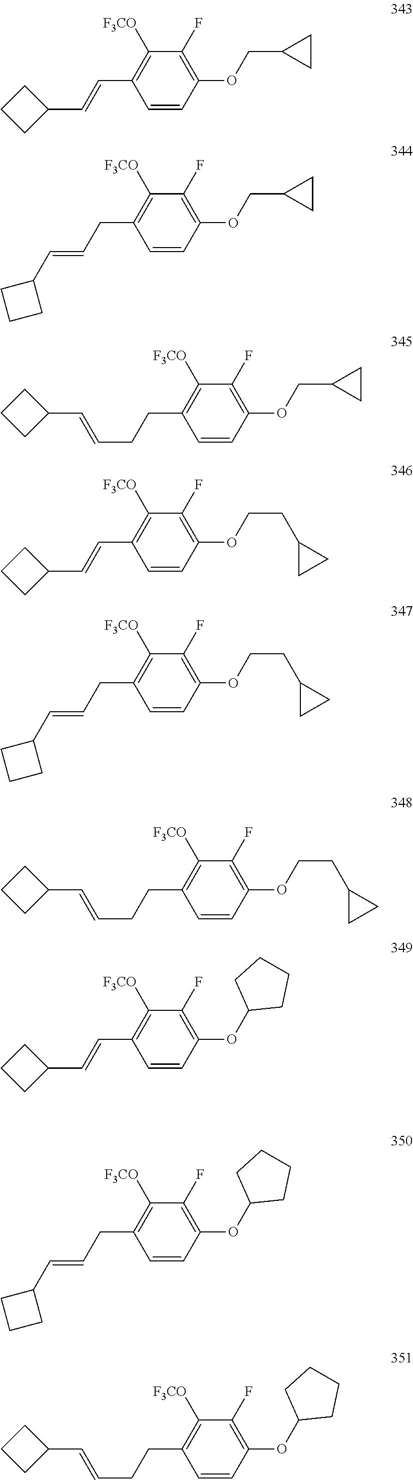

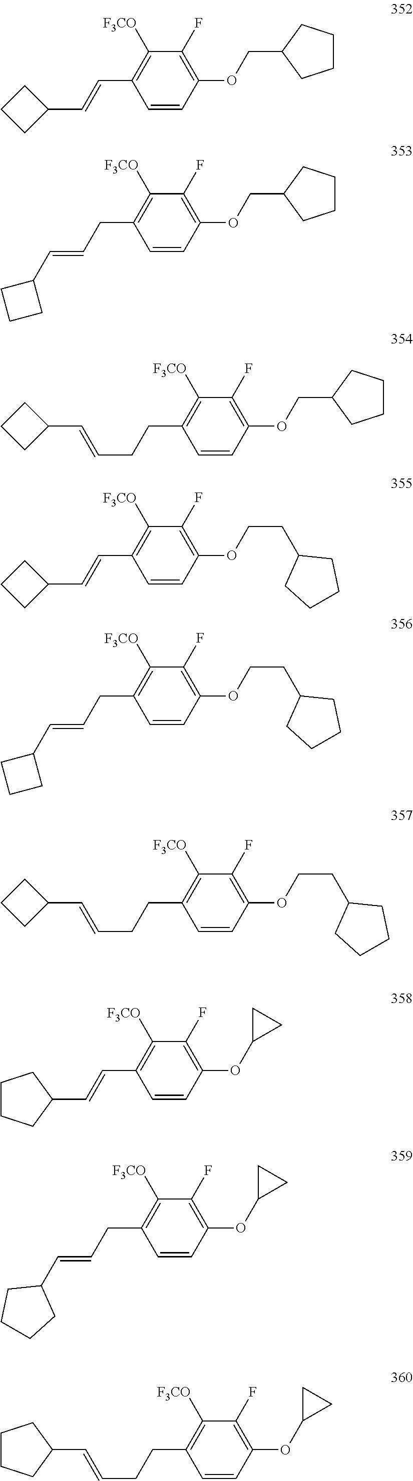

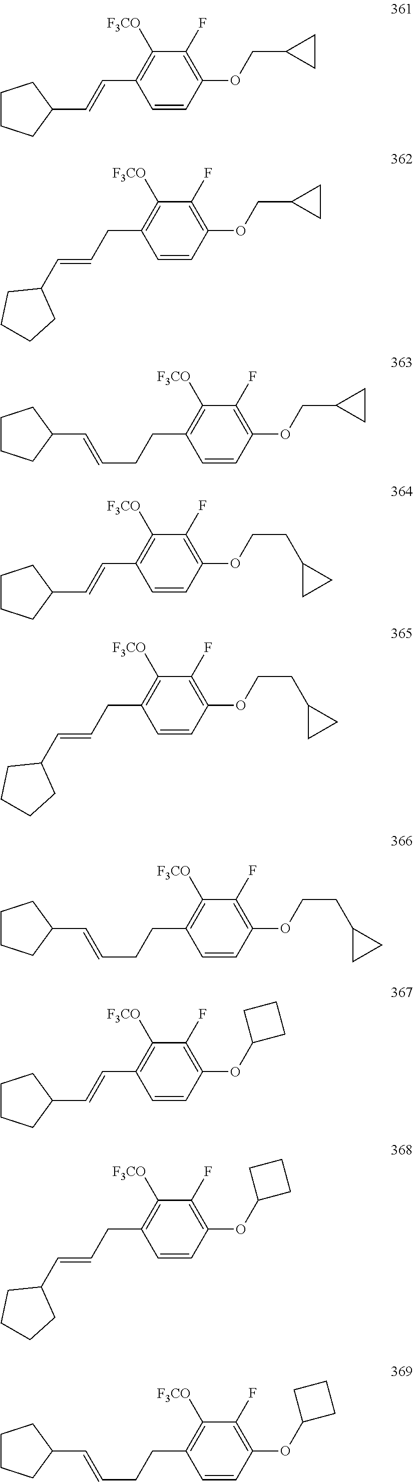

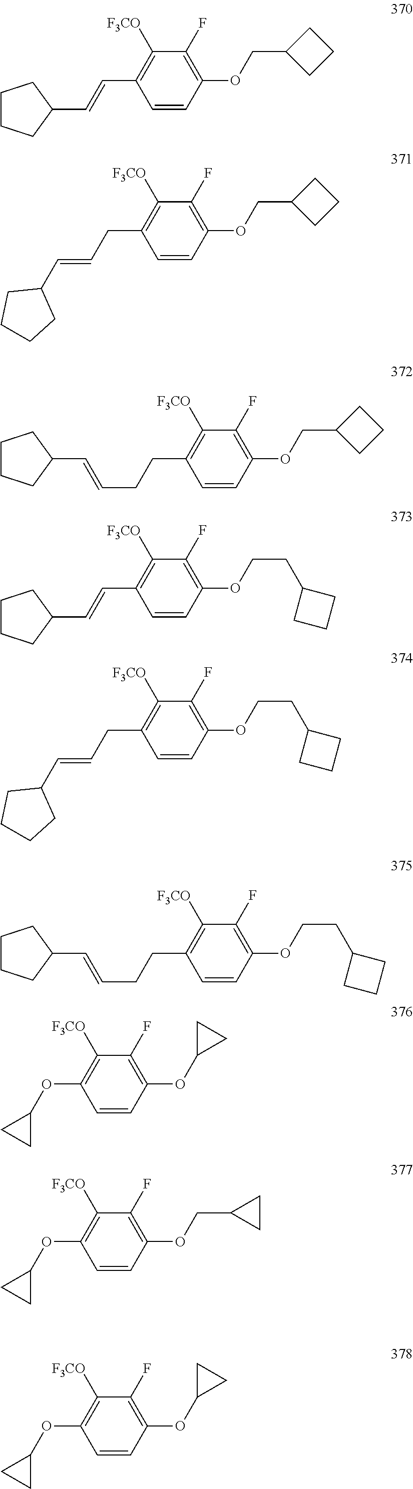

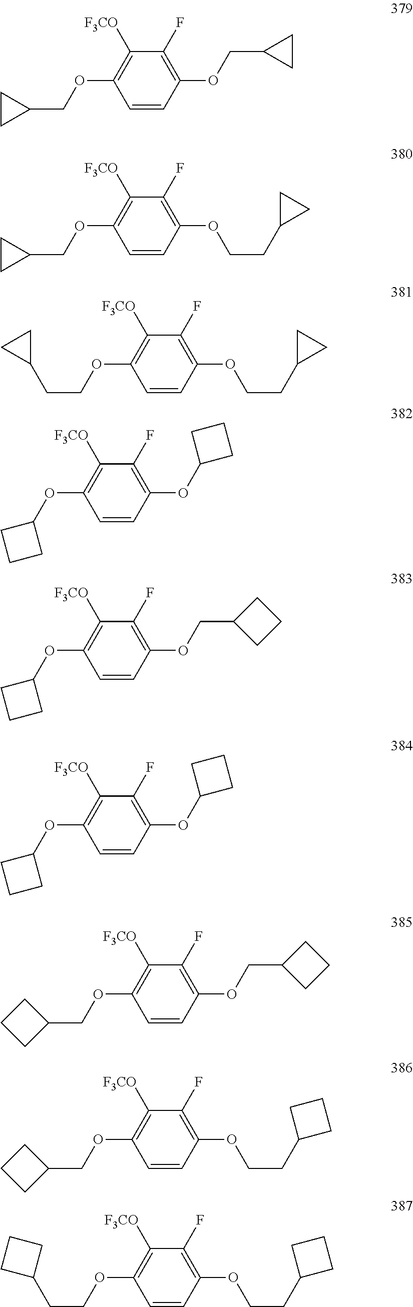

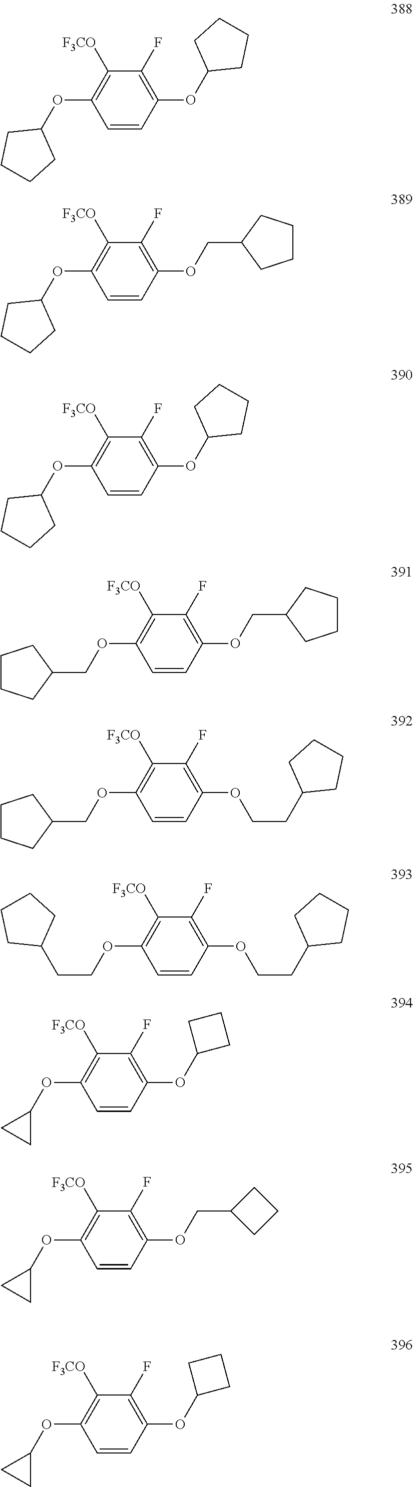

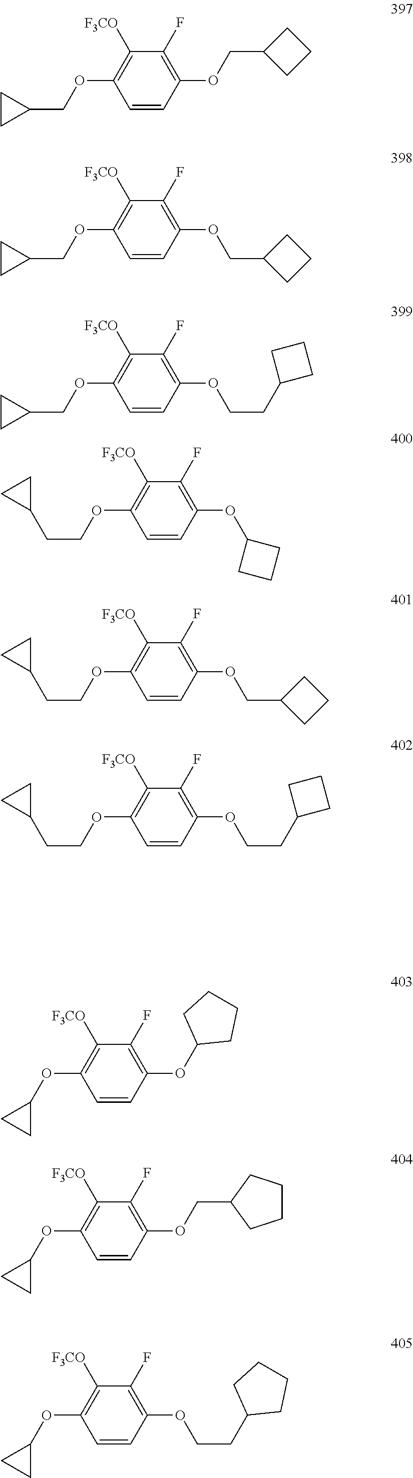

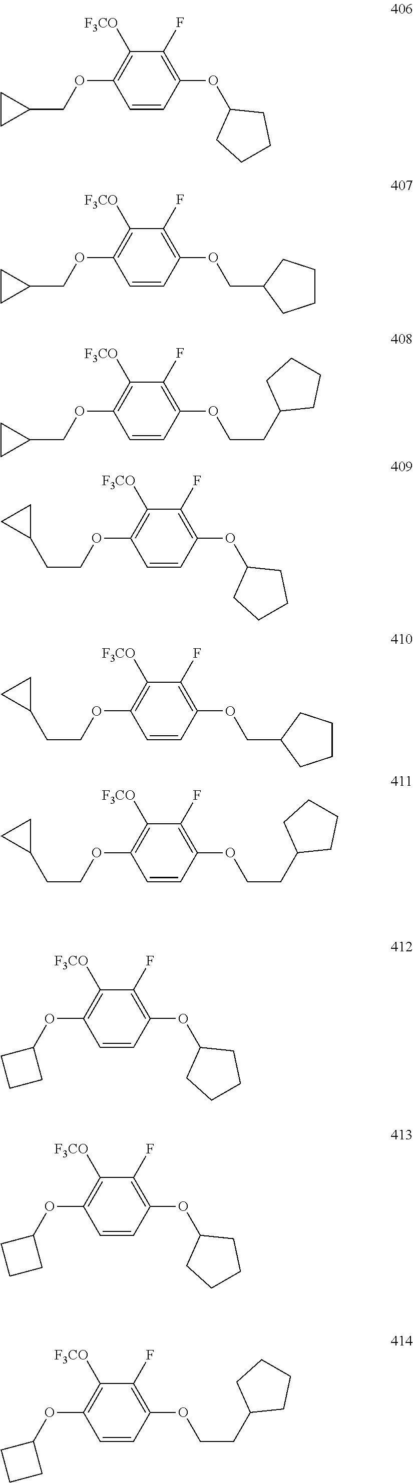

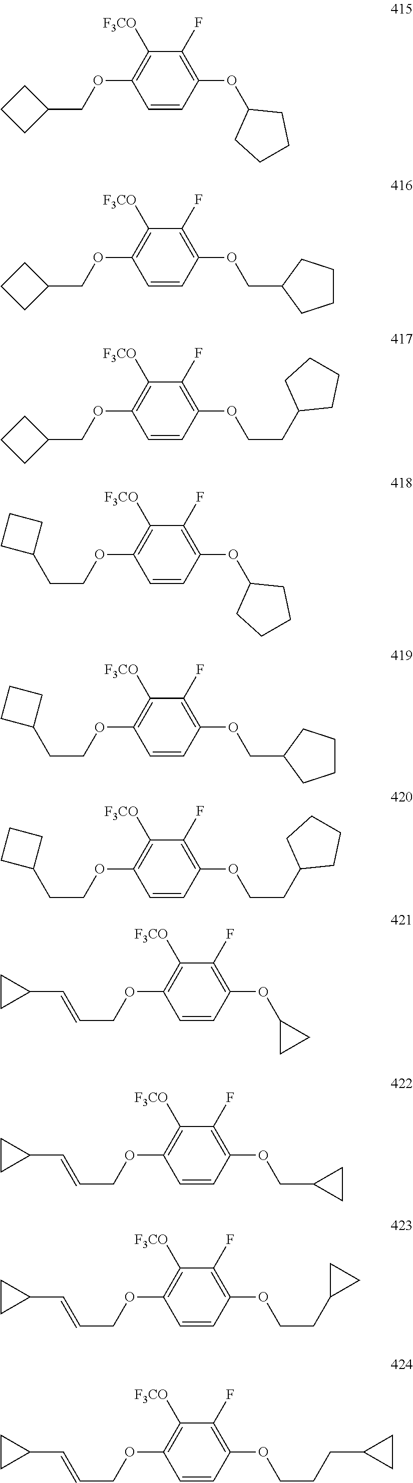

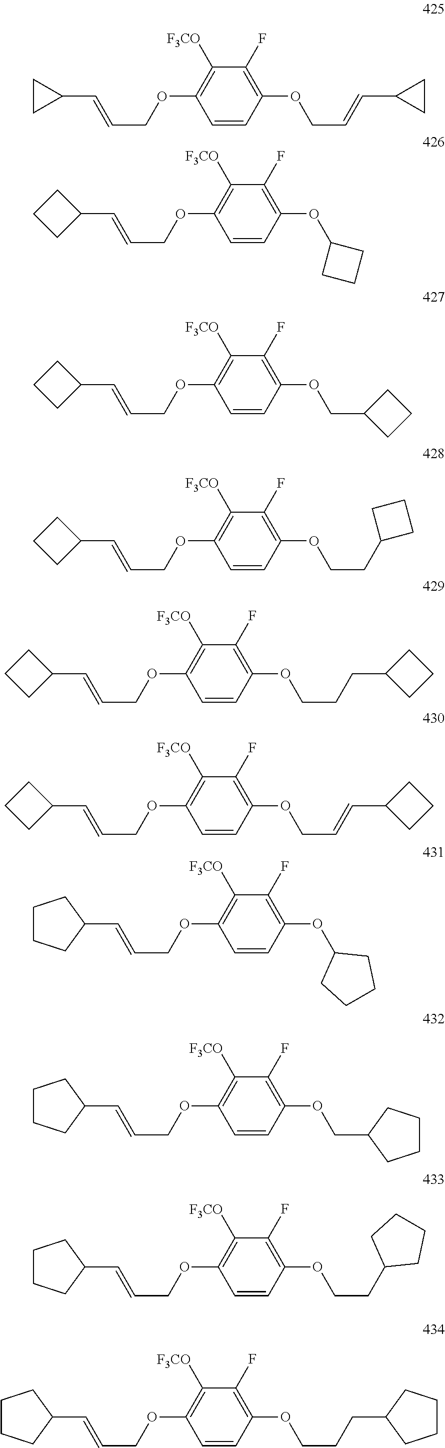

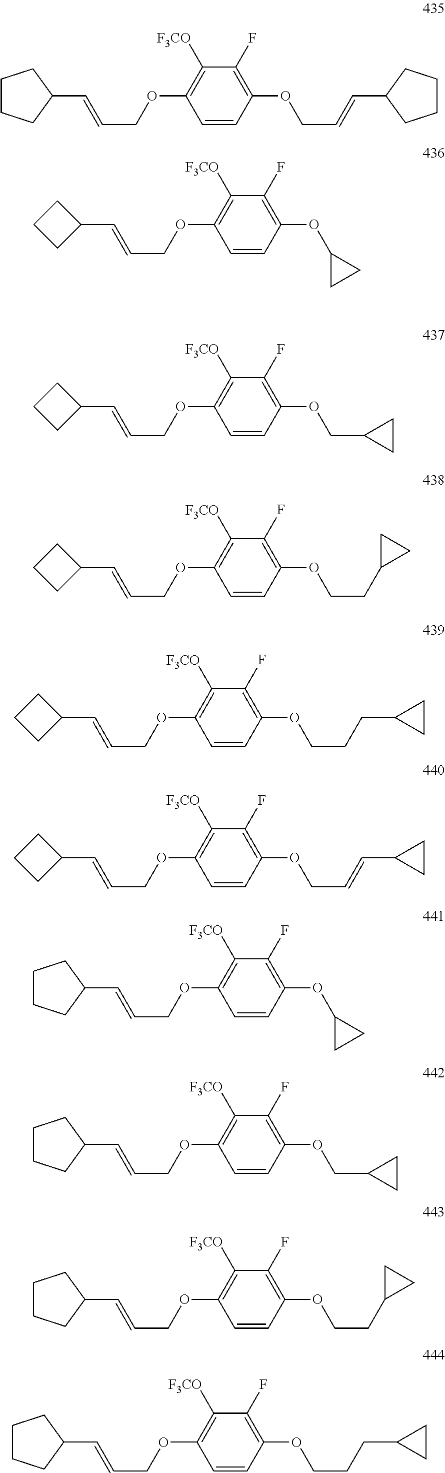

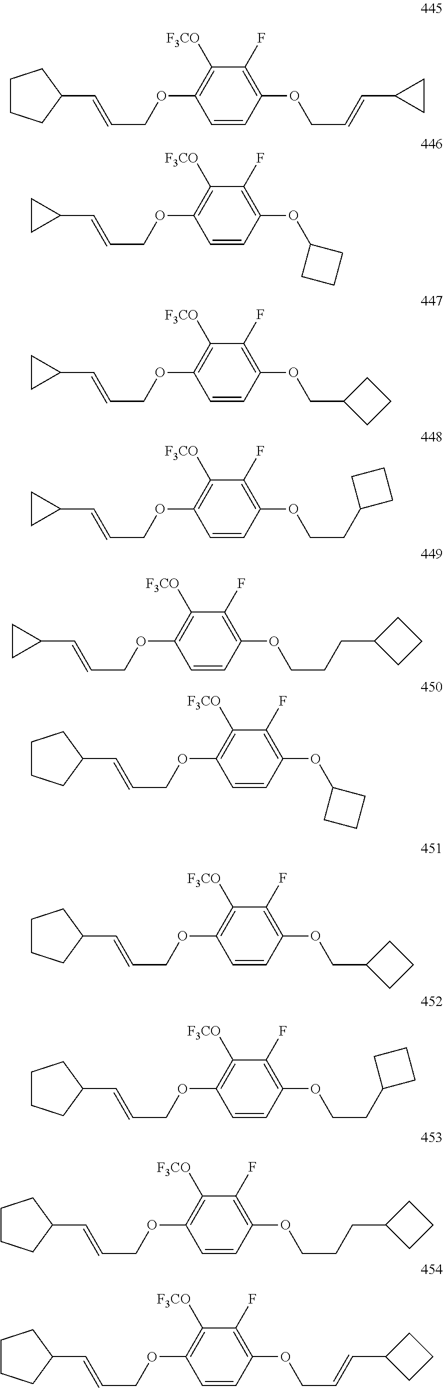

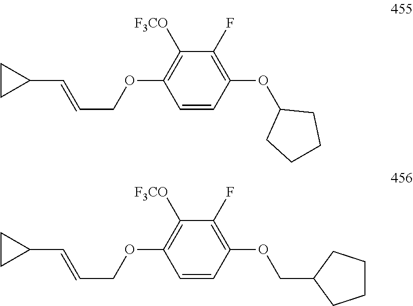 [SMILES: Fc1c(OC2CCCC2)ccc(OC/C=C/C2CC2)c1OC(F)(F)F ; Fc1c(OCC2CCCC2)ccc(OC/C=C/C2CC2)c1OC(F)(F)F]

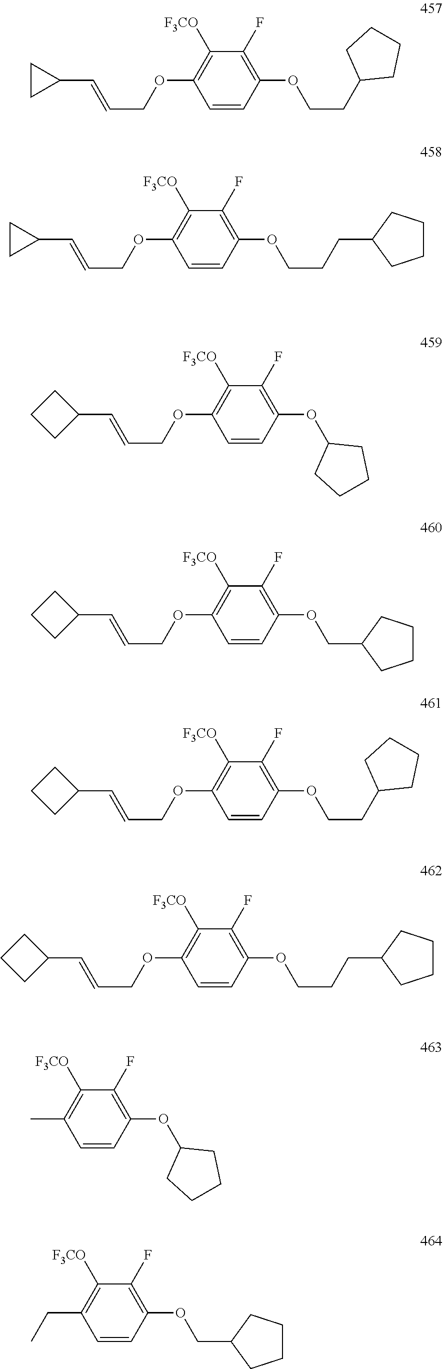

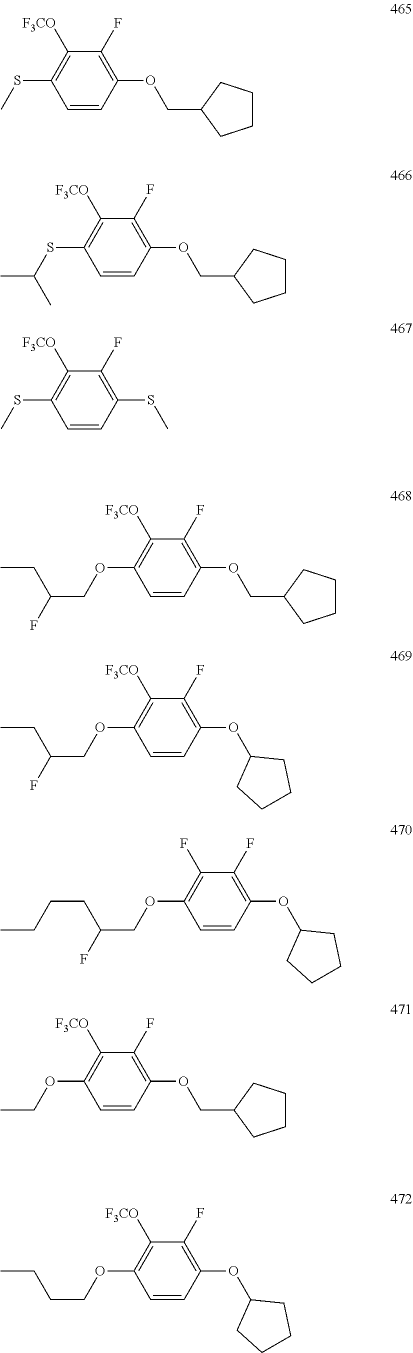

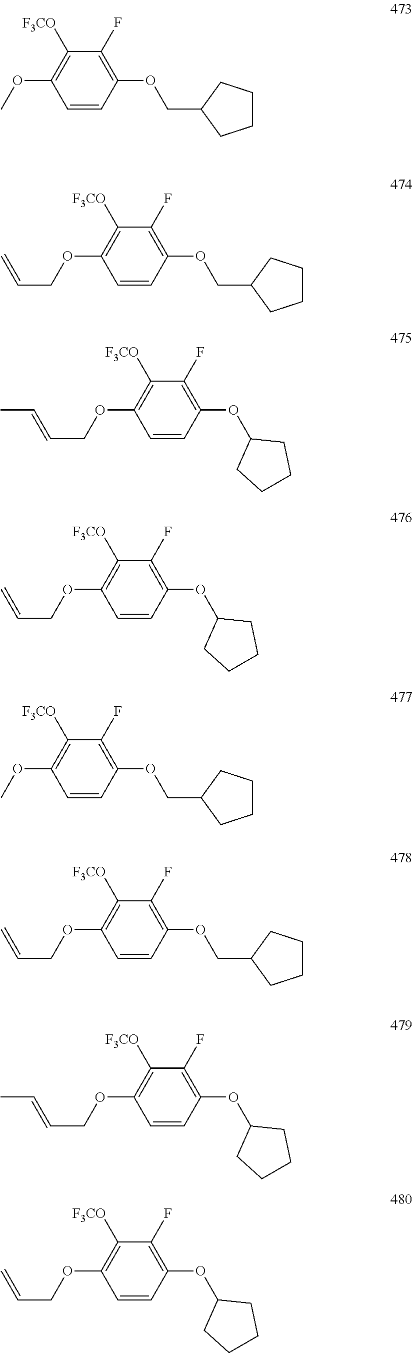

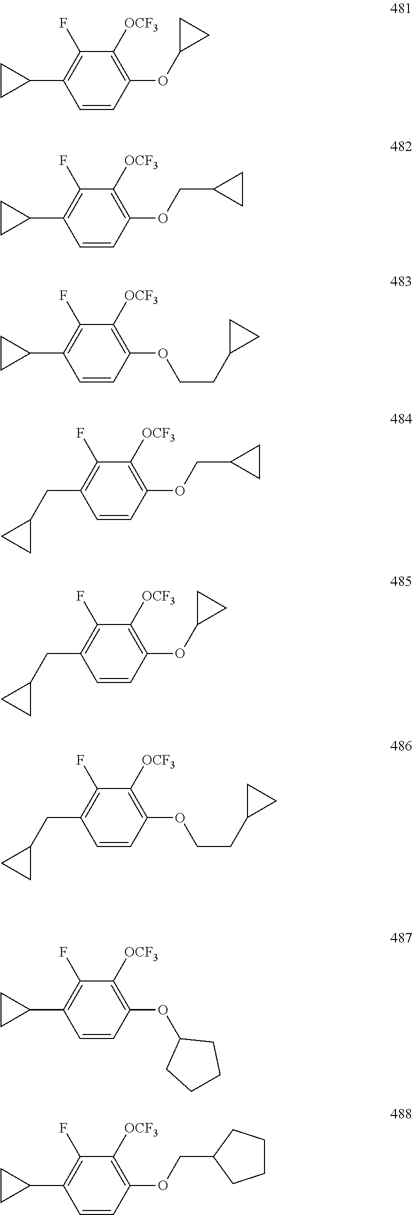

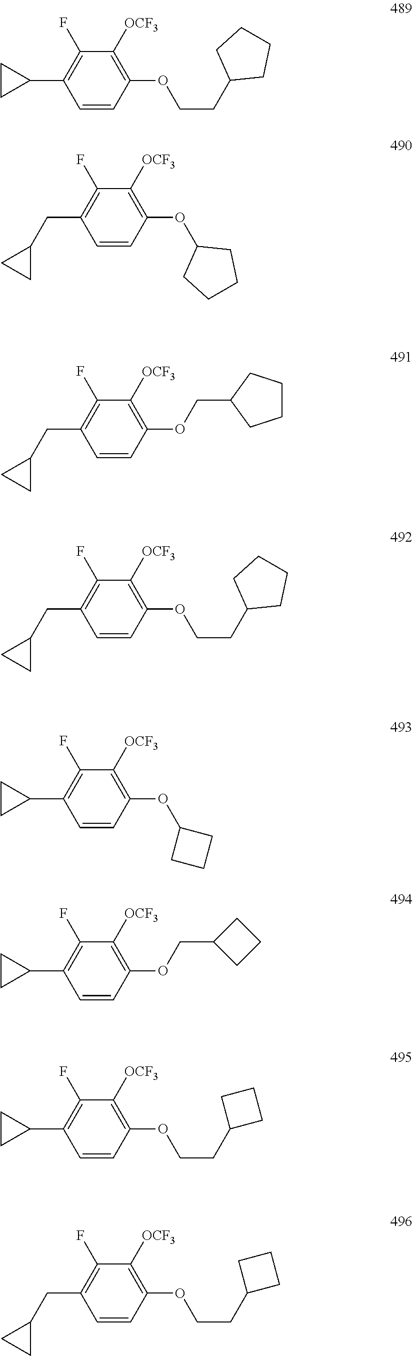

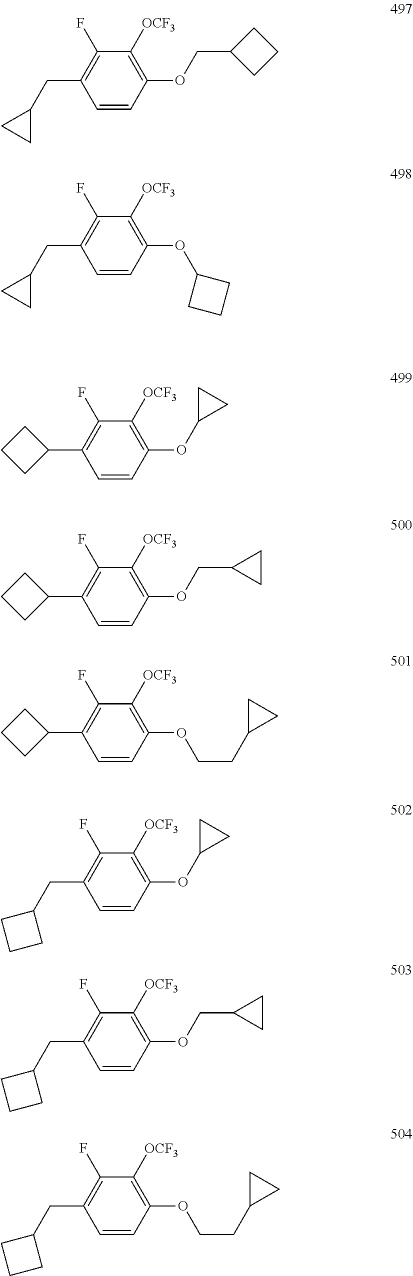

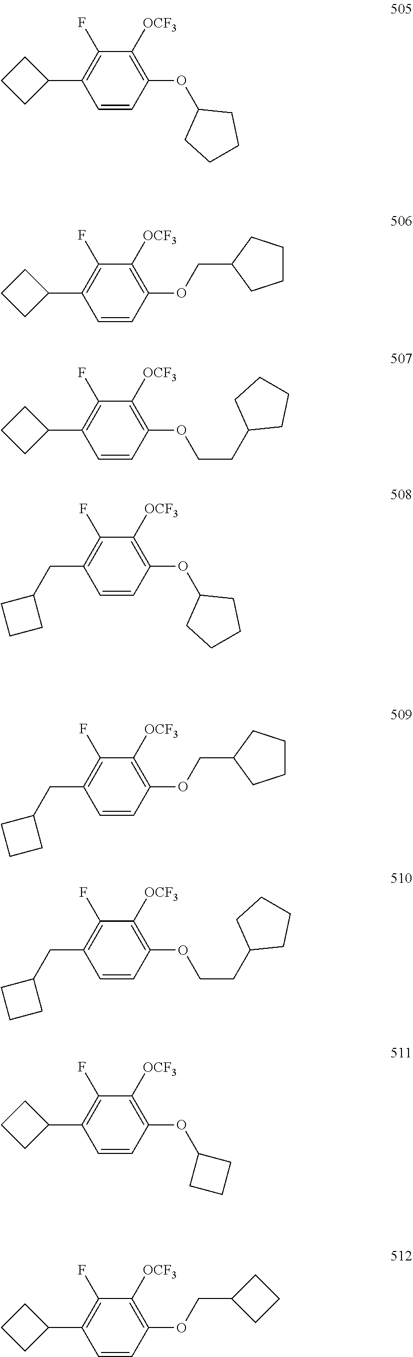

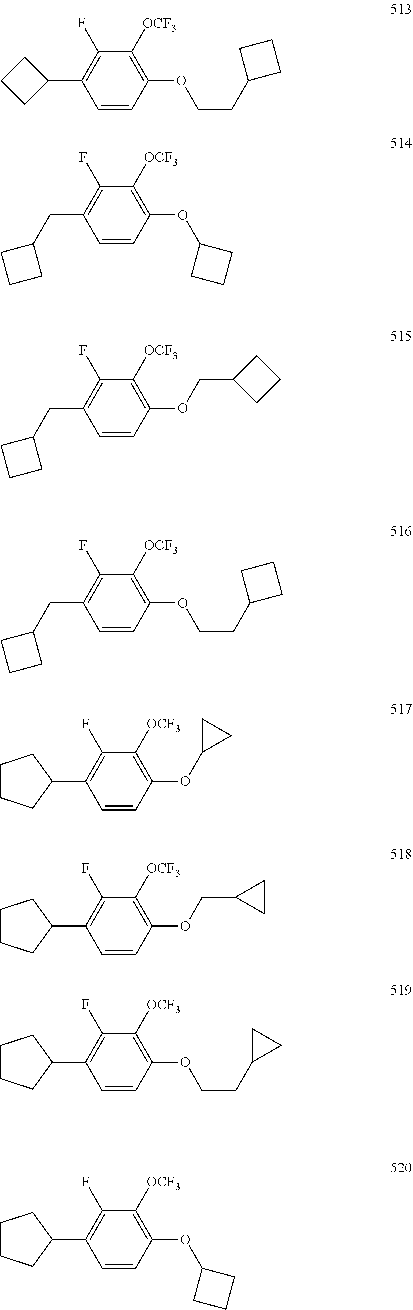

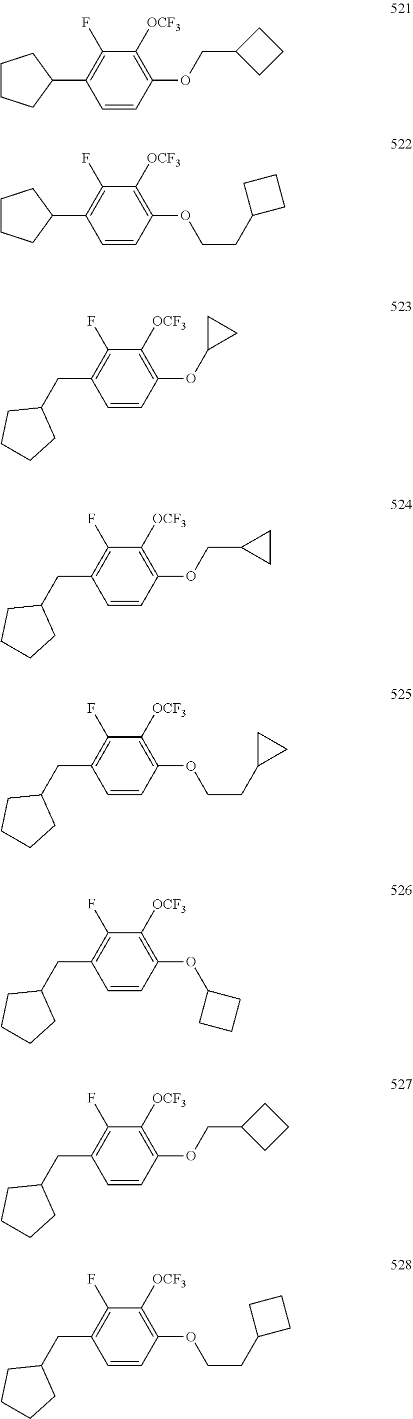

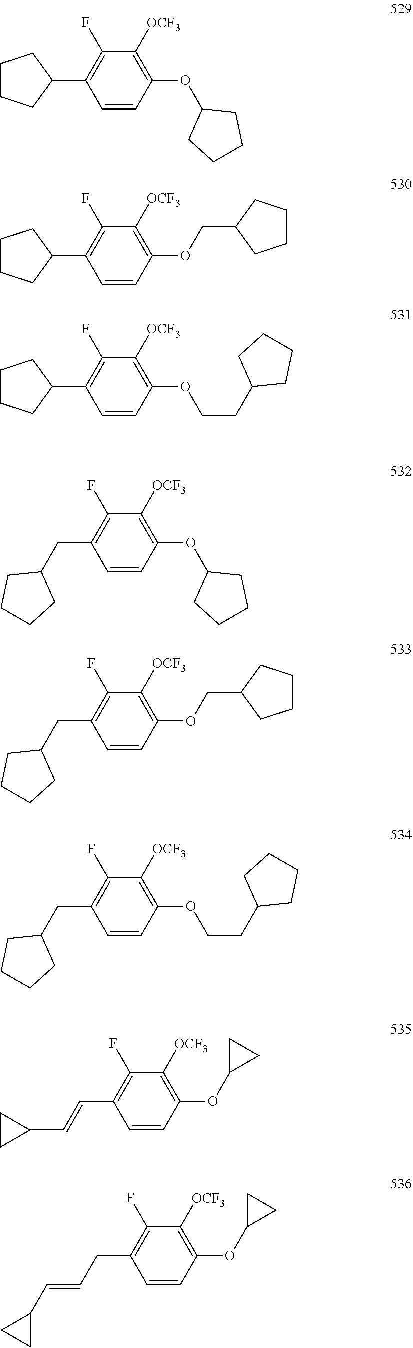

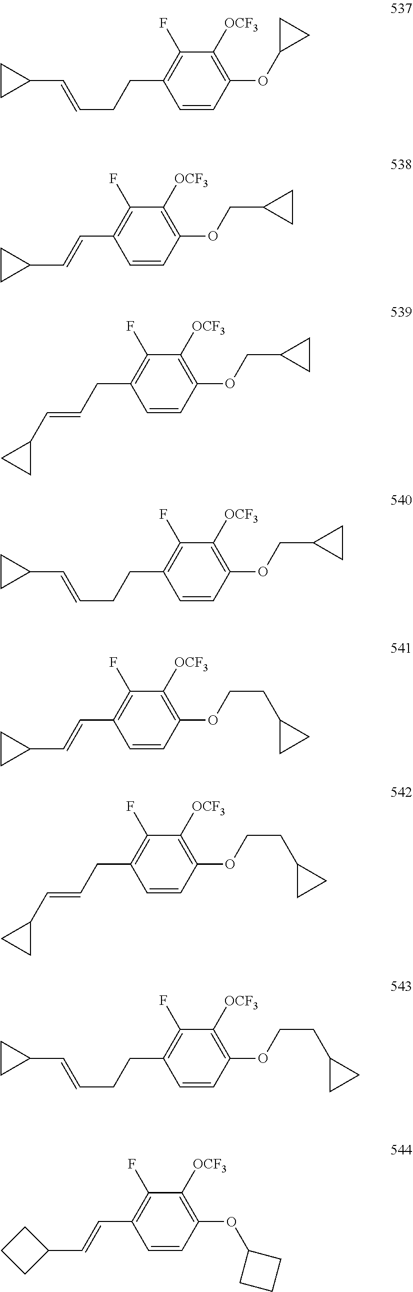

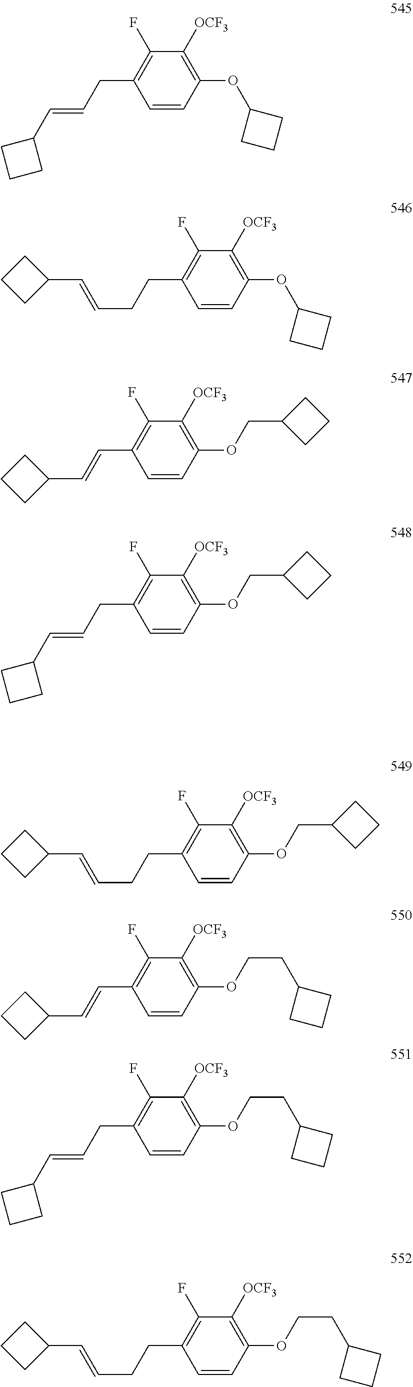

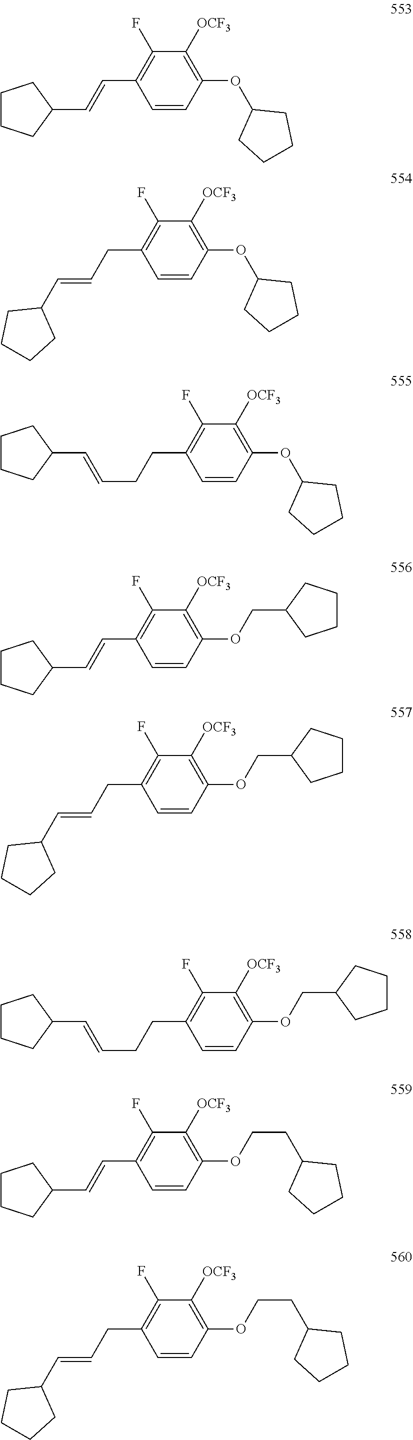

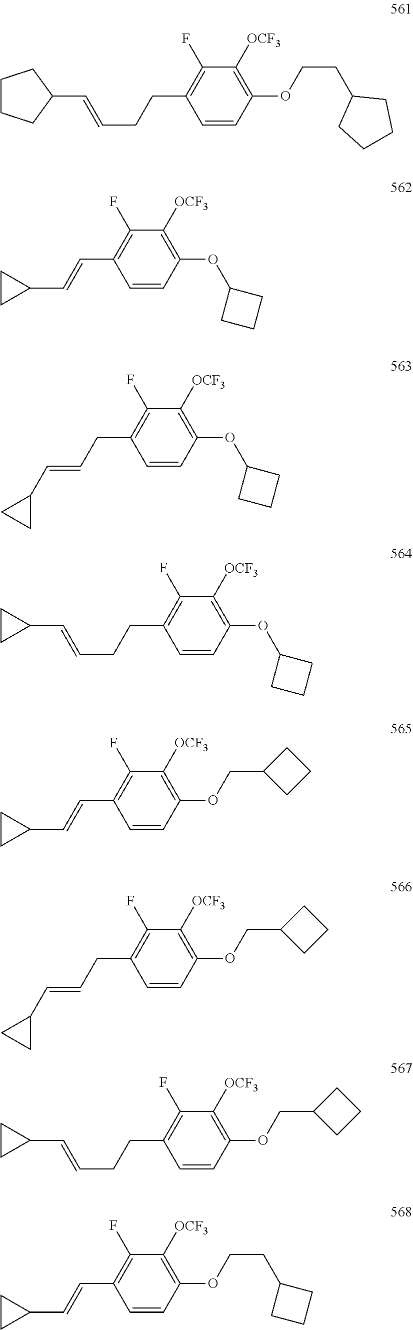

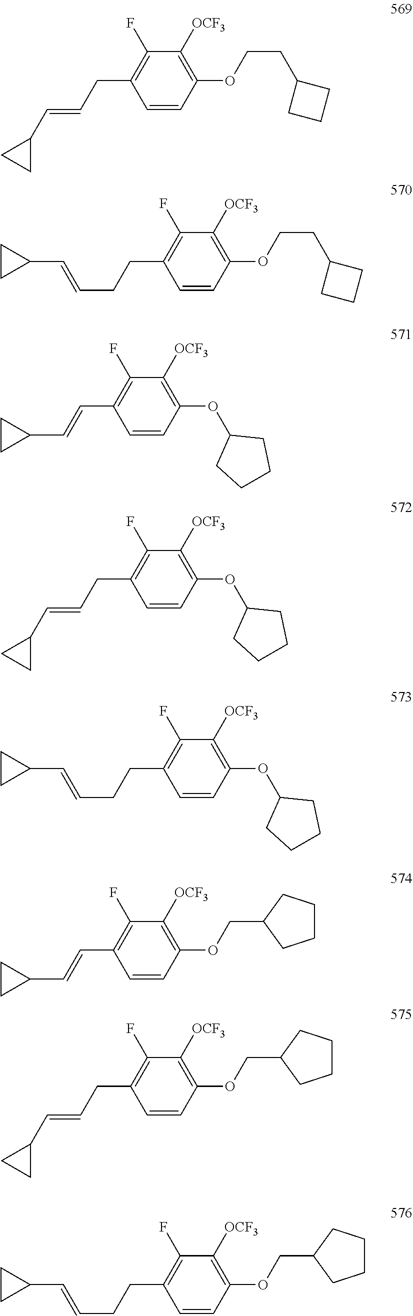

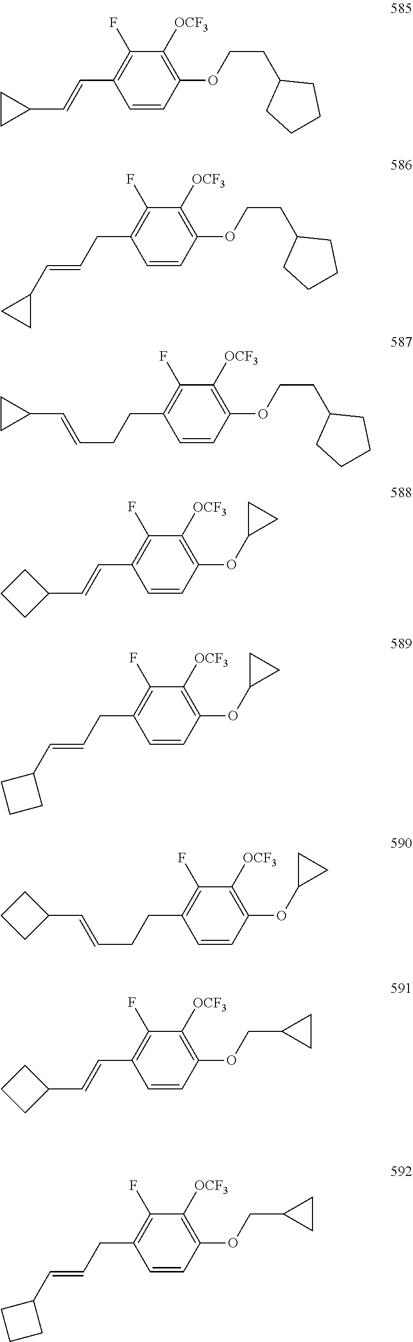

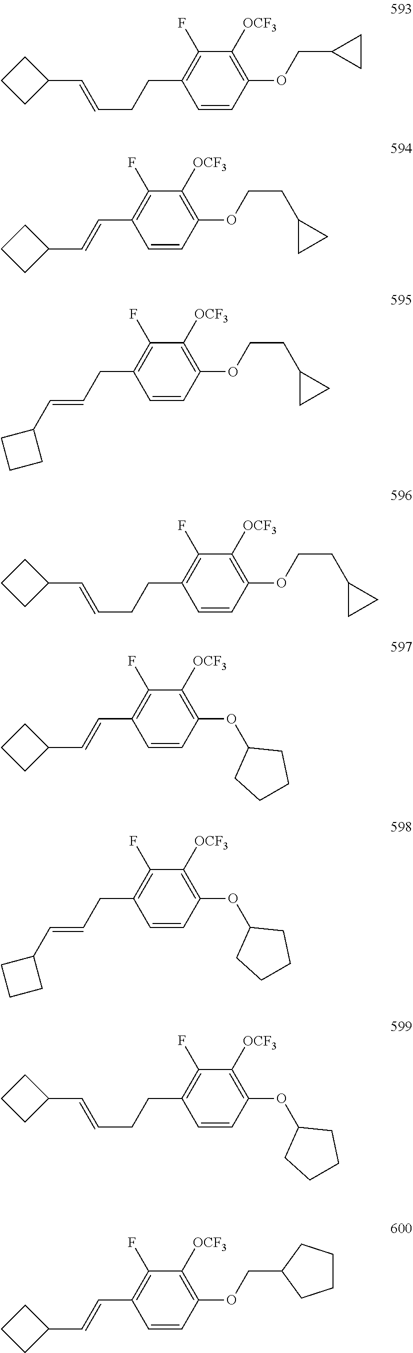

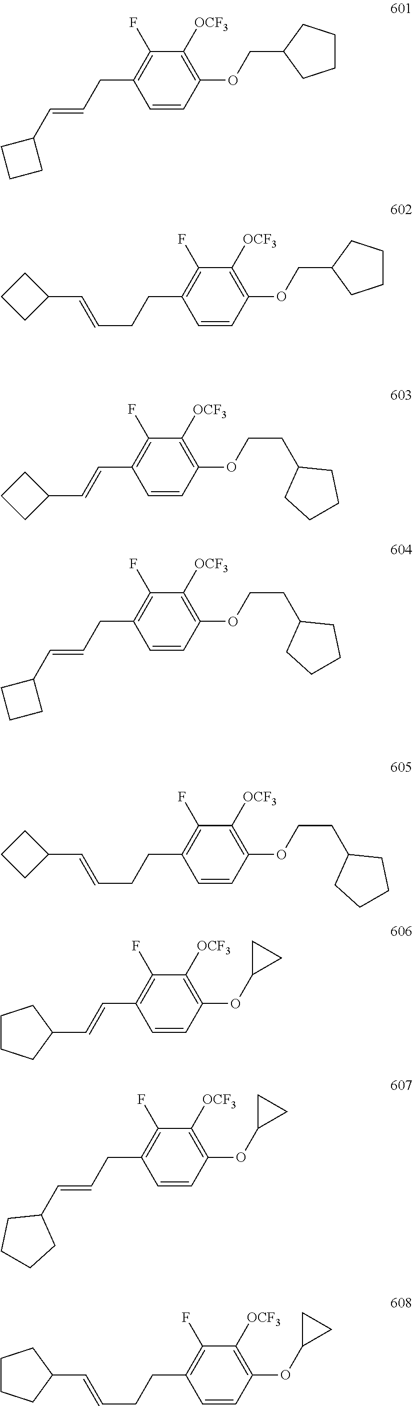

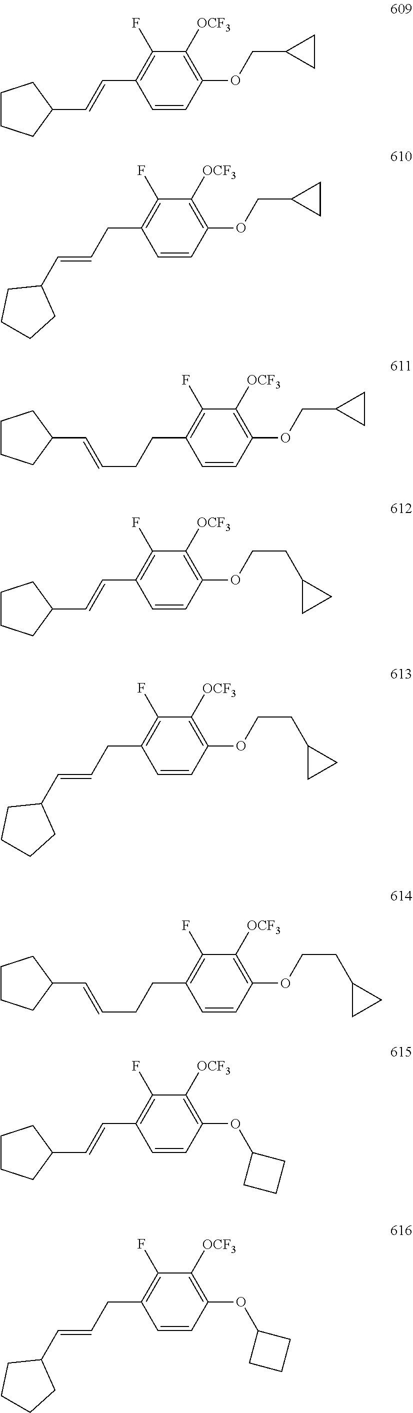

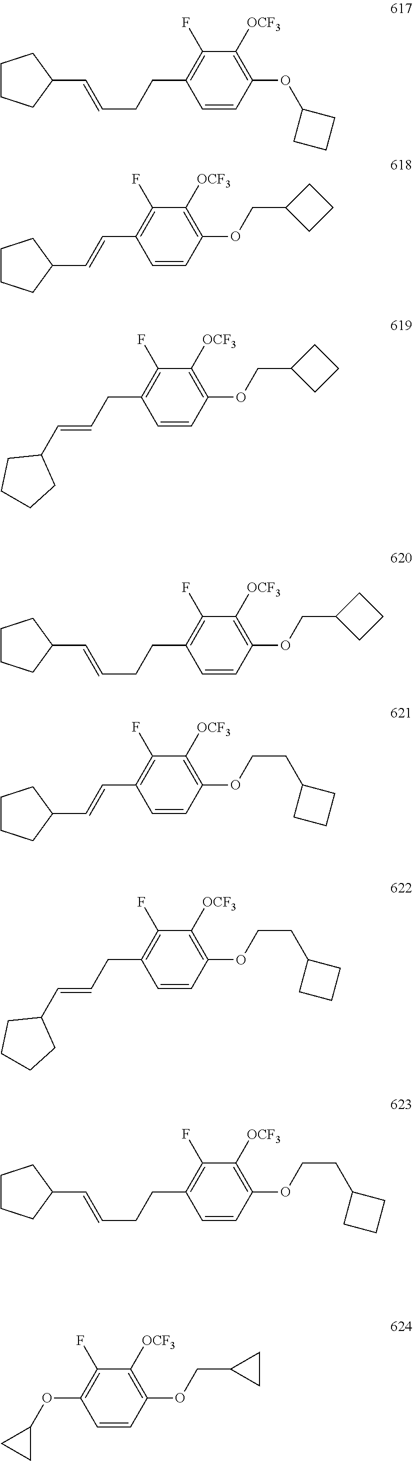

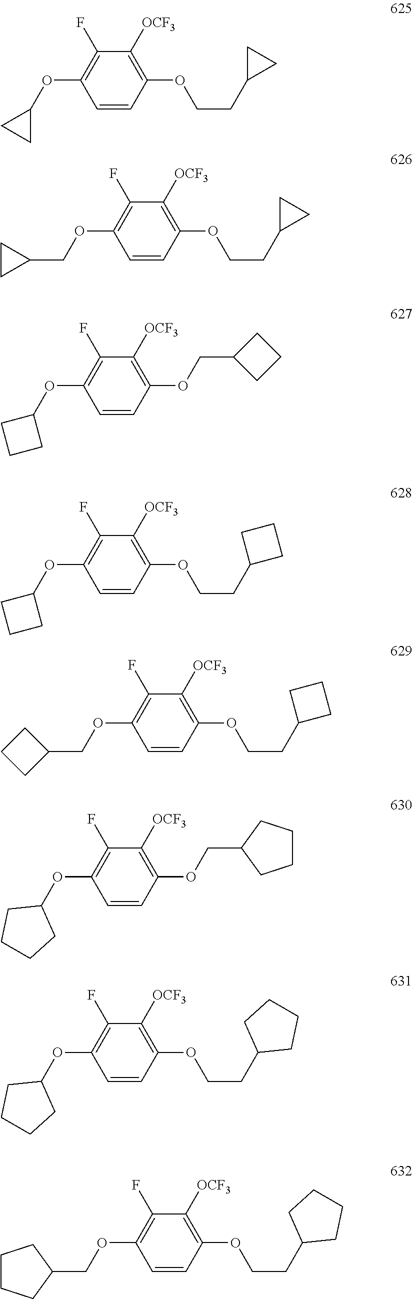

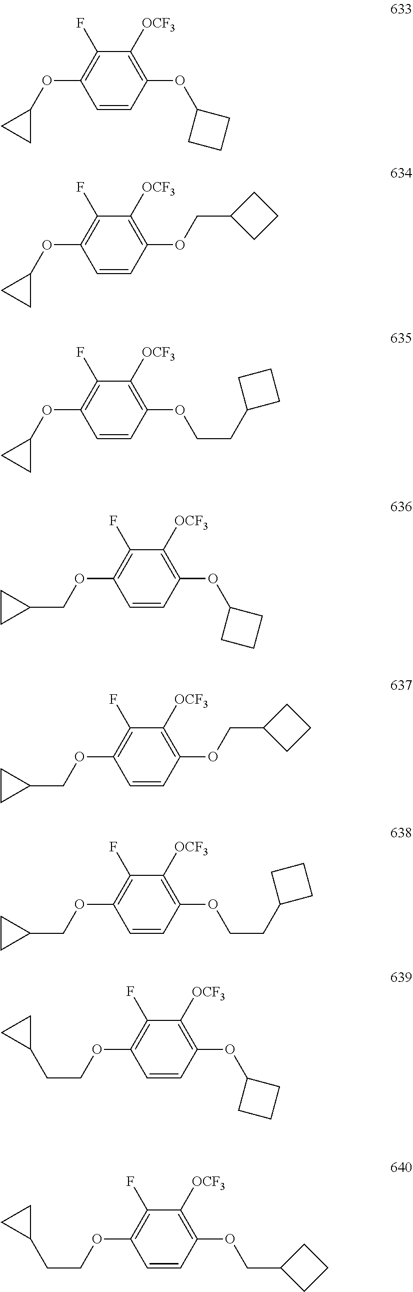

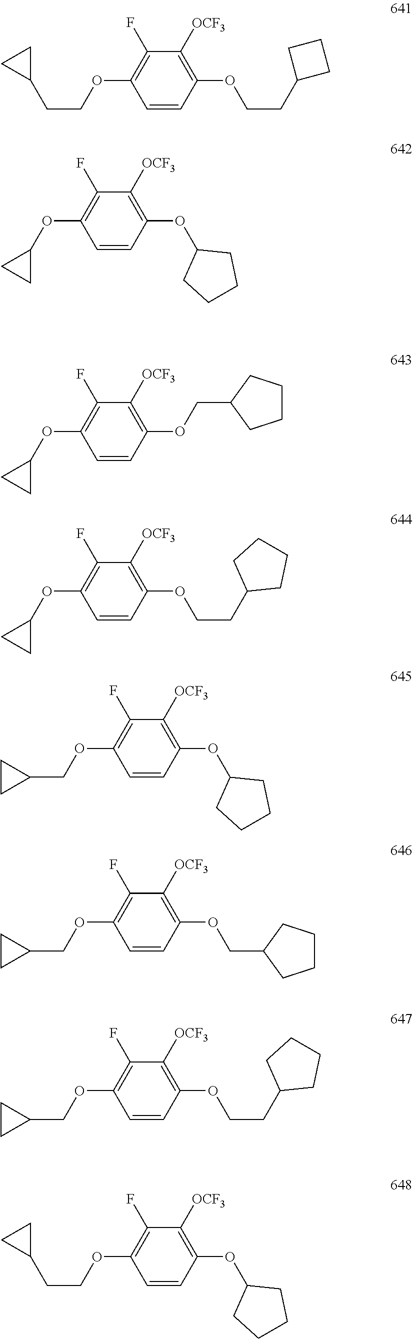

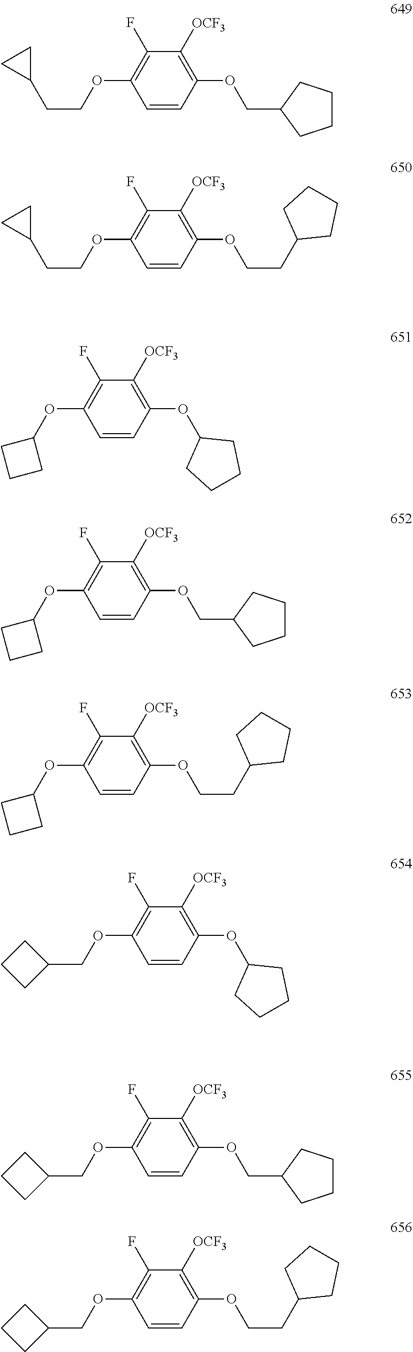

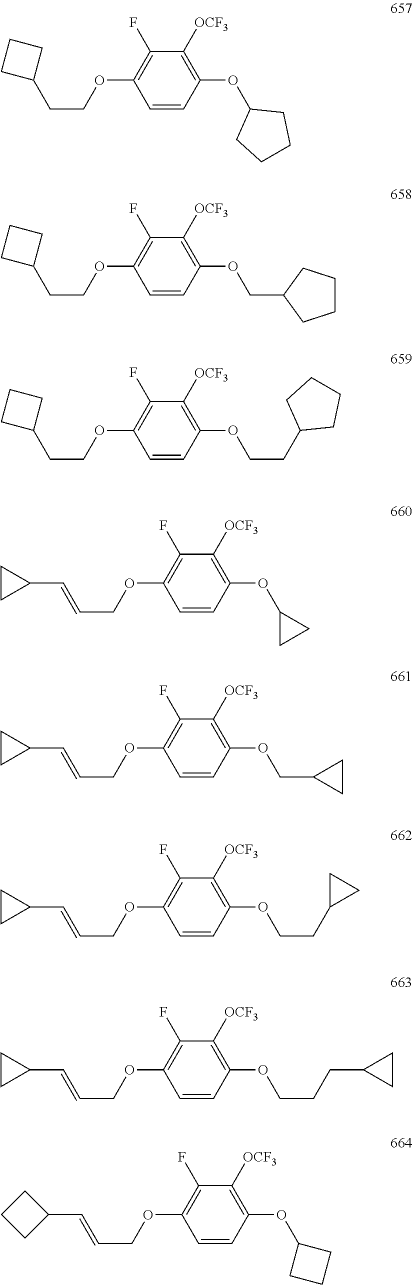

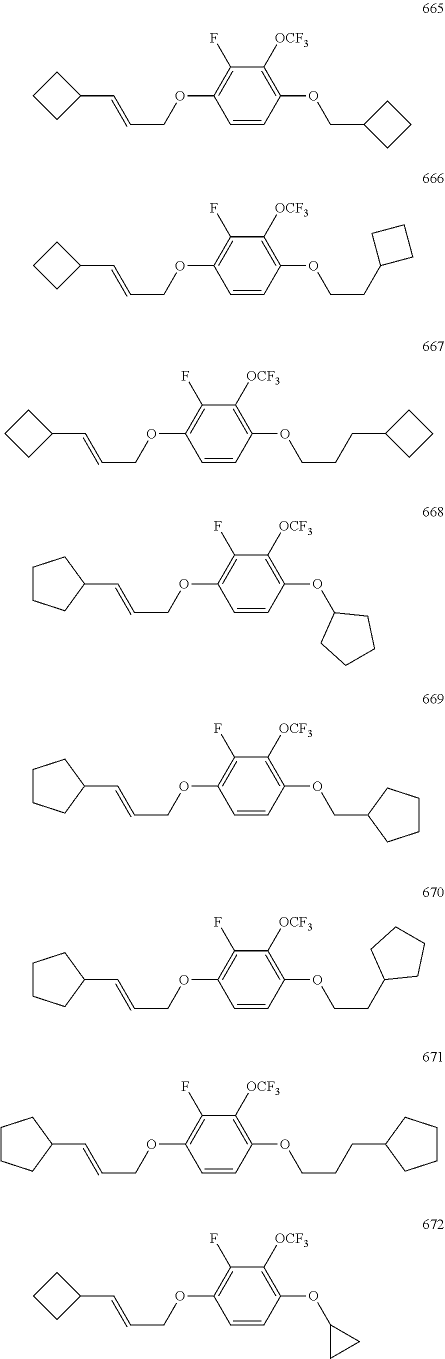

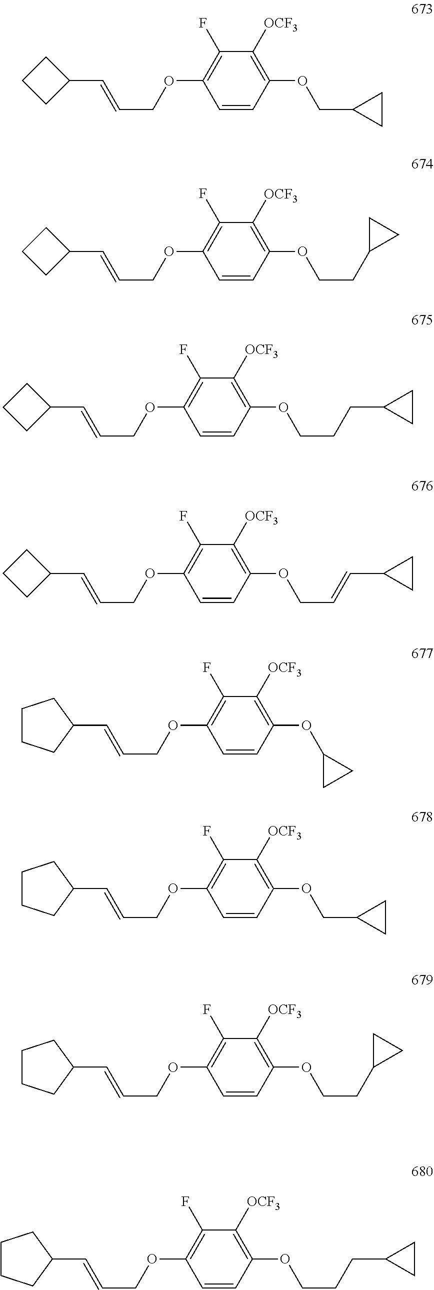

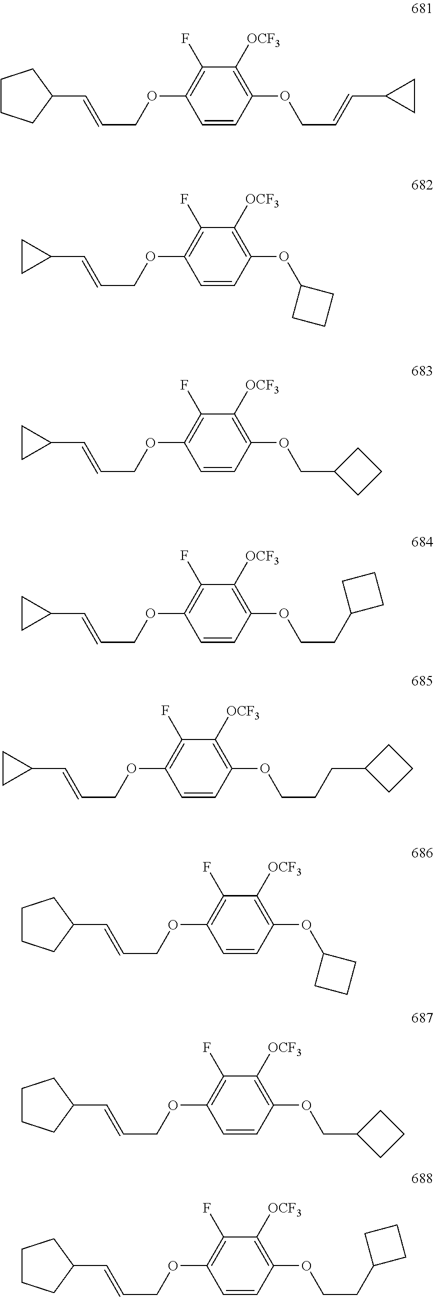

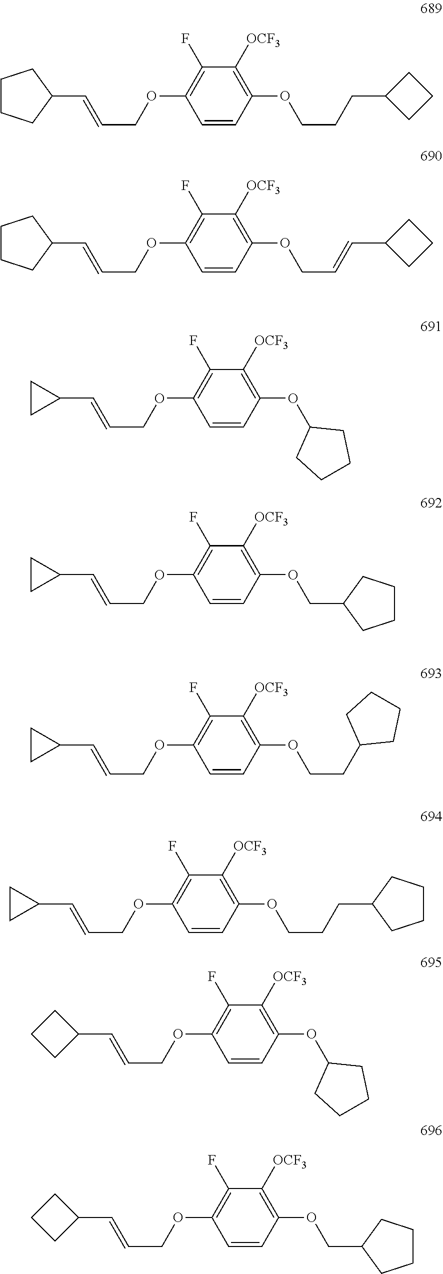

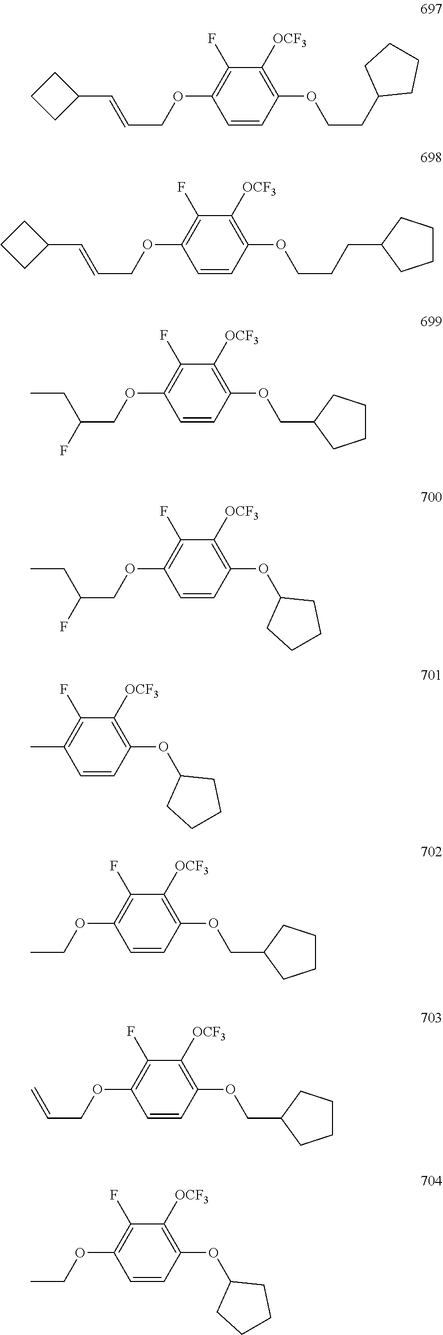

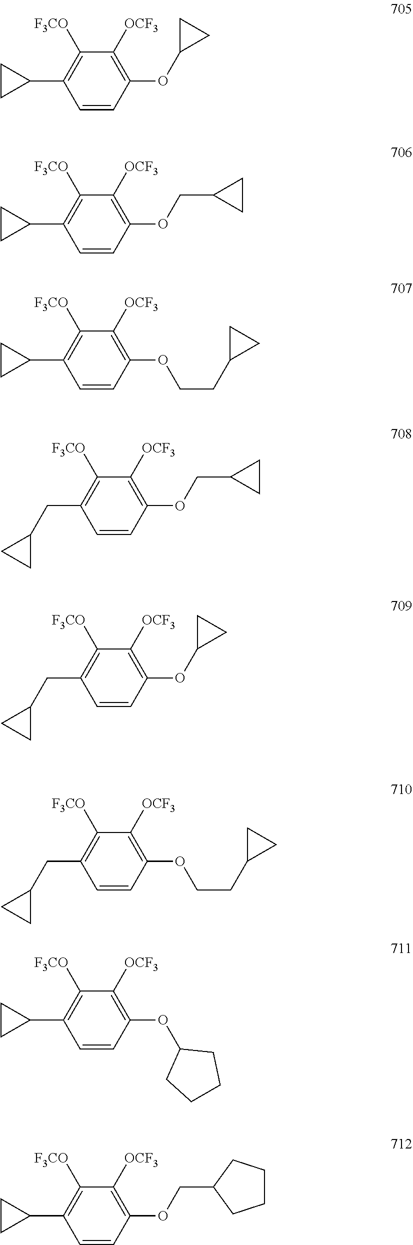

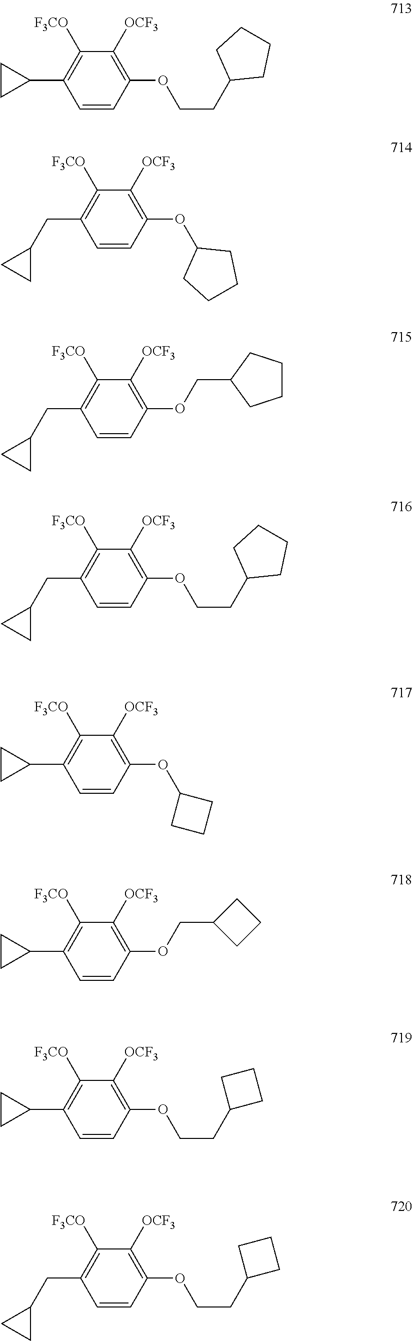

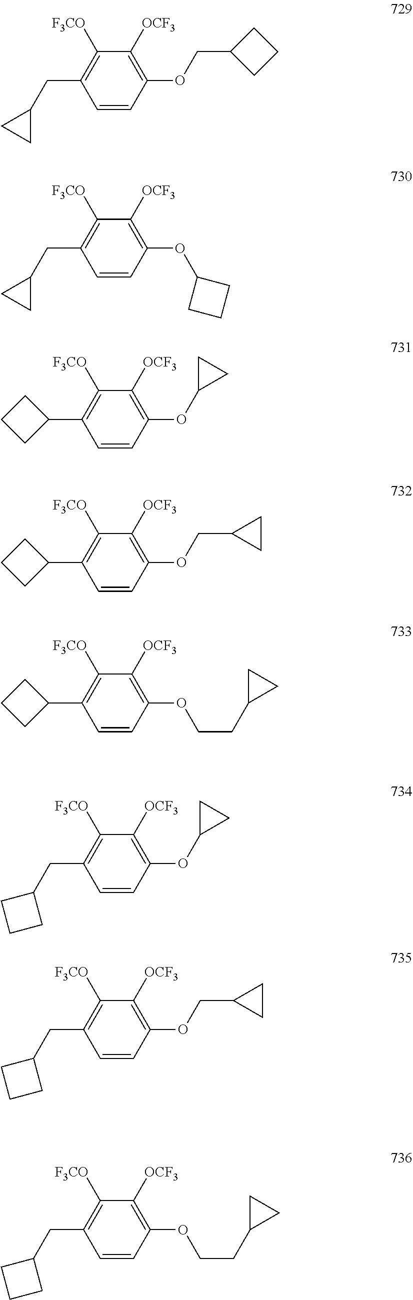

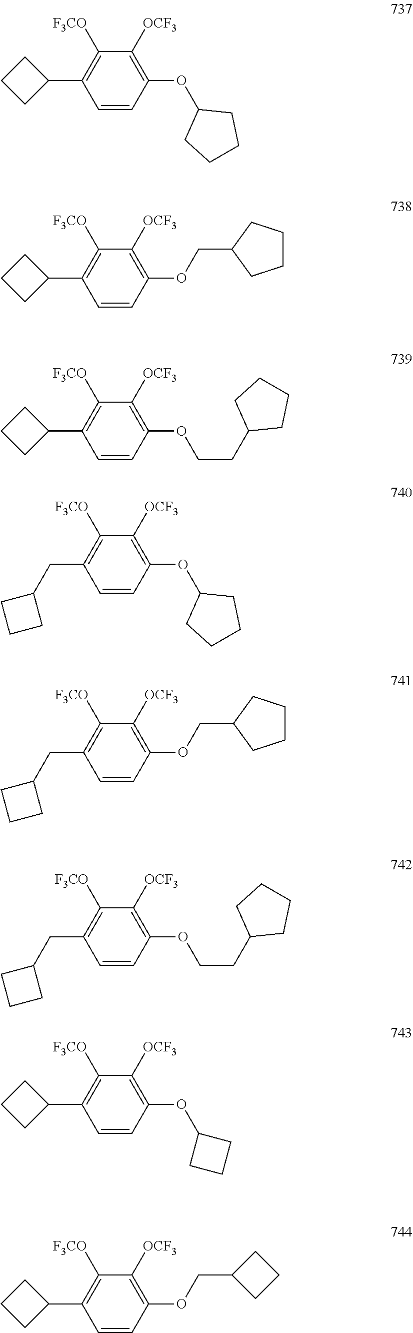

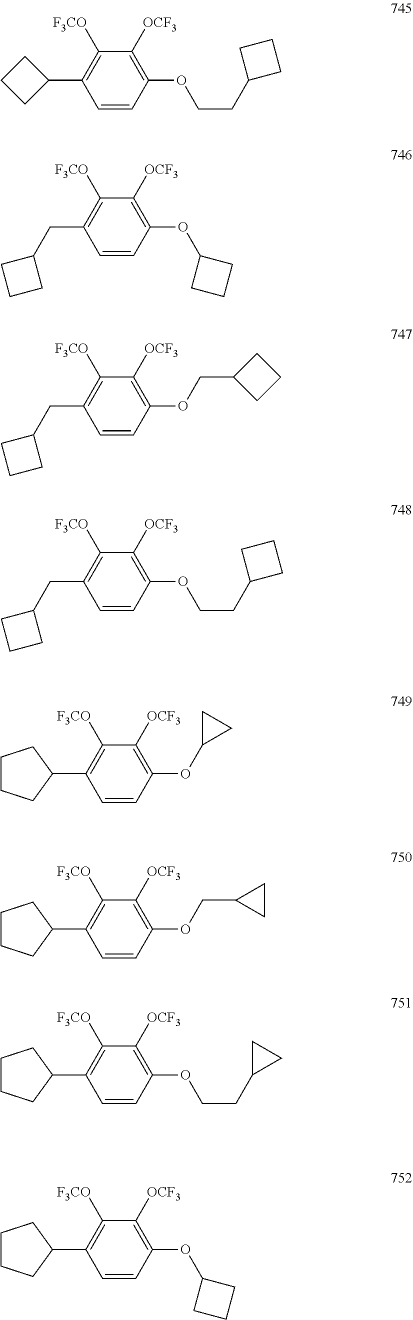

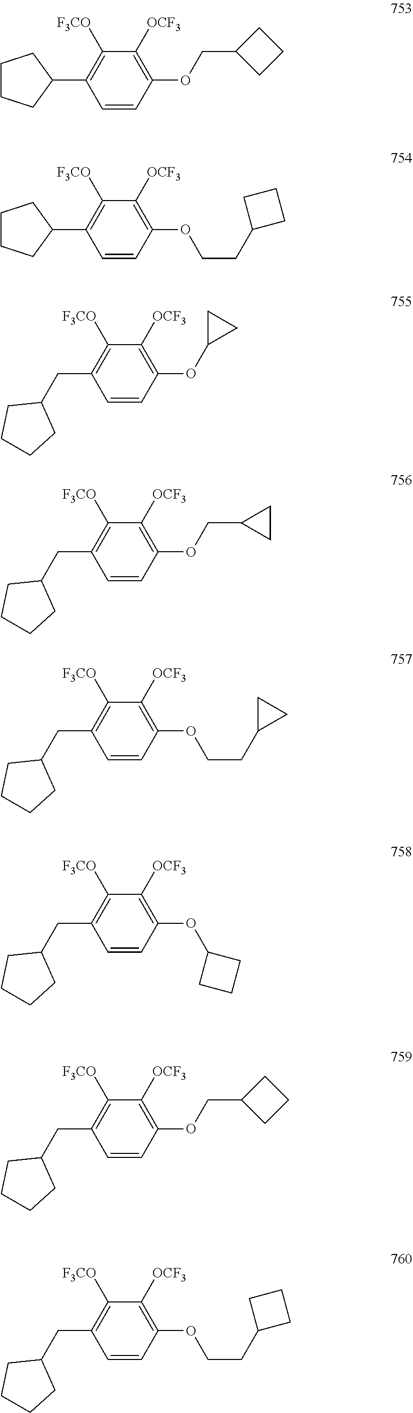

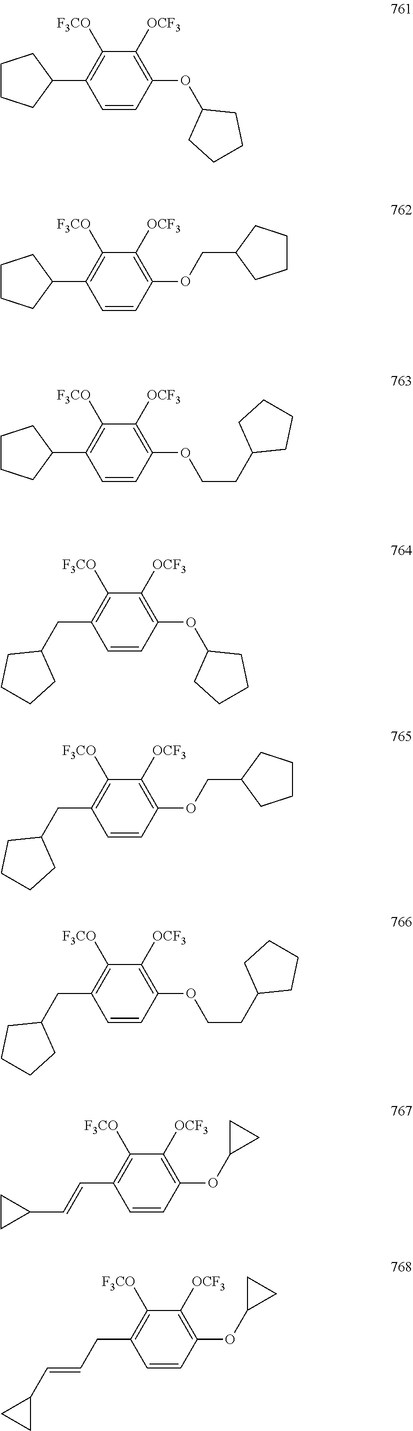

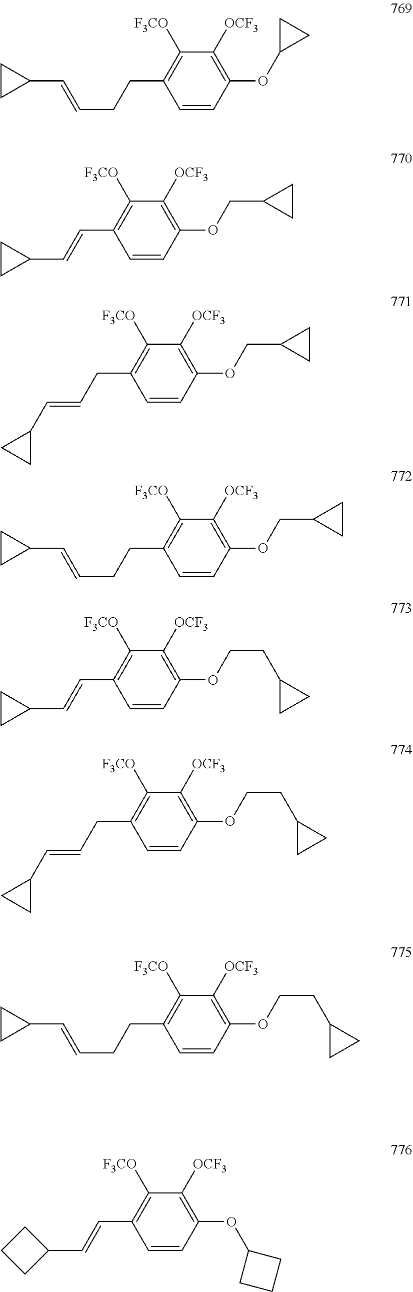

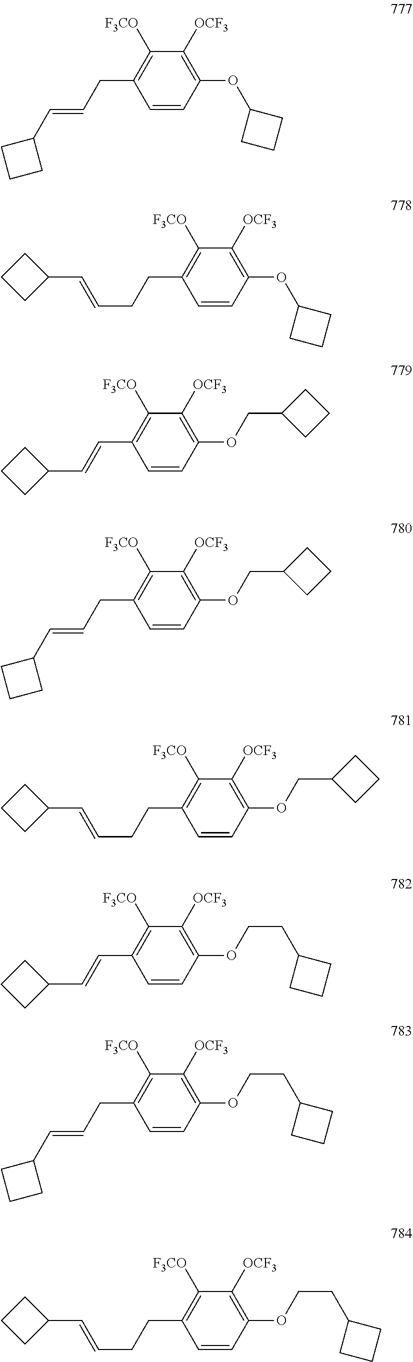

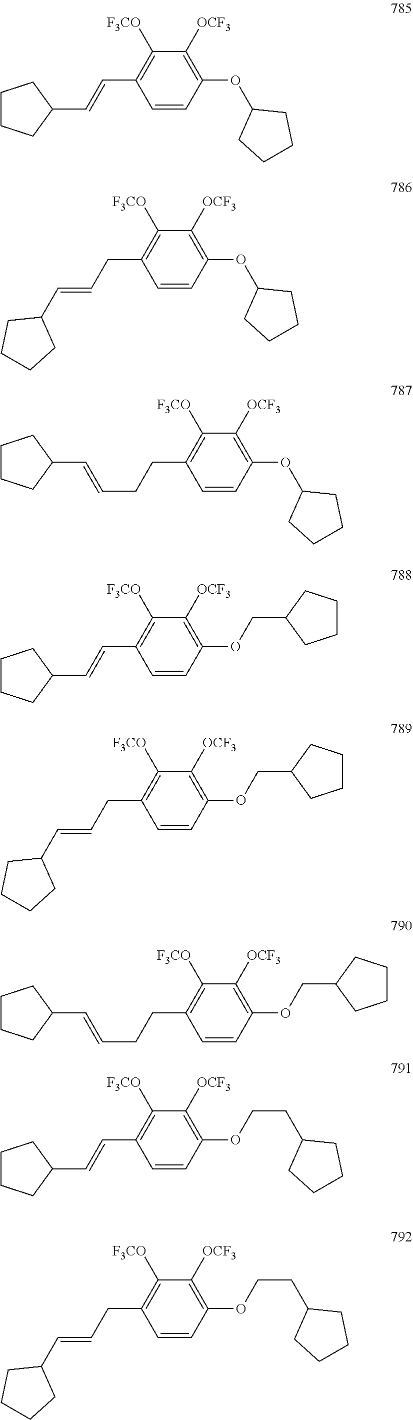

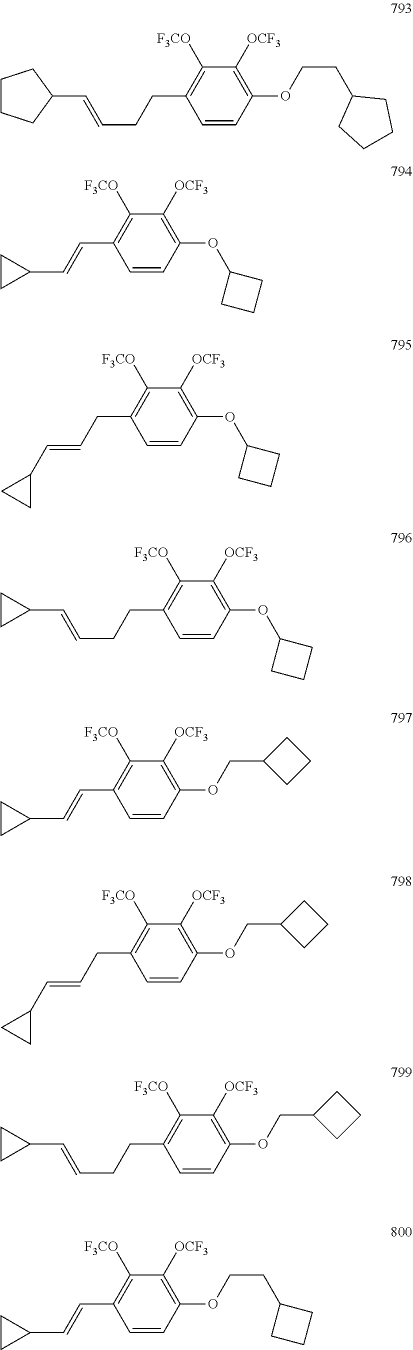

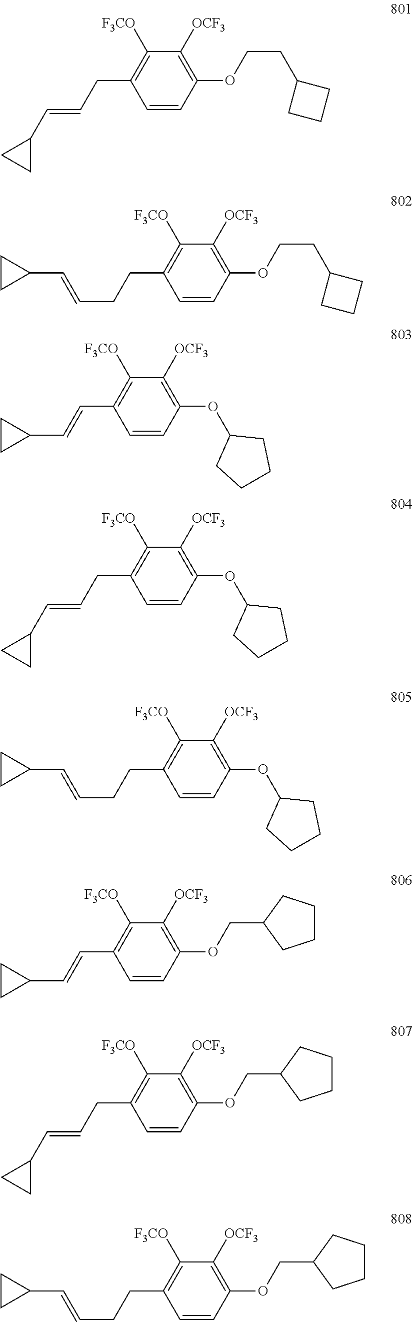

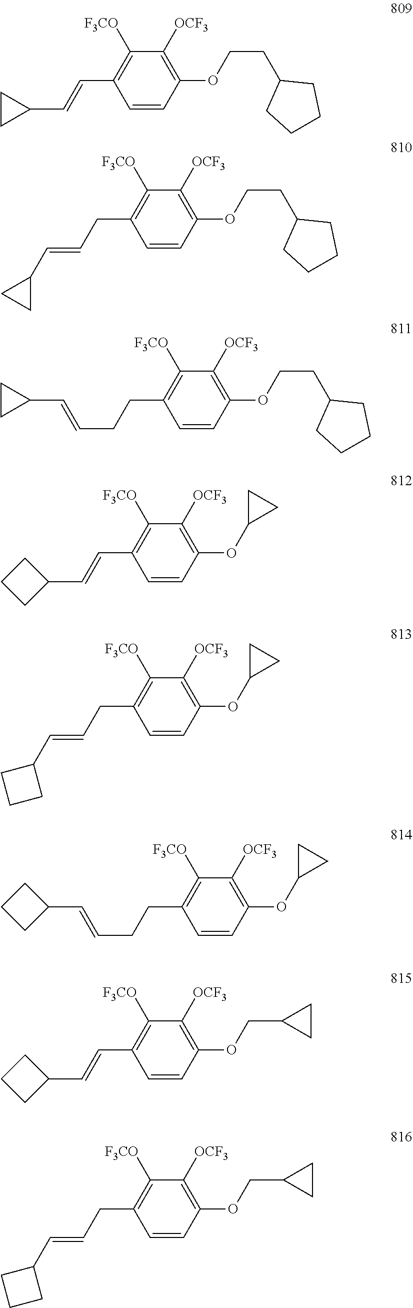

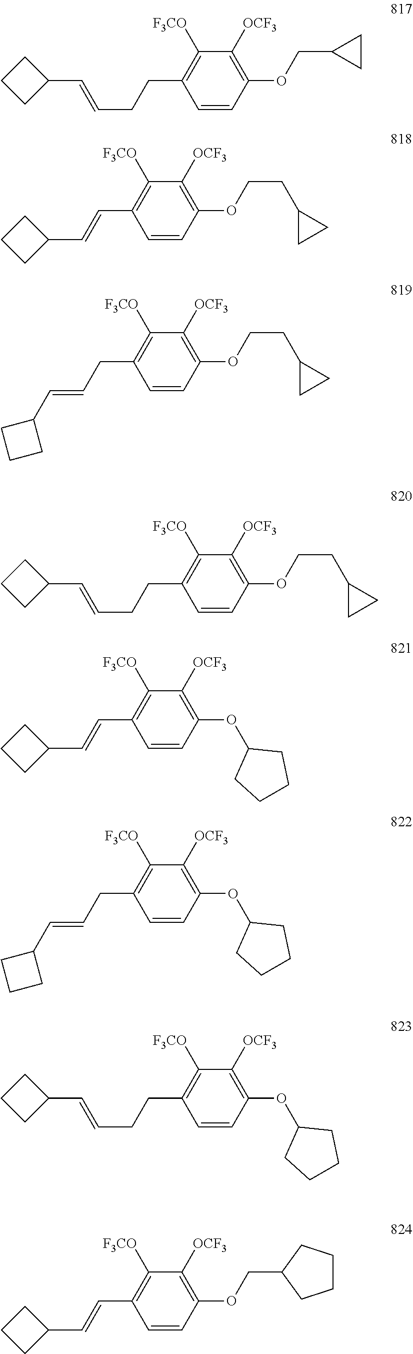

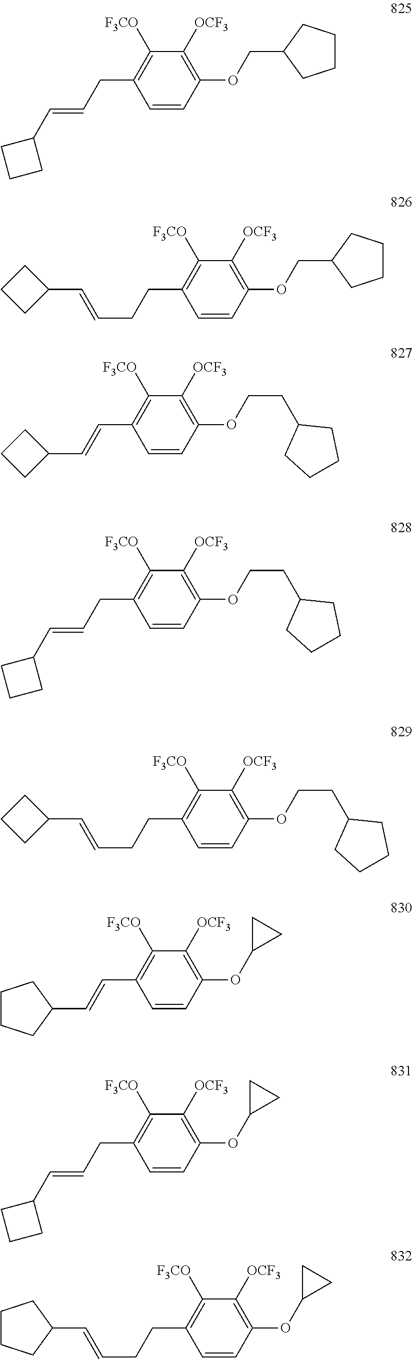

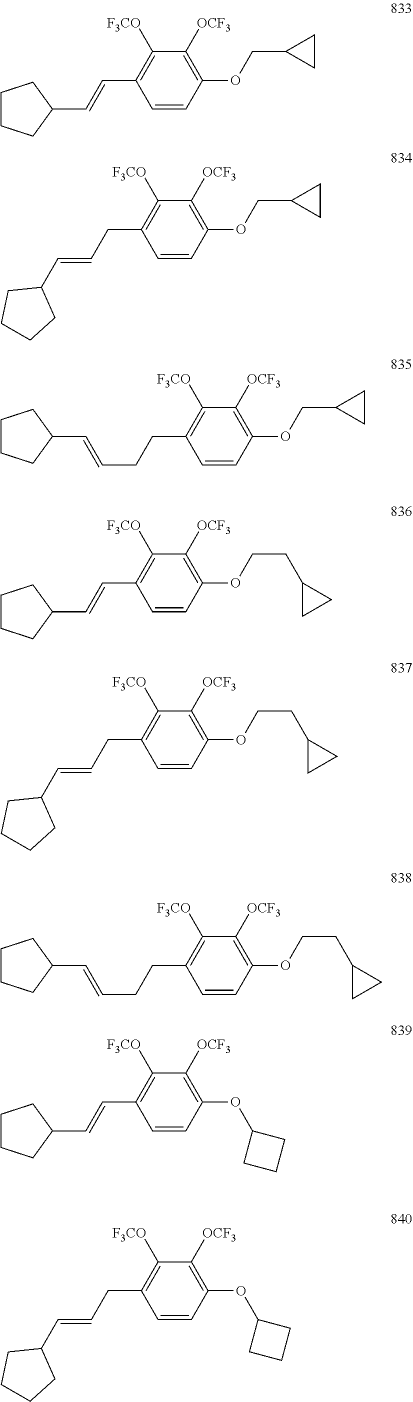

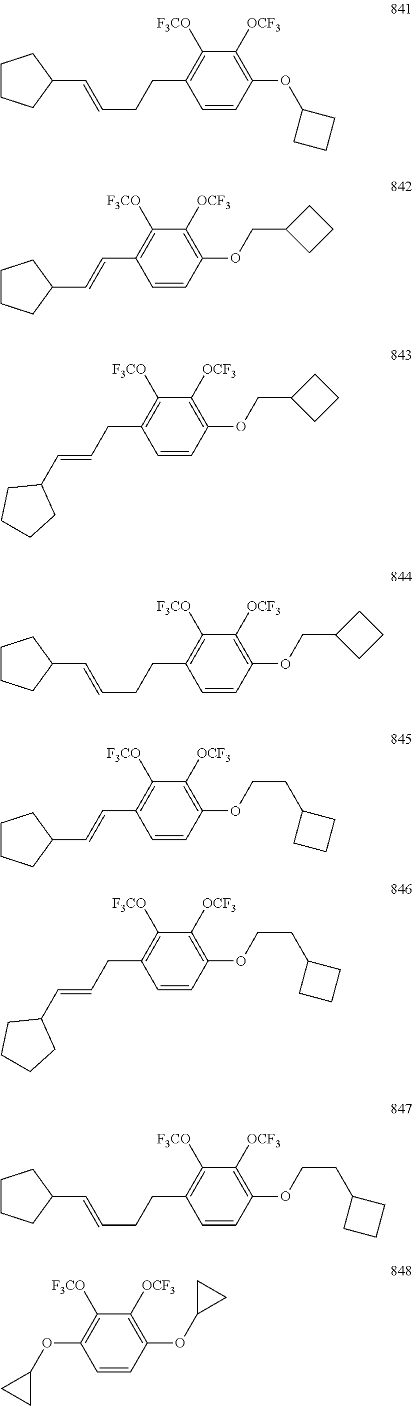

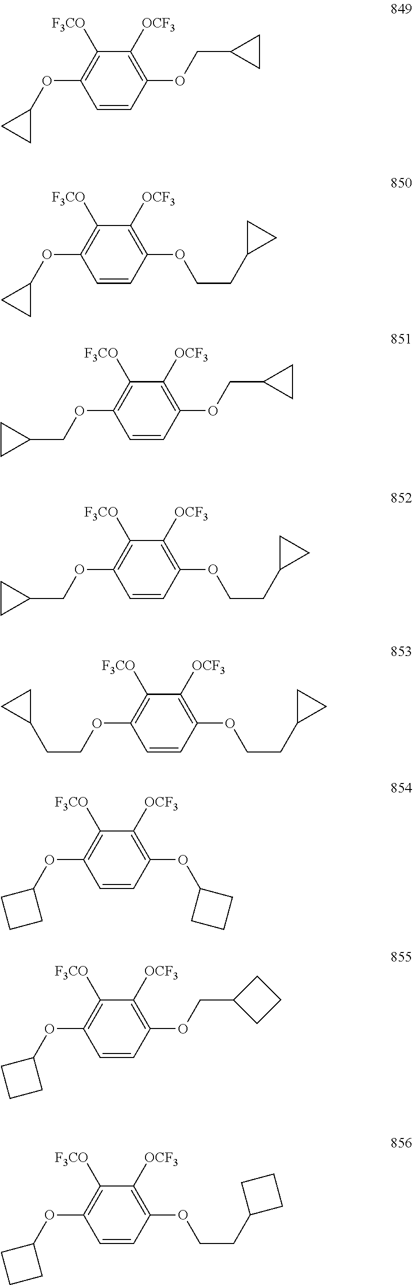

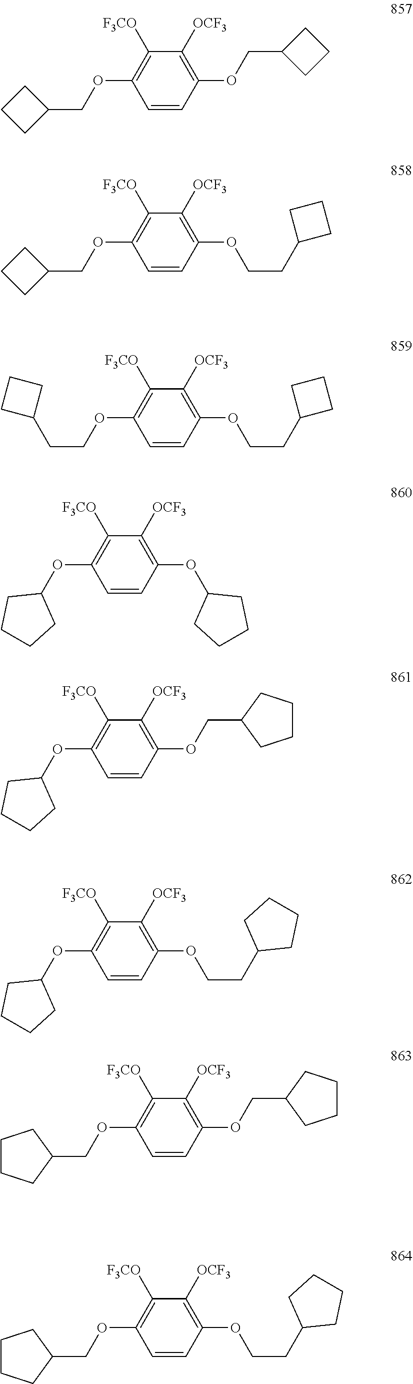

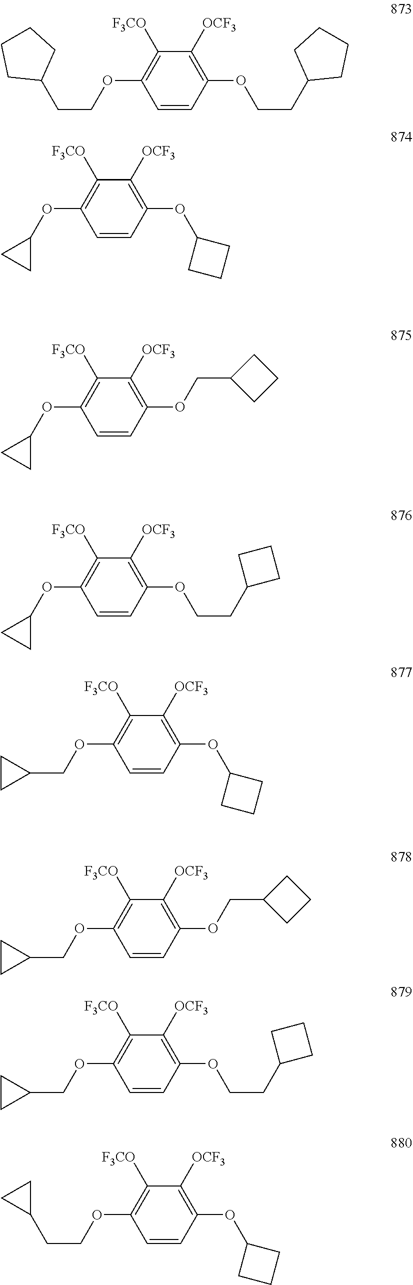

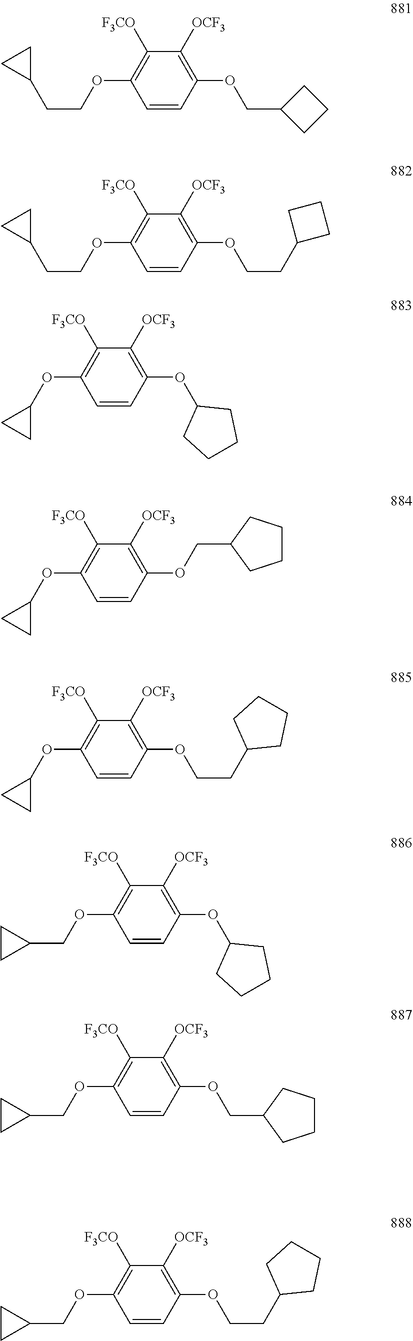

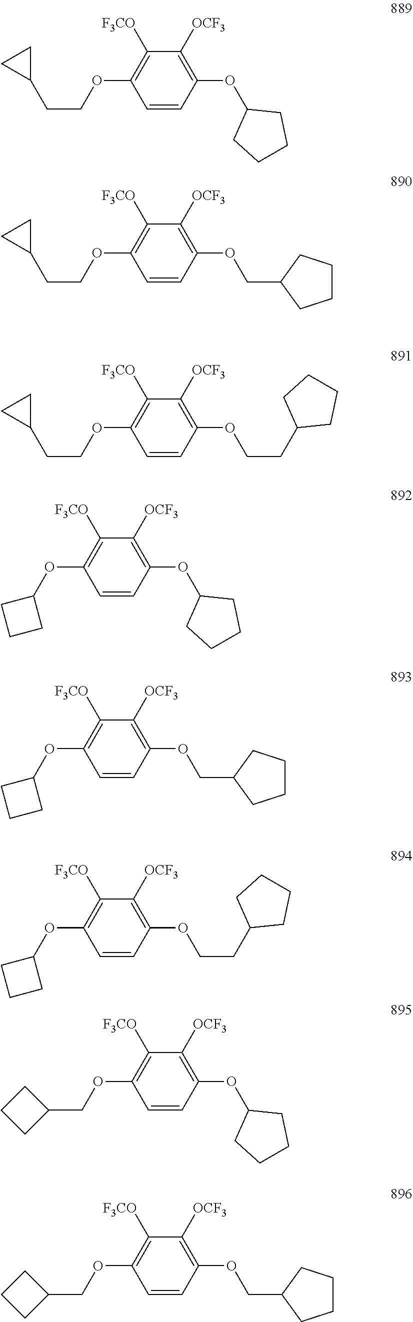

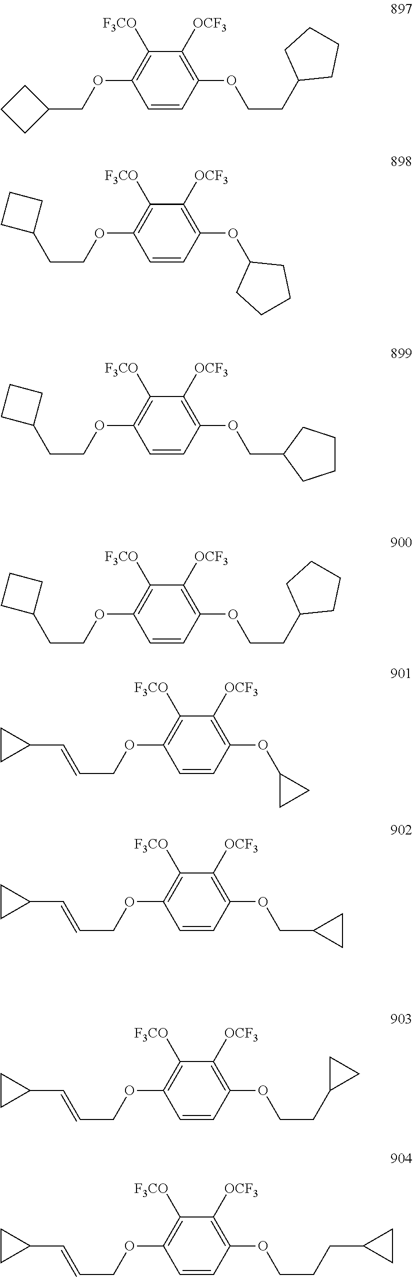

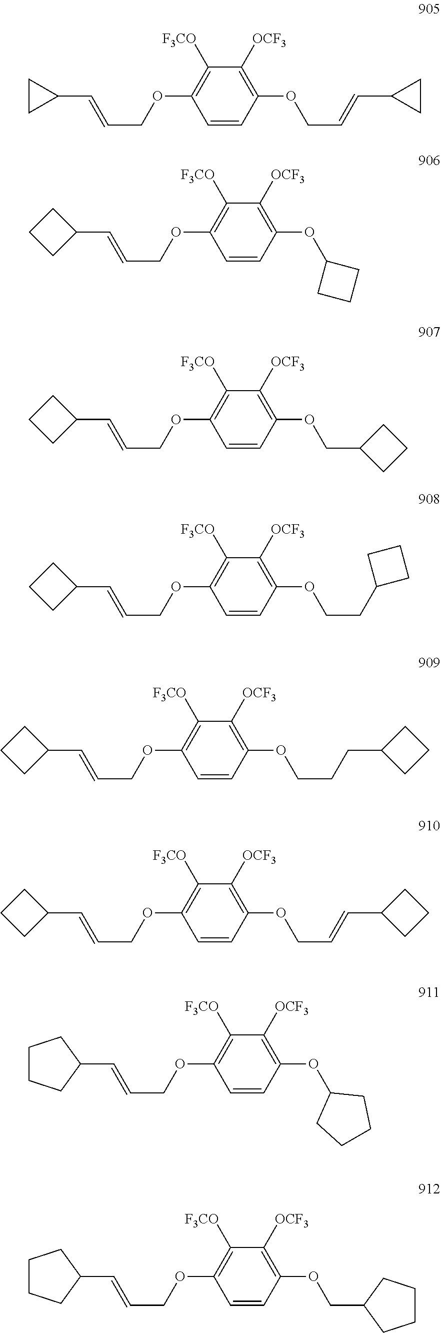

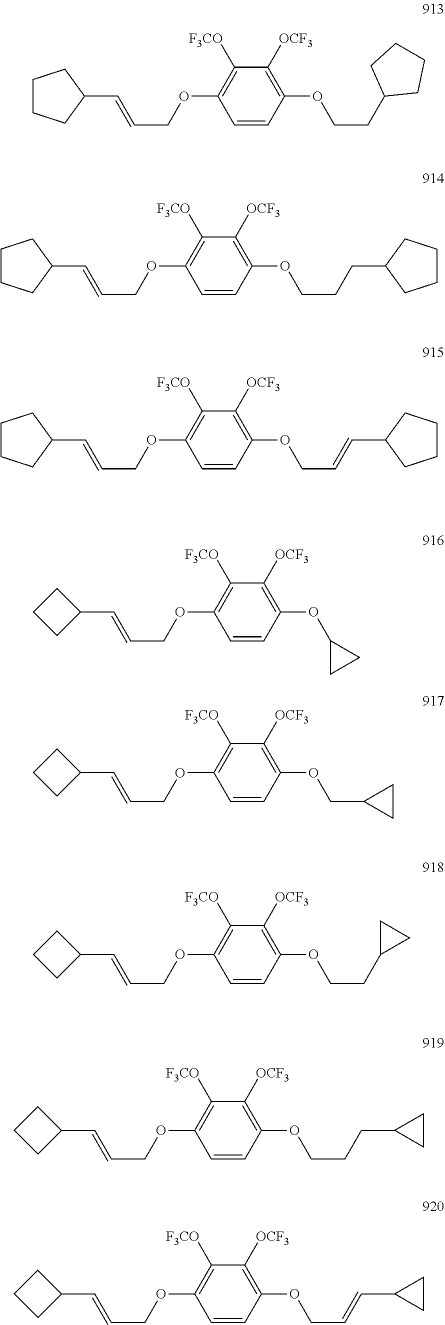

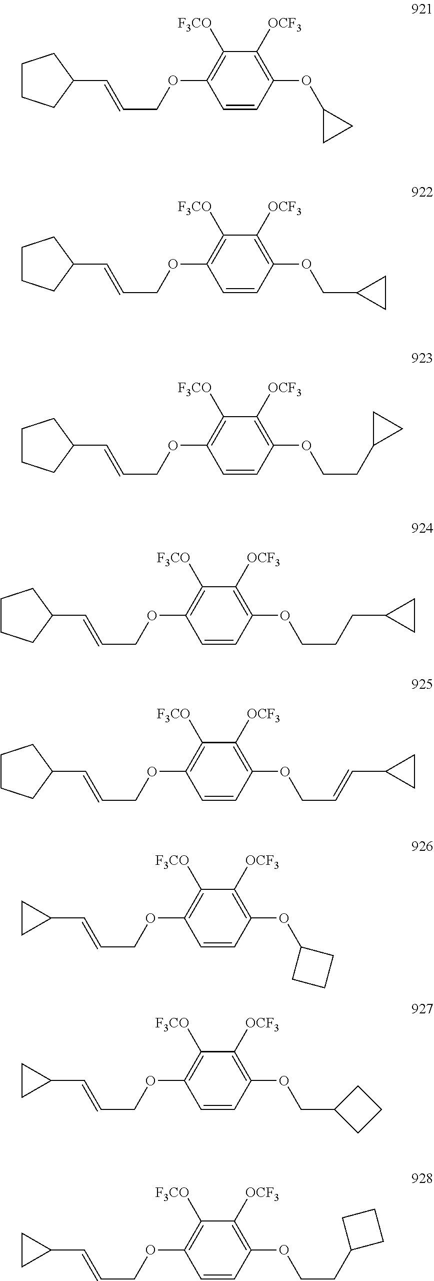

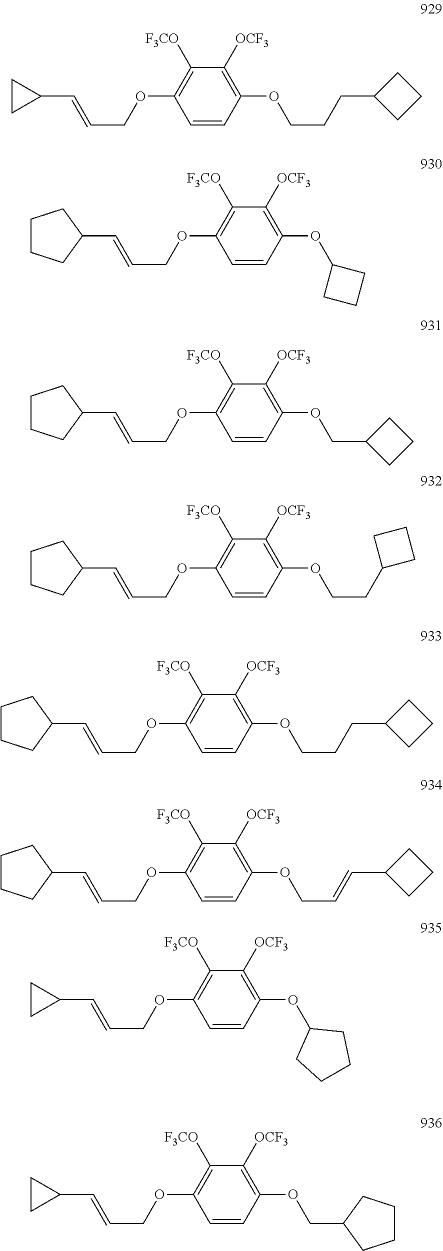

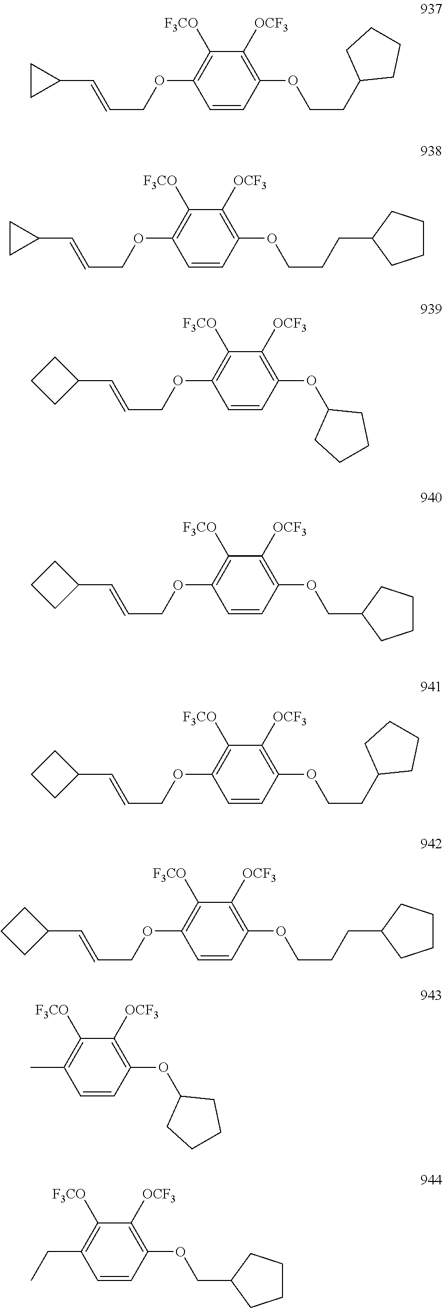

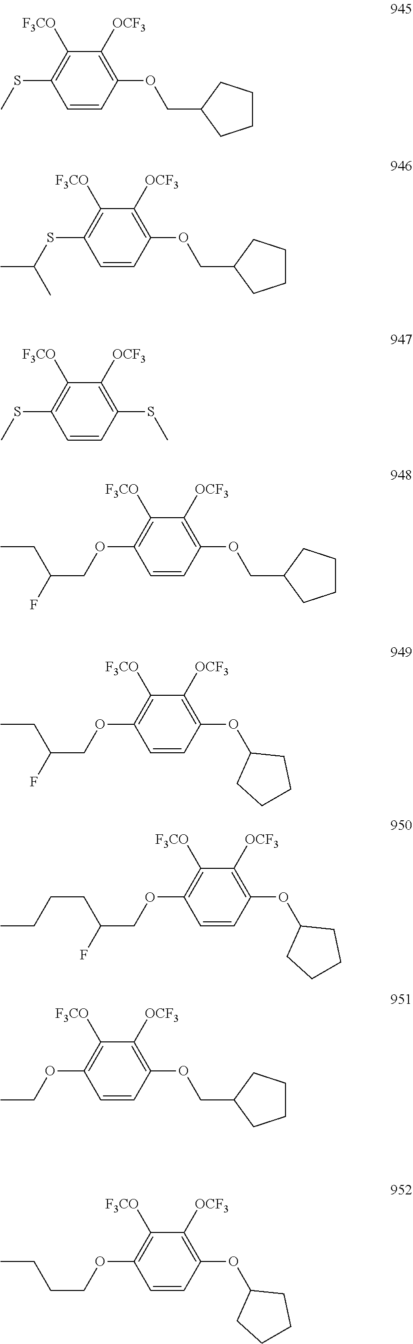

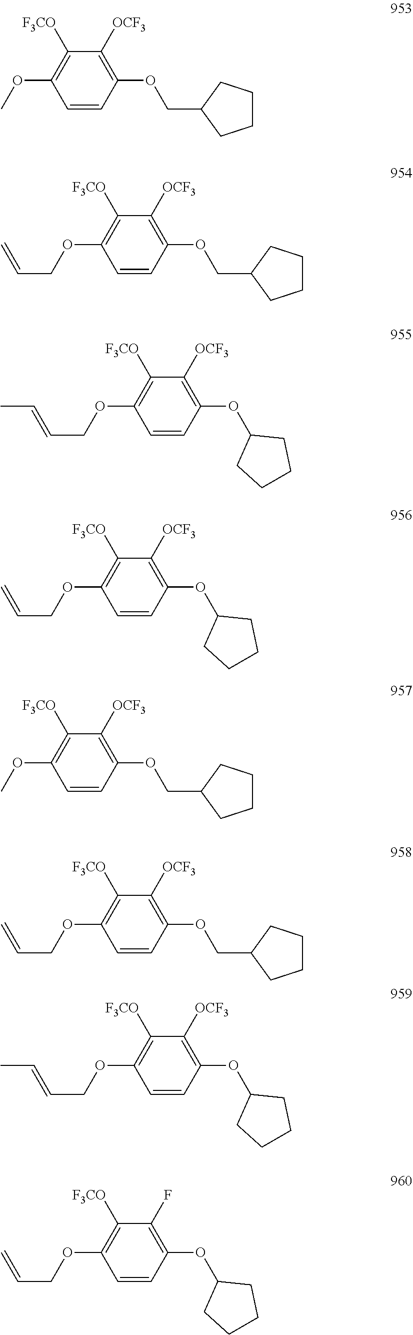

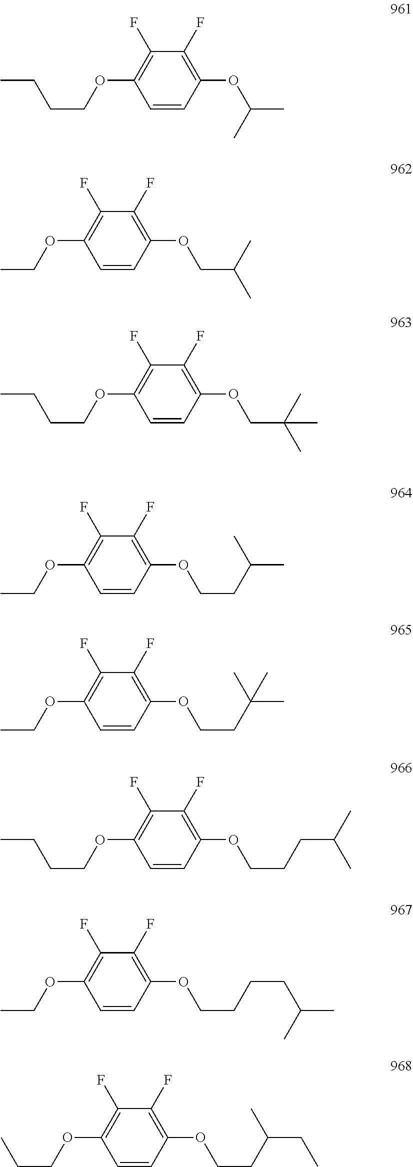

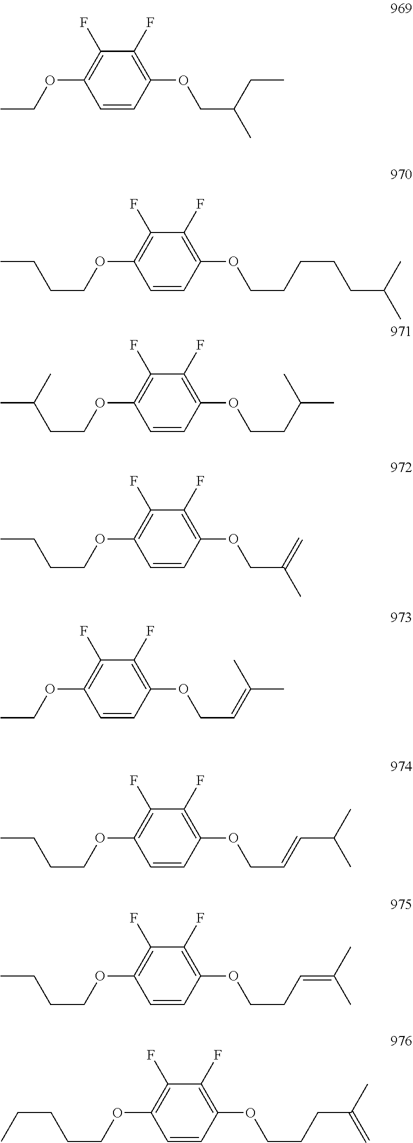

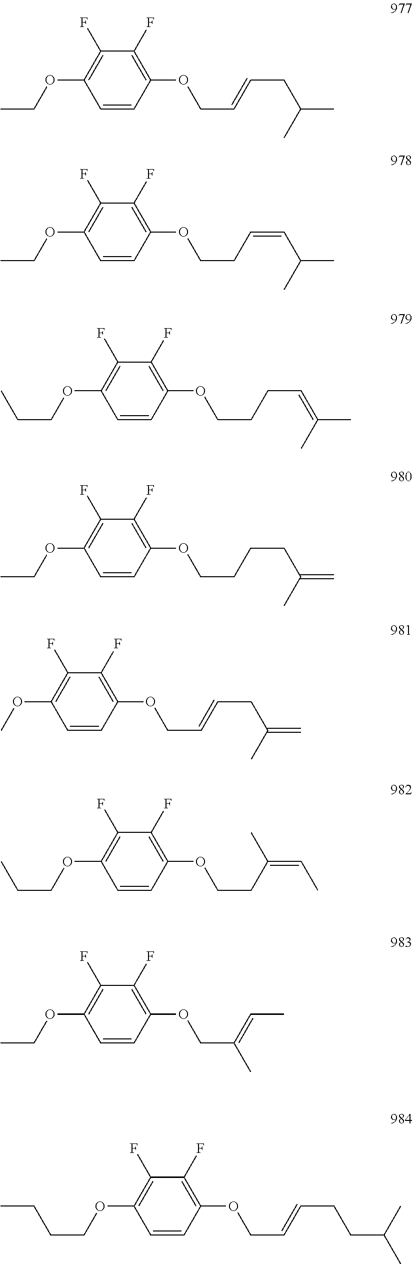

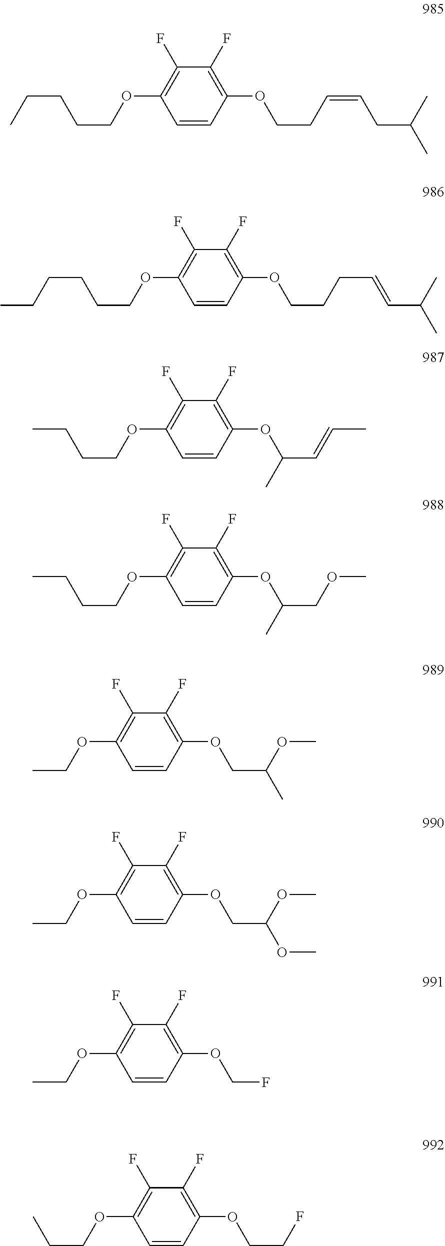

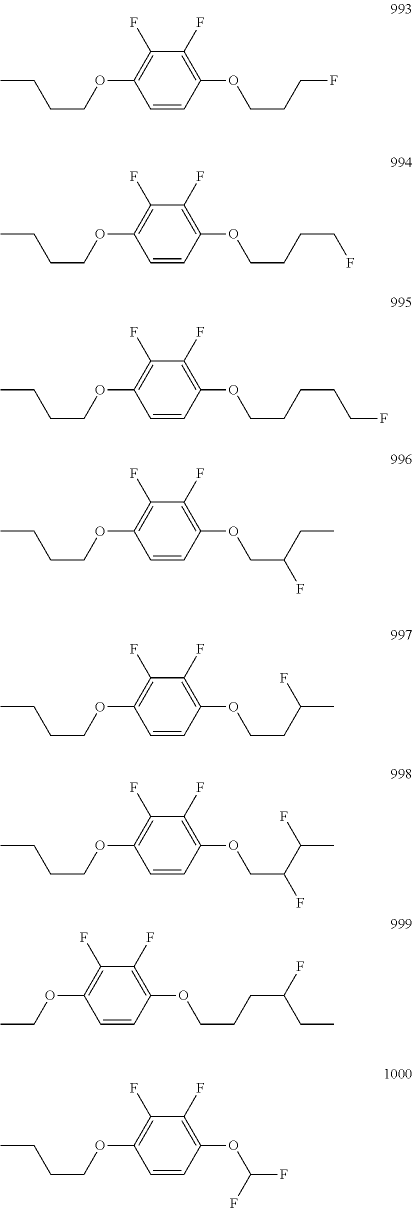

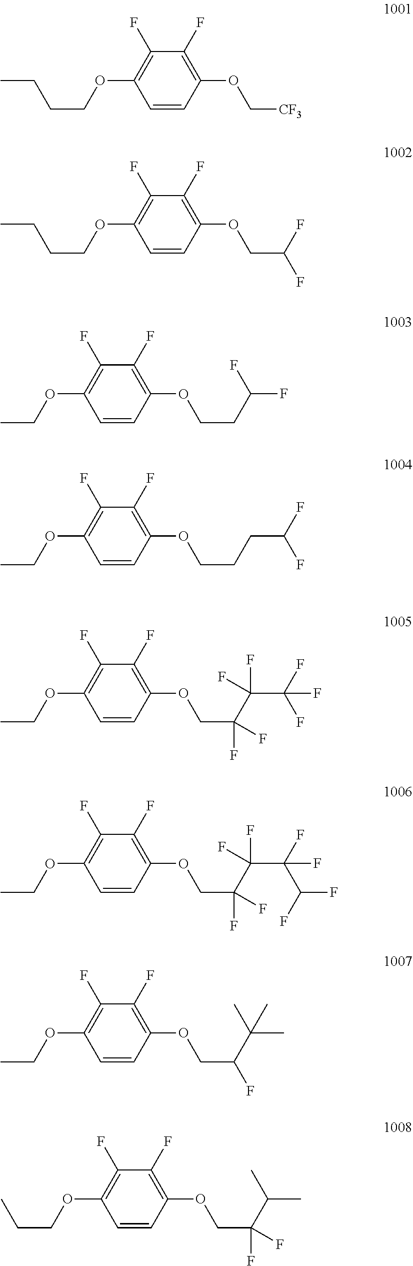

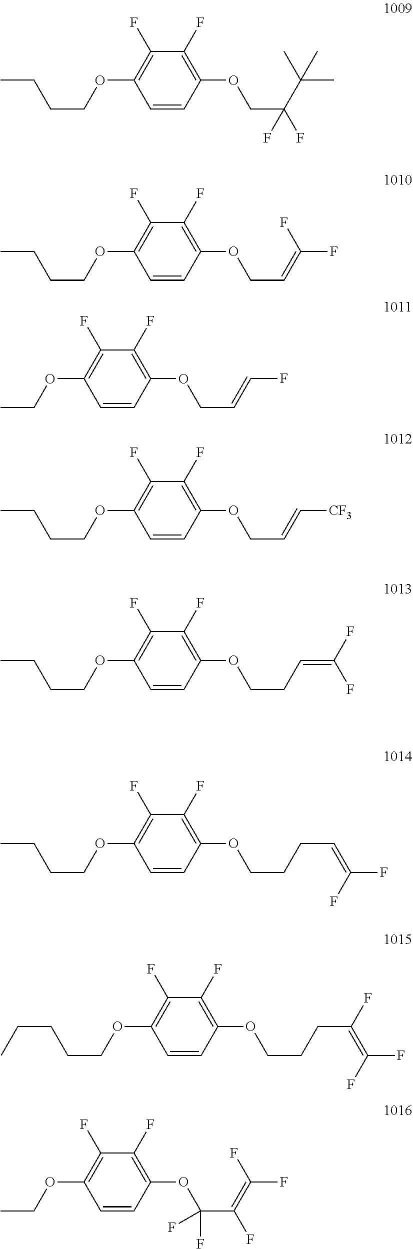

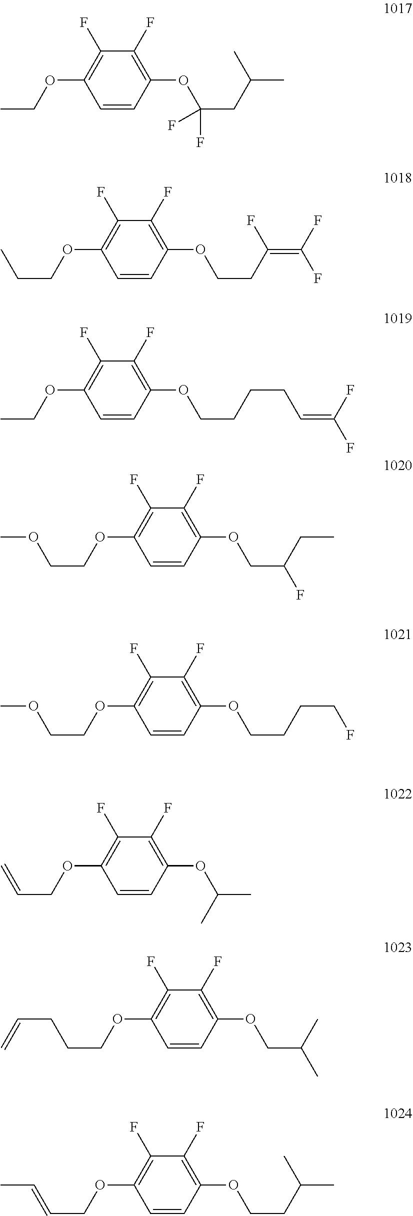

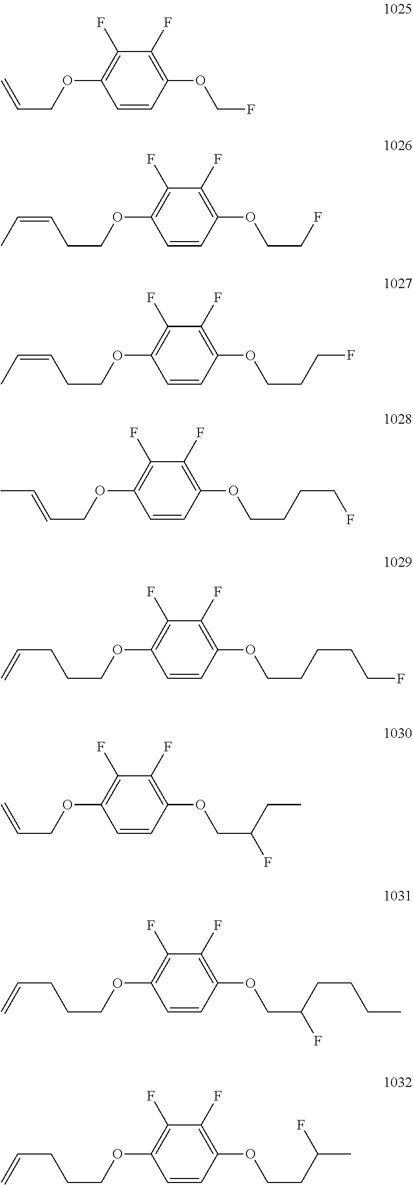

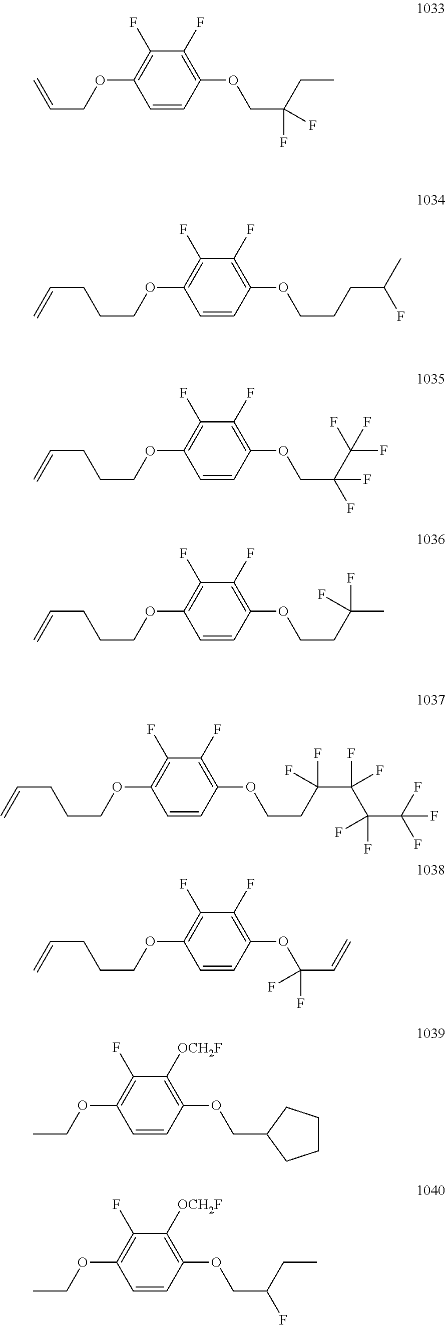

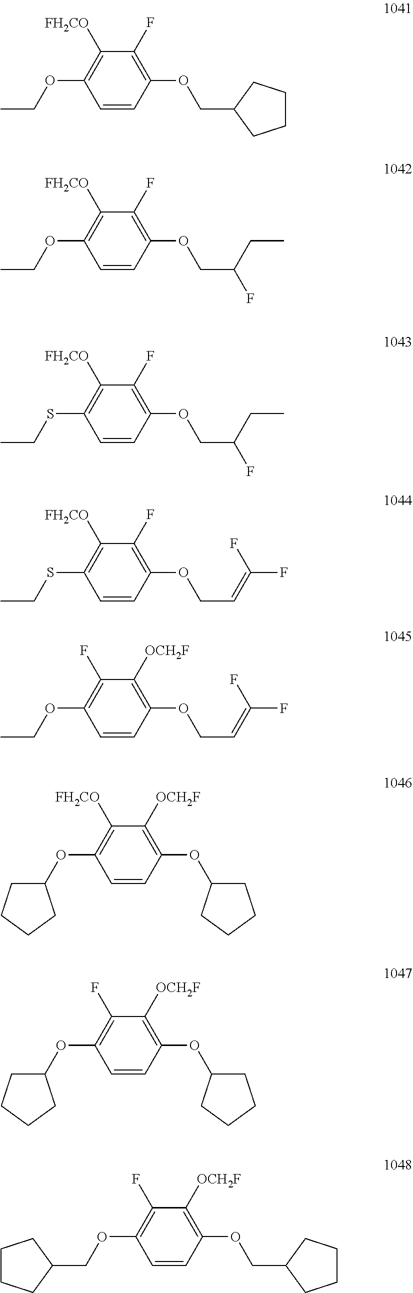

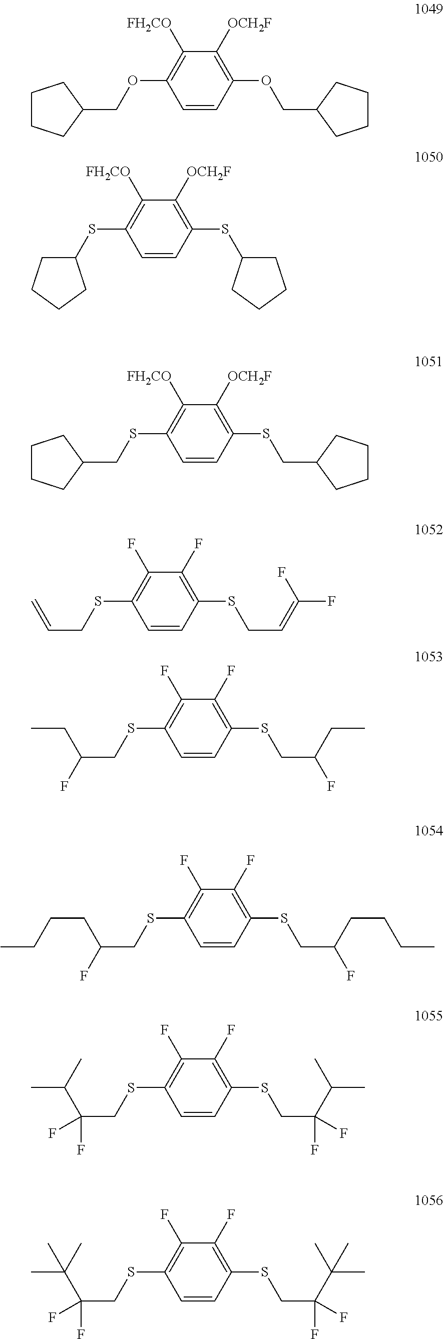

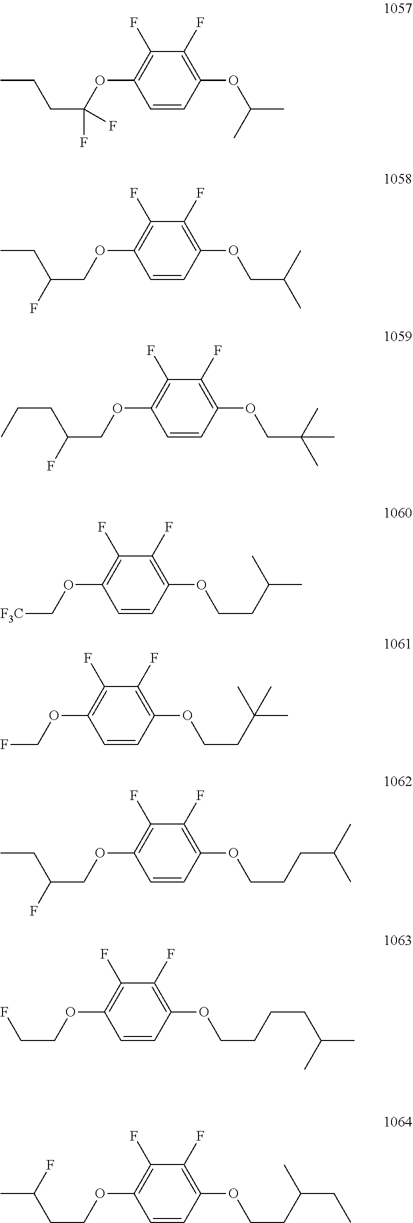

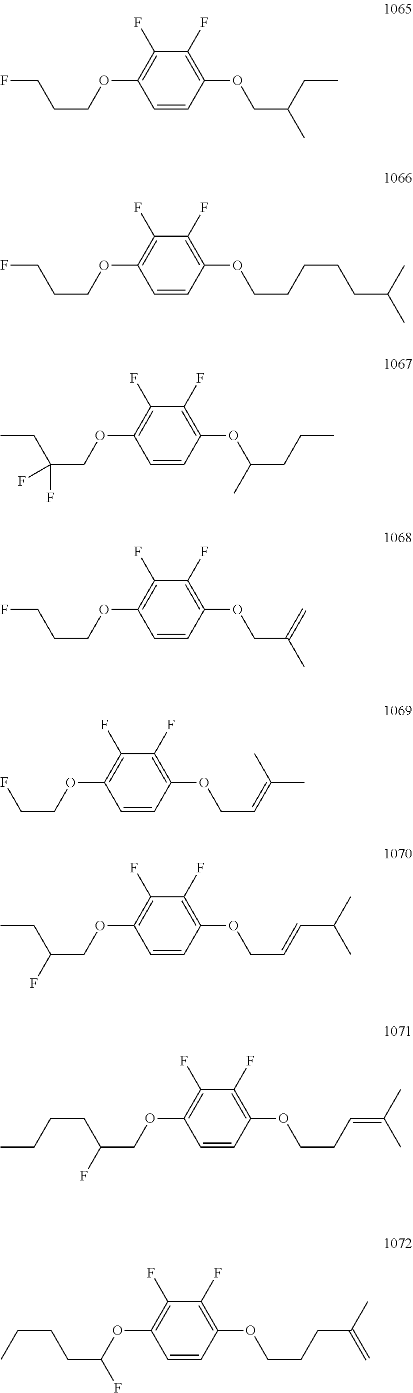

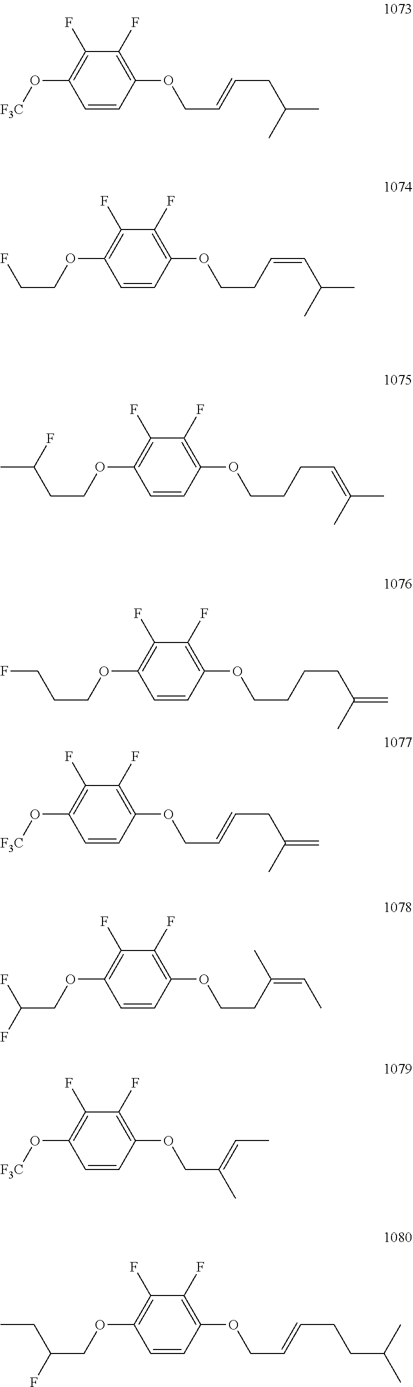

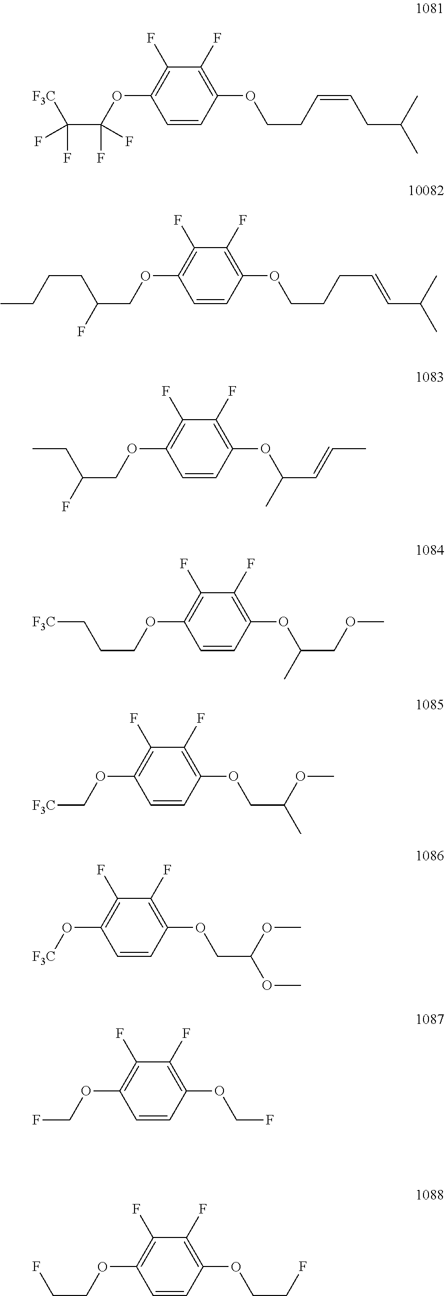

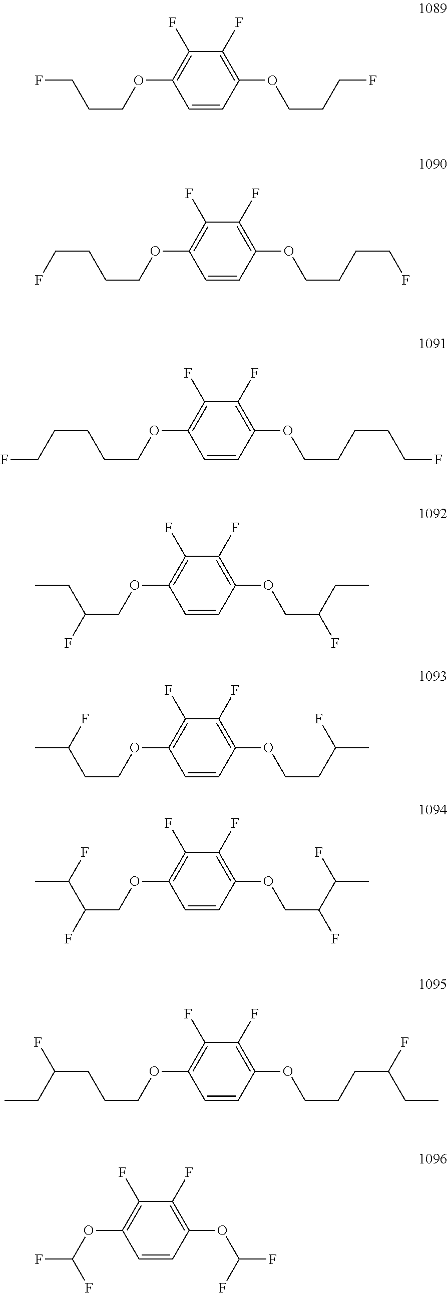

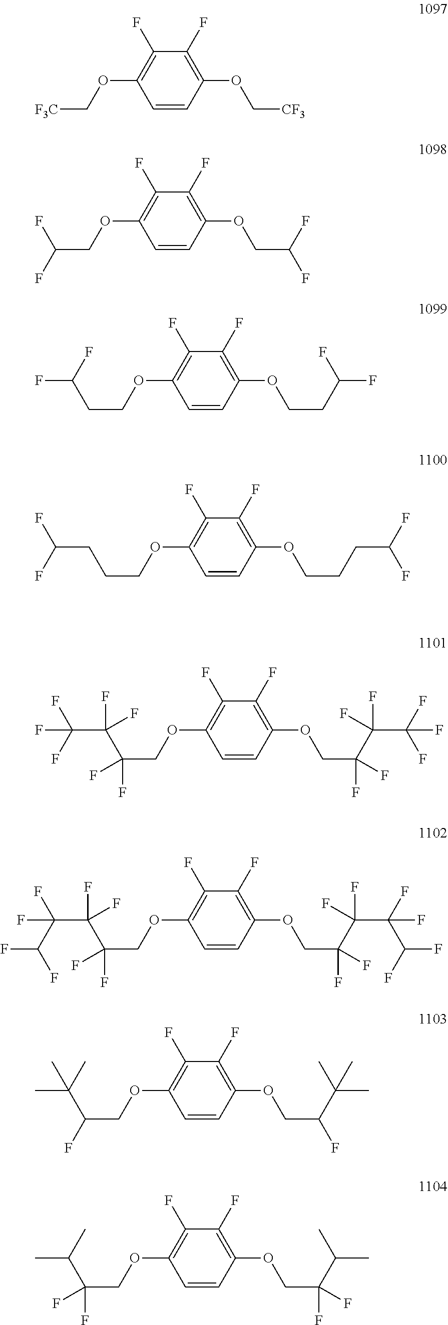

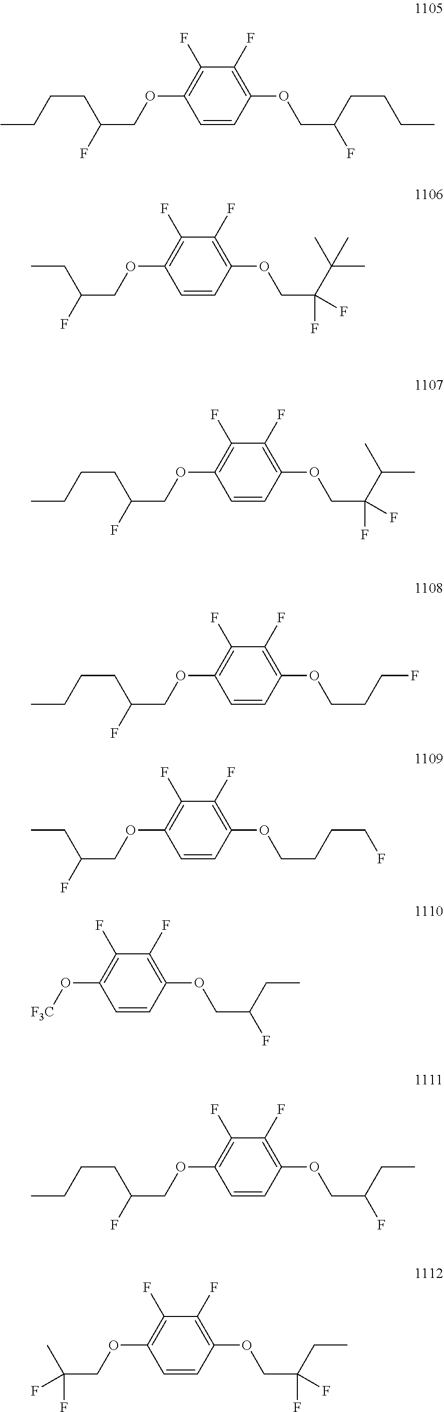

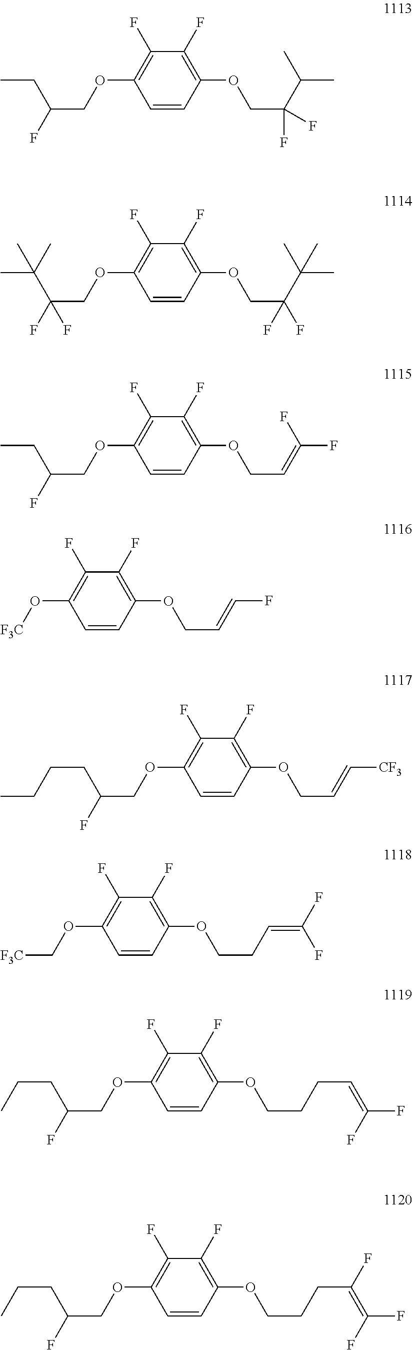

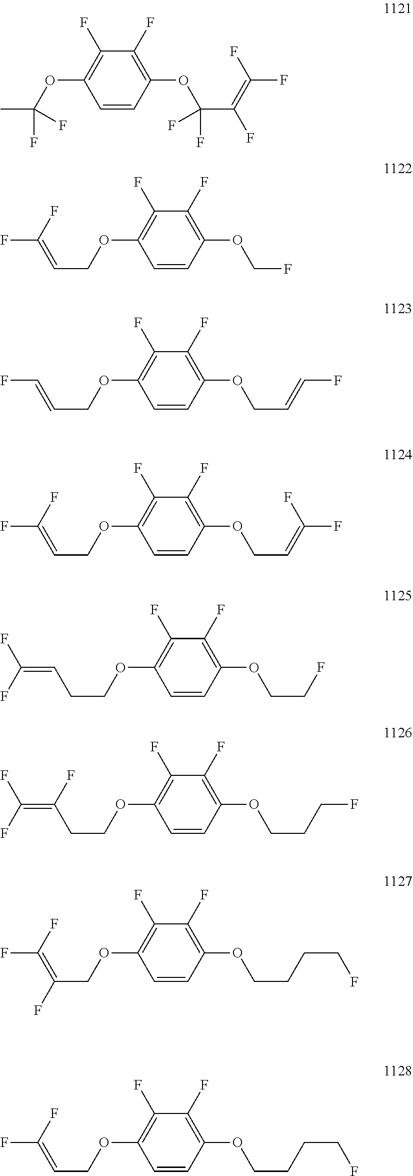

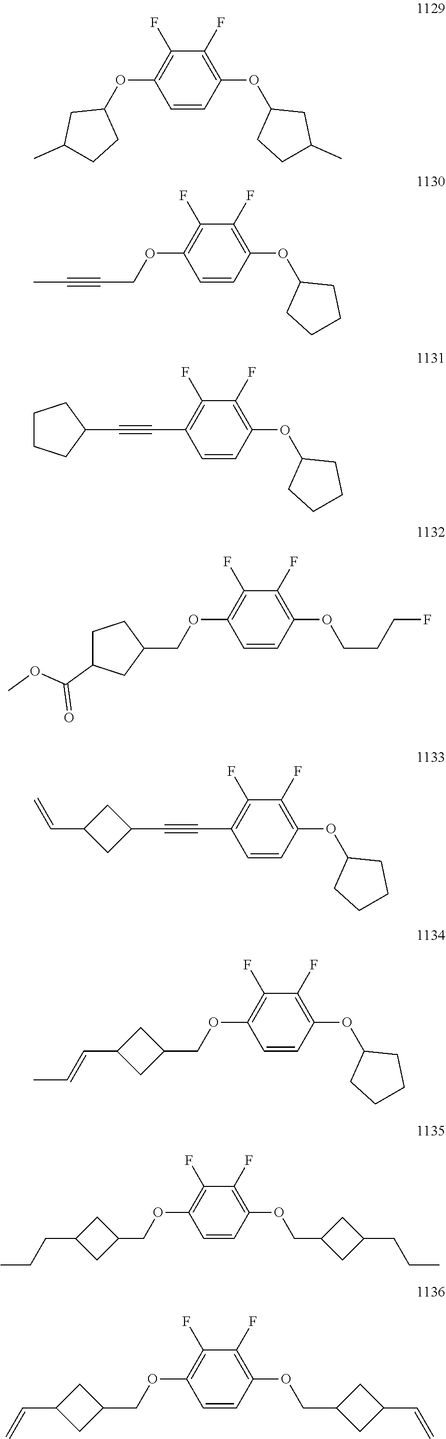

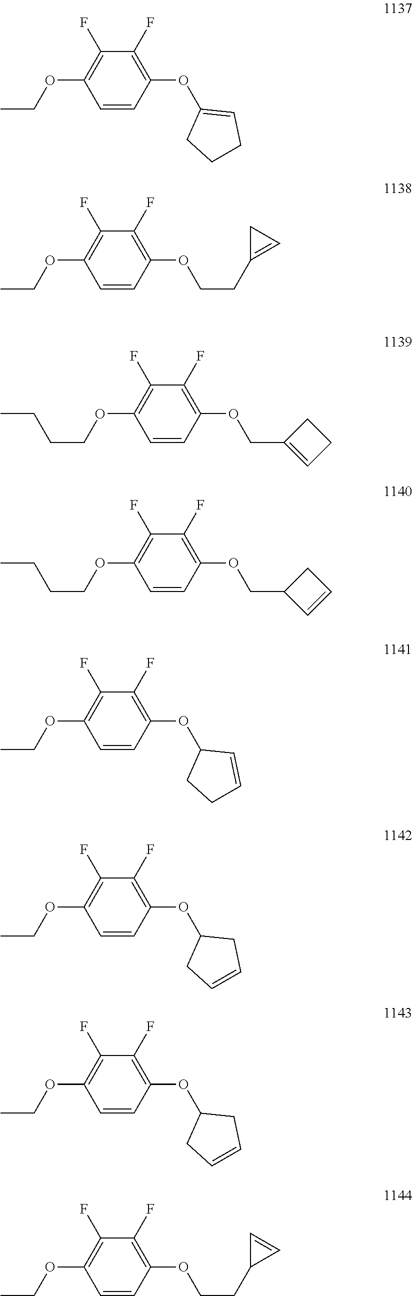

### 2. Examples of a Composition

The invention will be described in greater detail by way of Examples. The Examples include a typical example, and therefore the invention is not limited by the Examples. For example, in addition to compositions in Use Examples, the invention includes a mixture of a composition in Use Example 1 and a composition in Use Example 2. The invention also includes a mixture prepared by mixing at least two of the compositions in the Use Examples. Compounds in the Use Examples were represented using symbols according to definitions in Table 3 described below. In Table 3, the configuration of 1,4-cyclohexylene is trans. A parenthesized number next to a symbolized compound in the Use Examples represents a chemical formula to which the compound belongs. A symbol (−) means a liquid crystal compound different from components (a) to (e). A proportion (percentage) of the liquid crystal compound is expressed in terms of weight percent (% by weight) based on the weight of the liquid crystal composition containing no additives. Values of the physical properties of the composition are summarized in a last part. The physical properties were measured according to the methods described above, and measured values are directly described (without extrapolation).

TABLE 3
Method for description of compounds using symbols
R—(A₁)—Z₁— . . . Zₙ—(Aₙ)—R′

| 1) Left-terminal group R— | Symbol |
|---|---|
| CₙH₂ₙ₊₁— | n- |
| CₙH₂ₙ₊₁O— | nO— |
| CₘH₂ₘ₊₁OCₙH₂ₙ— | mOn- |
| CH₂═CH— | V— |
| CₙH₂ₙ₊₁—CH═CH— | nV— |
| CH₂═CH—CₙH₂ₙ— | Vn- |
| CₘH₂ₘ₊₁—CH═CH—CₙH₂ₙ— | mVn- |
| CF₂═CH— | VFF— |
| CF₂═CH—CₙH₂ₙ— | VFFn- |
| H— | h- |
| 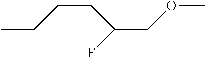 | 6(2F)O— |
| 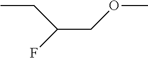 | 4(2F)O— |
| 2) Right-terminal group —R′ | Symbol |
| —CₙH₂ₙ₊₁ | -n |
| —OCₙH₂ₙ₊₁ | —On |
| —COOCH₃ | —EMe |
| —CH═CH₂ | —V |
| —CH═CH—CₙH₂ₙ₊₁ | —Vn |
| —CₙH₂ₙ—CH═CH₂ | -nV |
| —CₘH₂ₘ—CH═CH—CₙH₂ₙ₊₁ | -mVn |
| —CH═CF₂ | —VFF |
| —F | —F |
| —Cl | —CL |
| —OCF₃ | —OCF3 |
| —OCF₂H | —OCF2H |
| —CF₃ | —CF3 |
| —OCH═CH—CF₃ | —OVCF3 |
| —C≡N | —C |
| —H | -h |
| —OCₙH₂ₙ—F | —On(nF) |
| 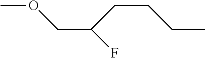 | —O6(2F) |
| 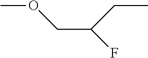 | —O4(2F) |
| 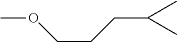 | —O5(4Me) |
| 3) Bonding group —Zₙ— | Symbol |
| —CₙH₂ₙ— | n |
| —COO— | E |
| —CH═CH— | V |
| —CH₂O— | 1O |
| —OCH₂— | O1 |
| —CF₂O— | X |
| —C≡C— | T |
| 4) Ring structure —Aₙ— | Symbol |
| 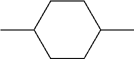 | H |
| 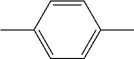 | B |
| 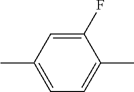 | B(F) |
| 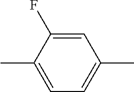 | B(2F) |
| 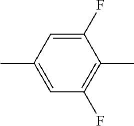 | B(F,F) |
| 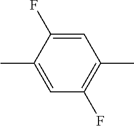 | B(2F,5F) |
| 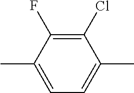 | B(2F,3CL) |
| 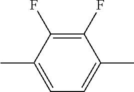 | B(2F,3F) |
| 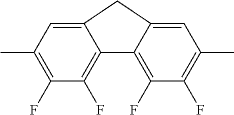 | FLF4 |
| 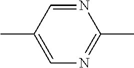 | Py |
| 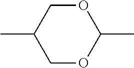 | G |
| 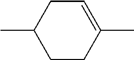 | ch |
| 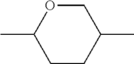 | Dh |
| 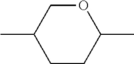 | dh |
| 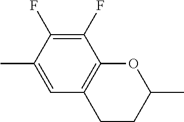 | Cro(7F,8F) |
| 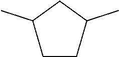 | Cp(1,3) |
| 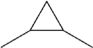 | Cpr |

5) Examples of description
Example 1 6(2F)O—B(2F,3F)—O6(2F)

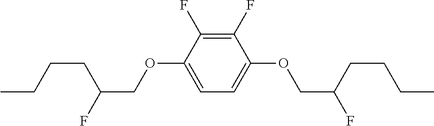 [SMILES: CCCCC(F)COc1ccc(OCC(F)CCCC)c(F)c1F]

Example 2 3-BB(F,F)XB(F,F)—F

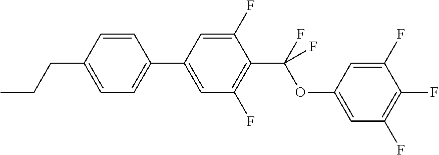 [SMILES: CCCc1ccc(-c2cc(F)c(C(F)(F)Oc3cc(F)c(F)c(F)c3)c(F)c2)cc1]

Example 3 3-HB—O2

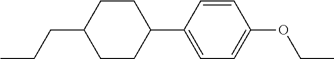 [SMILES: CCCC1CCC(c2ccc(OCC)cc2)CC1]

Example 4 3-HBB(2F,3F)—O2

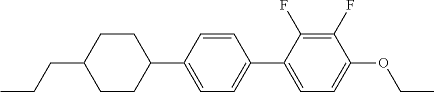 [SMILES: CCCC1CCC(c2ccc(-c3ccc(OCC)c(F)c3F)cc2)CC1]

### Use Example 1

| | | |
|---|---|---|
| 6(2F)O-B(2F,3F)-O6(2F) | (1105) | 10% |
| 1-BB-3 | (2-8) | 5% |
| 1-BB-5 | (2-8) | 7% |
| 2-BTB-1 | (2-10) | 3% |
| 3-HHB-1 | (3-1) | 7% |
| 3-HHB-O1 | (3-1) | 5% |
| 3-HHB-3 | (3-1) | 12% |
| 3-HHB-F | (22-1) | 4% |
| 2-HHB(F)-F | (22-2) | 6% |
| 3-HHB(F)-F | (22-2) | 6% |
| 5-HHB(F)-F | (22-2) | 6% |
| 3-HHB(F,F)-F | (22-3) | 5% |
| 3-HHEB-F | (22-10) | 4% |
| 5-HHEB-F | (22-10) | 4% |
| 2-HB-C | (24-1) | 4% |
| 3-HB-C | (24-1) | 12% |

NI=79.8° C.; η=23.5 mPa·s; Δn=0.100; Δε=3.4.

### Use Example 2

| | | |
|---|---|---|
| 4(2F)O-B(2F,3F)-O4(2F) | (1092) | 10% |
| 3-HH-4 | (2-1) | 11% |
| 7-HB-1 | (2-5) | 3% |
| 5-HB-O2 | (2-5) | 4% |
| 5-HBB(F)B-2 | (4-5) | 10% |
| 5-HBB(F)B-3 | (4-5) | 8% |
| 3-HB-CL | (21-2) | 10% |
| 3-HHB(F,F)-F | (22-3) | 3% |
| 3-HBB(F,F)-F | (22-24) | 21% |
| 5-HBB(F,F)-F | (22-24) | 20% |

NI=70.4° C.; η=25.9 mPa·s; Δη=0.115; Δη=3.5.

### Use Example 3

| | | |
|---|---|---|
| 4O-B(2F,3F)-O5(4Me) | (966) | 10% |
| 1V2-HH-1 | (2-1) | 2% |
| 1V2-HH-3 | (2-1) | 3% |
| 7-HB(F,F)-F | (21-4) | 1% |
| 2-HHB(F)-F | (22-2) | 10% |
| 3-HHB(F)-F | (22-2) | 12% |
| 5-HHB(F)-F | (22-2) | 12% |
| 2-HBB-F | (22-22) | 4% |
| 3-HBB-F | (22-22) | 5% |
| 5-HBB-F | (22-22) | 3% |
| 2-HBB(F)-F | (22-23) | 6% |
| 3-HBB(F)-F | (22-23) | 9% |
| 5-HBB(F)-F | (22-23) | 15% |
| 3-HBB(F,F)-F | (22-24) | 2% |
| 5-HBB(F,F)-F | (22-24) | 6% |

NI=71.0° C.; η=25.0 mPa·s; Δη=0.100; Δε=4.6.

### Use Example 4

| | | |
|---|---|---|
| h-Cpr1OB(2F,3F)-O4 | (224) | 10% |
| 2-HH-3 | (2-1) | 3% |
| 3-HH-4 | (2-1) | 10% |
| 1O1-HBBH-5 | (4-1) | 2% |
| 5-HB-CL | (21-2) | 15% |
| 3-HHB-F | (22-1) | 3% |
| 3-HHB-CL | (22-1) | 2% |
| 4-HHB-CL | (22-1) | 4% |
| 3-HHB(F)-F | (22-2) | 9% |
| 4-HHB(F)-F | (22-2) | 8% |
| 5-HHB(F)-F | (22-2) | 8% |
| 7-HHB(F)-F | (22-2) | 7% |
| 5-HBB(F)-F | (22-23) | 5% |
| 3-HHBB(F,F)-F | (23-6) | 2% |
| 4-HHBB(F,F)-F | (23-6) | 3% |
| 5-HHBB(F,F)-F | (23-6) | 3% |
| 3-HH2BB(F,F)-F | (23-15) | 3% |
| 4-HH2BB(F,F)-F | (23-15) | 3% |

NI=88.1° C.; η=20.9 mPa·s; Δη=0.077; Δε=3.0.

### Use Example 5

| | | |
|---|---|---|
| 4O-B(2F,3F)-O3(3F) | (993) | 10% |
| V-HBB-2 | (3-4) | 9% |
| 1O1-HBBH-4 | (4-1) | 4% |
| 1O1-HBBH-5 | (4-1) | 4% |
| 3-HHB(F,F)-F | (22-3) | 7% |
| 3-H2HB(F,F)-F | (22-15) | 8% |
| 4-H2HB(F,F)-F | (22-15) | 8% |
| 5-H2HB(F,F)-F | (22-15) | 8% |
| 3-HBB(F,F)-F | (22-24) | 7% |
| 5-HBB(F,F)-F | (22-24) | 17% |
| 3-H2BB(F,F)-F | (22-27) | 10% |
| 5-HHBB(F,F)-F | (23-6) | 3% |
| 3-HH2BB(F,F)-F | (23-15) | 3% |
| 5-HHEBB-F | (23-17) | 2% |

NI=85.8° C.; η=32.2 mPa·s; Δη=0.109; Δη=6.8.

### Use Example 6

| | | |
|---|---|---|
| h-Cp(1,3)1OB(2F,3F)O1Cp(1,3)-h | (151) | 10% |
| 5-HBBH-3 | (4-1) | 2% |
| 3-HB(F)BH-3 | (4-2) | 3% |
| 5-HB-F | (21-2) | 12% |
| 6-HB-F | (21-2) | 9% |
| 7-HB-F | (21-2) | 7% |
| 2-HHB-OCF3 | (22-1) | 5% |
| 3-HHB-OCF3 | (22-1) | 6% |
| 4-HHB-OCF3 | (22-1) | 7% |
| 5-HHB-OCF3 | (22-1) | 4% |
| 3-HHB(F,F)-OCF2H | (22-3) | 3% |
| 3-HHB(F,F)-OCF3 | (22-3) | 3% |
| 3-HH2B-OCF3 | (22-4) | 4% |
| 5-HH2B-OCF3 | (22-4) | 4% |
| 3-HH2B(F)-F | (22-5) | 3% |
| 3-HBB(F)-F | (22-23) | 9% |
| 5-HBB(F)-F | (22-23) | 9% |

### Use Example 7

| | | |
|---|---|---|
| 6(2F)O-B(2F,3F)-O6(2F) | (1105) | 7% |
| 2-HH-5 | (2-1) | 4% |
| 3-HH-4 | (2-1) | 3% |
| 5-B(F)BB-2 | (3-8) | 5% |
| 5-HB-CL | (21-2) | 8% |
| 3-HHB(F,F)-F | (22-3) | 8% |
| 3-HHEB(F,F)-F | (22-12) | 10% |
| 4-HHEB(F,F)-F | (22-12) | 3% |
| 5-HHEB(F,F)-F | (22-12) | 4% |
| 3-HBB(F,F)-F | (22-24) | 17% |
| 5-HBB(F,F)-F | (22-24) | 14% |
| 2-HBEB(F,F)-F | (22-39) | 3% |
| 3-HBEB(F,F)-F | (22-39) | 4% |
| 5-HBEB(F,F)-F | (22-39) | 3% |
| 3-HHBB(F,F)-F | (23-6) | 7% |

NI=70.6° C.; η=27.9 mPa·s; Δη=0.106; Δε=7.3.

### Use Example 8

| | | |
|---|---|---|
| 4(2F)O-B(2F,3F)-O4(2F) | (1092) | 5% |
| V2-HHB-1 | (3-1) | 8% |
| 3-HB-CL | (21-2) | 3% |
| 5-HB-CL | (21-2) | 2% |
| 3-HHB-OCF3 | (22-1) | 6% |
| 5-HHB(F)-F | (22-2) | 6% |
| V-HHB(F)-F | (22-2) | 4% |
| 3-H2HB-OCF3 | (22-13) | 5% |
| 5-H2HB(F,F)-F | (22-15) | 4% |
| 5-H4HB-OCF3 | (22-19) | 15% |
| 5-H4HB(F,F)-F | (22-21) | 7% |
| 3-H4HB(F,F)-CF3 | (22-21) | 8% |
| 5-H4HB(F,F)-CF3 | (22-21) | 10% |
| 2-H2BB(F)-F | (22-26) | 5% |
| 3-H2BB(F)-F | (22-26) | 8% |
| 3-HBEB(F,F)-F | (22-39) | 4% |

NI=70.6° C.; η=27.6 mPa·s; Δη=0.095; Δε=7.1.

### Use Example 9

| | | |
|---|---|---|
| 4O-B(2F,3F)-O5(4Me) | (966) | 5% |
| 3-HH-4 | (2-1) | 8% |
| 3-HH-5 | (2-1) | 5% |
| 3-HB-O2 | (2-5) | 14% |
| 3-HHB-1 | (3-1) | 10% |
| 3-HHB-O1 | (3-1) | 8% |
| 5-HB-CL | (21-2) | 13% |
| 7-HB(F,F)-F | (21-4) | 2% |
| 2-HHB(F)-F | (22-2) | 7% |
| 3-HHB(F)-F | (22-2) | 7% |
| 5-HHB(F)-F | (22-2) | 7% |
| 3-HHB(F,F)-F | (22-3) | 6% |
| 3-H2HB(F,F)-F | (22-15) | 4% |
| 4-H2HB(F,F)-F | (22-15) | 4% |

NI=70.8° C.; η=16.1 mPa·s; Δη=0.073; Δε=2.2.

### Use Example 10

| | | |
|---|---|---|
| h-Cpr1OB(2F,3F)-O4 | (224) | 5% |
| 3-HH-4 | (2-1) | 8% |
| 3-HH-5 | (2-1) | 10% |
| 4-HH-V | (2-1) | 13% |
| 5-HB-CL | (21-2) | 1% |
| 7-HB(F)-F | (21-3) | 5% |
| 2-HHB(F,F)-F | (22-3) | 4% |
| 3-HHB(F,F)-F | (22-3) | 5% |
| 3-HHEB-F | (22-10) | 10% |
| 5-HHEB-F | (22-10) | 9% |
| 3-HHEB(F,F)-F | (22-12) | 10% |
| 4-HHEB(F,F)-F | (22-12) | 5% |
| 3-GHB(F,F)-F | (22-109) | 4% |
| 4-GHB(F,F)-F | (22-109) | 5% |
| 5-GHB(F,F)-F | (22-109) | 6% |

NI=70.4° C.; η=18.1 mPa·s; Δη=0.057; Δη=4.5.

### Use Example 11

| | | |
|---|---|---|
| 4O-B(2F,3F)-O3(3F) | (993) | 5% |
| 3-HH-VFF | (2-1) | 4% |
| 5-HH-VFF | (2-1) | 25% |
| 2-BTB-1 | (2-10) | 8% |
| 3-HHB-1 | (3-1) | 4% |
| VFF-HHB-1 | (3-1) | 7% |
| VFF2-HHB-1 | (3-1) | 11% |
| 3-H2BTB-2 | (3-17) | 5% |
| 3-H2BTB-3 | (3-17) | 4% |
| 3-H2BTB-4 | (3-17) | 4% |
| 3-HB-C | (24-1) | 18% |
| 1V2-BEB(F,F)-C | (24-15) | 5% |

NI=71.8° C.; η=12.5 mPa·s; Δη=0.121; Δη=5.5.

### Use Example 12

| | | |
|---|---|---|
| h-Cp(1,3)1OB(2F,3F)O1Cp(1,3)-h | (151) | 5% |
| 3-HH-V | (2-1) | 33% |
| 3-HH-V1 | (2-1) | 4% |
| 5-HH-V | (2-1) | 5% |
| 3-HHB-1 | (3-1) | 4% |
| V-HHB-1 | (3-1) | 5% |
| 2-BB(F)B-3 | (3-6) | 5% |
| 3-HHEH-5 | (3-13) | 3% |
| 1V2-BB-F | (21-1) | 3% |
| 3-BB(F,F)XB(F,F)-F | (22-97) | 8% |
| 3-BB(2F,3F)XB(F,F)-F | (22-114) | 3% |
| 3-HHBB(F,F)-F | (23-6) | 3% |
| 3-HBBXB(F,F)-F | (23-32) | 3% |
| 5-HB(F)B(F,F)XB(F,F)-F | (23-41) | 5% |
| 3-BB(F)B(F,F)XB(F,F)-F | (23-47) | 3% |
| 4-BB(F)B(F,F)XB(F,F)-F | (23-47) | 5% |
| 5-BB(F)B(F,F)XB(F,F)-F | (23-47) | 3% |

### Use Example 13

| | | |
|---|---|---|
| 6(2F)O-B(2F,3F)-O6(2F) | (1105) | 9% |
| 3-HH-V | (2-1) | 28% |
| 3-HH-V1 | (2-1) | 7% |
| V-HH-V1 | (2-1) | 5% |
| 3-HHB-1 | (3-1) | 4% |
| V-HHB-1 | (3-1) | 5% |
| 1-BB(F)B-2V | (3-6) | 4% |
| 3-HHEH-5 | (3-13) | 3% |
| 1V2-BB-F | (21-1) | 3% |
| 3-BB(F,F)XB(F,F)-F | (22-97) | 2% |
| 3-HHXB(F,F)-CF3 | (22-100) | 3% |
| 3-GB(F,F)XB(F,F)-F | (22-113) | 3% |
| 3-GB(F)B(F,F)-F | (22-116) | 3% |
| 3-HHBB(F,F)-F | (23-6) | 3% |
| 3-BB(F)B(F,F)XB(F,F)-F | (23-47) | 3% |
| 4-BB(F)B(F,F)XB(F,F)-F | (23-47) | 7% |
| 5-BB(F)B(F,F)XB(F,F)-F | (23-47) | 3% |
| 3-GB(F)B(F,F)XB(F,F)-F | (23-57) | 5% |

NI=70.7° C.; η=18.9 mPa·s; Δη=0.098; Δη=4.9.

### Use Example 14

| | | |
|---|---|---|
| 4(2F)O-B(2F,3F)-O4(2F) | (1092) | 8% |
| 3-HH-V | (2-1) | 32% |
| 3-HH-V1 | (2-1) | 4% |
| 3-HHB-1 | (3-1) | 4% |
| V-HHB-1 | (3-1) | 5% |
| 3-HBB-2 | (3-4) | 5% |
| V2-BB(F)B-1 | (3-6) | 5% |
| 3-HHEH-3 | (3-13) | 3% |
| 3-HHEH-5 | (3-13) | 4% |
| 1V2-BB-F | (21-1) | 2% |
| 3-BB(F,F)XB(F,F)-F | (22-97) | 2% |
| 3-GB(F,F)XB(F,F)-F | (22-113) | 1% |
| 3-HHBB(F,F)-F | (23-6) | 3% |
| 3-HBB(F,F)XB(F,F)-F | (23-38) | 3% |
| 3-BB(F)B(F,F)XB(F)-F | (23-46) | 3% |
| 4-BB(F)B(F,F)XB(F,F)-F | (23-47) | 3% |
| 5-BB(F)B(F,F)XB(F,F)-F | (23-47) | 3% |
| 3-GB(F)B(F,F)XB(F,F)-F | (23-57) | 5% |
| 4-GB(F)B(F,F)XB(F,F)-F | (23-57) | 3% |
| 5-GB(F)B(F,F)XB(F,F)-F | (23-57) | 2% |

NI=70.8° C.; η=18.1 mPa·s; Δη=0.085; Δη=3.9.

### Use Example 15

| | | |
|---|---|---|
| 4O-B(2F,3F)-O5(4Me) | (966) | 8% |
| 3-HH-V | (2-1) | 31% |
| 3-HH-V1 | (2-1) | 4% |
| 3-HHB-1 | (3-1) | 5% |
| V-HHB-1 | (3-1) | 4% |
| V2-BB(F)B-1 | (3-6) | 4% |
| 3-HHEH-5 | (3-13) | 3% |
| 3-HHEBH-3 | (4-6) | 4% |
| 1V2-BB-F | (21-1) | 3% |
| 3-BB(F)B(F,F)-F | (22-69) | 2% |
| 3-BB(F,F)XB(F,F)-F | (22-97) | 3% |
| 3-HHBB(F,F)-F | (23-6) | 3% |
| 5-HB(F)B(F,F)XB(F,F)-F | (23-41) | 4% |
| 4-BB(F)B(F,F)XB(F,F)-F | (23-47) | 5% |
| 5-BB(F)B(F,F)XB(F,F)-F | (23-47) | 3% |
| 2-dhBB(F,F)XB(F,F)-F | (23-50) | 2% |
| 3-dhBB(F,F)XB(F,F)-F | (23-50) | 3% |
| 3-GBB(F)B(F,F)-F | (23-55) | 3% |
| 4-GBB(F)B(F,F)-F | (23-55) | 3% |
| 3-BB(F,F)XB(F)B(F,F)-F | (23-56) | 3% |

NI=70.9° C.; η=19.5 mPa·s; Δη=0.091; Δε=4.1.

### Use Example 16

| | | |
|---|---|---|
| h-Cpr1OB(2F,3F)-O4 | (224) | 7% |
| 3-HH-V | (2-1) | 33% |
| 3-HH-V1 | (2-1) | 5% |
| 3-HHB-1 | (3-1) | 4% |
| V-HHB-1 | (3-1) | 5% |
| V2-BB(F)B-1 | (3-6) | 5% |
| 3-HHEH-5 | (3-13) | 3% |
| 1V2-BB-F | (21-1) | 1% |
| 3-BB(F)B(F,F)-CF3 | (22-69) | 2% |
| 3-BB(F,F)XB(F,F)-F | (22-97) | 4% |
| 3-HHXB(F,F)-F | (22-100) | 5% |
| 3-GB(F,F)XB(F,F)-F | (22-113) | 1% |
| 3-GB(F)B(F)-F | (22-115) | 3% |
| 3-HHBB(F,F)-F | (23-6) | 4% |
| 5-HB(F)B(F,F)XB(F,F)-F | (23-41) | 3% |
| 3-GB(F)B(F,F)XB(F,F)-F | (23-57) | 3% |
| 3-GBB(F,F)XB(F,F)-F | (23-58) | 3% |
| 4-GBB(F,F)XB(F,F)-F | (23-58) | 3% |
| 5-GBB(F,F)XB(F,F)-F | (23-58) | 3% |
| 3-GB(F)B(F)B(F)-F | (23-59) | 3% |

NI=71.4° C.; η=17.3 mPa·s; Δη=0.083; Δε=4.2.

### Use Example 17

| | | |
|---|---|---|
| 4O-B(2F,3F)-O3(3F) | (993) | 8% |
| 3-HH-4 | (2-1) | 4% |
| 3-HB-O1 | (2-5) | 12% |
| 3-HHB-1 | (3-1) | 6% |
| 3-HB(2F,3F)-O2 | (5-1) | 10% |
| 5-HB(2F,3F)-O2 | (5-1) | 10% |
| 2-HHB(2F,3F)-1 | (6-1) | 12% |
| 3-HHB(2F,3F)-1 | (6-1) | 12% |
| 3-HHB(2F,3F)-O2 | (6-1) | 13% |
| 5-HHB(2F,3F)-O2 | (6-1) | 13% |

NI=73.9° C.; =36.8 mPa·s; Δη=0.083; Δε=−3.5.

### Use Example 18

| | | |
|---|---|---|
| h-Cp(1,3)1OB(2F,3F)O1Cp(1,3)-h | (151) | 8% |
| 2-HH-5 | (2-1) | 2% |
| 3-HH-4 | (2-1) | 13% |
| 3-HH-5 | (2-1) | 4% |
| 3-HB-O2 | (2-5) | 10% |
| 3-HHB-1 | (3-1) | 3% |
| 3-HHB-3 | (3-1) | 4% |
| 3-HHB-O1 | (3-1) | 3% |
| 3-H2B(2F,3F)-O2 | (5-4) | 12% |
| 5-H2B(2F,3F)-O2 | (5-4) | 15% |
| 2-HBB(2F,3F)-O2 | (6-7) | 3% |
| 3-HBB(2F,3F)-O2 | (6-7) | 9% |
| 5-HBB(2F,3F)-O2 | (6-7) | 9% |
| 3-HHB(2F,3CL)-O2 | (6-12) | 5% |

### Use Example 19

| | | |
|---|---|---|
| 6(2F)O-B(2F,3F)-O6(2F) | (1105) | 5% |
| 2-HH-3 | (2-1) | 19% |
| 3-HH-4 | (2-1) | 9% |
| 3-HB-O2 | (2-5) | 2% |
| 1-BB-3 | (2-8) | 7% |
| 3-HHB-1 | (3-1) | 5% |
| 3-HHB-O1 | (3-1) | 4% |
| 5-B(F)BB-2 | (3-8) | 2% |
| 3-BB(2F,3F)-O2 | (5-3) | 8% |
| 5-BB(2F,3F)-O2 | (5-3) | 5% |
| 2-HH1OB(2F,3F)-O2 | (6-5) | 13% |
| 3-HH1OB(2F,3F)-O2 | (6-5) | 21% |

NI=71.5° C.; η=19.0 mPa·s; Δη=0.092; Δη=−3.6.

### Use Example 20

| | | |
|---|---|---|
| 4(2F)O-B(2F,3F)-O4(2F) | (1092) | 6% |
| 2-HH-3 | (2-1) | 16% |
| 7-HB-1 | (2-5) | 8% |
| 5-HB-O2 | (2-5) | 8% |
| 5-HBB(F)B-2 | (4-5) | 11% |
| 5-HBB(F)B-3 | (4-5) | 10% |
| 3-HB(2F,3F)-O2 | (5-1) | 15% |
| 5-HB(2F,3F)-O2 | (5-1) | 13% |
| 3-HHB(2F,3CL)-O2 | (6-12) | 3% |
| 4-HHB(2F,3CL)-O2 | (6-12) | 3% |
| 5-HHB(2F,3CL)-O2 | (6-12) | 2% |
| 3-HH1OCro(7F,8F)-5 | (10-6) | 5% |

NI=71.4° C.; η=26.0 mPa·s; Δη=0.102; Δε=−2.8.

### Use Example 21

| | | |
|---|---|---|
| 4O-B(2F,3F)-O5(4Me) | (966) | 6% |
| 3-HH-V | (2-1) | 25% |
| 1-BB-3 | (2-8) | 7% |
| 3-HHB-1 | (3-1) | 10% |
| 5-B(F)BB-2 | (3-8) | 6% |
| 3-BB(2F,3F)-O2 | (5-3) | 10% |
| 2-HH1OB(2F,3F)-O2 | (6-5) | 21% |
| 3-HH1OB(2F,3F)-O2 | (6-5) | 15% |

NI=71.0° C.; η=17.7 mPa·s; Δη=0.098; Δε=−3.3.

### Use Example 22

| | | |
|---|---|---|
| h-Cpr1OB(2F,3F)-O4 | (224) | 9% |
| 2-HH-3 | (2-1) | 5% |
| 3-HH-V1 | (2-1) | 9% |
| 1V2-HH-1 | (2-1) | 7% |
| 1V2-HH-3 | (2-1) | 6% |
| 4-HH-V | (2-1) | 2% |
| 3-HHB-1 | (3-1) | 4% |
| 3-HHB-3 | (3-1) | 2% |
| 3-BB(2F,3F)-O2 | (5-3) | 4% |
| 5-BB(2F,3F)-O2 | (5-3) | 2% |
| 3-H1OB(2F,3F)-O2 | (5-5) | 5% |
| 2-HH1OB(2F,3F)-O2 | (6-5) | 8% |
| 3-HH1OB(2F,3F)-O2 | (6-5) | 19% |
| 3-HDhB(2F,3F)-O2 | (6-3) | 7% |
| 2-BB(2F,3F)B-3 | (7-1) | 11% |

NI=70.9° C.; η=22.0 mPa·s; Δη=0.093; Δε=−4.2.

### Use Example 23

| | | |
|---|---|---|
| 4O-B(2F,3F)-O3(3F) | (993) | 9% |
| 3-HH-4 | (2-1) | 5% |
| 3-HH-VFF | (2-1) | 3% |
| 3-HB-O1 | (2-5) | 13% |
| 1-BB-5 | (2-8) | 3% |
| 3-HHB-1 | (3-1) | 6% |
| 5-HB(2F,3F)-O2 | (5-1) | 10% |
| V-HB(2F,3F)-O2 | (5-1) | 2% |
| 2-HHB(2F,3F)-1 | (6-1) | 11% |
| 3-HHB(2F,3F)-1 | (6-1) | 12% |
| 3-HHB(2F,3F)-O2 | (6-1) | 13% |
| 5-HHB(2F,3F)-O2 | (6-1) | 13% |

NI=72.4° C.; η=33.9 mPa·s; Δη=0.083; Δη=−3.1.

### Use Example 24

| | | |
|---|---|---|
| h-Cp(1,3)1OB(2F,3F)O1Cp(1,3)-h | (151) | 7% |
| 2-HH-3 | (2-1) | 16% |
| 7-HB-1 | (2-5) | 5% |
| 5-HB-O2 | (2-5) | 7% |
| 5-HBB(F)B-2 | (4-5) | 9% |
| 5-HBB(F)B-3 | (4-5) | 10% |
| 3-HB(2F,3F)-O2 | (5-1) | 11% |
| 5-HB(2F,3F)-O2 | (5-1) | 12% |
| 2-H1OB(2F,3F)-O2 | (5-5) | 2% |
| 3-H1OB(2F,3F)-O2 | (5-5) | 3% |
| 2O-B(2F,3F)B(F)-2 | (5-9) | 3% |
| 4O-B(2F,3F)B(F)-O2 | (5-9) | 3% |
| V-HHB(2F,3F)-O2 | (6-1) | 3% |
| V2-HHB(2F,3F)-O2 | (6-1) | 3% |
| 5-HHB(2F,3CL)-O2 | (6-12) | 2% |
| 3-HH1OCro(7F,8F)-5 | (10-6) | 4% |

### Use Example 25

| | | |
|---|---|---|
| 6(2F)O-B(2F,3F)-O6(2F) | (1105) | 9% |
| 2-HH-5 | (2-1) | 3% |
| 3-HH-4 | (2-1) | 13% |
| 3-HH-5 | (2-1) | 4% |
| 3-HB-O2 | (2-5) | 10% |
| 3-HHB-1 | (3-1) | 3% |
| 3-HHB-3 | (3-1) | 4% |
| 3-HHB-O1 | (3-1) | 3% |
| 3-DhB(2F,3F)-O2 | (5-2) | 2% |
| 2-BB(2F,3F)-O2 | (5-3) | 7% |
| 5-H2B(2F,3F)-O2 | (5-4) | 10% |
| 3-HH2B(2F,3F)-O2 | (6-4) | 3% |
| 3-HBB(2F,3F)-O2 | (6-7) | 9% |
| V-HBB(2F,3F)-O2 | (6-7) | 3% |
| 5-HBB(2F,3F)-O2 | (6-7) | 9% |
| 3-HHB(2F,3CL)-O2 | (6-12) | 5% |
| 2O-B(2F,3F)B(F)H-3 | (6-19) | 3% |

NI=71.3° C.; η=28.3 mPa·s; Δη=0.099; Δε=−4.8.

### Use Example 26

| | | |
|---|---|---|
| 4(2F)O-B(2F,3F)-O4(2F) | (1092) | 12% |
| 2-HH-3 | (2-1) | 5% |
| 3-HH-V1 | (2-1) | 7% |
| 1V2-HH-1 | (2-1) | 8% |
| 1V2-HH-3 | (2-1) | 6% |
| V-HHB-1 | (3-1) | 3% |
| V2-HHB-1 | (3-1) | 3% |
| 3-HHB-1 | (3-1) | 3% |
| 3-HHB-3 | (3-1) | 2% |
| 5-BB(2F,3F)-O2 | (5-3) | 3% |
| V2-BB(2F,3F)-O2 | (5-3) | 3% |
| 3-H1OB(2F,3F)-O2 | (5-5) | 3% |
| 3-HDhB(2F,3F)-O2 | (6-3) | 7% |
| 3-HH1OB(2F,3F)-O2 | (6-5) | 19% |
| 3-dhBB(2F,3F)-O2 | (6-9) | 3% |
| 3-HchB(2F,3F)-O2 | (6-18) | 3% |
| 2-BB(2F,3F)B-3 | (7-1) | 10% |

NI=75.6° C.; η=25.3 mPa·s; Δη=0.100; Δε=−4.4.

### Use Example 27

| | | |
|---|---|---|
| 4O-B(2F,3F)-O5(4Me) | (966) | 7% |
| 2-HH-3 | (2-1) | 18% |
| 3-HH-4 | (2-1) | 9% |
| 3-HB-O2 | (2-5) | 2% |
| 1-BB-3 | (2-8) | 3% |
| 3-HHB-1 | (3-1) | 3% |
| 3-HHB-O1 | (3-1) | 4% |
| V-HBB-2 | (3-4) | 3% |
| 5-B(F)BB-2 | (3-8) | 4% |
| 3-BB(2F,3F)-O2 | (5-3) | 5% |
| 5-BB(2F,3F)-O2 | (5-3) | 5% |
| 2-HH1OB(2F,3F)-O2 | (6-5) | 13% |
| 3-HH1OB(2F,3F)-O2 | (6-5) | 15% |
| 3-HB(2F,3F)B-2 | (7-2) | 4% |
| V-HH2BB(2F,3F)-O2 | (8-3) | 5% |

NI=73.1° C.; η=17.1 mPa·s; Δη=0.091; Δε=−3.1.

### Use Example 28

| | | |
|---|---|---|
| h-Cpr1OB(2F,3F)-O4 | (224) | 11% |
| 3-HH-V | (2-1) | 24% |
| 1-BB-3 | (2-8) | 3% |
| 3-HHB-1 | (3-1) | 10% |
| 5-B(F)BB-2 | (3-8) | 6% |
| 3-BB(2F,3F)-O2 | (5-3) | 6% |
| 2-HH1OB(2F,3F)-O2 | (6-5) | 19% |
| 3-HH1OB(2F,3F)-O2 | (6-5) | 15% |
| 5-HFLF4-3 | (13-1) | 2% |
| 3-H2BBB(2F,3F)-O2 | (8-1) | 4% |

NI=71.9° C.; η=22.1 mPa·s; Δη=0.093; Δε=−3.5.

### INDUSTRIAL APPLICABILITY

A liquid crystal compound of the invention has excellent physical properties. A liquid crystal composition containing the compound can be widely utilized for a liquid crystal display device of a monitor, a television and so forth.

What is claimed is:

1. A compound, represented by formula (1): 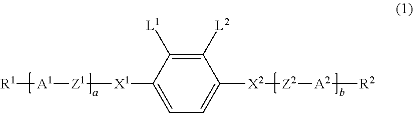
wherein, in formula (1),
R¹ is alkyl having 1 to 15 carbons, and in the alkyl, at least one —CH₂— may be replaced by —O— or —S—, and at least one —CH₂CH₂— may be replaced by —CH═CH—, —C≡C—, —COO— or —OCO—, and in the groups, at least one hydrogen may be replaced by fluorine or chlorine;
R² is alkyl having a branched-chain and 3 to 15 carbons, alkyl having a branched-chain and 3 to 15 carbons in which at least one hydrogen is replaced by fluorine, or straight-chain alkyl having 2 to 15 carbons in which 1 to 4 hydrogens are replaced by fluorine, and in the alkyl, at least one —CH₂— may be replaced by —O— or —S—, and at least one —CH₂CH₂— may be replaced by —CH═CH—, —C≡C—, —COO— or —OCO—;
A¹ and A² are independently 1,2-cyclopropylene, 1,2-cyclopropenylene, 1,3-cyclopropenylene, 1,3-cyclobutylene, 1,3-cyclobutenylene, 1,3-cyclopentylene, 1,3-cyclopentenylene, 1,4-cyclopentenylene or 3,5-cyclopentenylene;
Z¹ and Z² are independently a single bond or alkylene having 1 to 15 carbons, and in the alkylene, at least one —CH₂— may be replaced by —O— or —S—, and at least one —CH₂CH₂— may be replaced by —CH═CH—, —CC—, —COO— or —OCO—, and in the divalent groups, at least one hydrogen may be replaced by fluorine or chlorine;
L¹ and L² are independently fluorine, chlorine, —OCF₃ or —OCH₂F;
X¹ and X² are independently oxygen or sulfur;
a is 0 or 1, and b is 0 or 1, and a sum of a and b is 0, 1 or 2; and
R¹ is hydrogen when a is 1, and R² is hydrogen when b is 1, and X¹ may be a single bond when b is 1.

2. The compound according to claim 1, wherein
in formula (1),
R¹ is alkyl having 1 to 15 carbons, and in the alkyl, one or two —CH₂— may be replaced by —O—, and one or two —CH₂CH₂— may be replaced by —CH═CH—, —C≡C—, —COO— or —OCO—, and in the groups, at least one hydrogen may be replaced by fluorine or chlorine;
R² is alkyl having a branched-chain and 3 to 15 carbons, alkyl having a branched-chain and 3 to 15 carbons in which at least one hydrogen is replaced by fluorine, or straight-chain alkyl having 2 to 15 carbons in which 1 to 4 hydrogens are replaced by fluorine, and in the alkyl, one or two —CH₂— may be replaced by —O—, and one or two —CH₂CH₂— may be replaced by —CH═CH—, —C≡C—, —COO— or —OCO—;
A¹ and A² are independently 1,2-cyclopropylene, 1,3-cyclobutylene or 1,3-cyclopentylene;
Z¹ and Z² are independently a single bond or alkylene having 1 to 15 carbons, and in the alkylene, one or two —CH₂— may be replaced by —O— or —S—, and one or two —CH₂CH₂— may be replaced by —CH═CH—, —CC—, —COO— or —OCO—, and in the divalent groups, at least one hydrogen may be replaced by fluorine or chlorine;
L¹ and L² are independently fluorine, chlorine, —OCF₃ or —OCH₂F;
X¹ and X² are independently oxygen or sulfur;
a is 0 or 1, and b is 0 or 1, and a sum of a and b is 0, 1 or 2; and
R¹ is hydrogen when a is 1, and R² is hydrogen when b is 1, and X¹ may be a single bond when b is 1.

3. The compound according to claim 1, represented by any one of formula (1-1) to formula (1-5): 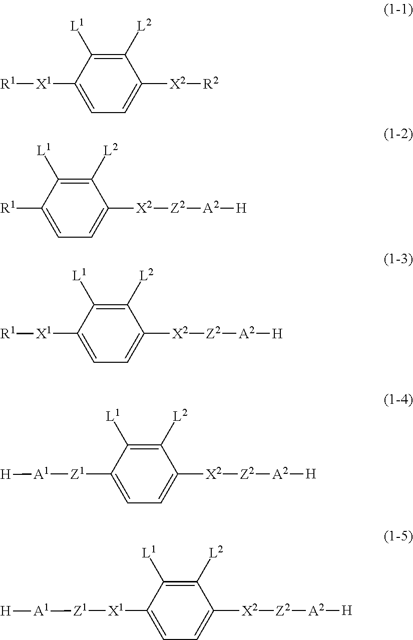
wherein, in formula (1-1) to formula (1-5),
R¹ is alkyl having 1 to 15 carbons, and in the alkyl, at least one —CH₂— may be replaced by —O—, and one or two —CH₂CH₂— may be replaced by —CH═CH—, and in the groups, at least one hydrogen may be replaced by fluorine;
R² is alkyl having a branched-chain and 3 to 15 carbons, alkyl having a branched-chain and 3 to 15 carbons in which at least one hydrogen is replaced by fluorine, or straight-chain alkyl having 2 to 15 carbons in which 1 to 4 hydrogens are replaced by fluorine, and in the alkyl, at least one —CH₂— may be replaced by —O—, and one or two —CH₂CH₂— may be replaced by —CH═CH—;
A¹ and A² are independently 1,2-cyclopropylene, 1,3-cyclobutylene or 1,3-cyclopentylene;
Z¹ and Z² are independently a single bond or alkylene having 1 to 15 carbons, and in the alkylene, one or two —CH₂— may be replaced by —O—, and one or two —CH₂CH₂— may be replaced by —CH═CH—, and in the divalent groups, at least one hydrogen may be replaced by fluorine;
L¹ and L² are independently fluorine, chlorine, —OCF₃ or —OCH₂F; and
X¹ and X² are independently oxygen or sulfur.

4. The compound according to claim 3, wherein
in formula (1-1) to formula (1-5),
R¹ is alkyl having 1 to 10 carbons, alkoxy having 1 to 9 carbons, alkoxyalkyl having 2 to 9 carbons, alkenyl having 2 to 10 carbons or alkenyloxy having 2 to 9 carbons, and in the groups, at least one hydrogen may be replaced by fluorine;
R² is alkyl having a branched-chain and 3 to 10 carbons, alkoxyalkyl having a branched-chain and 3 to 9 carbons, alkenyl having a branched-chain and 3 to 10 carbons, alkyl having a branched-chain and 3 to 10 carbons in which at least one hydrogen is replaced by fluorine, alkoxyalkyl having a branched-chain and 3 to 9 carbons in which at least one hydrogen is replaced by fluorine, alkenyl having a branched-chain and 3 to 10 carbons in which at least one hydrogen is replaced by fluorine, straight-chain alkyl having 2 to 10 carbons in which 1 to 4 hydrogens are replaced by fluorine, or straight-chain alkoxyalkyl having 2 to 9 carbons in which 1 to 4 hydrogens are replaced by fluorine, or straight-chain alkenyl having 2 to 10 carbons in which 1 to 4 hydrogens are replaced by fluorine;
A¹ and A² are 1,2-cyclopropylene, 1,3-cyclobutylene or 1,3-cyclopentylene;
Z¹ and Z² are independently a single bond or alkylene having 1 to 10 carbons, alkylene having 1 to 10 carbons in which one or two —CH₂— are replaced by —O—, or alkylene having 2 to 10 carbons in which one or two —CH₂CH₂— are replaced by —CH═CH—, and in the divalent groups, at least one hydrogen may be replaced by fluorine;
L¹ and L² are independently fluorine or —OCF₃; and
X¹ and X² are independently oxygen or sulfur.

5. The compound according to claim 1, represented by formula (1-6): 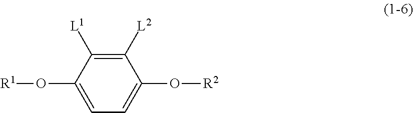
wherein, in formula (1-6),
R¹ is alkyl having 1 to 10 carbons, alkoxyalkyl having 2 to 9 carbons and alkenyl having 2 to 10 carbons;
R² is alkyl having a branched-chain and 3 to 10 carbons, alkoxyalkyl having a branched-chain and 3 to 9 carbons, alkenyl having a branched-chain and 3 to 10 carbons, straight-chain alkyl having 2 to 10 carbons in which 1 to 4 hydrogens are replaced by fluorine, straight-chain alkoxyalkyl having 2 to 9 carbons in which 1 to 4 hydrogens are replaced by fluorine, or alkenyl having 2 to 10 carbons in which 1 to 4 hydrogens are replaced by fluorine; and
L¹ and L² are independently fluorine or —OCF₃.

6. The compound according to claim 5, wherein
in formula (1-6),
R¹ is alkyl having 1 to 6 carbons, alkoxyalkyl having 2 to 6 carbons and alkenyl having 2 to 6 carbons;
R² is straight-chain alkyl having 2 to 6 carbons in which 1 to 4 hydrogens are replaced by fluorine, straight-chain alkoxyalkyl having 2 to 6 carbons in which 1 to 4 hydrogens are replaced by fluorine, or straight-chain alkenyl having 2 to 6 carbons in which 1 to 4 hydrogens are replaced by fluorine; and
L¹ and L² are fluorine.

7. The compound according to claim 1, represented by any one of formula (1-7) to formula (1-12): 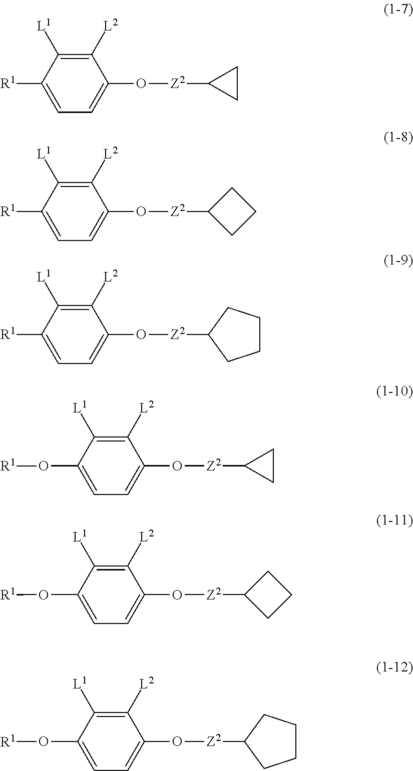
wherein, in formula (1-7) to formula (1-12),
R¹ is alkyl having 1 to 10 carbons, alkoxyalkyl having 2 to 9 carbons and alkenyl having 2 to 10 carbons;
Z² is a single bond or alkylene having 1 to 6 carbons, alkylene having 1 to 6 carbons in which one —CH₂— is replaced by —O—, or alkylene having 2 to 6 carbons in which one or two —CH₂CH₂— are replaced by —CH═CH—; and
L¹ and L² are independently fluorine or —OCF₃.

8. The compound according to claim 7, wherein
in formula (1-7) to formula (1-12),
R¹ is alkyl having 1 to 6 carbons, alkoxyalkyl having 2 to 6 carbons and alkenyl having 2 to 6 carbons;
Z² is a single bond or alkylene having 1 to 6 carbons, or alkylene having 2 to 6 carbons in which one —CH₂CH₂— is replaced by —CH═CH—; and
L¹ and L² are fluorine.

9. The compound according to claim 1, represented by any one of formula (1-12) to formula (1-29): 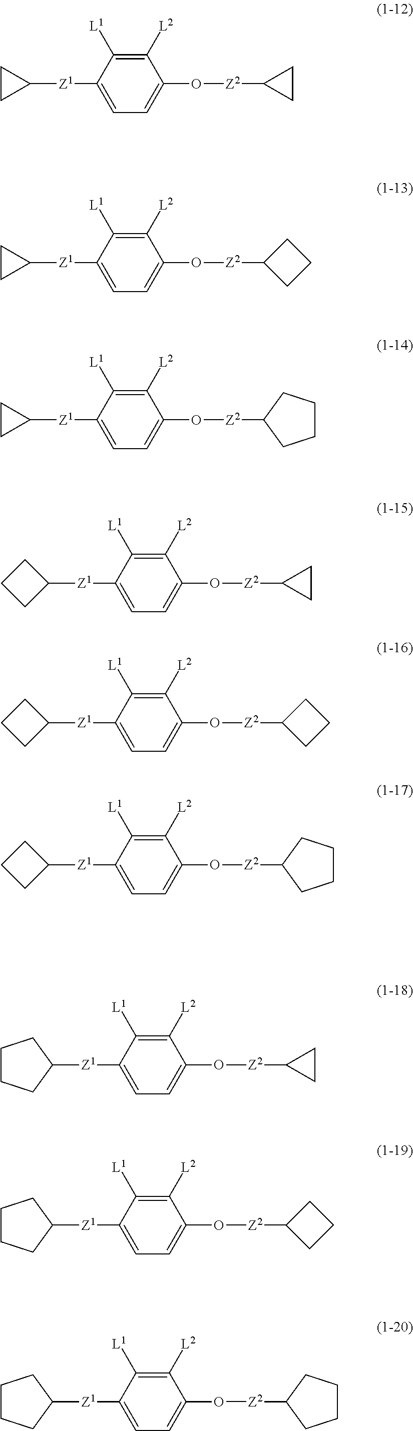 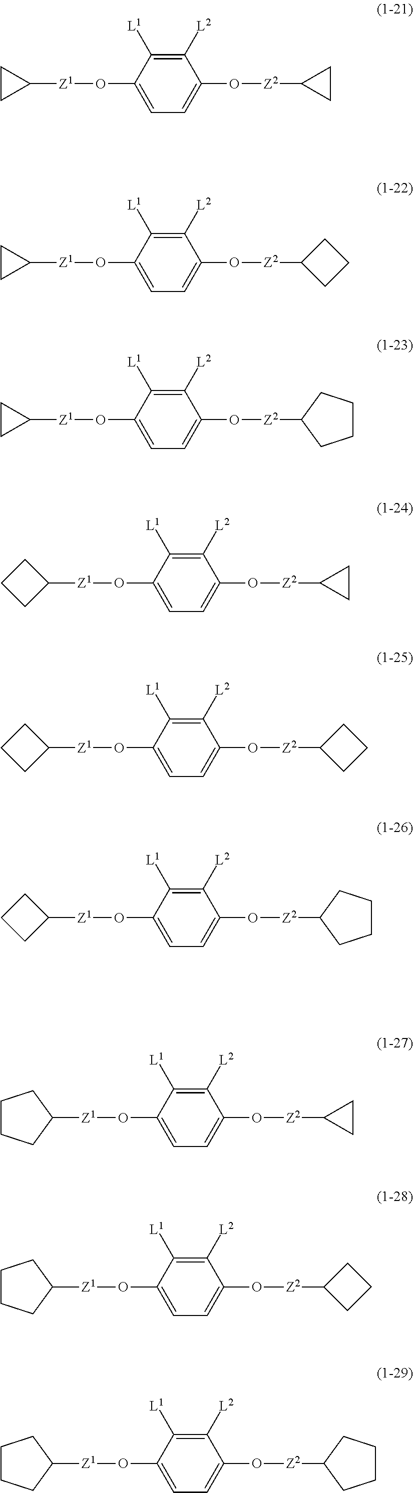
wherein, in formula (1-12) to formula (1-29),
Z¹ and Z² are independently a single bond or alkylene having 1 to 6 carbons, alkylene having 1 to 10 carbons in which one —CH₂— is replaced by —O—, or alkylene having 2 to 10 carbons in which one or two —CH₂CH₂— are replaced by —CH═CH—; and L¹ and L² are independently fluorine or —OCF₃.

10. The compound according to claim 9, wherein
in formula (1-12) to formula (1-29),
Z¹ and Z² are a single bond or alkylene having 1 to 6 carbons, or alkylene having 2 to 6 carbons in which one —CH₂CH₂— is replaced by —CH═CH—; and L¹ and L² are fluorine.

11. A liquid crystal composition, containing at least one compound represented by formula (1), and at least one compound selected from the group of compounds represented by formula (2) to formula (4): 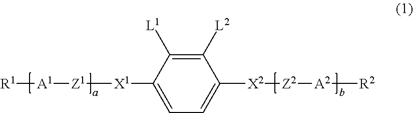
wherein, in formula (1),
R¹ is alkyl having 1 to 15 carbons, in the alkyl, at least one —CH₂— may be replaced by —O— or —S—, and at least one —CH₂CH₂— may be replaced by —CH═CH—, —C≡C—, —COO— or —OCO—, and in the groups, at least one hydrogen may be replaced by fluorine or chlorine;
R² is alkyl having a branched-chain and 3 to 15 carbons, alkyl having a branched-chain and 3 to 15 carbons in which at least one hydrogen is replaced by fluorine, or straight-chain alkyl having 2 to 15 carbons in which 1 to 4 hydrogens are replaced by fluorine, and in the alkyl, at least one —CH₂— may be replaced by —O— or —S—, and at least one —CH₂CH₂— may be replaced by —CH═CH—, —C≡C—, —COO— or —OCO—;
A¹ and A² are independently 1,2-cyclopropylene, 1,2-cyclopropenylene, 1,3-cyclopropenylene, 1,3-cyclobutylene, 1,3-cyclobutenylene, 1,3-cyclopentylene, 1,3-cyclopentenylene, 1,4-cyclopentenylene or 3,5-cyclopentenylene;
Z¹ and Z² are independently a single bond or alkylene having 1 to 15 carbons, and in the alkylene, at least one —CH₂— may be replaced by —O— or —S—, and at least one —CH₂CH₂— may be replaced by —CH═CH—, —CC—, —COO— or —OCO—, and in the divalent groups, at least one hydrogen may be replaced by fluorine or chlorine;
L¹ and L² are independently fluorine, chlorine, —OCF₃ or —OCH₂F;
X¹ and X² are independently oxygen or sulfur;
a is 0 or 1, b is 0 or 1, and a sum of a and b is 0, 1 or 2;
R¹ is hydrogen when a is 1, and R² is hydrogen when b is 1, and X¹ may be a single bond when b is 1; 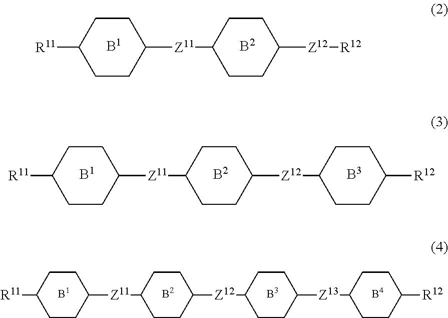
wherein, in formula (2) to formula (4),
R¹¹ and R¹² are independently alkyl having 1 to 10 carbons or alkenyl having 2 to 10 carbons, and in the alkyl and the alkenyl, at least one —CH₂— may be replaced by —O—, and in the groups, at least one hydrogen may be replaced by fluorine;
ring B¹, ring B², ring B³ and ring B⁴ are independently 1,4-cyclohexylene, 1,4-phenylene, 2-fluoro-1,4-phenylene, 2,5-difluoro-1,4-phenylene or pyrimidine-2,5-diyl; and
Z¹¹, Z¹² and Z¹³ are independently a single bond, —COO—, —CH₂CH₂—, —CH═CH— or —C≡C—.

12. The liquid crystal composition according to claim 11, further containing at least one compound selected from the group of compounds represented by formula (5) to formula (13): 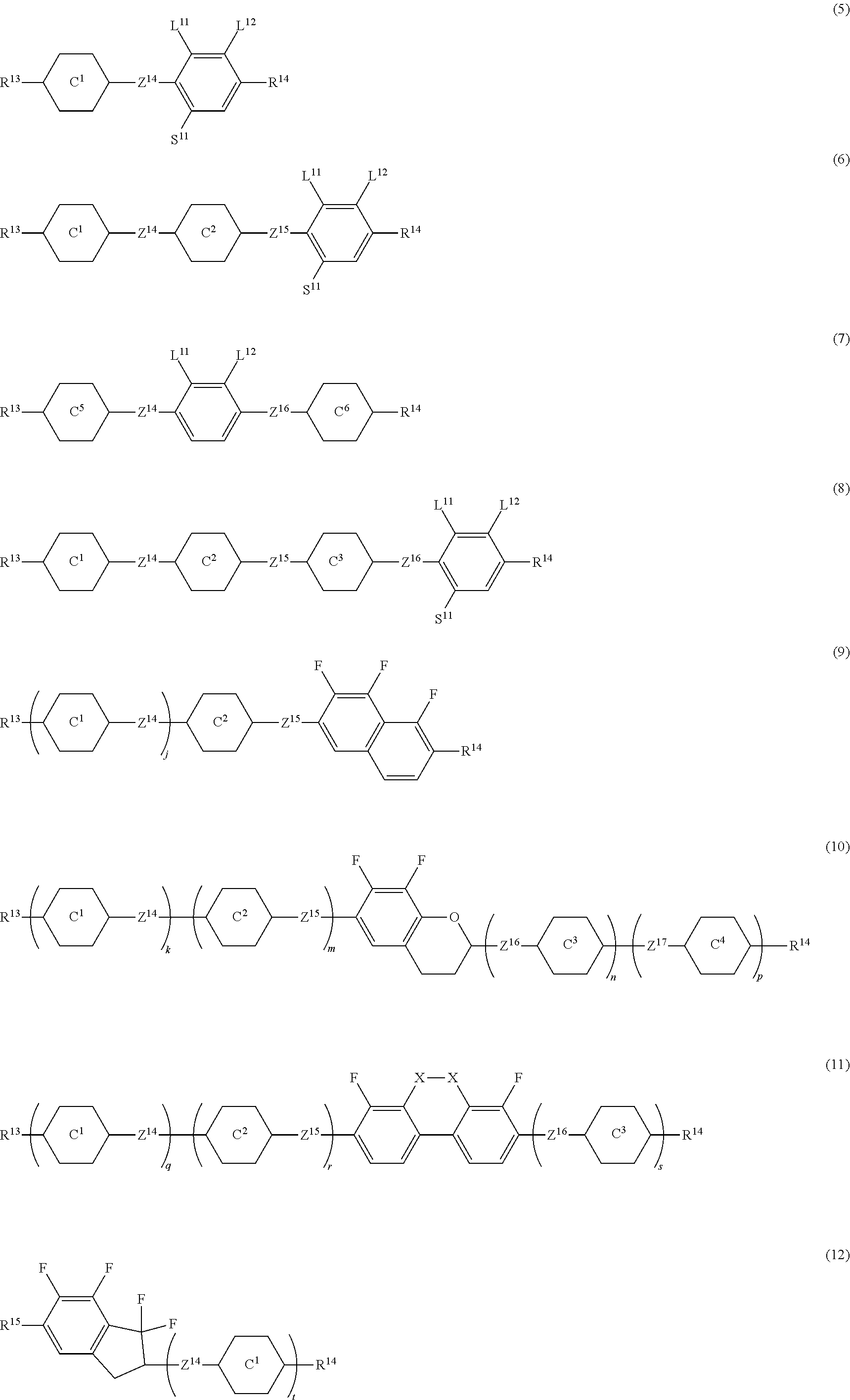 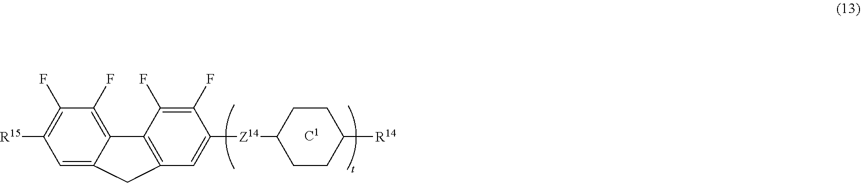
wherein, in formula (5) to formula (13),
R¹³, R¹⁴ and R¹⁵ are independently alkyl having 1 to 10 carbons or alkenyl having 2 to 10 carbons, and in the alkyl and the alkenyl, at least one —CH₂— may be replaced by —O—, and in the groups, at least one hydrogen may be replaced by fluorine, and R¹⁵ may be hydrogen or fluorine;
ring C¹, ring C², ring C³ and ring C⁴ are independently 1,4-cyclohexylene, 1,4-cyclohexenylene, 1,4-phenylene in which at least one hydrogen may be replaced by fluorine, tetrahydropyran-2,5-diyl or decahydronaphthalene-2,6-diyl;
ring C⁵ and ring C⁶ are independently 1,4-cyclohexylene, 1,4-cyclohexenylene, 1,4-phenylene, tetrahydropyran-2,5-diyl, or decahydronaphthalene-2,6-diyl;
Z¹⁴, Z¹⁵, Z¹⁶ and Z¹⁷ are independently a single bond, —COO—, —CH₂O—, —OCF₂—, —CH₂CH₂— or —OCF₂CH₂CH₂—;
L¹¹ and L¹² are independently fluorine or chlorine;
S¹¹ is hydrogen or methyl;
X is —CHF— or —CF₂—; and
j, k, m, n, p, q, r and s are independently 0 or 1, a sum of k, m, n and p is 1 or 2, a sum of q, r and s is 0, 1, 2 or 3, and t is 1, 2 or 3.

13. The liquid crystal composition according to claim 11, further containing at least one compound selected from the group of compounds represented by formula (21) to formula (23): 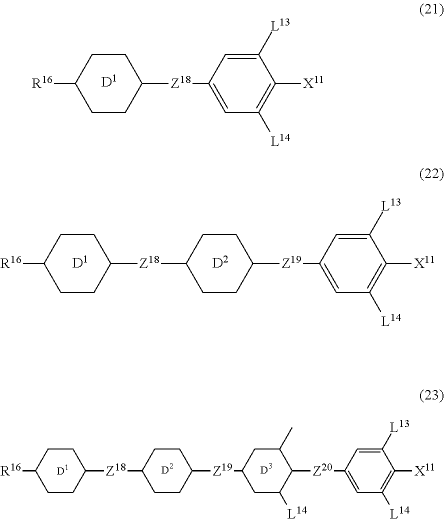
wherein, in formula (21) to formula (23),
R¹⁶ is alkyl having 1 to 10 carbons or alkenyl having 2 to 10 carbons, and in the alkyl and the alkenyl, at least one —CH₂— may be replaced by —O—, and in the groups, at least one hydrogen may be replaced by fluorine;
X¹¹ is fluorine, chlorine, —CF₃, —CHF₂, —CH₂F, —OCF₃, —OCHF₂, —OCF₂CHF₂ or —OCF₂CHFCF₃;
ring D¹, ring D² and ring D³ are independently 1,4-cyclohexylene, 1,4-phenylene in which at least one hydrogen may be replaced by fluorine, tetrahydropyran-2,5-diyl, 1,3-dioxane-2,5-diyl or pyrimidine-2,5-diyl;
Z¹⁸, Z¹⁹ and Z²⁰ are independently a single bond, —COO—, —CH₂O—, —CF₂O—, —OCF₂—, —CH₂CH₂—, —CH═CH—, —C≡C— or —(CH₂)₄—; and
L¹³ and L¹⁴ are independently hydrogen or fluorine.

14. The liquid crystal composition according to claim 11, further containing at least one compound represented by formula (24): 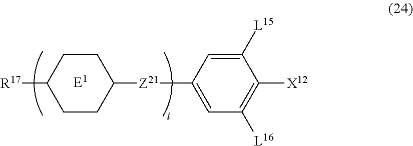
wherein, in formula (24),
R¹⁷ is alkyl having 1 to 10 carbons or alkenyl having 2 to 10 carbons, and in the alkyl and the alkenyl, at least one —CH₂— may be replaced by —O—, and in the groups, at least one hydrogen may be replaced by fluorine;
X¹² is —C≡N or —C≡C—C≡N;
ring E¹ is 1,4-cyclohexylene, 1,4-phenylene in which at least one hydrogen may be replaced by fluorine, tetrahydropyran-2,5-diyl, 1,3-dioxane-2,5-diyl or pyrimidine-2,5-diyl;
Z²¹ is a single bond, —COO—, —CH₂O—, —CF₂O—, —OCF₂—, —CH₂CH₂— or —C≡C—;
L¹⁵ and L¹⁶ are independently hydrogen or fluorine; and
i is 1, 2, 3 or 4.

15. A liquid crystal display device, including the liquid crystal composition according to claim 11.
